(19) United States
(12) Patent Application Publication
(10) Pub. No.: US 2013/0217333 A1
(43) Pub. Date: Aug. 22, 2013

(54) DETERMINING REWARDS BASED ON PROXIMITY OF DEVICES USING SHORT-RANGE WIRELESS BROADCASTS

(71) Applicant: QUALCOMM Incorporated, (US)

(72) Inventors: Stephen A. Sprigg, Poway, CA (US); Steven R. Altman, La Jolla, CA (US); Elizabeth A. Gasser, San Diego, CA (US); Joel Linsky, San Diego, CA (US); Leif A. Woodahl, Poway, CA (US); Jose R. Menendez, Encinitas, CA (US); Charles S. Wurster, San Diego, CA (US); Paul E. Jacobs, La Jolla, CA (US); Neville J. Meijers, San Diego, CA (US); Margaret L. Johnson, Rancho Santa Fe, CA (US); David E. Wise, San Diego, CA (US); Kevin E. Hunter, La Jolla, CA (US); Mark A. Maggenti, Del Mar, CA (US); Paul J. Lafata, San Diego, CA (US); Christopher P. Hebert, San Diego, CA (US); Jason B. Kenagy, San Diego, CA (US)

(73) Assignee: QUALCOMM Incorporated, San Diego, CA (US)

(21) Appl. No.: 13/833,291

(22) Filed: Mar. 15, 2013

Related U.S. Application Data
(63) Continuation-in-part of application No. 13/773,379, filed on Feb. 21, 2013.
Application No. 13/773,379 is a continuation-in-part of application No. 13/773,336, filed on Feb. 21, 2013.
(60) Provisional application No. 61/601,620, filed on Feb. 22, 2012.
(60) Provisional application No. 61/637,834, filed on Apr. 24, 2012.
(60) Provisional application No. 61/693,169, filed on Aug. 24, 2012.
(60) Provisional application No. 61/670,226, filed on Jul. 11, 2012.
(60) Provisional application No. 61/701,457, filed on Sep. 14, 2012.
(60) Provisional application No. 61/713,239, filed on Oct. 12, 2012.
(60) Provisional application No. 61/716,373, filed on Oct. 19, 2012.
(60) Provisional application No. 61/717,964, filed on Oct. 24, 2012.
(60) Provisional application No. 61/728,677, filed on Nov. 20, 2012.
(60) Provisional application No. 61/745,395, filed on Dec. 21, 2012.
(60) Provisional application No. 61/745,308, filed on Dec. 21, 2012.

(51) Int. Cl. H04W 4/00

(52) U.S. Cl. CPC H04W 4/008
USPC 455/41.2

(57) ABSTRACT

Methods, systems and devices for presenting rewards to users based on proximity of short-range wireless devices. A wireless identity transmitter may periodically transmit wireless broadcast messages that include obscured identifiers. When within proximity, a proximity broadcast receiver, such as a mobile device carried by a user, may receive and relay the broadcast messages to a server which may process the included information. Based on decrypting the obscured identifiers, the central server may determine whether relayed messages relate to devices associated with a reward program, and may calculate rewards, such as coupons, money, or prizes. Rewards may be presented to users based on sensor data indicated within broadcast messages. In an embodiment, when the server receives a sighting message related to an active search for a target device, a reward is presented to the user of the proximity broadcast receiver that transmitted the sighting message.

### RELATED APPLICATIONS

The present application is a continuation-in-part of and claims priority to U.S. patent application Ser. No. 13/733,379, titled “Platform for Wireless Identity Transmitter and System Using Short-Range Wireless Broadcasts,” filed Feb. 21, 2013 and U.S. patent application Ser. No. 13/773,336, titled “Preserving Security By Synchronizing a Nonce or Counter Between Systems,” filed Feb. 21, 2013, each of which claims the benefit of priority to U.S. Provisional Application No. 61/601,620, filed Feb. 22, 2012, U.S. Provisional Application No. 61/637,834, filed Apr. 24, 2012, U.S. Provisional Application No. 61/693,169, filed Aug. 24, 2012, U.S. Provisional Application No. 61/670,226, filed Jul. 11, 2012, U.S. Provisional Application No. 61/701,457, filed Sep. 14, 2012, U.S. Provisional Application No. 61/713,239, filed Oct. 12, 2012, U.S. Provisional Application No. 61/716,373, filed Oct. 19, 2012, U.S. Provisional Application No. 61/717,964, filed Oct. 24, 2012, U.S. Provisional Application No. 61/728,677, filed Nov. 20, 2012, and U.S. Provisional Application No. 61/745,395, filed Dec. 21, 2012, U.S. Provisional Application No. 61/745,308, filed Dec. 21, 2012, the entire contents of all of which are hereby incorporated by reference.

### BACKGROUND

Cellular and wireless communication devices have seen explosive growth over the past several years. This growth has been fueled by better communications hardware, larger networks, and more reliable protocols. Today's smartphones include cameras, GPS receivers, Bluetooth® transceivers, and of course the cellular communication capabilities (e.g., LTE, 3G and/or 4G network access) to enable the devices to establish data communication links with the Internet. Smartphones are now very widely deployed in society. Additionally, the components and capabilities in smartphones are now very affordable, enabling the capabilities to be deployed in other types of devices.

Numerous solutions have been proposed to facilitate tracking or locating persons or assets leveraging cellular and wireless devices. Most of these systems involve the development of a wearable device that communicates the position of the wearer to a server. Others involve establishment of a radio connection between the wearer and a cellular device. In both cases, these systems suffer from issues of cost, effectiveness and practicality, which limit their viability.

In general, tracking systems may also have suboptimal value when they do not include sufficient coverage for the areas where tracked items may be located. For example, if a large area (e.g., a city) includes only a few devices that participate in reporting location information of tracked items, an associated tracking system may only be able to provide partial, out-of-date, or sporadic tracking information that may not be useful to users attempting to locate the tracked items. Additionally, retailers and merchants are generally interested in finding better ways to track and encourage business interactions with customers. For example, a merchant may desire to increase customer visits or foot traffic within a store in order to encourage purchases and/or promote goodwill. Further, such tracking systems may be used beyond determining location information of tracked items, and may be employed to identify and adjust behaviors of items and/or users.

### SUMMARY

The various embodiments provide systems, devices, and methods for presenting rewards to users based on proximity of short-range wireless devices. In general, a compact wireless identity transmitter associated with a user may be configured to broadcast messages that include a unique and secure identification code via a short-range wireless radio, such as a Bluetooth® Low Energy (LE) transceiver. In various embodiments, the wireless identity transmitter may be affixed to an item, person, pet, or other asset. The identification broadcast packets (“broadcast messages”) may be received by physically proximate proximity broadcast receivers (PBR), which may be dedicated receivers, smartphones configured with a PBR application, tablet computers configured with a PBR application, and stationary receivers, to name just a few examples. The broadcast messages may be received by proximity broadcast receivers when the wireless identity transmitter is within reception range (e.g., within 0 to 25 feet). Proximity broadcast receivers may be mobile (e.g., smartphones configured with a PBR application) or stationary. Stationary proximity broadcast receivers may be positioned in strategic locations, such as in a movie theater, in or near stores within a shopping mall, at various locations within an amusement park, near doors of a house, and near particular product displays within a retail store. Because the wireless identity transmitter broadcasts short-range wireless signals, the approximate location of the wireless identity transmitter is provided by the location of the proximity broadcast receiver receiving its broadcast signals. Proximity broadcast receivers may relay received broadcast messages, along with other information (e.g., timestamp data, proximity information, etc.), to a central server in the form of sighting messages. Such a central server may use the information received in sighting messages to track the wireless identity transmitter, and thus a user associated with that device.

The central server may maintain a database of relayed information that may represent historical and/or actively updated information for the wireless identity transmitter, such as proximities to proximity broadcast receivers and/or predefined areas over a period. The central server may use the identification code within the relayed messages to identify the wireless identity transmitter, and thus the user associated with the device. In this way, when the wireless identity transmitter is affixed to or otherwise collocated with a lost, stolen, or searched for items, the central server may locate the item based on messages received from proximity broadcast receivers.

Users registered with the central server may be encouraged to configure their mobile devices to operate as proximity broadcast receivers by offering rewards when proximity broadcast receivers transmit messages related to a wireless identity transmitter that is the subject of an active search. In particular, in response to a mobile proximity broadcast receiver (e.g., a smartphone configured to operate as a proximity broadcast receiver) relaying or otherwise transmitting proximity information corresponding to a searched for wireless identity transmitter (e.g., a lost, stolen, or targeted item), the central server may identify the user of the mobile proximity broadcast receiver as a reward recipient. Reward recipients may receive notification messages indicating their reward and/or instructions for obtaining the reward. Rewards may include various incentives, such as coupons, money, prizes, product offers, items, and information. Additionally, users may be encouraged to adjust their behavior based on participation in various reward programs. For example, when the central server receives messages indicating a user's activity (e.g., accelerometer sensor data) or the user has been within proximity of a predefined area (e.g., school), the user may receive an accolade, prize, or credits. In another embodiment, a mobile device may be configured to implement a user interface that appears as a scratch-off ticket. For example, the mobile device may display coupons for nearby product deals that cannot be claimed by the user until a scratch-off graphical element is removed via a touchscreen touch input gesture.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system diagram illustrating network components suitable for use in various embodiments.

FIG. 2 is a communication system diagram illustrating network components of embodiment architectures suitable for use in various embodiments.

FIG. 3 is a process flow diagram illustrating an embodiment method for broadcasting an identifier from a wireless identity transmitter.

FIG. 4 is a process flow diagram illustrating an embodiment method for a wireless identity transmitter receiving configuration settings after performing boot-up operations.

FIG. 5 is a process flow diagram of an embodiment method for a wireless identity transmitter performing two-way wireless communications with a proximity broadcast receiver.

FIG. 6 is a component diagram illustrating various modules within a mobile proximity broadcast receiver suitable for use in various embodiments.

FIG. 7 is a process flow diagram illustrating an embodiment method of a mobile proximity broadcast receiver relaying a wireless identity transmitter's identifier along with other data such as a time or location.

FIG. 8 is a call flow diagram for responding to a user request for a wireless identity transmitter's location in accordance with various embodiments.

FIG. 9 is a process flow diagram illustrating an embodiment method of performing code within a received broadcast message.

FIG. 10 is a process flow diagram illustrating an embodiment method of receiving an instruction from a central server in response to transmitting a sighting message based on proximity to a wireless identity transmitter.

FIG. 11 is a process flow diagram illustrating an embodiment method for a proximity broadcast receiver relaying a received broadcast message to and receiving a return message from a central server.

FIG. 12 is a component diagram illustrating various modules within a central server suitable for use in various embodiments.

FIG. 13 is a diagram illustrating a wireless identity transmitter registration process for use in various embodiments.

FIGS. 14A and 14B are process flow diagrams illustrating embodiment methods for a central server to process sighting messages received from proximity broadcast receivers.

FIGS. 15A-B are call flow diagrams illustrating communications between a wireless identity transmitter, a proximity broadcast receiver, and a central server in accordance with various embodiments.

FIG. 16 is a process flow diagram illustrating an embodiment method for a central server receiving sighting messages from a proximity broadcast receiver and transmitting return messages including various data.

FIG. 17 is a process flow diagram illustrating an embodiment method for a central server determining whether a proximity broadcast receiver has lost a wireless identity transmitter.

FIGS. 18A and 18C are communication system diagrams of mobile proximity broadcast receivers in communication with a wireless identity transmitter.

FIGS. 18B and 18D are process flow diagrams illustrating embodiment methods for determining the location of the wireless identity transmitter in the communication systems illustrated in FIGS. 18A and 18C, respectively.

FIG. 19 is a process flow diagram illustrating an embodiment method for a server handling a rolling identifier.

FIG. 20 is a process flow diagram illustrating embodiment operations by a wireless identity transmitter and a central server for transmitting and processing rolling identifiers encrypted with an encryption algorithm.

FIG. 21A is a process flow diagram illustrating an embodiment method for a wireless identity transmitter generating and broadcasting rolling identifier payloads using an encryption algorithm.

FIG. 21B a process flow diagram illustrating an embodiment method for a central server receiving and handling rolling identifier payloads using an encryption algorithm.

FIG. 22 is a process flow diagram illustrating embodiment operations by a wireless identity transmitter and a central server for transmitting and processing rolling identifiers using a pseudo-random function.

FIG. 23A is a process flow diagram illustrating an embodiment method for a wireless identity transmitter generating and broadcasting rolling identifier payloads using a pseudo-random function.

FIG. 23B a process flow diagram illustrating an embodiment method for a central server receiving and handling rolling identifier payloads using a pseudo-random function.

FIG. 24A is a process flow diagram illustrating an embodiment method for a wireless identity transmitter generating and broadcasting messages with rolling identifiers and encoded nonces or counters.

FIGS. 24B-24C are process flow diagrams illustrating embodiment methods for a central server receiving and handling messages including rolling identifiers and encoded nonces or counters.

FIG. 25 is a process flow diagram of an embodiment method for calculating rewards program information in response to receiving sighting messages related to a wireless identity transmitter.

FIG. 26 is a process flow diagram of an embodiment method for calculating rewards program information in response to receiving sighting messages related to a wireless identity transmitter within proximity of a reward area.

FIG. 27 is a process flow diagram illustrating an embodiment method of a mobile proximity broadcast receiver responding to an alert for a particular wireless identity transmitter.

FIG. 28 is a call flow diagram for responding to a user request for a wireless identity transmitter's location by sending an alert in accordance with various embodiments.

FIG. 29 is a process flow diagram illustrating an embodiment method for sending alerts to mobile proximity broadcast receivers in identified sectors in response to a user request for a wireless identity transmitter's location.

FIGS. 30-31 are process flow diagrams of embodiment methods for determining rewards in response to receiving sighting messages related to a wireless identity transmitter.

FIGS. 32A-32B are diagrams of a mobile device displaying a coupon reward using a scratch-off user interface suitable for use in various embodiments.

FIGS. 32C-32D are process flow diagrams of embodiment methods for revealing reward information on a mobile device with a graphical user interface employing a scratch-off element.

FIGS. 33A-33B are component block diagrams of wireless identity transmitters in accordance with various embodiments.

FIGS. 34A-34B are component block diagrams of proximity broadcast receivers in accordance with various embodiments.

FIG. 35 is a component block diagram of a mobile device suitable for use in various embodiments.

FIG. 36 is a component block diagram of a server device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile device” is used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with a short-range radio (e.g., a Bluetooth® radio, a Peanut® radio, a WiFi radio, etc.) and a wide area network connection (e.g., an LTE, 3G or 4G wireless wide area network transceiver or a wired connection to the Internet). Reference to a particular type of computing device as being a mobile device is not intended to limit the scope of the claims unless a particular type of mobile device is recited in the claims.

The term “broadcast message” is used herein to refer to short-range wireless broadcast signals broadcast by wireless identity transmitters (defined below) that may include identification information (i.e., identifiers) associated with the wireless identity transmitters and/or their users. Such identifiers may be periodically changed and encrypted, encoded, or otherwise obscured (i.e., rolling identifiers). In various embodiments, broadcast messages may include other identifying information, such as Bluetooth® MAC addresses and nonces or counters, which may also be encrypted. Additionally, broadcast messages may include metadata and other data, such as characteristics of the transmitting wireless identity transmitter (e.g., device type), sensor data, and/or commands or other instructions. In various embodiments, broadcast messages may be transmitted via a wireless communication protocol, such as Bluetooth® Low Energy, WiFi, WiFi Direct, Zigbee®, Peanut®, and other RF protocol. In various embodiments, because of the high unreliability of certain short-range transmission channels, broadcast messages may be single packet transmissions limited to a certain size (e.g., 80 bits, 10 bytes, 20 bytes, etc.). For example, the payload of an embodiment broadcast message may be 80 total bits, including 4 bits that indicate battery status information and 76 bits that indicate a rolling identifier. As another example, an embodiment broadcast message may include 20 bits representing a nonce or counter and 60 bits representing a rolling identifier, such as generated with a pseudo-random function or encryption algorithm.

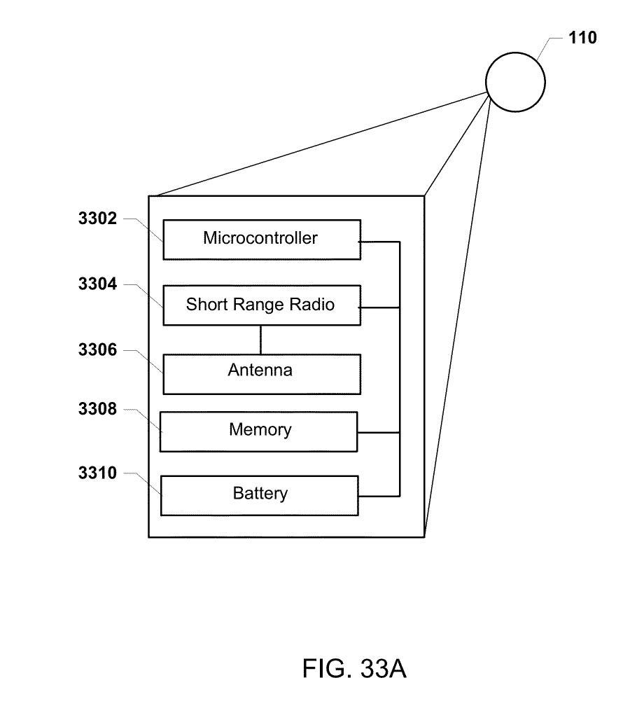

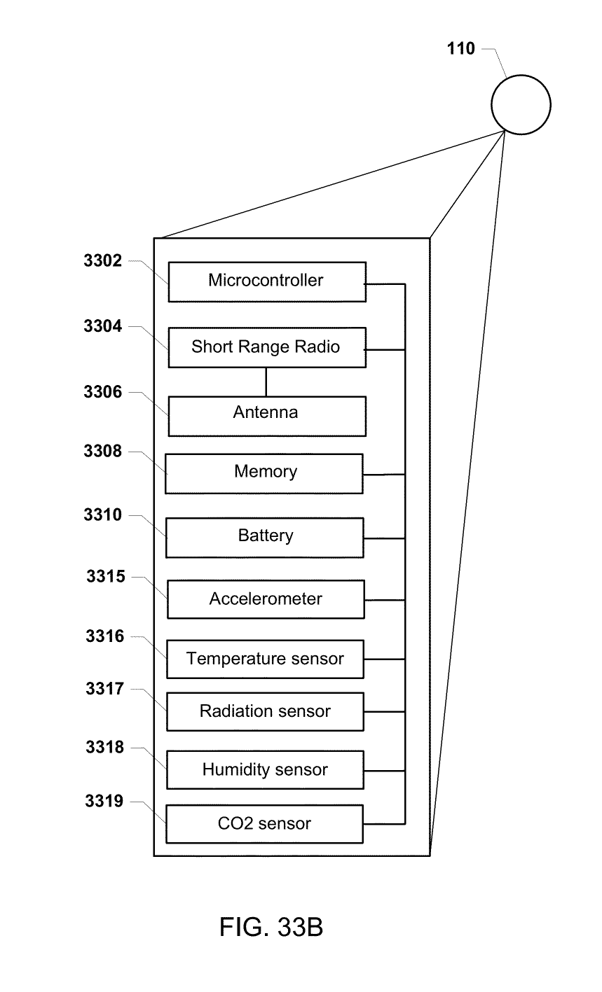

The term “wireless identity transmitter” is used herein to refer to a compact device configured to periodically transmit broadcast messages via short-range wireless transmitters. Wireless identity transmitters may be mobile, such as when carried or affixed to mobile persons or items, or alternatively may be stationary, such as when installed within buildings. Wireless identity transmitters may store and be associated with a unique device identifier (i.e., a “deviceID”), such as a factory ID. In an embodiment, the unique device identifier may be a code 56-bits in length. In various embodiments, for security purposes, this unique device identifier, along with other data (e.g., nonce or counter values), may be encoded, encrypted, or otherwise obfuscated when included within broadcast messages as a “rolling identifier.” Wireless identity transmitters may be configured to maintain inaccurate time (e.g., UTC) information, such as by using a 30 ppm 16 kHz crystal oscillator as a clock. In an embodiment, the wireless identity transmitter may be within or a mobile device, or alternatively, operations may be performed by a mobile device that are similar to the operations of the wireless identity transmitter. For example, a smartphone may execute software that configures that smartphone to utilize its Bluetooth® radio to transmit broadcast messages that include a secured, unique identifier. Wireless identity transmitters are described in more detail below with reference to FIGS. 33A-33B. In various figures and diagrams of this disclosure, wireless identity transmitters may be referred to as “WIT” or “WITs”.

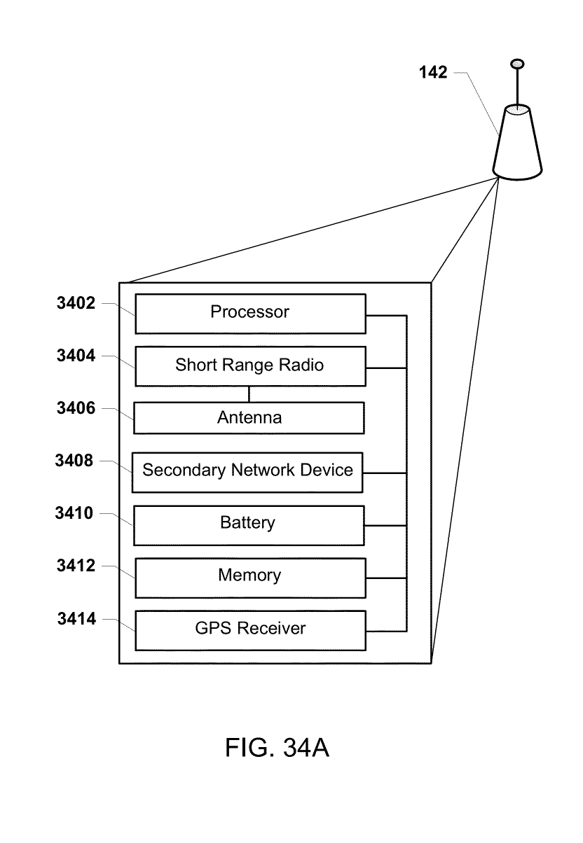

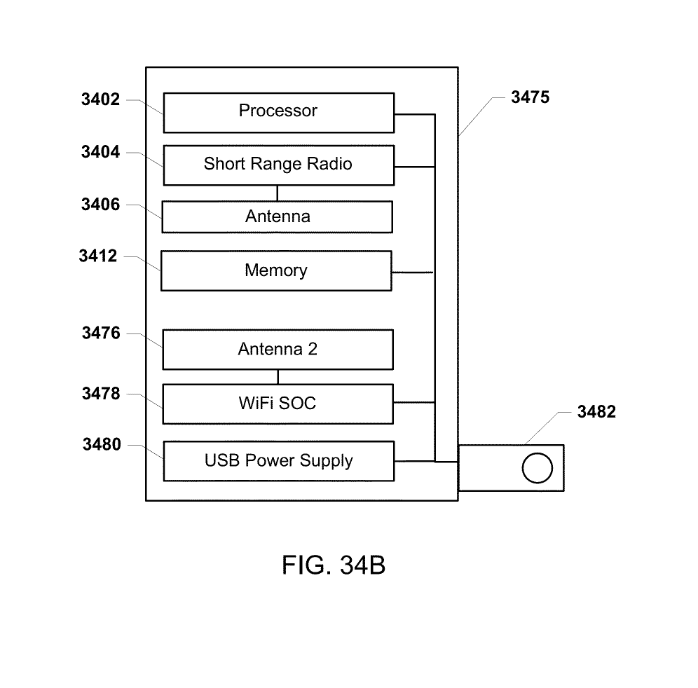

The term “proximity broadcast receiver” is used herein to refer to devices that are configured to receive broadcast messages, such as transmitted by wireless identity transmitters. In various embodiments, proximity broadcast receivers may be stationary devices (or “stationary proximity broadcast receivers”) permanently positioned throughout places (e.g., buildings, retail stores, etc.) or alternatively may be mobile devices configured to operate as proximity broadcast receivers (or “mobile proximity broadcast receivers”). For example, a smartphone may be configured to receive broadcast messages and operate as a mobile proximity broadcast receiver. Reference to a particular type of computing device as being a proximity broadcast receiver is not intended to limit the scope of the claims unless a particular type of device is recited in the claims. Further, unless otherwise indicated, references to proximity broadcast receivers throughout this disclosure are not intended to limit any method or system to a particular type of proximity broadcast receiver device (e.g., wireless or stationary). Proximity broadcast receivers are described in more detail below with reference to FIGS. 34A-34B. In various figures and diagrams of this disclosure, proximity broadcast receivers may be referred to as “PBR” or “PBRs,” and mobile proximity broadcast receivers are referred to in the figures as “MPBR” or “MPBRs.”

The terms “identity transceiver” and “wireless identity transceiver” are used herein to refer to devices that are configured to receive and transmit broadcast messages. In other words, an identity transceiver may function as both a proximity broadcast receiver and an identity transmitter. For example, a smartphone may be configured to broadcast short-range signals that include its unique identifier as well as receive broadcast messages from wireless identity transmitters within proximity. Throughout this disclosure, various operations may be described as being distinctly performed by either a wireless identity transmitter or a proximity broadcast receiver, however, those skilled in the art should appreciate that a device configured to operate as an identity transceiver may be configured to perform any or all of the same operations and thus may be interchangeable with references to either a wireless identity transmitter or a proximity broadcast receiver.

The term “sighting message” is used herein to refer to reports, signals, and/or messages sent by proximity broadcast receivers to a central server in response to receiving broadcast messages from wireless identity transmitters. Sighting messages may be transmissions that include part or all of the information encoded in received broadcast messages, including any obscured or encrypted information, such as identifiers of wireless identity transmitters. Additionally, sighting messages may include metadata and other information (or “associated data”), such as the sending proximity broadcast receivers' identification information (e.g., device ID, third-party affiliations, etc.), whether the proximity broadcast receiver paired with a wireless identity transmitter, transmissions context information (e.g., a code indicating the sighting message is related to an alert or a registered service), information regarding software or applications executing on proximity broadcast receivers (e.g., app IDs), location information, proximity information with respect to known areas within a place, and timestamp data. In an embodiment, sighting messages may also include authentication information (e.g., secret keys, passes, special codes, digital certificates, etc.) that may be used by a central server to confirm the identification (or identification information) of proximity broadcast receivers transmitting the sighting messages. For example, a sighting message may include a code from a hash function that can be decoded by the central server to ensure the sending proximity broadcast receiver is associated with a particular registered service. In various embodiments, sighting messages may be sent immediately after receipt of broadcasts (e.g., when related to an alert), buffered, or scheduled along with other scheduled transmissions.

The various embodiments provide systems, devices, and methods for presenting rewards to users based on proximity of short-range wireless devices to objects, points or locations of interest. By allocating rewards, which may be coupons, cash, or even “thank you”, to users of mobile broadcast receivers or wireless identity transmitters who come within the broadcast range of an object or location, the various embodiments enable organizations to motivate users to participate in searches, marketing promotions, or other desired mobility behavior. For example, an owner of a lost dog with a wireless identity transmitter on its collar may incentivize users of mobile broadcast receivers (e.g., smartphones with a PBR application) to activate their devices (e.g., launch the PBR application) in order to participate in a search. If the reward is large enough, users may not only activate their devices, but modify their travels to maximize their chances of coming within broadcast range of the lost dog, and thus being the one to transmit the sighting message that “finds” the dog. Similarly, retailers and advertisers may reward customers for visiting various locations (e.g., in front of an advertisement or demonstration) by transmitting valuable coupons to their mobile devices.

In the various embodiments, the wireless identity transmitter may be a compact device configured to transmit a packet with a secured identification code (i.e., a rolling identifier) in a format that can be received by any proximity broadcast receiver within range of the short-range wireless broadcast. Since the wireless identity transmitter relies on relatively short-range wireless signaling (e.g., short-range radio signals, Peanut®, Zigbee®, RF, WiFi, Bluetooth® Low Energy signals, light signals, sound signals, etc.) to transmit broadcast messages that include its identifier, only proximity broadcast receivers within proximity of the transmitter may receive such broadcast messages. Thus, a proximity broadcast receiver's own location may provide an approximate location for the wireless identity transmitter at the time of receipt of a broadcast message. Wireless identity transmitters may be deployed by various parties registered with the central server, such as government agencies, merchants, retailers, and stores. In an embodiment, the broadcast range of wireless identity transmitters may be from three or less to one hundred feet while within a retail store.

Proximity broadcast receivers, in particular mobile proximity broadcast receivers (e.g., smartphones, etc.), may be configured with processor-executable instructions, such as an application that users may download or that may be incorporated in the device by the manufacturer. By configuring many mobile devices with such an application, a wide spread network of proximity broadcast receivers may be deployed for little or no cost, taking advantage of the popularity of smartphones. Stationary proximity broadcast receivers may be deployed in various places, such as throughout retail stores, to supplement the network of smartphones. For example, proximity broadcast receivers may be located coincident to, within, or otherwise within proximity of predefined areas within a place, such as merchandise displays in a movie theater or an entrance to a retail store.

Each proximity broadcast receiver receiving a broadcast message from the wireless identity transmitter may pass information to a central server for processing, such as by transmitting sighting messages including the rolling identifier of the wireless identity transmitter. Sighting messages transmitted by proximity broadcast receivers to the central server may include part or all of the information encoded in received broadcast messages from proximate wireless identity transmitters, including any rolling, obscured, or encrypted information related to the wireless identity transmitters. In various embodiments, sighting messages may be sent immediately after receipt of broadcast message (e.g., when related to an alert), buffered, scheduled along with other scheduled transmissions, or otherwise based on characteristics of broadcast message. Sighting messages may include metadata, header information, or other encodings to indicate various reported data. For example, a sighting message may contain metadata that includes a code for a particular merchant, and may therefore indicate that the sighting message was transmitted by a proximity broadcast receiver within the merchant's store. As another example, a sighting message may contain metadata that includes a code indicating a user's smartphone and therefore the proximity broadcast receiver may be a mobile proximity broadcast receiver belonging to the user. In an alternative embodiment, intermediate devices, such as a local router, server, or other computing device, may receive sighting messages from proximity broadcast receivers and may in turn pass each sighting message to the central server.

Upon receipt of sighting messages, the central server may decode, decrypt, or otherwise access obscured information (e.g., rolling identifiers) within the sighting messages. For example, the central server may decode a broadcast message within a sighting message and determine the user associated with the broadcast message using data stored within a registration database. Based on the location of a proximity broadcast receiver that transmitted a sighting message, the central server may determine the proximity of the related broadcast message, or the approximate proximity. For example, since a stationary proximity broadcast receiver that transmits a sighting message is within proximity of a user's wireless identity transmitter at the time of receiving a broadcast message, the central server may determine the user's wireless identity transmitter is within several feet of the GPS coordinates indicated in the proximity broadcast receiver's sighting message or known to the central server in the case of fixed proximity broadcast receivers. Further, the central server may be configured to perform various operations in response to receiving and processing sighting messages. For example, the central server may transmit return messages to devices associated with a merchant/retailer/store, such as a store server, a point-of-sale device (e.g., a cash register device), a mobile device or other computing device used by an employee of the merchant (e.g., a tablet device used by a waiter/hostess/user service rep, etc.), and/or a proximity broadcast receiver associated with the merchant (e.g., a stationary proximity broadcast receiver that relayed the broadcast signal from the user's wireless identity transmitter).

With the above described framework, various embodiments may be used to provide rewards to users registered with the central server. Rewards may include coupons, product offers, promotions, money, prizes, information (e.g., a secret), privileges (e.g., allowance, loyalty credits, etc.) and messages (e.g., “Thanks!”). Further, rewards may be provided for a variety of reasons, including entertainment (e.g. a treasure hunt or scavenger hunt), advertising (e.g. lure a shopper into a particular store or region of a store with a coupon), and/or encouraging participation in search and recovery operations (e.g., rewarding users who report “sightings” of a lost object, pet, or person).

Rewards may be presented as part of a rewards program to influence behaviors. In particular, rewards may be calculated for users by the central server based on the users' activities (e.g., movement or locations over time). In an embodiment, wireless identity transmitters associated with users may include sensors that generate sensor data that may be encoded in broadcast messages. Such sensors data may include microphones, cameras, pressure sensors, heat sensors, accelerometers, humidity sensors, temperature sensors, CO2 sensors, etc. When sighting messages from proximity broadcast receivers are received that contain sensor data, the central server may store the sensor data for use regarding a rewards program maintained by the central server. Such a rewards program may enable users, such as children, to accrue rewards or otherwise progress towards goals based on their physical activity as indicated in the sensor data broadcast by their wireless identity transmitters. Further, rewards may be presented to such users based on the proximity of the users to predefined areas. For example, when a child's wireless identity transmitter is sighted by a proximity broadcast receiver within a school during school hours, the child may be rewarded with more allowance money or minutes to use an electronic device.

Rewards may also be associated with tracking or searching for assets associated with wireless identity transmitters, such as children, mental patients, pets, Alzheimer patients, victims of natural disasters, first responders, equipment, art, and other high-value property. Wireless identity transmitters and/or receiver devices may be installed on, carried by, or connected to such assets for tracking in logistics systems, monitoring boundary area transits (e.g., into/out of construction sites), and/or to help locate the assets when stolen or reported missing. The central server may administer active searches for lost, stolen, misplaced, or otherwise targeted assets associated with a wireless identity transmitters by comparing identifiers received within sighting messages to identifiers corresponding to the targeted assets. Such searches may also include planned events, such as scavenger hunts or marketing stunts established by merchants or other parties registered with the central server. When sighting messages are received that relate to devices targeted by a search, the central server may distribute rewards to the users of the proximity broadcast receivers that transmitted the helpful information. For example, a monetary incentive may be awarded to a user when his/her mobile proximity broadcast receiver transmits a sighting message in response to receiving a broadcast message from a wireless identity transmitter targeted by a search.

In various embodiments, the central server may serve as a “middle-man” that delivers rewards (or reward information) to the users participating in searches without providing any identity information related to the objects of the searches. In other words, the central server may act as an indirection mechanism that keeps the personal information of searched for, lost, or stolen assets anonymous. For example, a user may receive a reward of an Amazon gift card “out of the blue” based on his/her mobile proximity broadcast receiver automatically transmitting a sighting message related to a wireless identity transmitter affixed to a stolen bulldozer.

In an embodiment, a requester (e.g., a business owner looking for a stolen vehicle, a pet owner searching for a lost dog, a merchant conducting an advertising gimmick, etc.) may activate a search by transmitting to a central server a request for location information of a target wireless identity transmitter. For example, the requester may send a request to the central server to locate a dog wearing a wireless identity transmitter having a particular identification code. In response to a mobile proximity broadcast receiver (e.g., a smartphone) sending the central server a sighting message that relates to the target wireless identity transmitter, the central server may identify the user of the reporting mobile proximity broadcast receiver as a reward recipient. The central server may then take a predefined action to reward the identified user, such as sending a reward notification message to the user's mobile device indicating the reward and/or instructions for obtaining the reward. The requester may indicate the reward to be awarded for participating in the search (i.e., transmitting a sighting of the target wireless identity transmitter). For example, the requester may indicate that a reward for relaying location information related to a lost dog may include a money reward and/or a personal message (e.g., “Thank you!”). In various embodiments, a plurality of reward recipients may be identified by the central server based on received sighting messages that are relevant to the target of the search. For example, when a lost dog is found, the search reward may be split and reward notification messages may be sent to all the mobile proximity broadcast receivers that transmitted sighting messages that indicated proximity information of the dog.

In another embodiment, reward information may be displayed on mobile devices such using a user interface that simulates a scratch-off ticket or card. The mobile device may initially hide the reward information behind a graphical element of the user interface that may be similar to a scratch-off card or ticket. To view the reward information, the user may be required to move a finger over the scratch-off graphical element on the mobile device's touchscreen display. For example, the user may perform a scratching gesture as a touch input. The user interface may sense the sliding movements of the user's finger on the touchscreen, and in response may cause the graphical element to change until the reward information is visible. In another embodiment, reward information may not be accessible or capable of being used to claim a reward until the user is within proximity of a particular predefined area. For example, the scratch-off element displayed over a coupon code may be disabled until the user is within proximity of a predefined area associated with the coupon, such as within proximity of a store's cash register. In this way, retailers or other parties may tease rewards in order to compel certain behavior from users.

The terms “permissions” and “permissions settings” are used herein to refer to information that indicates whether users authorize to have their identity or other related user data provided to merchants, retailers, other users, and other parties associated (or registered) with a central server. Permissions may be set, provided, or otherwise indicated by customers when they register a wireless identity transmitter and/or mobile proximity broadcast receiver with the central server. In an embodiment, rewards or reward information may be transmitted to users without providing identifying user data to third parties. The central server may check stored permissions related to users to determine whether messages that share the user's data are authorized by the user. For example, when a coupon is transmitted to the user based on the user's proximity to a predefined area within a retail store, the central server may only transmit a message to the store that indicates the user's identity if the user has provided permissions that allow such a message. In other words, users may be anonymous recipients of rewards.

In various embodiments, companies, organization and institutions (e.g., schools, stores, parks, airports, shopping malls, office buildings, etc.) may deploy stationary proximity broadcast receivers to receive and relay broadcast messages from users' wireless identity transmitters. Alternatively, places may deploy stationary wireless identity transmitters and users' mobile proximity broadcast receivers may receive and relay broadcast messages. In further embodiments, places may employ both proximity broadcast receivers and wireless identity transmitters to receive, relay, and process data from both users carrying wireless identity transmitters and/or mobile proximity broadcast receivers. Regardless of the source of broadcast messages, the central server (or a local computing device) may determine approximate proximities between a proximity broadcast receiver and a wireless identity transmitter based on received sighting messages.

Additionally, based on identification of the proximity broadcast receiver and the wireless identity transmitter related to a received sighting message, the central server may be configured to determine which device is related to a registered service (e.g., a retail store) and which is related to a user (e.g., a user). The term “registered service” may be used herein to refer to a party or service that is registered, authenticated, valid, or otherwise known to a central server and that may be related with sighting messages. Registered services may include merchants, retailers, services, stores (e.g., big-box retailers, local coffee shops, etc.), and various other third-parties that are registered with the central server. Registered services may also include known routines, actions, or services managed by the central server, such as particular searches or active alerts, or alternatively applications that may be executing on a mobile device (e.g., a third-party app). In an embodiment, registered services may further include any third-parties that have registered as developers with the central server. For example, a registered service may correspond to a merchant that has registered proximity broadcast receivers with the central server. In an embodiment, registered users (e.g., users) employing mobile proximity broadcast receivers that transmit sighting messages in response to receiving broadcast messages from others' wireless identity transmitters (e.g., a merchant's stationary identity transmitter positioned within a retail store) may also be considered registered services by the central server.

For illustration purposes, a mobile proximity broadcast receiver (e.g., a smartphone configured to operate as a proximity broadcast receiver) carried by a user waiting in the check-out line may receive a broadcast message from a wireless identity transmitter positioned on top of the cash register point-of-sale device within the retail store and may transmit a sighting message to the central server. Upon receive of the sighting message, the central server may determine that the wireless identity transmitter belongs to the retail store based on the profile that corresponds to a rolling identifier and that the mobile proximity broadcast receiver is associated with a user profile based on an identifier of the proximity broadcast receiver included within metadata in the sighting message. From this information, the central server may transmit marketing information to the user.

In various embodiments, a wireless identity transmitter may be configured to periodically generate new identification data (referred to as a rolling identifier) that may be decoded by a central server to reveal the unique device identifier and other identifying information of the wireless identity transmitter. For example, a wireless identity transmitter may be configured to periodically broadcast a Bluetooth® packet including an encoded version of the wireless identity transmitter's device identifier (i.e., deviceID). Such encryption of identifiers indicated in broadcast messages may be required to enable the central server to reliably identify the wireless identity transmitter that sent the broadcast message while forcing a third-party (e.g., passive attacker) to determine the origin of the broadcast message by guessing. For example, if the identifier was static, the third party could sniff the identifier, such as by impersonating a proximity broadcast receiver, and then use the identifier to track the wireless identity transmitter. Rolling identifiers may make such an attack impossible if the third party lacks the means of generating the encrypted identifiers.

Since a single packet broadcast message may not support a payload that can fit a cipher text of a conventional asymmetric key encryption, standard private/public key pair encryption may not be useable in the various embodiments. Additionally, wireless identity transmitters are generally broadcast-only devices, so there is no back channel that is typically required in conventional encryption schemes. Therefore, the central server in various embodiments may process encrypted message payloads by pre-provisioning a shared secret key unique to each wireless identity transmitter. Such secret keys may be associated with each wireless identity transmitter's unique device identifier at the central server and may be used to decode data (e.g., identifiers) encoded by the each wireless identity transmitter.

Performing an embodiment method, a wireless identity transmitter may use a streaming-like encryption algorithm (e.g., AES-CTR) to encrypt its device identifier, shared secret key, and a nonce or counter, broadcasting a payload that includes the encrypted data with and the nonce or counter in the clear. Performing another embodiment method, a wireless identity transmitter may use a pseudo-random function to encrypt the device identifier, shared secret key, and a nonce or counter, broadcasting a payload that includes the encrypted data without the nonce or counter in the clear. Performing another embodiment method, a wireless identity transmitter may use a combination of a streaming-like encryption and pseudo-random function encryption to generate a payload to broadcast. In an embodiment, the wireless identity transmitter and the central server may each have a cryptographically secure pseudo-random number generator or algorithm that is used to generate identifiers on a common time scale so that any given moment, the central server can calculate the identifier being transmitted by a particular wireless identity transmitter.

In various embodiments, the wireless identity transmitter may maintain a nonce or counter (or clock data) that periodically increments to represent the passage of time and that may be used in various encryption methods. When the wireless identity transmitter is powered on (or the battery is replaced), the nonce or counter may be set to a known initial value, such as 0. As the wireless identity transmitter functions, the nonce or counter may increase periodically (e.g., increment by one every several seconds/minutes/hours). If the wireless identity transmitter encounters inconsistent power (e.g., the battery is taken out or replaced), the nonce or counter may reset. Using such a nonce or counter, a wireless identity transmitter may be configured to periodically broadcast messages with encrypted payloads that include changing and encrypted device identification. In an embodiment, an encrypted payload may contain a concatenation of the device's unique identifier (i.e., the deviceID) and a current nonce or counter value for that wireless identity transmitter. In an embodiment, the wireless identity transmitter may encrypt the concatenated data using a secret key. Payloads may be broadcast at varying frequencies and may be received by proximity broadcast receivers or a central server for processing.

In an embodiment, the central server may be configured to identify wireless identity transmitters by matching received encrypted payloads with pre-generated payloads (or model payloads) corresponding to registered wireless identity transmitters. Based on information obtained during registration operations between the central server and wireless identity transmitters, the central server may store unique information about each wireless identity transmitter. For example, the central server may know the secret key, device identifier (or deviceID), and initial nonce or counter value of a wireless identity transmitter based on registration communications. Using such stored information, the central server may generate a series of model payloads that the wireless identity transmitter is expected (or likely) to broadcast within a time period, such as a 24-hour period. If the central server receives a payload that matches any of these model payloads, the central server may determine the identity of the originating wireless identity transmitter, as well as a loosely-accurate nonce or counter value within the wireless identity transmitter. Model payloads may be generated based off of a current, synched nonce or counter for each registered wireless identity transmitter (i.e., current model payloads). In an embodiment, the central server may also adjust for wireless identity transmitter clock skew by keeping a window of model payloads. For example, the central server may generate payloads using nonce or counter values representing times before and after an expected nonce or counter. The central server may also determine the period of the wireless identity transmitter clock by monitoring the change in the received payloads over time. In an embodiment, the central server may track changes of the reported nonce or counter values of a wireless identity transmitter and may report how inaccurate a device clock is for a particular period of time.

Model payloads may also be generated based off of initial nonce or counter values reported by each registered wireless identity transmitter during registration operations (i.e., initial model payloads). When a wireless identity transmitter is powered off and on again (e.g., rest, battery replaced, etc.), the wireless identity transmitter may reset to the original or initial nonce or counter value. If an encrypted payload received at the central server does not match any current model payload, the central server may compare the received encrypted payload to stored initial model payloads. When the central server finds an initial model payload matches the received encrypted payload (e.g., the wireless identity transmitter was reset), the central server may update a database to indicate the corresponding wireless identity transmitter's nonce or counter was reset, thus resynchronizing with the reset wireless identity transmitter's clock.

In a situation in which a wireless identity transmitter pauses for a period of time but does not reset its nonce or counter used for generating encrypted payloads, payloads subsequently generated by the wireless identity transmitter may not match expected payloads stored in the central server (e.g., current model payloads and initial model payloads). To address this situation, the central server may determine that a pause occurred when model payloads and/or nonce or counter values do not match a received encrypted payload. The central server may identify the wireless identity transmitter by performing a brute-force search of all known and/or registered wireless identity transmitters represented in a database and decode the received encrypted payload based on recorded secret keys and device identifications. In an embodiment, the brute-force search may include only wireless identity transmitters that have not broadcast payloads recently received by the central server.

For the purposes of this disclosure, the various embodiment methods for decoding, decrypting, and otherwise accessing obscured identification information (e.g., rolling identifiers) are described as being performed by a central server to associate such information with registered users and/or registered devices. However, those skilled in the art should appreciate that any computing device with authorization may be configured to perform such operations to decipher obscured identification information broadcast by wireless identity transmitters. For example, a mobile proximity broadcast receiver (e.g., a smartphone) employed by a user may utilize the various methods for decrypting, decoding, and otherwise accessing rolling identifiers that are associated with wireless identity transmitters also owned by that user.

Additional precautions may be important to protect against security breaches, such as hacker attacks against databases associated with a central server, as well as to provide registered users (e.g., merchants, parents, children, etc.) peace of mind and confidence their privacy may be fully protected. Such privacy safeguards may be provided to parties registered with embodiment systems by storing identifying information (e.g., names, addresses, financial information, medical information, etc.) separately from other information related to tracking devices and/or proximity information of users. In particular, to avoid unintended leaking of personal information of registered merchants, customers, children, or individuals, embodiment systems may utilize “double-blind” architectures. For example, such a double-blind architecture may use a first unit (e.g., a server, database, or other computing hub) that stores and has access to information related to the proximity information or other location-based data of registered users' devices (e.g., wireless identity transmitters, proximity broadcast receivers, identity transceivers, mobile devices, etc.). In other words, the first unit may access information associated with sighting messages that indicate approximate locations/proximities of various users' devices. However, the first unit may not store uniquely identifying personal information, such as user names, addresses, and/or social security numbers. Instead, a second unit may store the identifying personal information without being configured to access any location/proximity information as used by the first unit. The first and second units may use anonymous identifiers that connect data stored within the two units without indicating the protected information stored in either unit. In an embodiment, the first and second units may be maintained by separate entities (e.g., service providers), and further, at least one of such entities may be trusted by registered users who provide identifying information.

The various embodiments may leverage a large infrastructure of mobile devices already in place. Many modern mobile devices, such as smartphones, are already equipped with multiple radios, including short-range radios such as Bluetooth® radios, and therefore may be configured to perform as mobile proximity broadcast receivers and receive identification codes from a proximate wireless identity transmitter. For example, a customer carrying a smartphone configured to operate as a mobile proximity broadcast receiver (or mobile identity transceiver) may receive broadcast messages from wireless identity transmitters within a retail store. Mobile devices are also often equipped with a clock that may provide a current time and a GPS receiver that may provide a current location whenever a wireless identity transmitter identifier is received. The mobile devices may communicate these identification codes, times, and locations via sighting messages to central servers through longer range network connections, such as a cellular radio connection. Thus, many of the large number of mobile devices already in use or soon to be in use may be incorporated as mobile proximity broadcast receivers to extend the reach of various embodiment systems.

By relying on the long range radios and other services of proximity broadcast receivers to report the location and time of received broadcast message (or “sightings”) to a central server, wireless identity transmitters can be relatively small, inexpensive, and simple devices, including little more than a short-range radio, such as a Bluetooth® LE transceiver, and a battery. In various embodiments, wireless identity transmitters may also include additional short-range radios, such as Peanut® radios. In various embodiments, the wireless identity transmitters may not include a user interface, multiple radios, global positioning system (GPS) receiver, or other features common on mobile devices. Embodiment wireless identity transmitters may also consume very little power allowing them to be deployed without needing to be frequently recharged or replaced. These characteristics make them ideal for a wide variety of uses and implementation in a variety of physical configurations. For example, wireless identity transmitters may be easily hidden or incorporated into many different personal objects, such as buttons, watches, shoes, briefcases, backpacks, ID badges, clothing, product packaging, etc.

In further embodiments, wireless identity transmitters and proximity broadcast receivers may be configured to exchange transmissions using various wireless technologies, such as LTE-D, peer-to-peer LTE-D, WiFi, and WiFi Direct. In an embodiment, wireless identity transmitters may be configured to broadcast messages via a WiFi radio such that proximity broadcast receivers with WiFi transceivers may receive the broadcast messages. In such embodiments, wireless identity transmitters may utilize WiFi transmissions to broadcast identification information similar to WiFi access point broadcasts advertisements. For example, a wireless identity transmitter including a WiFi radio may be configured to transmit broadcast messages via WiFi transmissions with low power so that the reception range is limited, thereby providing a short-range radio signal with a range similar to that of Bluetooth® LE transmissions. In utilizing various wireless broadcast technologies and communication protocols with wireless identity transmitters, proximity broadcast receivers with limited capabilities may still be capable of receiving and processing broadcast messages from wireless identity transmitters. For example, a smartphone configured to operate as a mobile proximity broadcast receiver and including a WiFi transceiver but not a Bluetooth® LE radio may receive and process broadcast messages from a wireless identity transmitter configured to broadcast short-range signals with a WiFi radio. In an embodiment, wireless identity transmitters may broadcast over multiple radios, such as a Bluetooth® LE transceiver and a low-power WiFi transceiver, in order to enable more models of proximity broadcast receivers (e.g., more types of smartphones) to receive and relay sightings.

Wireless identity transmitters and proximity broadcast receivers are described throughout this disclosure as exchanging short-range wireless signals that include short-range RF signals, such as Bluetooth®, Bluetooth® Low Energy, Peanut, Zigbee, etc. However, such short-range wireless signals are not limited to short-range RF signals, and wireless identity transmitters may broadcast messages using other forms of wireless signaling, such as infrared light, visible light, vibration, heat, inaudible sound, and audible sound, as well as combinations of radio frequency (RF) signals and non-RF signals. For example, wireless identity transmitters may emit heat signals, such as infrared light, using infrared light-emitting diodes or other components capable of emitting infrared radiation. Additionally, wireless identity transmitters may emit vibration signals using vibration motors and other mechanical components capable of generating controlled vibrations. Wireless identity transmitters may also emit light signals from a number of common emitters, such as light emitting diodes, incandescent lights and projectors. Light signals may be received by light sensors (e.g., cameras) on proximity broadcast receivers, and may include visuals, such as lights, colors, and imagery (e.g., photos, projections, videos, symbols, etc.). Wireless identity transmitters may also or alternatively emit audible or inaudible (i.e., infrasonic or ultrasonic) sound signals from a speaker (e.g., a piezoelectric speaker). Sound signals may be received by a microphone of the proximity broadcast receivers, and may include a variety of sounds, such as beeps, voices, noise, clicks, ultrasounds, tones, and musical notes.

Wireless identity transmitters may be configured to broadcast the various short-range wireless signals in particular sequences, patterns, manners, durations, or manifestations such that proximity broadcast receivers may convert the signals into data in a manner similar to how RF signals (e.g., Bluetooth® LE signals) are interpreted in embodiments described herein. For example, a wireless identity transmitter may broadcast particular sequences of modulating visible or sound signals, such as strings of differing musical notes, changing images, or flashing lights that a proximity broadcast receiver may receive and convert into data that includes an identity of the wireless identity transmitter. In an embodiment, proximity broadcast receivers may convert such wireless signals into data (and vice versa) based on matching sequences of signals with patterns within predefined protocols. As an illustrative example, a wireless identity transmitter affixed to the outside of a child's clothing may periodically emit a sequence of flashes using an embedded light source (e.g., an LED bulb) that may be received, converted to data, and relayed by a proximity broadcast receiver to a central server for determining identification information related to the child. As another example, a wireless identity transmitter within a business establishment may be mounted on the ceiling and may periodically emit a sequence of flashes using an embedded light source that may be received, converted to data, and relayed by a proximity broadcast receiver to a central server to obtain coupons, announcements or customer-incentives tied to the customer being on the premises.

The various embodiments are described within this disclosure as including communication systems for providing intermediary communications between wireless identity transmitters, proximity broadcast receivers (e.g., mobile proximity broadcast receivers and stationary proximity broadcast receivers) and a central server that utilize short-range messaging (such as with Bluetooth® LE signaling) that enables proximity detection based simply on signal reception. However, the various embodiments are not limited to the described communication systems and methods, and other communication systems, protocols, devices, methods and messaging protocols may be used to convey information to a central server to enable identifying when customers are within proximity of predefined areas to enable the central server to distribute relevant marketing information without disclosing identities of customers. For example, transceivers in a retail store may be configured to monitor for WiFi, Zigbee®, Bluetooth®, Peanut®, and/or other radio frequency signaling from customers' mobile devices or wireless broadcasting devices within proximity of predefined areas, and relay proximity information to a central server that delivers coupons to customers. Further, embodiments may not require determining exact locations for wireless identity transmitters and/or proximity broadcast receivers but instead may determine approximate and/or relative locations of devices between each other. Accordingly, references to determining location and/or distance throughout the disclosure may be for the purpose of determining proximity between signaling devices.

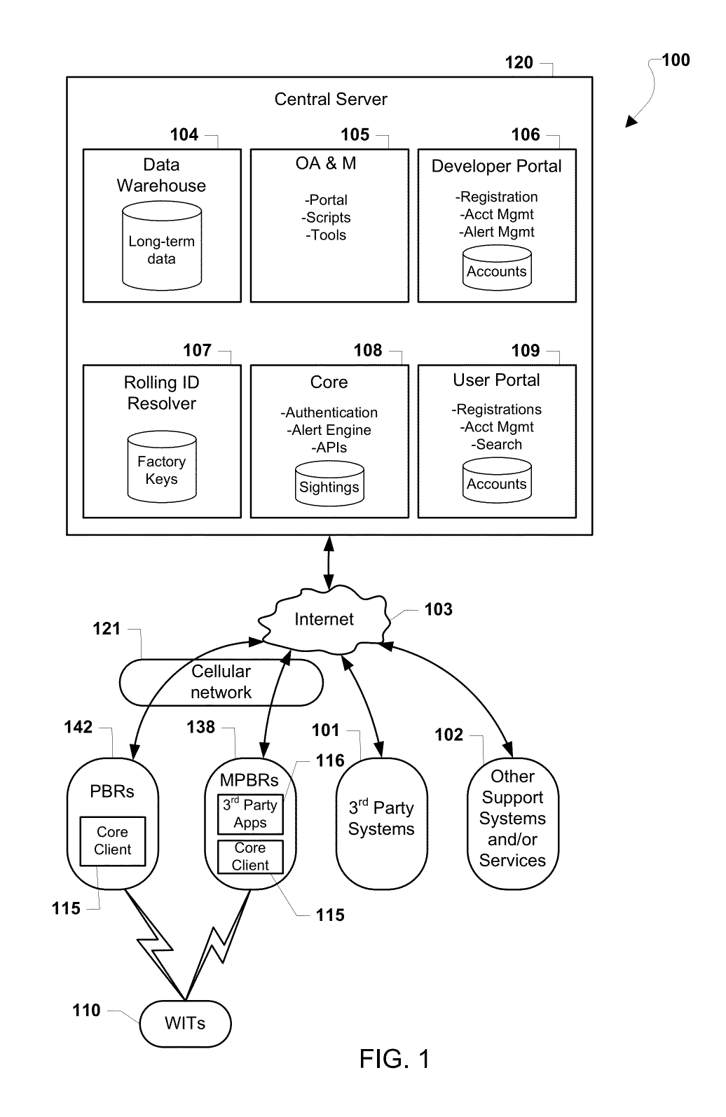

FIG. 1 illustrates an exemplary system 100 that may be used in various embodiments. In general, a central server 120 may be configured to receive, store, and otherwise process data corresponding to wireless identity transmitters 110. The central server 120 may be configured to exchange communications with various devices via the Internet 103, such as proximity broadcast receivers 142, mobile proximity broadcast receivers 138, third-party systems 101, and other support systems and/or services 102. The wireless identity transmitters 110 may broadcast messages that may be received by nearby proximity broadcast receivers 142 and/or the mobile proximity broadcast receivers 138 via short-range wireless signals. The proximity broadcast receivers 142, 138 may utilize long-range communications to relay received broadcast messages as sighting messages to the central server 120 via the Internet 103. For example, the proximity broadcast receivers 142 and mobile proximity broadcast receivers may utilize a cellular network 121 to transmit sighting messages to the central server 120. The third-party systems 101 may include merchant servers, retail store computing devices, computing devices associated with emergency services. The other support systems and/or services 102 may include computing devices associated with various technologies, such as computing devices utilized by users to provide registration information, systems that deliver user-relevant content (e.g., Qualcomm Gimbal™), and services that provide location-specific information (e.g., Qualcomm IZat™).

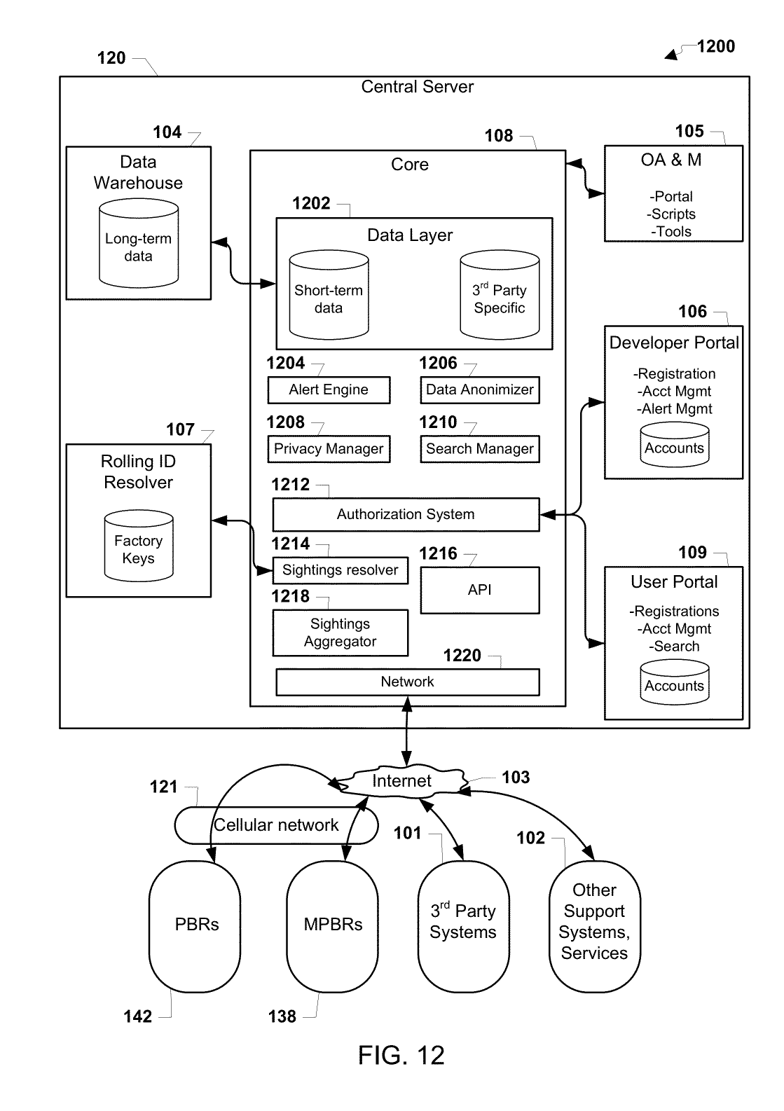

The central server 120 may include several components 104-109 to perform various operations to process data, such as received from proximity broadcast receivers 142, 138, third-party systems 101, or other support systems and/or services 102. In particular, the central server 120 may include a data warehouse component 104 that may store long-term data (e.g., archived user data, past location information, etc.). The central server 120 may also include an operations, administration and management (or OA&M) component 105 that may manage, process and/or store software associated with user portal accesses, scripts, tools (e.g., software utilities, routines, etc.), and any other elements for administering the central server 120. The central server 120 may also include a developer portal component 106 that may store developer account data and perform registration, account management, and alert (or notice) management routines associated with developers, such as vendors or merchants that register to interact with users of wireless identity transmitters 110. The central server 120 may also include a rolling identifier (or ID) resolver component 107 that may store factory keys associated with wireless identity transmitters 110 as well as perform operations, software, or routines to match encrypted, encoded, rolling, or otherwise obfuscated identification information within received sighting messages with affiliated user data. The central server 120 may also include a user portal component 109 that may store user account data and perform registration, account management, and search routines associated with users, such as persons associated with wireless identity transmitters 110. The central server 120 may also include a core component 108 that may process sighting messages, execute an alert or notice engine module, handle application programming interface (API) commands, and exchange data with other components within the central server 120. The core component 108 is described below with reference to FIG. 12.

In various embodiments, the various system components 104-109 may be computing devices, servers, software, and/or circuitry that is included within, connected to, or otherwise associated with the central server 120. For example, the core component 108 may be a server blade or computing unit included within the central server 120. As another example, the data warehouse component 104 may be a remote cloud storage device that the central server 120 communicates with via Internet protocols.

In an embodiment, the proximity broadcast receivers 142 and mobile proximity broadcast receivers 138 may be configured to execute a core client module 115 that may be software, instructions, routines, applications, operations, or other circuitry that enable the proximity broadcast receivers 142, 138 to process received broadcast messages from proximate wireless identity transmitters 110. The core client module 115 may also handle communications between the proximity broadcast receivers 142, 138 and the central server 120, such as transmitting sighting messages and receiving return messages from the central server 120. Further, the mobile proximity broadcast receivers 138 may be configured to execute third-party applications module 116 that may related to performing software instructions, routines, applications, or other operations provided by various third-parties (e.g., merchant apps). In an embodiment, when configured as registered services with the central server 120, the third-party applications module 116 may receive various data from the core client module 115. For example, a third-party application that is registered with the central server 120 may be configured to receive notifications from the core client module 115 when the user of the mobile proximity broadcast receiver 138 enters, remains, and/or leaves a particular place (e.g., a geofence, a retail store, etc.).

In another embodiment, the mobile proximity broadcast receivers 138 may be configured to receive and transmit broadcast messages and may also be referred to as “wireless identity transceivers.” For example, a user may employ a smartphone that is configured to receive broadcast messages from nearby wireless identity transmitters 110 as well as broadcast signals that include identifying information associated with the user.

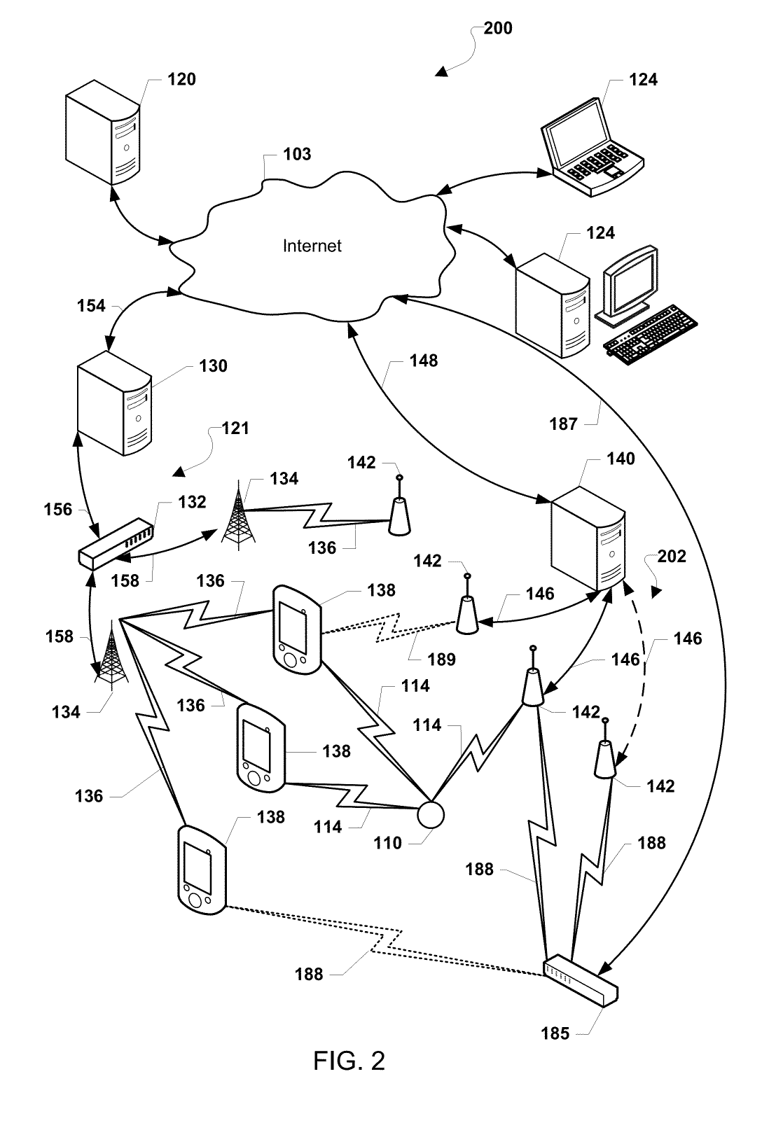

FIG. 2 illustrates an exemplary communication system 200 that may be used in various embodiments. The communication system 200 effectively enables wireless identity transmitters 110 (e.g., Bluetooth® LE transmitters) to transmit broadcast messages that include identification information to the central server 120 via a plurality of mobile proximity broadcast receivers 138 and/or stationary proximity broadcast receivers 142, without the need to negotiate a direct communication link. Such broadcast messages may be collected automatically by any proximity broadcast receiver within proximity (or broadcast range) of wireless identity transmitters. For example, a mobile proximity broadcast receiver 138 within a certain proximity may receive a broadcast message transmitted by a Bluetooth® radio within the wireless identity transmitter 110.

The communication system 200 may include a wireless identity transmitter 110. The wireless identity transmitter 110 may be coupled with various objects. For example, it may be embedded in a bracelet. The wireless identity transmitter 110 may transmit a short-range wireless signal 114, such as a broadcast message as described above. For example, this short-range wireless signal 114 may be a periodic broadcast of a packet, which includes the wireless identity transmitter's identification code. Alternately, the short-range wireless signal 114 may be an attempt to establish a wireless communication link with any of a plurality of mobile devices 138 that may be acting as proximity broadcast receivers. The short-range wireless signal 114 may be received by proximate proximity broadcast receivers, such as stationary proximity broadcast receivers 142 and/or mobile proximity broadcast receivers 138.

The short-range wireless signal 114 may be according to any of a variety of communication protocols, such as Bluetooth®, Bluetooth® LE®, Wi-Fi, infrared wireless, induction wireless, ultra-wideband (UWB), wireless universal serial bus (USB), Zigbee®, Peanut®, or other short-range wireless technologies or protocols which have or which can be modified (e.g., by restricting transmit power) to limit their effective communication range to relatively short range (e.g., within about 100 meters). In some embodiments, the wireless identity transmitter 110 may use the low energy technology standardized in the Bluetooth® 4.0 protocol (or later versions). For example, in some embodiment systems a wireless identity transmitter 110 may periodically broadcast identification packets configured as an advertiser as described in the Bluetooth® 4.0 protocol, and proximate proximity broadcast receivers 142, 138 may be configured to act as scanners according to that protocol.

The Bluetooth® protocol and Bluetooth® devices (e.g., Bluetooth® LE devices) have a relatively short effective communication range, are widely used in deployed communication and computing devices, have standard advertising or pairing procedures that meets the discovery and reporting needs of various embodiments, and exhibit low power consumption, which make the protocol ideal for many applications of the various embodiments. For this reason, Bluetooth® and Bluetooth® LE protocols and devices are referred to in many of the examples herein for illustrative purposes. However, the scope of the claims should not be limited to Bluetooth® or Bluetooth® LE devices and protocol unless specifically recited in the claims. For example, Peanut® transceivers may be included within wireless identity transmitters 110 and may be used to transmit two-way communications with proximity broadcast receivers 142, 138 also configured to utilize Peanut® short-range radio transmissions.

The communication system 200 may include a plurality of stationary proximity broadcast receivers 142, which may be deployed by authorities, merchants, or various third-parties throughout a region, building, or place. Such stationary proximity broadcast receivers 142 may be designed specifically for wireless identity transmitters 110 (or include such tracking functions in addition to other primary functionality, such as traffic lights, utility transformers, etc.). Stationary proximity broadcast receivers 142 may be located in strategic locations within a locality, such as forming a perimeter about a community and/or being located in high traffic areas (e.g., major intersections and highway on-ramps). The stationary proximity broadcast receivers 142 may be in communication with a local area network 202, such as a WiFi network, that may include an Internet access server 140 that provides a connection 148 to the Internet 103. Stationary proximity broadcast receivers 142 may be connected to the local area network 202 by a wired or wireless link 146. In various embodiments, the stationary proximity broadcast receivers 142 may be contained within or located nearby the Internet access server 140. For example, the stationary proximity broadcast receivers 142 may be components within the Internet access server 140 or alternatively, may be placed on top of or to the sides of the Internet access server 140. In an embodiment, stationary proximity broadcast receivers 142 may be located in strategic places within a locality, such as forming a perimeter about a community and/or being located in high traffic areas (e.g., along aisles of a retail store, at entry ways to buildings, etc.). In an embodiment, stationary proximity broadcast receivers 142 may have additional functionality. For example, stationary proximity broadcast receivers 142 may also function as or be included within cash registers, point-of-sale devices, and/or display units within a retail store.

The communication system 200 may also include one or more mobile devices configured to act as mobile proximity broadcast receivers 138. The mobile proximity broadcast receivers 138 may be typical mobile devices or smartphones communicating with a cellular network 121 via long range wireless links 136 to one or more base stations 134 coupled to one or more network operations centers 132 by a wired or wireless connection 158. Such cellular network 121 may utilize various technologies, such as 3G, 4G, and LTE. The network operations centers 132 may manage voice calls and data traffic through the cellular network 121, and typically may include or may be connected to one or more servers 130 by a wired or wireless connection 156. The servers 130 may provide a connection 154 to the Internet 103. In the various embodiments, the mobile proximity broadcast receivers 138 may be mobile devices configured by an application or other software module to act as proximity broadcast receivers to relay reports of received broadcast messages from wireless identity transmitters 110 (i.e., sighting messages) to the central server 120 by way of the Internet 103. In an embodiment, stationary proximity broadcast receivers 142 may also communicate with the cellular network 121 via long range wireless links 136 to a base station 134.

Proximity broadcast receivers 138, 142 may be configured to report contacts (or sightings) with a wireless identity transmitter 110 to a central server 120 via the Internet 103. For example, the proximity broadcast receivers 142 may transmit a sighting message to the central server 120 that includes a rolling identifier corresponding to the identity of a user of the wireless identity transmitter 110. Each time a proximity broadcast receiver 138, 142 receives an identifier from a wireless identity transmitter 110, the identifier may be associated with the time of the connection and the location of the proximity broadcast receiver 138, 142, and this information may be transmitted to the central server 120, such as within a sighting message. In some embodiments, the identifier, the time, and the location of the contact may be stored in the memory of the proximity broadcast receiver 138, 142 (or an intermediary server 130, 140) for later reporting, such as in response to a query message broadcast or multicast by the central server 120. Also, the central server 120 may store location information reported by sighting messages in a database, which may be used for locating, tracking or otherwise monitoring movements of the wireless identity transmitter 110.

In an embodiment, mobile proximity broadcast receivers 138 may be configured to exchange short-range wireless signals 189 with stationary proximity broadcast receivers 142. In other words, a mobile proximity broadcast receiver 138 may be configured to operate as a wireless identity transceiver that is capable of receiving short-range wireless signals 114 (i.e., broadcast messages) from the wireless identity transmitter 110 as well as transmitting short-range wireless signals 189 for receipt by proximity broadcast receivers 142.

In an embodiment, proximity broadcast receivers 138, 142 may transmit wireless signals 188 to a wireless router 185, such as part of the local area network 202, which may provide a connection 187 to the Internet 103. For example, the stationary proximity broadcast receivers 142 may transmit sighting messages that include data from broadcast messages transmitted by the wireless identity transmitter 110 to a WiFi wireless router 185.

The central server 120 may also be connected to the Internet 103, thereby allowing communication between proximity broadcast receivers 142, 138 and the central server 120. As described above, the central server 120 may include a plurality of components, blades, or other modules to process sighting messages and data received from proximity broadcast receivers 142, 138. Further embodiments may provide a direct connection (not shown) between the central servers 120 and any of the mobile device network components, such as the network operations centers 132, to more directly connect the proximity broadcast receivers 142, 138 and the central servers 120.

The communication system 200 may also include computing terminals 124, such as personal computers at home or work, through which users may communicate via the Internet 103 with the central server 120. Such terminals 124 may allow users, such as parents, police, fire, medical attendants, and other authorized authorities to register devices (e.g., wireless identity transmitters 110), access tracking records on the central servers 120, and/or to request that the central server 120 initiate a search for a particular wireless identity transmitter 110. In an embodiment, users may use such terminals 124 to register wireless identity transmitters 110, proximity broadcast receivers 142, 138 (e.g., smartphones configured to execute client software associated with the central server), and/or identity transceivers (not shown), such as by accessing web portals and/or user accounts associated with the central server 120. Similarly, third-parties, such as merchants, may use terminals 124 to register wireless identity transmitters 110, proximity broadcast receivers 142, 138 (e.g., stationary receivers configured to execute client software and relay broadcast to the central server), and/or identity transceivers (not shown).

Based on the location of the proximity broadcast receivers 138, 142 within a place, multiple proximity broadcast receivers 138, 142 may be within the broadcast area of the wireless identity transmitter 110 and may concurrently receive broadcast messages. The central server 120 may detect when proximity broadcast receivers 138, 142 concurrently (or within a certain time period) transmit sighting messages that indicate receipt of broadcast messages from the wireless identity transmitter. Such concurrent sighting messages may be used to determine more precise proximity information relating to the wireless identity transmitter at the time of broadcasting.

The communication system 200 may operate in a passive information gathering mode and/or an active search mode. In the passive information gathering mode, proximity broadcast receivers 138, 142 may continuously listen for broadcasts from any wireless identity transmitters 110, and report all identifier reception events via sighting messages (e.g., transmissions including identifiers, time and location) to the central server 120. When no active search is underway (i.e., no one is looking for a particular wireless identity transmitter 110), sightings of wireless identity transmitters 110 or received broadcast messages from wireless identity transmitters 110 may be stored in memory of the proximity broadcast receivers 138, 142 or the central server 120 for access at a later time. In order to protect privacy, such stored data may be stored for a limited period of time, such as a day, a week or a month, depending upon the person or asset being tracked. Then, if a person or asset is discovered to be missing, the stored data may be instantly accessed to locate and track the associated wireless identity transmitter 110, or at least determine its last reported location.

In a modification of the passive tracking mode, each proximity broadcast receiver 138, 142 may store IDs, times and locations corresponding to received broadcast messages (or contacts) from wireless identity transmitters 110 for a limited period of time. Alternatively, such information may be stored in servers 130, 140 connected to such proximity broadcast receivers 138, 142. Then, if a person or asset associated with a wireless identity transmitter 110 is discovered missing, a search can be initiated by the central server 120 querying the proximity broadcast receivers 138, 142 (or servers 130, 140) to download their stored data (e.g., databases indicating contacts with wireless identity transmitters 110) for analysis and storage in a database of the central server 120.

In an embodiment, in order to limit the demands on civilian mobile devices configured to operate as mobile proximity broadcast receivers 138, the passive tracking mode may only be implemented on the stationary proximity broadcast receivers 142. While the fewer number of such devices means the tracking of wireless identity transmitters 110 may be less effective, this embodiment may nevertheless enable receiving broadcast messages and thus the tracking of wireless identity transmitters 110 through high-traffic zones, such as intersections, highway on/off ramps, bus stations, airports, etc.

In the passive information gathering mode/embodiment, a user may use the communication system 200 to request the location of a particular wireless identity transmitter 110, such as by sending a request from a terminal 124 to the central server 120. For example, a mother may log in on her home computer terminal 124 and request the location of the wireless identity transmitter 110 in her child's backpack. The request may include a serial number, code, or other identifier corresponding to the wireless identity transmitter 110. The central server 120 may search the stored identification messages for the serial number, code, or other identifier and return any reported locations matching entered information, along with the times of such locations were reported via sighting messages. In further embodiments, the serial number or code entered by the parent may be cross-referenced with the identifier that the requested wireless identity transmitter 110 communicates in broadcast messages and that are relayed to the central server 120 in sighting messages submitted by proximity broadcast receivers 138, 142. In this manner only an authorized user (i.e., someone who knows the access code, password, or other secret code associated with a particular wireless identity transmitter 110) can obtain information regarding a given wireless identity transmitter 110 even though data is being gathered continuously.

In the active search mode/embodiment, the central server 120 may instruct proximity broadcast receivers 138, 142 to actively search for a particular wireless identity transmitter 110 (i.e., a “targeted” wireless identity transmitter). An active search may be initiated in response to a request received from a terminal 124. Such a request may include the identifier for the particular wireless identity transmitter 110, or an account number/name that is or can be cross-linked to the identifier of the wireless identity transmitter 110. The central server 120 may transmit activation messages, such as via broadcast or multicast, to proximity broadcast receivers 138, 142 that may instruct proximity broadcast receivers 138, 142 to search for a particular wireless identity transmitter 110 and that may include an identifier of the targeted wireless identity transmitter 110 (i.e., target device ID). For example, an activation message corresponding to an active search for a targeted wireless identity transmitter 110 may include a rolling identifier that the wireless identity transmitter 110 changes periodically in an unpredictable manner and that is known to the central server 120. In an embodiment, activation messages transmitted, broadcast or multicast by the central server 120 may be sent only to proximity broadcast receivers 138, 142 within particular sectors or within a given distance of a particular location. Alternatively, the activation messages may identify particular sectors or a distance from a particular location to enable the proximity broadcast receivers 138, 142 to determine whether the activation message is applicable to them based on their own known location. In this manner the search can be focused on a given area, such as a sector encompassing the last known location of the wireless identity transmitter 110 or an eye witness sighting. By focusing the search in this manner, proximity broadcast receivers 138, 142 not within the sector of search need not be activated.

In the active search mode/embodiment, in response to receiving activation messages from the central server 120 that include target device IDs and determining that they are within the identified sector of search, proximity broadcast receivers 138, 142 may configure their short-range radios (e.g., Bluetooth® radio) to listen for broadcast messages having the identifiers. In other words, the proximity broadcast receivers 138, 142 may be considered activated for a search and may or pairing attempts with an identifier look for the identifiers included in the activation message (i.e., target device IDs). In embodiments that do not rely on pairing with the wireless identity transmitter, proximity broadcast receivers 138, 142 matching an identifier within a received broadcast message to a target device ID within an activation message may promptly report the event to the central server 120 via sighting messages transmitted via links 146 or long-range wireless links 136. In embodiments that rely on pairing or an exchange of messages between the wireless identity transmitter and proximity broadcast receivers, proximity broadcast receivers 138, 142 may listen for and only complete communication handshaking or pairing with a device that broadcasts the target device ID, and ignore other pairing attempts. In this alternative embodiment, proximity broadcast receivers 138, 142 may be protected from pairing with unauthorized devices while in the active search mode. Also, proximity broadcast receivers 138, 142 may modify the pairing process in the active search mode to terminate the communication link as soon as the device ID is received, further protecting against pairing with unauthorized devices in the active search mode. In the active search mode/embodiment, proximity broadcast receivers 138, 142 receiving the target device ID may promptly report that event to the central server 120 via a wired or wireless link to the Internet 103. As mentioned above, such a report may include the location of the proximity broadcast receiver 138, 142 and the time when the identifier was received if the report is not transmitted immediately. In the active search mode/embodiment, each sighting message received by the central server 120 may be reported to an interested person or authority, such as in the form of a webpage showing an update location indicator on a map.

Further, in the active search mode/embodiment, an authorized user, such as a police, FBI, fire/rescue or other person of authority may use the communication system 200 to activate a search for a particular wireless identity transmitter 110, such as by using a terminal 124 to provide the central server 120 with the target device ID and search location or sectors to be searched. For example, a mother discovering that her child is missing may call the police and provide them with an identifier of the wireless identity transmitter 110 concealed in her child's clothing. With the search activated, the central server 120 may transmit an alert (or message that indicates a search for a wireless identity transmitter has been activated) to proximity broadcast receivers 138, 142 within the initial targeted search sector. The central server 120 may then activate a webpage that presents a map of the search area and that may be maintained in near-real time so, that as relevant sighting messages are received, reported location information is displayed on the map. Authorized users may then access the website (or other information provided by the server) to coordinate in-person search efforts.

Of course, information gathered and stored in proximity broadcast receivers 138, 142 or in a database of the central server in the passive mode may be used upon initiation of an active search, such as to identify an initial search location or sector, track recent locations and movements, and to provide/display a history of locations reported by sighting messages that may be combined with near-real time search reports.

In another embodiment, the communication system 200 may further include a plurality of wireless identity transmitters (not shown in FIG. 2) that are placed throughout a building. In such a situation, the plurality's broadcast areas may cover a large portion of the enclosed area of such a building. For example, the building may be a retail store and the plurality of wireless identity transmitters may be permanently stationed throughout the sales floor of the building. As a mobile proximity broadcast receiver 138, such as a smartphone carried by a customer, moves throughout the building and within the broadcast areas of the plurality of wireless identity transmitters, the mobile proximity broadcast receiver 138 may receive broadcast messages associated with the building. In another embodiment, the Internet access server 140 may be configured to store, receive, and otherwise process information relevant to the building. For example, the Internet access server 140 may be configured to perform as a local server for a retail store or alternatively a point-of-sale device that is configured to perform software and operations for conducting transaction with customers. For example, the Internet access server 140 may be configured to perform operations related to a customer purchase within a retail store building.

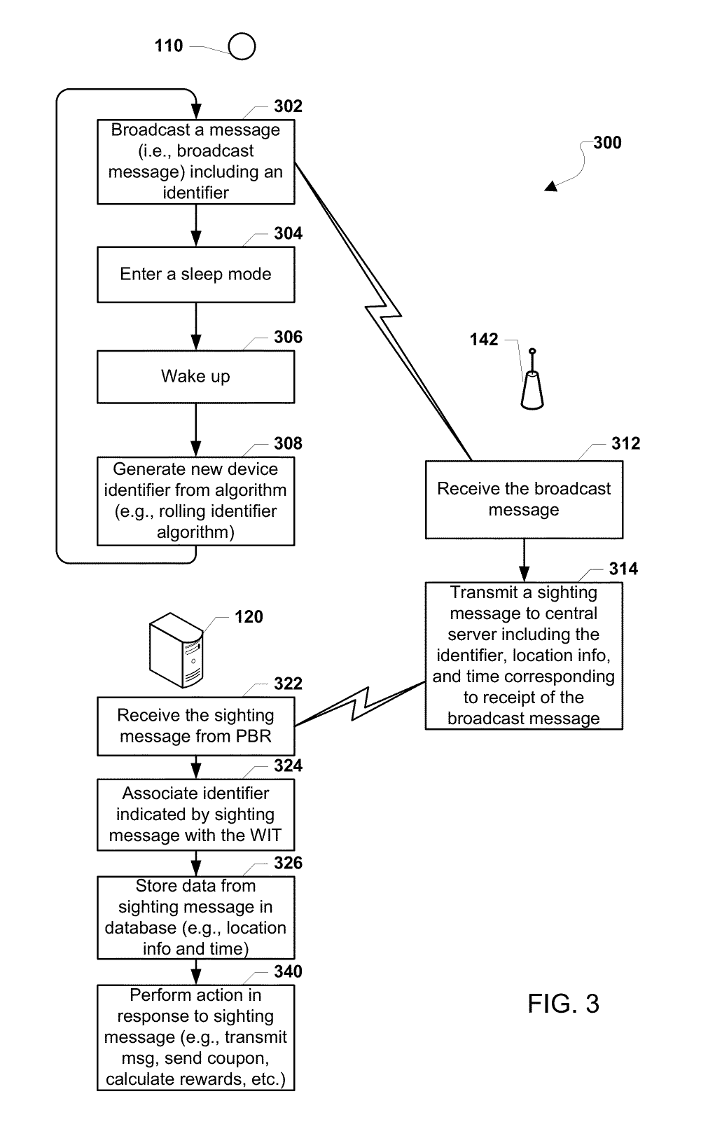

FIG. 3 illustrates an embodiment method 300 for implementation in a wireless identity transmitter 110 (referred to as “WIT” in FIG. 3), a proximity broadcast receiver 142, and a central server 120. In block 302, a wireless identity transmitter 110 may broadcast a message that includes an identifier, such as a broadcast message as described above. For example, the wireless identity transmitter 110 may broadcast a Bluetooth® LE advertising packet that includes a rolling identifier as described herein. This may be accomplished in block 302 by a microcontroller within the wireless identity transmitter 110 determining that it is time to broadcast its identifier, configuring a suitable broadcast message (e.g., an advertisement packet as specified for Bluetooth® LE devices in the Bluetooth®4.0 protocol), and transmitting that packet via a short-range radio.

In various embodiments, the message broadcast by the wireless identity transmitter (i.e., the broadcast message) may include an identifier segment, such as a rolling identifier. In various embodiments, the broadcast message may also include additional segments, such as a type segment. The type segment may indicate the type of wireless identity transmitter. For example, wireless identity transmitters may be marketed for various purposes, such as child safety devices, dog collars, or security tags for stores. The wireless identity transmitters may have a different type segment based on the intended purpose (e.g., one code for child safety devices, a second code for dog collars, etc.). Type segments may be static and set by manufacturers, while the remaining portion of the identifier may be unique to each device, and may roll as described below. The type segment may also be changed by a user, such as when a wireless identity transmitter is reset for a different purpose or application.

In other embodiments, a broadcast message may also include one or more static or dynamic segments with instructions or commands to be implemented by a proximity broadcast receiver. Such command segments may also be passed along to instruct a central server or other network device. Command segments may be set or static, similar to type segments, or may vary over time based on various conditions, such as pairings or data from one or more proximity broadcast receivers. Such command settings may also be configured by a user of the wireless identity transmitter. Second or additional segments may also indicate the status of the wireless identity transmitter. For example, a second segment may indicate the remaining power or estimated time left before the battery dies. Proximity broadcast receivers or a central server may interpret this status and respond accordingly.

Returning to FIG. 3, in block 304, the wireless identity transmitter 110 may enter a sleep mode. For example, after broadcasting the broadcast message having the identifier, the wireless identity transmitter 110 may be configured to enter a power conservation state that may continue for a predetermined period of time. In various embodiments, the wireless identity transmitter 110 may sleep for a predetermined time, never sleep, or sleep for varying times determined based on various inputs. In block 306, the wireless identity transmitter 110 may wake up from the sleep mode, such as after the predetermined duration expires. In block 308, the wireless identity transmitter 110 may generate a new device identifier from an algorithm, such as a rolling identifier algorithm. For example, the wireless identity transmitter 110 may generate a rolling identifier using a pseudo-random function or a streaming-like encryption algorithm (e.g., AES-CTR), as described below. The wireless identity transmitter 110 may then return to block 302 to broadcast again. In an embodiment, the broadcast message may contain timing, nonce or counter, count-down, or scheduling information indicating the availability of the wireless identity transmitter for receiving messages. For example, the broadcast message may indicate that the wireless identity transmitter will accept incoming configuration messages within a specified time window. In various embodiments, the operations in blocks 302-308 may be performed by an identity transceiver (e.g., a smartphone configured to operate as both an identity transmitter and a proximity broadcast receiver).

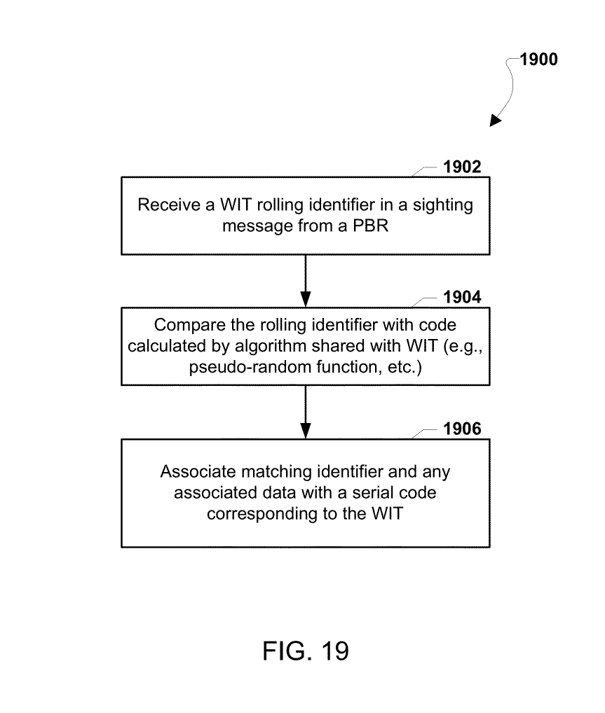

As mentioned above, the algorithm (or rolling identifier algorithm) used in block 308 may generate a rolling identifier which is very difficult to predict or recognize by a device or system that does not know either an identity of the wireless identity transmitter 110 (e.g., a MAC or Bluetooth® ID), a decode key, and/or the algorithm used to generate the rolling identifier. As discussed below with reference to FIG. 19, the central server 120, configured with the algorithm (or a decoding algorithm) or a decode key, and in possession of the wireless identity transmitter 110 identities, can use the rolling identifier to determine a corresponding account or device identity. While method 300 shows the rolling identifier changing with every wake and broadcast cycle as one example, in other embodiments the identifier may be changed less frequently, such as once per minute, once per hour, etc. In such embodiments, the operation of generating a new identifier in block 308 may be performed only at the designated interval, so at other times upon waking (i.e., block 306) the wireless identity transmitter 110 may return to block 302 to broadcast the identifier. Various algorithms for generating rolling identifiers or other encoded identifiers, as well as other decoding algorithms, are discussed below as well as in related application U.S. patent application Ser. No. 13/773,336, entitled “Preserving Security By Synchronizing a Nonce or Counter Between Systems,” the entire contents of which are hereby incorporated by reference for purposes of algorithms for generating, transmitting and decoding rolling identifiers and other data.

The method 300 also illustrates operations that may be implemented in the proximity broadcast receiver 142. In block 312, the proximity broadcast receiver 142 may receive the broadcast message from the wireless identity transmitter 110. The proximity broadcast receiver 142 may receive the broadcast message when within proximity of the wireless identity transmitter 110 (i.e., within communication range). When the broadcasted message with included identifier is received, the proximity broadcast receiver 142 may analyze header or metadata within the received broadcast message, as well as parse and evaluate various data within the broadcast message. In an embodiment, the broadcast message may contain encrypted and non-encrypted data that the proximity broadcast receiver 142 may or may not be configured to decrypt or otherwise access. In block 314, the proximity broadcast receiver 142 may transmit a sighting message to the central server 120 including the identifier, location information, and time corresponding to the receipt of the broadcast message. This transmission may be accomplished via a wireless wide area network, such as a cellular data network coupled to the Internet. In various embodiments, the operations in blocks 312 and 314 may be performed by a stationary proximity broadcast receiver, a mobile proximity broadcast receiver, or alternatively, an identity transceiver (e.g., a smartphone configured to operate as both a transmitter and a receiver).

In general, sighting messages may include metadata or header information that may describe received broadcast messages (e.g., message size, indicators of subject matter, etc.), the proximity broadcast receiver 142, such as the proximity broadcast receiver identification (e.g., a code, username, etc.), indications of services with which the proximity broadcast receiver 142 is affiliated regarding the server (e.g., the proximity broadcast receiver 142 participates in a tracking program for a particular vendor, merchant, area, etc.), as well as the conditions at the time of receipt of the broadcast message. For example, the sighting message may include signal strength information of the received broadcast message. In an embodiment, sighting messages may each include codes, flags, or other indicators that describe the general topic, subject matter, or reason for the sighting message. For example, the sighting message may contain a flag that indicates a relation to an active alert.

Additionally, sighting messages may include location information of the proximity broadcast receiver 142. In particular, sighting messages may indicate network-specific information that relates to a location. For example, a sighting message may indicate the cell site (e.g., cell site ID), cellular network tower (e.g., cell tower ID), or other wireless network with which a mobile proximity broadcast receiver was in communication at the time of receipt of the broadcast message. Further, sighting messages may include more refined location information based on data from global positioning systems (GPS) or chips included within the proximity broadcast receiver 142. For example, the proximity broadcast receiver 142 may determine GPS information (i.e., GPS coordinates) of the proximity broadcast receiver 142 at the time of receipt of a broadcast message, including the coordinates in the corresponding sighting message. In an embodiment, sighting messages may also include sensor data from various sensors within the proximity broadcast receiver 142, such as accelerometers, gyroscopes, and magnetometers. Further, sighting messages may include authentication information that may confirm the legitimacy of the sighting message as coming from a known, registered, or otherwise valid proximity broadcast receiver 142. For example, authentication information included in a sighting message may include secret codes, certificates, or hash data that is shared between the proximity broadcast receiver and the central server 120.

In various embodiments, the proximity broadcast receiver 142 may generate sighting messages by appending data and various information to broadcast messages received from the wireless identity transmitter 110. In an embodiment, sighting messages may include the entirety of received broadcast messages or, alternatively, only portions of the received broadcast messages that the proximity broadcast receiver 142 determines to be of significance. For example, the proximity broadcast receiver 142 may extract particular header or metadata information from a broadcast message before generating a corresponding sighting message. As another example, the proximity broadcast receiver 142 may compress, abbreviate, truncate and/or summarize data within the broadcast message. In another embodiment, the proximity broadcast receiver 142 may simply redirect, relay, or retransmit received broadcast messages to the central server.

Sighting messages may be transmitted via a wireless or wired communication link, such as a wireless cellular network, a local area network configured to communicate via Internet protocols, a long-range radio communication link, or a short-range radio. For example, the proximity broadcast receiver 142 may transmit sighting messages over a cellular network via the Internet to the central server. As another example, the proximity broadcast receiver 142 may transmit sighting messages via a wired Ethernet connection.

Returning to FIG. 3, the method 300 also illustrates operations that may be implemented in the central server 120. In block 322, the central server 120 may receive the sighting message from the proximity broadcast receiver 142. In block 324, the central server 120 may associate an identifier indicated by the sighting message with the wireless identity transmitter 110. The central server 120 may associate the identifier within the sighting message with an account registered/created by a user. Associating the identifier with a particular wireless identity transmitter 110 or user account may be accomplished by comparing the identifier with a database of codes corresponding to the wireless identity transmitter 110 or user accounts to determine the database record in which information from the sighting message (e.g., location info) should be stored. Since in some embodiments the wireless identity transmitter 110 identifier changes (rolls) frequently, this process may involve comparing the identifier received in the sighting message to several possible serial codes generated by a pseudo-random number generator algorithm, or applying a reverse algorithm which uses the received identifier as an input and outputs the corresponding account number. In block 326, the central server 120 may store data from the sighting message in a database, such as location information and time data. For example, the central server 120 may determine the location of the proximity broadcast receiver 142 when the broadcast message was received based evaluating the received sighting message, and may store that data in a database linked to the wireless identity transmitter 110 or its user/owner.

In block 340, the central server 120 may perform an action in response to the sighting message, such as transmit a message to a recipient, send a coupon, and/or calculate rewards. In an embodiment, the central server 120 may transmit a return message to a recipient, such as the proximity broadcast receiver 142, that includes instructions, software, or codes indicating how the proximity broadcast receiver 142 may respond to the received broadcast message. For example, the return message may direct the proximity broadcast receiver 142 to transmit a link advertisement message. Recipients of such messages from the central server may include various devices and parties, including computing devices of registered services (e.g., merchants, emergency personnel), mobile devices of users, and proximity broadcast receivers (e.g., the proximity broadcast receiver 142 that received the broadcast message). In another embodiment, the central server 120 may use the stored data to identify when the wireless identity transmitter 110 enters, is within, and/or leaves a designated area. In other words, the central server 120 may identify when the wireless identity transmitter 110 comes within proximity, stays within proximity, or leaves proximity of a proximity broadcast receiver 142.

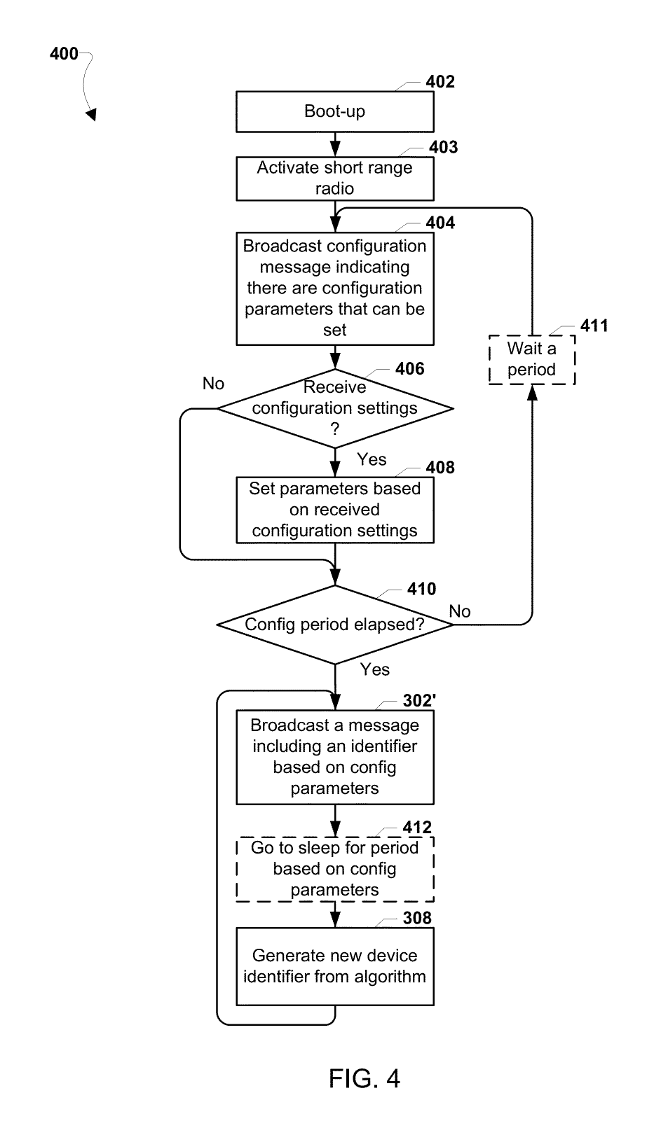

FIG. 4 illustrates an embodiment method 400 for a wireless identity transmitter (referred to as “WIT” in FIG. 4) receiving configuration settings after performing boot-up operations. Typically, wireless identity transmitters may only perform one-way communications, broadcasting signals for receipt by proximity broadcast receivers. However, wireless identity transmitters may be configured to selectively engage in two-way communications with other devices with similar short-range wireless signaling capabilities (e.g., Bluetooth® LE transceivers). In particular, upon initialization operations (or “booting-up”), a wireless identity transmitter may be configured to receive incoming short-range wireless communications from proximity broadcast receivers. For example, when a battery is replaced or inserted for the first time, the wireless identity transmitter may accept incoming Bluetooth® packets for a predefined period of time, such as sixty seconds. Alternatively, the wireless identity transmitter may receive incoming messages as part of power-cycling (e.g., receive for the sixty seconds after a reboot of the wireless identity transmitter).

Such incoming short-range wireless communications may include instructions, software, firmware, commands, or other code for setting values for configuration parameters utilized by the wireless identity transmitter for performing various functions. In particular, the incoming communications may include configuration settings (or values) the wireless identity transmitter may use to set or modify established configuration parameters associated with transmitting broadcast messages that include identification information of the wireless identity transmitter. In an embodiment, incoming communications that include configuration settings may be Bluetooth® signals (e.g., setters or getters) that may not require pairing operations between the sender and receiver (i.e., the wireless identity transmitter). In other words, the incoming communications may be non-pairing Bluetooth® advertisements.

Configuration parameters may include the transmit interval for transmitting broadcast messages (i.e., how often the wireless identity transmitter should broadcast packets that include its identity) and the transmit power for transmitting broadcast messages (i.e., what signal strength to use when broadcasting). For example, received configuration settings may vary the intervals (i.e., broadcasting frequency) at which the wireless identity transmitter broadcasts its identifier in a manner configured to facilitate accurate tracking of the wireless identity transmitter while conserving battery power. This may be important as setting transmit power configuration parameters may affect the battery service life of the wireless identity transmitter (e.g., a longer interval may include a longer sleep mode and thus decreased power consumption). In an embodiment, configuration parameters may also include a debug parameter that may be set or modified by a manufacturer or administrative party (e.g., a central server). The debug parameter may be utilized by software or algorithms executed by the wireless identity transmitter and may indicate when the wireless identity transmitter should generate new identifiers to broadcast (e.g., an interval for generating a new rolling identifier or Bluetooth® MAC address identifier). In another embodiment, incoming communications with configuration settings may include commands that instruct the wireless identity transmitter to change the data represented within broadcast messages, such as by entering/exiting an encoded mode. Alternatively, incoming communications may include instructions for the wireless identity transmitter to shorten its broadcast signal range to emulate near field communications (NFC).

In block 402, the wireless identity transmitter may boot-up. In other words, the wireless identity transmitter may be energized, initialized, and otherwise configured to operate from a hibernating, sleep, dormant, or otherwise deactivated state. In various embodiments, the boot-up operations may be performed in response to a user input (e.g., a button press), the insertion of a battery in the wireless identity transmitter, or receiving a short-range wireless signal (e.g., an activation signal). In block 403, the wireless identity transmitter's short-range radio may be activated. This activation may be accomplished by a timer or by the microcontroller determining that a duration has expired since the boot-up operations were performed or concurrently with the boot-up operations. In an embodiment, the activation of the short-range radio may be a routine within the boot-up operations in block 402.

In block 404, the wireless identity transmitter may broadcast a configuration message indicating there are configuration parameters that can be set in the wireless identity transmitter. For example, the configuration message may include the wireless identity transmitter's identity (or identifier) as well as an indication that a certain number or type of configuration parameters can be set, modified, or initialized by subsequent short-range wireless signals. In an embodiment, the configuration message may include a list of configuration parameters available to be set, such as the transmit interval.

In an alternative embodiment, the configuration message may include an indicator that the wireless identity transmitter is available to receive configuration settings. In such an embodiment, any responding devices, such as proximate proximity broadcast receivers, may transmit responses (e.g., Bluetooth® LE signals) that request the list of configuration parameters. In response to receiving such a request, the mobile proximity broadcast receiver may transmit a second message that includes the list of configuration parameters.

In determination block 406, the wireless identity transmitter may determine whether configuration settings are received, such as in a short-range wireless signal from a proximate proximity broadcast receiver or identity transceiver. The wireless identity transmitter may monitor the short-range radio to determine whether a response is received from a proximate device. A response may be in the form of a simple response packet or pulse that the wireless identity transmitter microcontroller can recognize, or alternatively, an advertisement according to the Bluetooth® LE protocol. If configuration settings are received (i.e., determination block 406=“Yes”), in block 408 the wireless identity transmitter may set parameters based on the received configuration settings. For example, the wireless identity transmitter may set a value that indicates how often it transmits broadcast messages. If no configuration settings are received (i.e., determination block 406=“No”), or if the wireless identity transmitter performs the operations in block 408, in determination block 410 the wireless identity transmitter may determine whether a configuration period has elapsed. For example, the wireless identity transmitter may evaluate a counter or timer to determine whether a predefined number of seconds (e.g., 60 seconds) have elapsed since the boot-up operations were performed. If the configuration period has not elapsed (i.e., determination block 410=“No”), in optional block 411 the wireless identity transmitter may wait a period, such as a number of milliseconds, seconds, etc., and then may continue with the operations in block 404.

However, if the configuration period has elapsed (i.e., determination block 410=“Yes”), in block 302′ the wireless identity transmitter may broadcast a message including an identifier based on the configuration parameters. For example, the wireless identity transmitter may transmit a broadcast message at a signal strength indicated by configuration parameters set in response to receiving configuration settings (or values) from a nearby proximity broadcast receiver. In optional block 412, the wireless identity transmitter may go to sleep for a period based on the configuration parameters, such as a transmit interval configuration parameter. In block 308, the wireless identity transmitter may generate a new device identifier (e.g., rolling identifier) from an algorithm, and may continue with the operations in block 302′.

In alternate embodiments, the wireless identity transmitter may be configured to receive incoming messages from proximity broadcast receivers based on clock timing (or clock signals), detected inputs from a user (e.g., a detected button press), or information within a previously received signal (e.g., a received message from a proximity broadcast receiver may instruct the wireless identity transmitter to become available for subsequent messages at a particular future time).

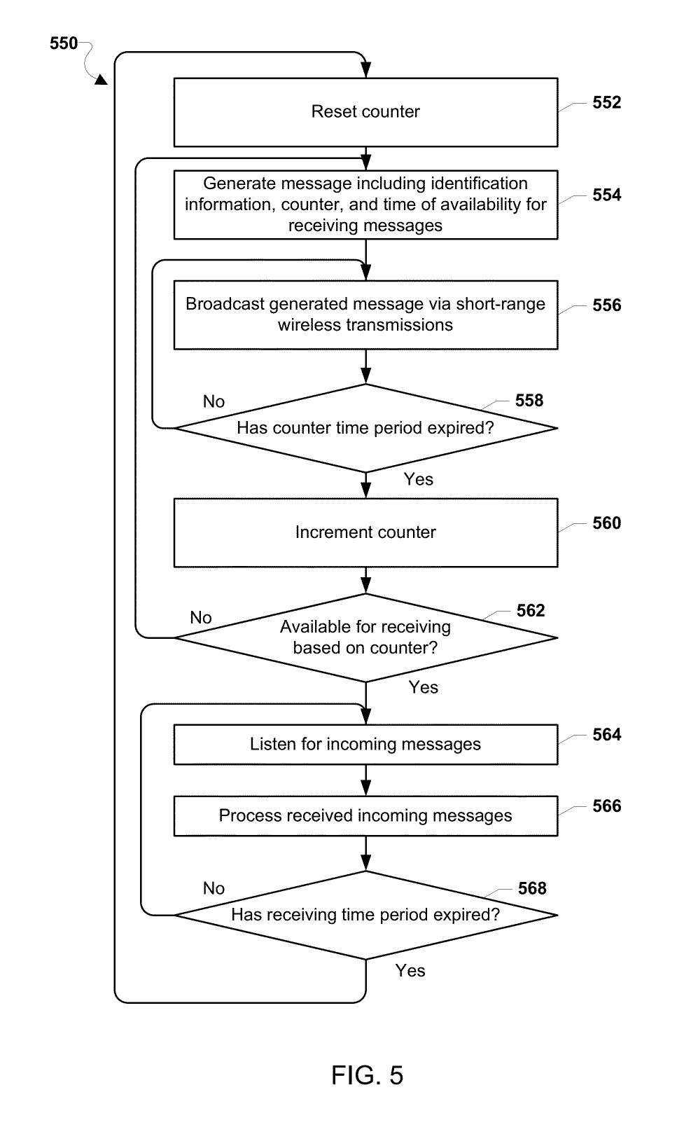

FIG. 5 illustrates an embodiment method 550 for a wireless identity transmitter performing two-way wireless communications with a proximity broadcast receiver. As described above, wireless identity transmitters may typically be used for one-way signaling, such as transmitting broadcast messages for receipt, use, and relay by proximity broadcast receivers. However, wireless identity transmitters may be configured to conduct two-way communications in order to receive firmware, software instructions or trigger signals directing the transmitter to perform certain operations (e.g., activate sensors), configuration data, and other information the wireless identity transmitter may use to transmit broadcast messages. Such two-way communications may be available to wireless identity transmitters that include short-range radio transceivers, such as Bluetooth® radios. However, wireless identity transmitters may be configured to selectively engage in two-way communications with proximity broadcast receivers to minimize power consumption and maximize battery service life. In an embodiment, the wireless identity transmitter may broadcast messages indicating to proximity broadcast receivers a period of time when the wireless identity transmitter may be available for receiving messages from proximity broadcast receivers, and may receive messages for a limited or predefined period of time.

In block 552, the wireless identity transmitter may reset a counter, such as a counter variable to indicate the beginning (or initialization) of a period during which the wireless identity transmitter may not receive messages. The counter may be reset to a zero value and may be incremented up to a predefined number during the operations of the method 550. Alternatively, the counter may be reset or initialized at a predefined number and decremented down to a zero value. The use of a counter variable is merely a non-limiting example technique for the wireless identity transmitter determining when to configure itself for receiving messages. In alternate embodiments, the wireless identity transmitter may instead determine when to be available for receiving incoming messages based on clock timing (or clock signals), detected inputs from a user (e.g., a detected button press), information within a previously received signal (e.g., a received message from a proximity broadcast receiver may instruct the wireless identity transmitter to become available for subsequent messages at a particular future time), or power-cycling (e.g., one such time might be for the sixty seconds after initial boot-up or reboot of the wireless identity transmitter).

In an embodiment, the wireless identity transmitter may be roughly in clock synchronization with or maintain the counter variable that it is known and roughly tracked by various proximity broadcast receivers (e.g., smartphones, listening radios throughout a place, etc.) and/or a central server. For example, when the wireless identity transmitter is activated (e.g., turned on, initialized by inserting a battery, etc.), a user may register the wireless identity transmitter with a central server that stores the wireless identity transmitter identification along with information that enables the central server to estimate a nonce or counter value or clock timing within the wireless identity transmitter. In an embodiment, such a nonce or counter variable or clock synchronization may be used to disambiguate wireless identity transmitter identities and/or be used as a decryption key for obfuscated or encoded messages. Such registration and synchronization operations are described further below.

In block 554, the wireless identity transmitter may generate a message including identification information, counter, and time of availability for receiving messages. The generated message may include information about the wireless identity transmitter's identity (e.g., a serial code/number, a username, or a rolling identifier). In an embodiment, the generated message may be encrypted, encoded, or otherwise obscured to prevent proximity broadcast receivers from determining the identity of the wireless identity transmitter and/or the user thereof. For example, the generated message may employ a rolling identifier or code known only to the wireless identity transmitter and a central server but not proximity broadcast receivers.

The generated message may also include information indicating a time or condition when the wireless identity transmitter may be available for accepting communications for proximity broadcast receivers. For example, the message may describe the current value of the counter or indicate a count-down timer showing when the wireless identity transmitter may be available. In another embodiment, the generated message may include instructions for proximity broadcast receivers to enable successful transmissions to the wireless identity transmitter. For example, the generated message may contain specifications (e.g., required codes, content, delivery time, etc.) for any messages transmitted by proximity broadcast receivers to the wireless identity transmitter.

In block 556, the transmitter may broadcast the generated message via short-range wireless transmissions, such as Bluetooth® LE packets. If within the range of the short-range broadcasts, a proximity broadcast receiver may receive and process the broadcasts as described below.

The wireless identity transmitter may periodically broadcast the same generated message multiple times for each counter time period. In other words, the wireless identity transmitter may broadcast the generated message more than once before modifying the counter variable value. In determination block 558, the wireless identity transmitter may determine whether the predetermined counter time period has expired. If the counter time period has not expired (i.e., determination block 558=“No”), the wireless identity transmitter may continue to broadcast the generated message periodically in block 556.

If the counter time period has expired (i.e., determination block 558=“Yes”), in block 560 the wireless identity transmitter may increment the counter and, in determination block 562, determine whether the wireless identity transmitter has become available for receiving messages based on the counter value. For example, the wireless identity transmitter may compare the current counter variable value to a predefined maximum (or minimum) counter value. As stated above, in various other embodiments, the wireless identity transmitter may determine availability for receiving messages based on other evaluations of time or instructions stored within the wireless identity transmitter.

If it is not available to receive messages (i.e., determination block 562=“No”), the wireless identity transmitter may continue with the operations in block 554 to generate a new message to broadcast. If the wireless identity transmitter is available to receive messages (i.e., determination block 562=“Yes”), in block 564 the wireless identity transmitter may listen for incoming messages, such as by monitoring a receiver circuit for incoming short-range radio transmissions, and in block 566 the wireless identity transmitter may process any received incoming messages, such as with software or operations running on a processor or wireless modem within the wireless identity transmitter.

In determination block 568, the wireless identity transmitter may determine whether the receiving time period has expired. In other words, the wireless identity transmitter may determine whether incoming messages may still be received. The time period for receiving incoming messages may be based on a nonce or counter variable maintained by the wireless identity transmitter, a clock signal indication, or information within a received message. If the receiving time period has not expired (i.e., determination block 568=“No”), the wireless identity transmitter may continue to listen for incoming messages in block 564. However, if the receiving time period has expired (i.e., determination block 568=“Yes”), the wireless identity transmitter may repeat the process by returning to block 552.

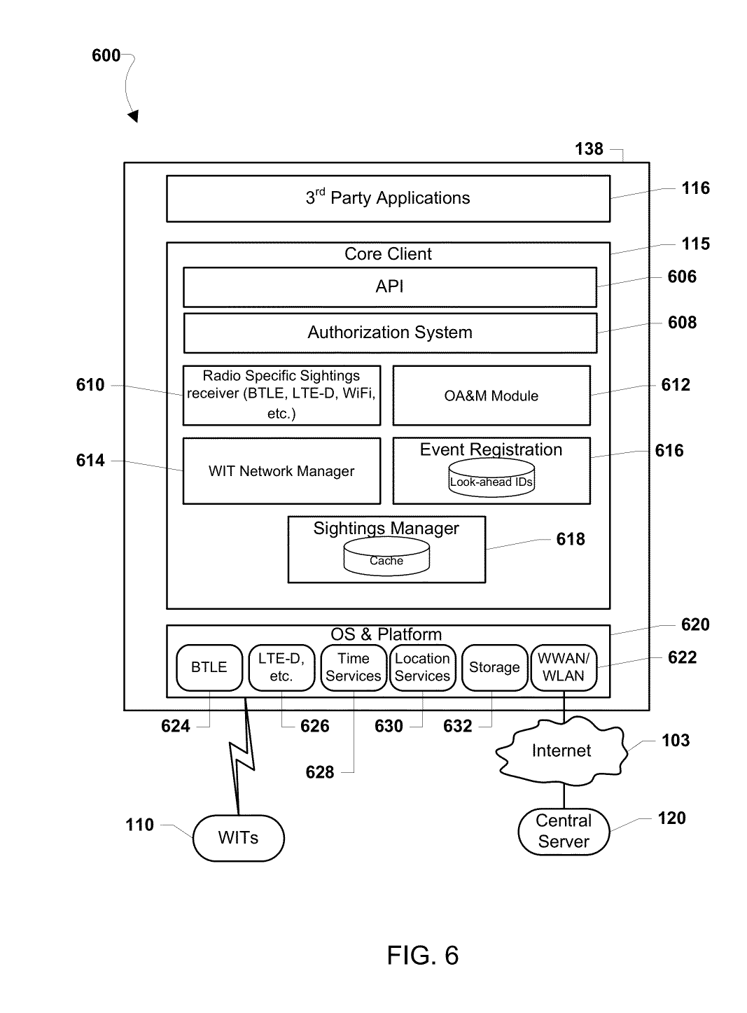

FIG. 6 illustrates various modules within a mobile proximity broadcast receiver 138. As described above, proximity broadcast receivers may include stationary proximity broadcast receivers, such as dedicated devices placed around a building, and mobile proximity broadcast receivers 138, such as mobile devices that are configured to perform operations to receive broadcast messages from wireless identity transmitters 110 and transmit sighting messages over the Internet 103 to a central server 120 via long-range communications (e.g., via WiFi or a cellular network). The various modules and components are described below in the context of elements within a mobile proximity broadcast receiver 138, however in various embodiments, any proximity broadcast receiver, such as a stationary proximity broadcast receiver, may include similar modules and/or components.

The mobile proximity broadcast receiver 138 may include a core client module 115 that may be software, instructions, routines, applications, operations, or other circuitry utilized to process received broadcast messages from proximate wireless identity transmitters 110. The core client module 115 may also handle communications between the proximity broadcast receivers 142, 138 and the central server 120, such as transmitting sighting messages and receiving return messages from the central server 120. For example, the core client module 115 may operate as a background service that performs operations, such as uploading or transmitting sighting messages, without interaction from a user.

The core client module 115 may include an API component 606 that corresponds to application programming interface data, code, or other commands related to broadcast messages and/or sighting messages. For example, the API component 606 may be utilized by a proximity broadcast receiver when listening for Bluetooth® LE advertising packets received from the wireless identity transmitter 110. As another example, the API component 606 may be utilized to register the mobile proximity broadcast receiver 138 to receive notifications, alerts, or other communications corresponding to wireless identity transmitters 110. The core client module 115 may also include an authorization system component 608 for processing received broadcast messages. For example, the mobile proximity broadcast receiver 138 may support oAuth for authorization requests and xAuth for approved communication partners. The core client module 115 may also include a radio specific sightings receiver component 610 (e.g., a component for handling Bluetooth® LE, LTE-D, WiFi, and other communications), an operations, administration, and management module 612, a wireless identity transmitter network manager component 614, an event registration component 616 that relates to stored look-ahead identifiers, and a sightings manager component 618. In an embodiment, the event registration component 616 may store numerous rolling identifiers downloaded from the central server 120 and corresponding to a particular wireless identity transmitter 110, such as a set of rolling identifiers that may match possible rolling identifiers broadcast by the wireless identity transmitter 110 during a certain time window.

Like many modern mobile devices, the mobile proximity broadcast receiver 138 may be configured to execute third-party applications (or “apps”), and thus may include a third-party applications module 116 that may execute, manage, and otherwise perform software instructions and routines related to applications provided by various third-parties (e.g., merchants). For example, the third-party applications module 116 may receive various data from the core client module 115 to be used by various third-party applications. For illustration purposes, a third-party application related to a department store that is registered with the central server 120 may be configured to receive notifications from the core client module 115 when the user of the mobile proximity broadcast receiver 138 enters, remains, and/or leaves the department store (e.g., a geofence of the store). In an embodiment, for optimization purposes, applications or apps executing via the third-party applications module 116 may register or otherwise be configured to received notifications from the core client module 115 when particular wireless identity transmitters are within proximity, or alternatively, leave proximity. For example, applications may register in advance with the core client module 115 to receive event notifications that indicate whether a particular wireless identity transmitter enters proximity, stays within proximity (e.g., standing nearby and not moving), or leaves proximity of a proximity broadcast receiver.

The mobile proximity broadcast receiver 138 may also include an operating system and platform module 620 for performing various operations and managing circuitry, such as short-range signal receiver circuitry. In particular, the operating system and platform module 620 may include a Bluetooth® Low Energy module 624 for processing communications utilizing Bluetooth® LE protocols, a cellular network module 626 for processing communications corresponding to various cellular and similar long-range wireless networks (e.g., LTE-D, etc.). The operating system and platform module 620 may also include a time services component 628 that may track time and generate timestamp data, a location services component 630 that may maintain low-precision location data or alternatively more precise GPS (or A-GPS) location data, a storage component 632, and a wireless wide area network/wireless local area network component 622 for enabling communications via WiFi or other wireless networks.

In an embodiment, the core client module 115 may request from the central server sets of wireless identity transmitter identifiers (e.g., rolling identifiers of all transmitters on an interested list, identifiers for all transmitters owned by a user, etc.). Such sets may correspond to wireless identity transmitters that are currently in use and are expected to be in use for some period of time.

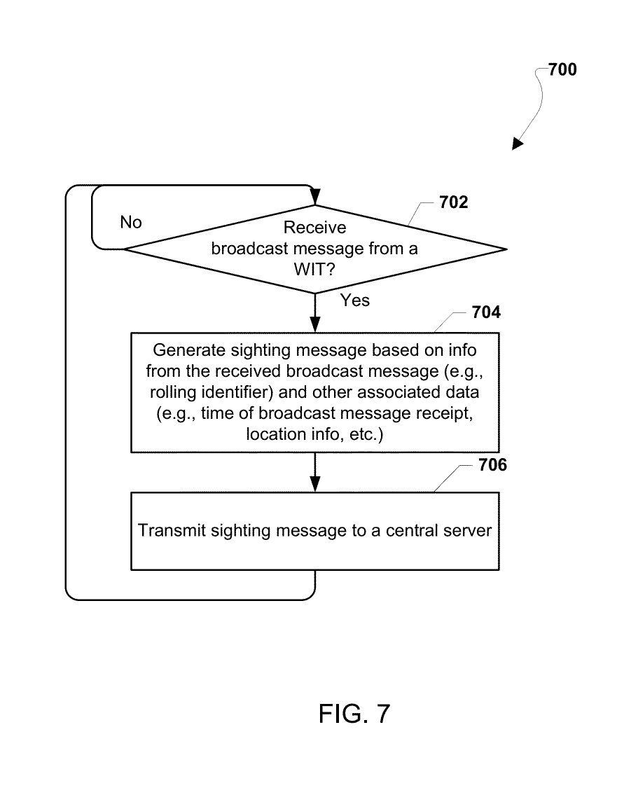

FIG. 7 illustrates an embodiment method 700 that may be implemented on a proximity broadcast receiver, such as a stationary proximity broadcast receiver or a mobile proximity broadcast receiver. In determination block 702, the proximity broadcast receiver may determine whether a broadcast message is received. For example, the proximity broadcast receiver may begin listening for broadcast advertisement packets or pairing attempts by wireless identity transmitters. As discussed above, in the passive mode/embodiment, the proximity broadcast receiver may continuously be in a monitoring mode, or begin listening for particular identifiers in response to an alert (or search activation message) received from a central server. In embodiments in which pairing takes place, the pairing may be established automatically if the proximity broadcast receiver is set to pair with any wireless identity transmitter without using a key, by using a key saved from a previous pairing with the wireless identity transmitter, or by using a key received from a central server. If the proximity broadcast receiver does not receive a broadcast message (i.e., determination block 702=“No”), the proximity broadcast receiver may continue with the operations in determination block 702.

If the proximity broadcast receiver receives a broadcast message (i.e., determination block 702=“Yes”), in block 704 the proximity broadcast receiver may generate a sighting message based on information from the received broadcast message and other associated data. In particular, the sighting message may include an identifier specific to the wireless identity transmitter that transmitted the received broadcast message, such as a rolling identifier (i.e., an encoded device identifier), MAC address, or other unique code that may be used to identify the particular wireless identity transmitter. In alternate embodiments, the wireless identity transmitter's identifier may be received as part of a pairing process. The other associated data may include various information related to the receipt of the broadcast message, such as the time the proximity broadcast receiver received the broadcast message, location information, the proximity broadcast receiver's identification information, related services (e.g., associated merchants), and signal strength information. In other words, the proximity broadcast receiver may associate data about present conditions (e.g., a timestamp, GPS coordinates, Cell ID of the closest base station, etc.) with the broadcast message and/or the wireless identity transmitter's identifier. This data may be stored in any of various types of data structures, such as an array with one or more identifiers associated with timestamps and GPS coordinates from when the sighting corresponding to each identifier occurred. In an embodiment, the sighting message may include authentication data, such as a digital certificate or code, that may be used by a central server to confirm the identity of the proximity broadcast receiver. For example, within the metadata of the sighting message, the proximity broadcast receiver may include a special hash code known only to the proximity broadcast receiver and the central server.

In block 706, the proximity broadcast receiver may transmit the sighting message to a central server, such as via a cellular (e.g., an LTE, 3G, or 4G network) or other network and the Internet as discussed above with reference to FIGS. 2A-2B. Upon reporting a contact event by transmitting the sighting message, the proximity broadcast receiver may promptly return to perform the operations in determination block 702 and await further broadcasts from wireless identity transmitters. This enables the proximity broadcast receiver to continuously report contact events to the central server.

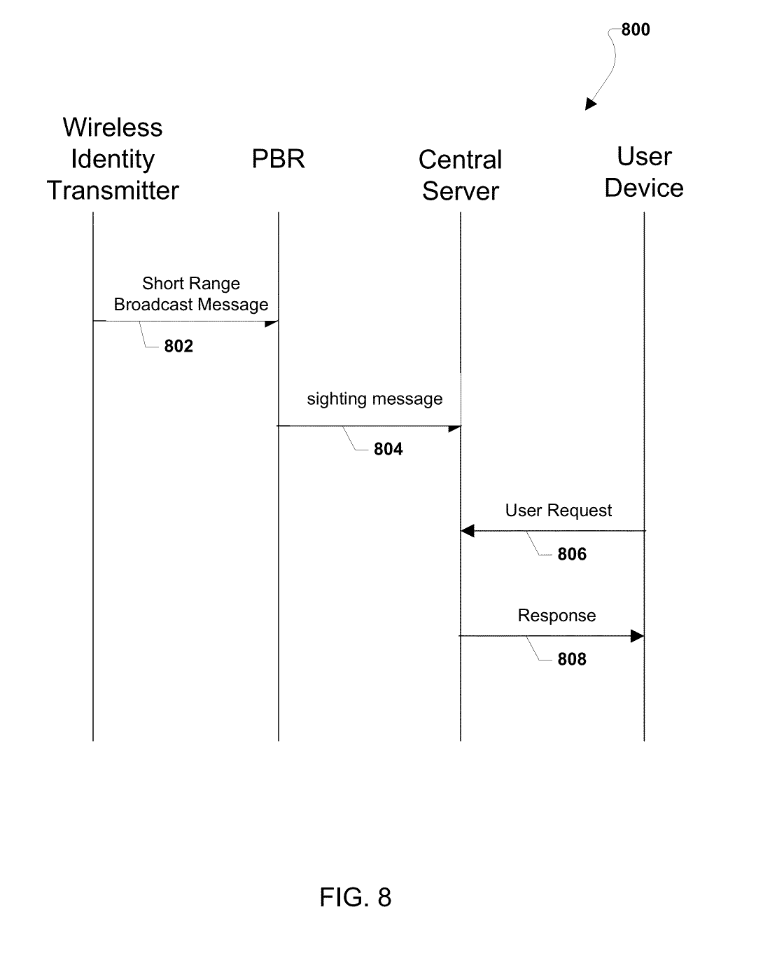

FIG. 8 is a call flow diagram 800 illustrating communications during various embodiments. A wireless identity transmitter 110 may transmit a short range broadcast message 802 (e.g., a Bluetooth® LE signal) to a proximity broadcast receiver, such as a mobile proximity broadcast receiver (e.g., a mobile device, cellular phone, etc.) or various other proximity broadcast receivers as discussed above. The broadcast message 802 may contain an identifier for the wireless identity transmitter. The proximity broadcast receiver may transmit (or upload) the wireless identity transmitter's identifier along with any associated data (e.g., timestamp, GPS coordinates, Cell ID, etc.) as a sighting message 804 to a central server 120. The central server 120 may receive the sighting message 804 and store many different identifiers from one or more proximity broadcast receivers.

In some embodiments, identifiers and the associated data may be transmitted (or uploaded) to the central server without any of a user's personal data to protect privacy. In the various embodiments attempting to leverage personal mobile phones, the phone users may opt-in as mobile proximity broadcast receivers. However, these phone users may refuse to opt-in if they fear that personally identifiable data will also be transmitted to the central server. Therefore, an application for uploading received identifiers installed on these personal mobile devices (i.e., mobile proximity broadcast receivers) may prohibit transmission of personal data or other data that may identify the mobile proximity broadcast receivers.

The central server 120 may receive a user request 806 from a user device, such as a terminal 124 or a mobile device, requesting the location of a wireless identity transmitter. This request may be sent by a user after logging into an account associated with a particular wireless identity transmitter. For example, each wireless identity transmitter may be registered with an authenticated user such that a request 806 for the registered wireless identity transmitter's location can only be transmitted after the authenticated user logs into a secure account.

After receiving a user request 806, the central server 120 may search through the previously reported wireless identity transmitter identifiers that are received via sighting messages to find any matches with the identifier of the requested wireless identity transmitter. Any matches could be reported to the user in a response 808. The response 808 may also include associated data (e.g. timestamp, GPS coordinates, Cell ID) within the sighting message 804. A user may use this associated data to help locate or track the wireless identity transmitter (e.g., a mother could look for a lost child at the latest location reported for the child's wireless identity transmitter).

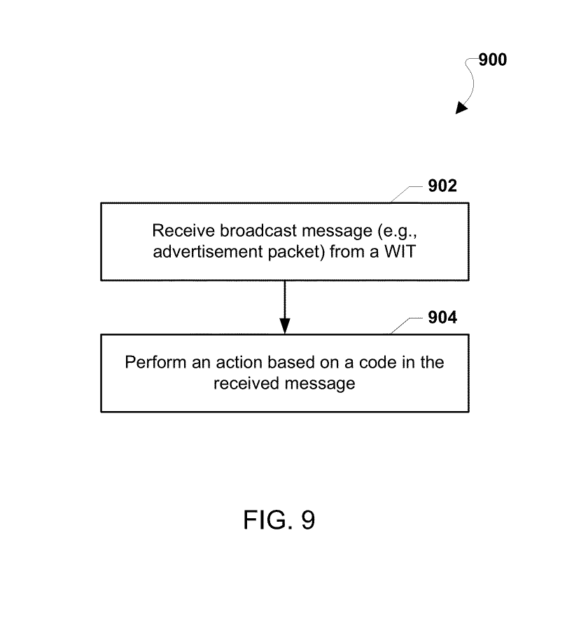

FIG. 9 illustrates an embodiment method 900 for including a type or command segment. In block 902, a proximity broadcast receiver may receive a broadcast message, such as a broadcast advertising packet, from a wireless identity transmitter (referred to as “WIT” in FIG. 9). In alternate embodiments, this message may be sent over a connection established by pairing or as part of the pairing procedure. The broadcast message may contain an identifier segment, as well as an additional segment or code, such as a type segment or command segment. The proximity broadcast receiver may perform an action based on this code in the received broadcast message in block 904. In various embodiments, this action may include any operation the proximity broadcast receiver is capable of performing. For example, the proximity broadcast receiver may assign different levels of priority to messages or identifiers based on a type segment or command segment (e.g., child safety devices have higher priority than security tags from stores). Received messages or identifiers with higher priority may be transmitted to a central server first or deleted last from a proximity broadcast receiver's local log.

A proximity broadcast receiver may handle the broadcast message or identifier differently based on a type or command segment. For example, the message may be stored locally for a certain time (e.g., various times depending on the value of the segment) prior to being transmitted to a central server. Alternatively, the message or identifier, along with any associated data such as timestamps and GPS coordinates, may be transmitted to multiple locations.

As another example, a proximity broadcast receiver may initiate various communications based on the type and/or command segments. The proximity broadcast receiver may report to particular URLs, transmit an SMS message, initiate a phone call, or establish new network connections. In various embodiments, some of these actions may be optionally disabled to protect user privacy.

In further embodiments, the proximity broadcast receiver may be configured to transmit the additional segment or other message to another network device for the other network device to take some action. For example, the proximity broadcast receiver may forward the message along with associated data to the central server. The central server may perform an action based on the additional segment in the message, such as automatically sending a message to a user without waiting for a user request.

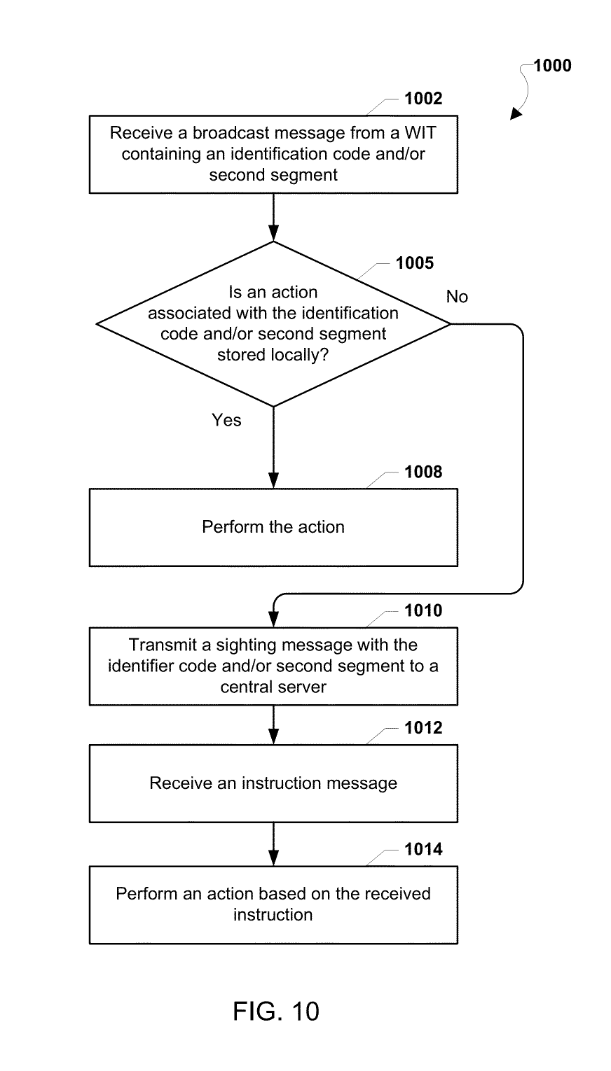

FIG. 10 illustrates an embodiment method 1000 for providing content based on proximity to a wireless identity transmitter. A proximity broadcast receiver may receive a broadcast message from a wireless identity transmitter (referred to as “WIT” in FIG. 10) containing an identification code and/or second segment in block 1002. The proximity broadcast receiver may determine whether an action associated with the identification code and/or second segment is stored locally (e.g., in the proximity broadcast receiver's memory) in determination block 1005. If an associated action is found locally (i.e., determination block 1005=Yes), the action may be performed by the proximity broadcast receiver in block 1008.

If an associated action is not found locally (i.e., determination block 1005=No), the proximity broadcast receiver may transmit a sighting message with the identifier and/or second segment to a central server in block 1010. In an embodiment, the proximity broadcast receiver may transmit a message to another device, such as a user device. The proximity broadcast receiver may receive an instruction message in block 1012. This instruction may be sent by the central server or other device in response to the sighting message with the identifier and/or second segment. In block 1014, the proximity broadcast receiver may perform an action based on the received instruction message, such as access content by going to a web page or other online resource. In alternate embodiments, the proximity broadcast receiver may skip the determination block 1005 and automatically proceed to either transmit a sighting message in block 1010 or attempt to perform an action stored locally.

A proximity-based content publishing system may be used for a wide range of activities. For example, teens may carry a wireless identity transmitter with them that they point to their social networking pages (e.g., Facebook®). When they are proximate to friends, the pages can be quickly accessed on proximity broadcast receivers (i.e., mobile phones configured to operate as mobile proximity broadcast receivers). Realtors may setup a web page for a home and affix to the home's signpost a wireless identity transmitter pointing to the web page so that anyone driving by the home can access that information. Stores may include wireless identity transmitters with products to provide dynamic displays such as links to coupons, customer reports, or additional nutritional information. If a lost dog has a wireless identity transmitter on its collar, instead of trying to wrestle the dog for access to his collar, a proximity broadcast receiver may simply access the wireless identity transmitter and send a message or call the owner.

The various features and alternative actions may enable the system to have flexible and extensible functionality. The functionality could be added later as the actions taken are controlled by applications that may be updated in proximity broadcast receivers over time.

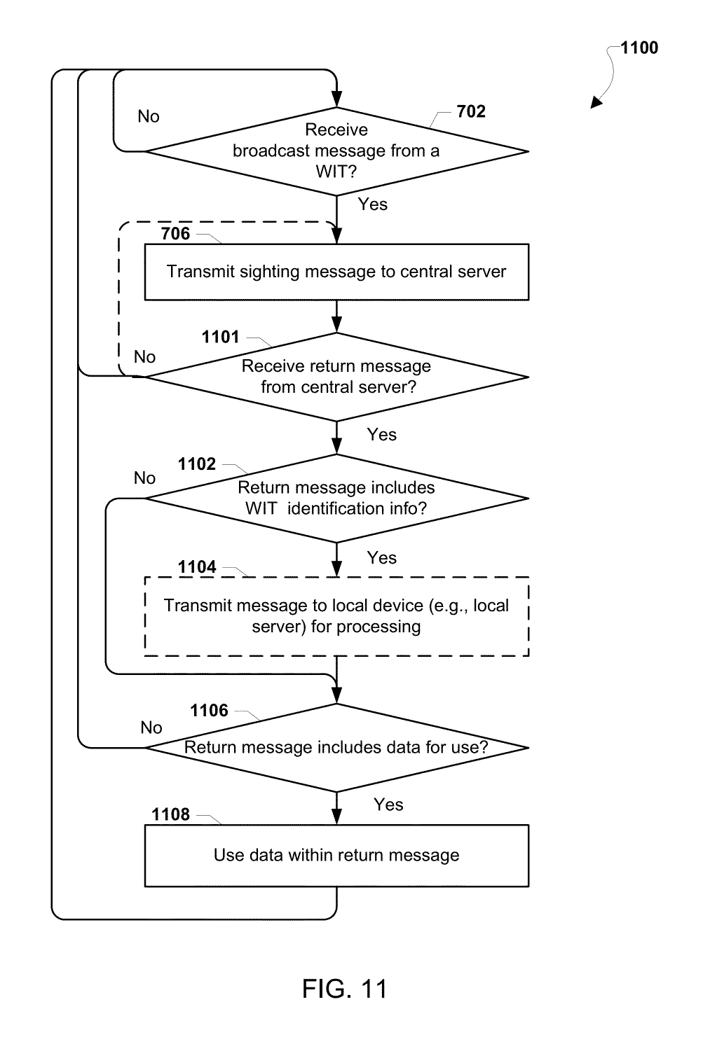

FIG. 11 illustrates an embodiment method 1100 for a proximity broadcast receiver relaying a broadcast message to and receiving a return message from a central server. Proximity broadcast receivers may be connected to facilities, such as houses, stores, gyms, schools, etc., and may be configured to execute various operations relating to those facilities. For example, a proximity broadcast receiver may be contained within equipment that executes software routines. Such proximity broadcast receivers may be configured to execute particular routines in response to receiving broadcast messages from a wireless identity transmitter (referred to as “WIT” in FIG. 11). For example, the proximity broadcast receiver may modify the execution of operations to suit preferences of the user of the wireless identity transmitter.

However, as discussed above, the wireless identity transmitter may obscure, encode, or encrypt data within broadcast messages to protect the privacy and identity of the wireless identity transmitter user. For example, the broadcast messages may not transmit the user's identity in the clear. To determine the identity information related to received broadcast messages, the proximity broadcast receiver may relay the broadcast messages to the central server, which may identify the wireless identity transmitter and its user based on information in the messages (e.g., a disguised, rolled, or encrypted device ID). As discussed above, the central server may store a secret to decrypt messages transmitted by the wireless identity transmitter. In response to receiving a sighting message, the central server may transmit a return message to the proximity broadcast receiver including identification information of the wireless identity transmitter.

In an embodiment, the central server may also store additional information relevant to the operations of the facility associated with the proximity broadcast receiver. For example, the central server may be an information hub that stores proprietary information related to the operations of the facility the proximity broadcast receiver is within. As another example, the central server may contain instructions for the proximity broadcast receiver to perform based on the identity of the wireless identity transmitter. Accordingly, the central server may transmit a return message that may not identify the wireless identity transmitter (or its user) related to a sighting message, but may instead includes data relevant to the wireless identity transmitter. In various embodiments, return messages may include or not include either data or identification information based on the preferences of the user of the wireless identity transmitter and/or the services associated with the proximity broadcast receiver. For example, the proximity broadcast receiver may be registered as relating to a trusted service for the user of the wireless identity transmitter, and therefore the central server may transmit return messages that identify the user. As another example, the user of the wireless identity transmitter may have set privacy permissions (or settings) during a registration procedure with the central server that enable anonymous data to be distributed to proximity broadcast receivers. Privacy permissions are further discussed below.

In determination block 702, the proximity broadcast receiver may determine whether a broadcast message is received, such as from a wireless identity transmitter. If no broadcast message is received (i.e., determination block 702=“No”), the proximity broadcast receiver may continue with the operations in determination block 702. If a broadcast message is received (i.e., determination block 702=“Yes”), in block 706 the proximity broadcast receiver may transmit a sighting message to a central server. For example, the sighting message may include identification information of the wireless identity transmitter as well as associated data, such as the location of the proximity broadcast receiver and a timestamp. In determination block 1101, the proximity broadcast receiver may determine whether a return message from the central server is received. In an embodiment, the proximity broadcast receiver may record identification information about the sighting message and may compare that information to received messages to find a match. If no return message is received (i.e., determination block 1101=“No”), the proximity broadcast receiver may continue with the operations in determination block 702. Alternatively, if no return message is received (i.e., determination block 1101=“No”), the proximity broadcast receiver may optionally re-transmit the sighting message to the central server in block 706. In an embodiment, the proximity broadcast receiver may retransmit sighting messages a predefined number of times over a period of time when no return message is received.

When a return message is received (i.e., determination block 1101=“Yes”), in determination block 1102 the proximity broadcast receiver may determine whether the return message includes wireless identity transmitter identification information. For example, identification information may include user names, addresses, sensitive information (e.g., social security number, banking information, passwords, etc.), and other data describing the wireless identity transmitter and/or the user of the wireless identity transmitter. If the return message does contain identification information (i.e., determination block 1102=“Yes”), in optional block 1104 the proximity broadcast receiver may transmit a message to a local device, such as a local server, for processing. In other words, the proximity broadcast receiver may relay the identification information in the return message to a local device associated with proximity broadcast receiver and/or the facility in which the proximity broadcast receiver is located. For example, the proximity broadcast receiver may transmit the identification information of the wireless identity transmitter to a local computing device of a gym, retail store, a school, or other third-party that may in turn determine instructions for the proximity broadcast receiver based on the identification information. In an embodiment, the local device may store the identification information and/or relate the information to database data for further use with the various related devices of the facility.

If the return message does not include identification information (i.e., determination block 1102=“No”) or the proximity broadcast receiver transmits a message to the local device in optional block 1104, the proximity broadcast receiver may determine whether the return message includes other data for use, such as by the proximity broadcast receiver or other devices associated with the proximity broadcast receiver in determination block 1106. For example, the return message may include commands or instructions for the proximity broadcast receiver to perform. Additionally, the data may contain configuration data (or configuration information) that may be used by various devices to accommodate the wireless identity transmitter and/or the preferences of the wireless identity transmitter's user. For example, the return message may contain software instructions for the proximity broadcast receiver to use or transfer to the local device, the wireless identity transmitter, or various other associated devices. If the return message includes data for use (i.e., determination block 1106=“Yes”), in block 1108 the proximity broadcast receiver may use the data within the return message. For example, the proximity broadcast receiver may execute operations to utilize configuration data from the return message (e.g., set equipment to suit the user's preferences). If the return message does not contain data for use by the proximity broadcast receiver (i.e., determination block 1106=“No”), the proximity broadcast receiver may continue with the operations in determination block 702.

As a non-limiting, illustrative example: the proximity broadcast receiver may be connected to a piece of exercise equipment within a fitness facility that is registered with a central server (i.e., the facility relates to a registered service). When the proximity broadcast receiver receives a broadcast message from the wireless identity transmitter carried by a user intending to work-out on the exercise equipment, the proximity broadcast receiver may transmit a sighting message to the central server. The proximity broadcast receiver may receive a return message from the central server that includes data which may be used to configure the exercise equipment to suit the anatomical dimensions and preferences of the user of the wireless identity transmitter without necessarily sharing the user's identity. For example, the proximity broadcast receiver may use the data to adjust the height of the equipment's seat or pedals. As another example, the data may define a workout routine to be executed on the exercise equipment. Alternatively, the return message may include the user's fitness facility identification, which the proximity broadcast receiver may transmit to a local server (e.g., a gym administrative server). The local server may compare the user's fitness facility identification to a local database and in response to the comparison, may transmit personalized configuration instructions to the proximity broadcast receiver and exercise equipment. Other non-limiting but illustrative applications of return message data may include configuring rental cars (e.g., seat positions, settings, etc.) and computer components (e.g., mouse, keyboards, etc.) for personalized use by the user of the wireless identity transmitter.

In an embodiment, return messages may include identification information such as photographic imagery useful to identify the user of the wireless identity transmitter. For example, in response to receiving a return message identifying the user of the wireless identity transmitter, the proximity broadcast receiver may display an image of the user or a sample of the user's handwriting (e.g., a signature). This functionality may be used by emergency personnel, citizens on alert, or merchants when attempting to quickly verify the identity of a person (e.g., a missing child, customer, etc.) equipped with a wireless identity transmitter. In another embodiment, a merchant's proximity broadcast receiver engaged in a business transaction (e.g., a point-of-sale device with an embedded proximity broadcast receiver) may transmit a sighting message including information broadcast by a proximate user's wireless identity transmitter. The resulting return message may include confirmation that the identities of the registered user of the wireless identity transmitter and the user match (i.e., the in-store person matches the user indicated in the central server as relating to the wireless identity transmitter). Additionally, if the identities are the same, the return message may include additional information to assist in the transactions, such as payment information, credit card numbers, or contact information for follow-up communications.

In another embodiment, the return message from the central server may include software instructions and/or data that may cause the proximity broadcast receiver to modify, adjust, remove, activate, or disable components, sensors, features, software, and/or functions of the proximity broadcast receiver. For example, the return message may include software instructions that the proximity broadcast receiver executes upon receiving the return message, or triggers the proximity broadcast receiver to execute a pre-loaded routine or enter a particular operating mode. Such software instructions may define operations the proximity broadcast receiver may execute that configure the proximity broadcast receiver, such as activating (or de-activating) a camera component, a cellular network modem, speaker systems, WiFi transceivers, etc. As another example, the return message may instruct the proximity broadcast receiver, such as a smartphone configured to operate as a mobile proximity broadcast receiver, to execute an application, transmit a message (e.g., email, SMS, short-range radio signal, etc.), or turn itself off. Software instructions within such return messages may include timing information that indicates when affected components, sensors, features, software, and/or functions may be configured and/or re-configured. For example, the return message may include instructions that cause the proximity broadcast receiver to disable a microphone for a certain period of time. In an embodiment, the proximity broadcast receiver may be configured to reverse any modifications, adjustments, operating mode selections, or other configurations identified in return message software instructions after a period of time and/or when the proximity broadcast receiver no longer receives broadcast messages from wireless identity transmitters related to the return message. For example, the proximity broadcast receiver may disable the speakers on the proximity broadcast receiver so long as the proximity broadcast receiver receives broadcast messages from the wireless identity transmitter. In another embodiment, the proximity broadcast receiver may modify, adjust, remove, activate, or disable components, sensors, features, software, and/or functions of the proximity broadcast receiver based on information within received broadcast messages. For example, the proximity broadcast receiver may process a received broadcast message and execute detected software instructions that direct the proximity broadcast receiver to disable a sensor, such as a camera.

FIG. 12 illustrates a diagram 1200 of various modules within a central server 120. The various modules and components are described below in the context of modules, components, and/or elements within a central server 120. However, in various embodiments, the central server 120 may include or be connected to individual computing devices, server blades, or other units that may perform the operations associated with the various modules and/or components described below.

As described above with reference to FIG. 1, the central server 120 may be configured to receive, store, and otherwise process data corresponding to wireless identity transmitters. For example, the central server 120 may be configured to exchange communications with various devices via the Internet 103, such as proximity broadcast receivers 142 and mobile proximity broadcast receivers 138 communicating via a cellular network 121, third-party systems 101, and other support systems and/or services 102.

The central server 120 may include several components 104-109 to perform various operations to process data, such as received from proximity broadcast receivers 142, 138, third-party systems 101, or other support systems and/or services 102. In particular, the central server 120 may include a core component 108 that may process sighting messages, execute an alert or notice engine module, handle application programming interface (API) commands, and exchange data with other components within the central server 120. The core component 108 may include a data layer module 1202 that may include units for storing short-term data and third-party specific data. The core component 108 may also include an alert engine module 1204 for generating alert messages for transmissions to proximity broadcast receivers and initiating searches of various target wireless identity transmitters. The core component 108 may further include a data anonimizer module 1206 that may generate generic, anonymous, or otherwise processed data based on privacy policies or profile preferences of users. For example, the data anonimizer module 1206 may strip personal information from return messages transmitted to a proximity broadcast receiver associated with a store so that a customer user of a wireless identity transmitter is not identified to the store, but the fact that the user is within the store is still reported to the store. The core component 108 may also include a privacy manager module 1208 that may maintain privacy permission information for various users. For example, the privacy manager module 1208 may include a database of privacy parameters provided by users at registration. In an embodiment, the data anonimizer module 1206 and/or the privacy manager module 1208 may utilize the permissions described below.

The core component 108 may also include a search manager module 1210 for assisting in organizing and administering searches and an authorization system module 1212. The core component 108 may further include a sightings resolver module 1214 that may be utilized by the central server 120 for identifying wireless identity transmitters associated with broadcast messages reported within received sighting messages from proximity broadcast receivers 142, 138. The core component 108 may include an API module 1216 that may include functions and interfaces for initiating operations, a sightings aggregator module 1218 for compounding various sighting messages over a period for transmissions in consolidated form to merchants, third-parties, and other services. The core component 108 may also include a network module 1220 for transmitting and receiving various communications with devices, such as proximity broadcast receivers 142, 138 and third-party systems 101 via the Internet.

The central server 120 may also include a data warehouse component 104 that may store long-term data (e.g., archived user data, past location information, etc.). The data warehouse component 104 may include various databases for storing information pertinent to users of wireless identity transmitters, such as profile information provided by users via registration websites. The data warehouse component 104 may be configured to exchange data with the data layer module 1202 of the core component 108. The central server 120 may also include an operations, administration, and management component 105 that may process and/or store software associated with user portal accesses, scripts, and tools (e.g., software utilities, routines, etc.). The operations, administration, and management component 105 may be configured to exchange data with the core component 108.

The central server 120 may also include a developer portal component 106 that may store developer account data and perform registration, account management, and alert (or notice) management routines associated with developers, such as vendors or merchants that register to interact with users of wireless identity transmitters 110. The central server 120 may also include a user portal component 109 that may store user account data and perform registration, account management, and search routines associated with users, such as persons associated with wireless identity transmitters. The user portal component 109 and developer portal component 106 may be configured to exchange data with the authorization system module 1212 of the core component 108. The central server 120 may also include a rolling identifier (or ID) resolver component 107 that may store factory keys associated with wireless identity transmitters 110 as well as perform operations, software, or routines to match encrypted, encoded, rolling, or otherwise obfuscated identification information within received sighting messages with affiliated user data. The rolling identifier (or ID) resolver component 107 may be configured to exchange data with the sightings resolver module 1214 of the core component 108.

In various embodiments, the modules and components described with reference to FIG. 12, such as the rolling ID resolver component 107, may be performed or otherwise enabled by software instructions, applications, routines, threads, circuitry, or hardware units.

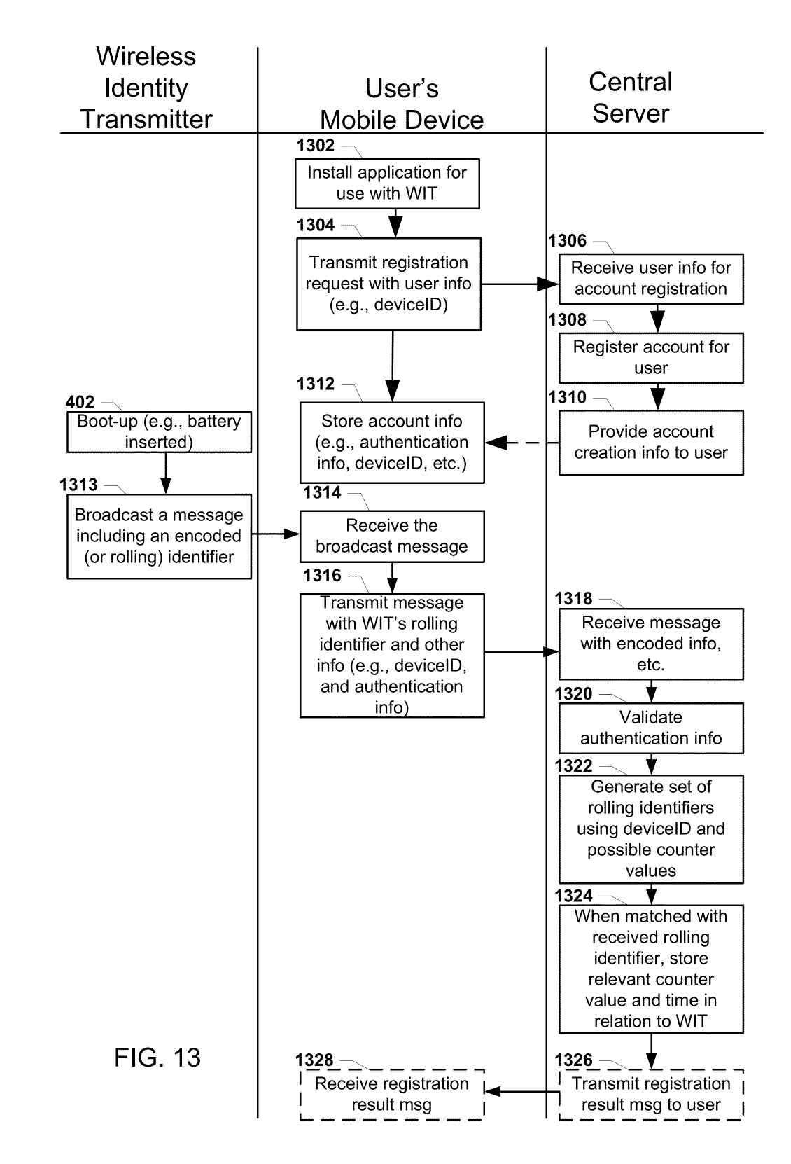

FIG. 13 illustrates a wireless identity transmitter registration process for use in various embodiments. In general, before broadcast messages may be processed by a central server, the central server may require that wireless identity transmitters and their users be registered with the central server. For example, before any tracking, searching, or other location-based activities related to a wireless identity transmitter can be initiated, the central server must be able to determine the users associated with the various wireless identity transmitters circulating in the world. Registration may create links between identifiers transmitted by wireless identity transmitters in broadcast messages, the wireless identity transmitters, and their users. For example, in order to transmit a notification to a missing child's parents that the child has been found, relayed obfuscated (or encoded) identifiers must be matched to account information that indicates the parents' cell phone numbers as stored in relation to a registered user account.

In particular, through registration, a timing mechanism may be synchronized between each wireless identity transmitter and the central server (i.e., a nonce or counter). With such a nonce or counter, a wireless identity transmitter and the central server may encode (or roll) and decode identifiers respectively, keeping the identity associated with the wireless identity transmitter (and its users) concealed and private. The most appropriate time to synchronize such a timing mechanism or nonce or counter may be during a device registration and/or account creation process as described below. For the purpose of FIG. 13, a mobile device, such as a smartphone, is described as being used by a user to perform account creation and registration operations (e.g., the mobile device accesses a web portal to register with the central server, etc.). However, any computing device connected to the Internet and capable of exchanging communications with the central server via a registration web portal or website may be relevant.

In block 1302, a user's mobile device (e.g., an iPhone, Android, tablet device, etc.) may install an application for use with wireless identity transmitters. Such an application (or “app”) may execute on the mobile device's processor as a background service or alternatively may be activated for selective use by the user. As described throughout this disclosure, such an application may enable the mobile device to process short-range broadcast messages from proximate wireless identity transmitters, such as by identifying received signals as broadcast messages and relaying sighting messages having location information to the central server in response. In block 1304, the mobile device may transmit a registration request with user information (e.g., a device identity or “deviceID”). The registration request may be sent to the central server via Internet communications with a web portal, web site, or web server controlled or otherwise accessible by the central server. In other words, the mobile device may invoke the registration process or by providing user information (e.g., device ID) through the installed app by providing the device ID (deviceID) and other information the central server may utilize to bind the registration request to an account. For example, the user's mobile device may access a registration website, receive inputs from the user, and transmit the user input as data to the registration website for use by the central server as described above with reference to FIG. 12. In an embodiment, the user information may include personal information about the user, such as name, address, contact information (e.g., social network sites, cell phone number, email address, telephone number, etc.) age, and other demographic information, as well as identifying information about wireless identity transmitters and/or proximity broadcast receivers that may be associated with the user's account. For example, the user information transmitted to the central server may include the serial number on a wireless identity transmitter and/or a confirmation code produced by the mobile device in response to installing the application with the operations in block 1302. The user information may also include preference information, such as the user's preferred retails stores, product lines, and areas to eat or consume. The user information may further include privacy permissions that indicate how personal information may be distributed or used by the central server, such as discussed below. In an embodiment, users may register as anonymous users, such that the central server does not store any identifying information about the users. For example, an account may be registered that is linked to a non-descript post office box, a disposable cellular telephone number, or other contact information that does not directly identify the user or the holder of the account. This may be important for those who may choose to utilize services provided by the central server, but who are concerned about leaked private or identifying information. In block 1312, the user's mobile device may store account information, such as authentication information (e.g., codes, messages) from the central server or device ID associated with an owned wireless identity transmitter.

In block 1306, the central server may receive the user information for account registration. In block 1308, the central server may register an account for the user. For example, the central server may store the user's information, including provided device identifications, in a database of all registered users. In block 1310 the central server may provide account creation information to the user. The account creation information may include an authentication code or other information the user's mobile device may store for future use. For example, the central server may display confirmation of account creation on a website accessible by the user's mobile device or alternatively may transmit a confirmation signal, text message, email, or other communication to the user's mobile device.

In block 402, the wireless identity transmitter boots-up, such as in response to the user inserting a battery. When the wireless identity transmitter boots, a nonce or counter value may be initialized. For example, the wireless identity transmitter may begin to increment a value that represents the passage of time, starting from a zero value. In block 1313, the wireless identity transmitter may broadcast a message (i.e., a broadcast message) that includes an encoded (or rolling) identifier. For example, the wireless identity transmitter may begin transmitting broadcast messages every few seconds. The wireless identity transmitter may generate rolling identifiers with the embodiment methods described below. In general, the broadcast message may include a payload that includes data generated by performing a pseudo-random function. For example, the wireless identity transmitter may perform a pseudo-random function to generate encoded data based on input values of the wireless identity transmitter's device ID, a nonce or counter value, and a secret key, seed, or other value known only to the wireless identity transmitter and the central server. In an embodiment, the pseudo-random function may be a polynomial time computable function that may utilize a randomly selected seed value only known to the wireless identity transmitter and the central server, such that the pseudo-random function may be computationally indistinguishable from a random function defined on the same domain with output to the same range as the pseudo-random function. In an embodiment, the keyed-hash Message Authentication Code (HMAC) or the cipher-based Message authentication Code (CMAC) may be used as the pseudo-random function.

In an embodiment, the wireless identity transmitter may be required to be activated within a predefined number of seconds within the time the mobile device begins the registration process with the operations in block 1304. In other words, once the wireless identity transmitter begins incrementing its nonce or counter value, the user must register with the central server within a certain period. This enables the central server to try at only a certain number of values when trying to determine the nonce or counter value at the wireless identity transmitter during registration.

In an embodiment, the wireless identity transmitter may indicate an initial broadcast by adjusting data within a broadcast message's payload. For example, the wireless identity transmitter may change a bit within a broadcast message that the central server may recognize as indicating an initialization time period for the wireless identity transmitter. If there are initialization indicators within payloads, the central server may expedite comparisons between received payloads and stored payloads by avoiding comparisons to payloads corresponding to already registered (or recognized) wireless identity transmitters within a central server lookup data table.

In block 1314, the user's mobile device may receive the broadcast message. In other words, based on the installed application (or app), the mobile device may function as a mobile proximity broadcast receiver. An installed application may, such as the app installed with the operations in block 1302, may be waiting to receive such a broadcast message in response to initiating registration operations with the central server via the registration request. In block 1316, the mobile device may transmit the wireless identity transmitter's rolling identifier and other information, such as the stored device ID and authentication information. In an embodiment, the mobile device may extract encoded information from the received broadcast message, such as by using text comparison and/or parsing operations. For example, the mobile device may perform a most-significant bit operation.

In block 1318, the central server may receive the message with the encoded information, as well as the authentication information and the device ID. In block 1320, the central server may validate authentication information, such as in the received message from the mobile device. In particular, the central server may compare the authentication information to information generated in the operations in blocks 1308-1310. In block 1322, the central server may generate a set of rolling identifiers using the device ID and possible nonce or counter values. The central server may compare the encoded identifiers of the set with the rolling identifier received from the mobile device. In an embodiment, the central server may compute a set of encoded data by using a pseudo-random function, such as described above, along with the device ID and a number of nonce or counter values. For example, the central server may execute the pseudo-random function with a seed shared with wireless identity transmitters, the device ID indicated by the mobile device, and many nonce or counter values, starting with 0. In block 1324, when the central server matches the received rolling identifier to one of the rolling identifiers in the generated set, the central server may store relevant nonce or counter value and time in relation to the WIT. The central server may use the nonce or counter value used to generate the matching rolling identifier to sync with the nonce or counter running on the wireless identity transmitter. In an embodiment, the central server may store an indicator that describes the wireless identity transmitter as having been successfully registered and/or synced. In optional block 1326, the central server may then transmit a registration result message to the user, such as by transmitting a message to the mobile device. The registration result message may indicate whether or not the central server was able to match the received encoded identifier with a generated identifier. In optional block 1328, the mobile device may receive the registration result message. In an embodiment, the registration result message indicates that the registration process failed (e.g., the received broadcast message received by the mobile device did not correspond to the user's wireless identity transmitter), the mobile device may re-attempt the registration by receiving and relaying another broadcast message.

The operations described above, particularly within blocks 1313-1324, assume that message processing operations performed by the various devices, as well as any propagation delay, may be much smaller than the time required to increment (or update) the nonce or counter value at the wireless identity transmitter. This ensures that the nonce or counter values at the wireless identity transmitter and central server do not differ by more than 1.

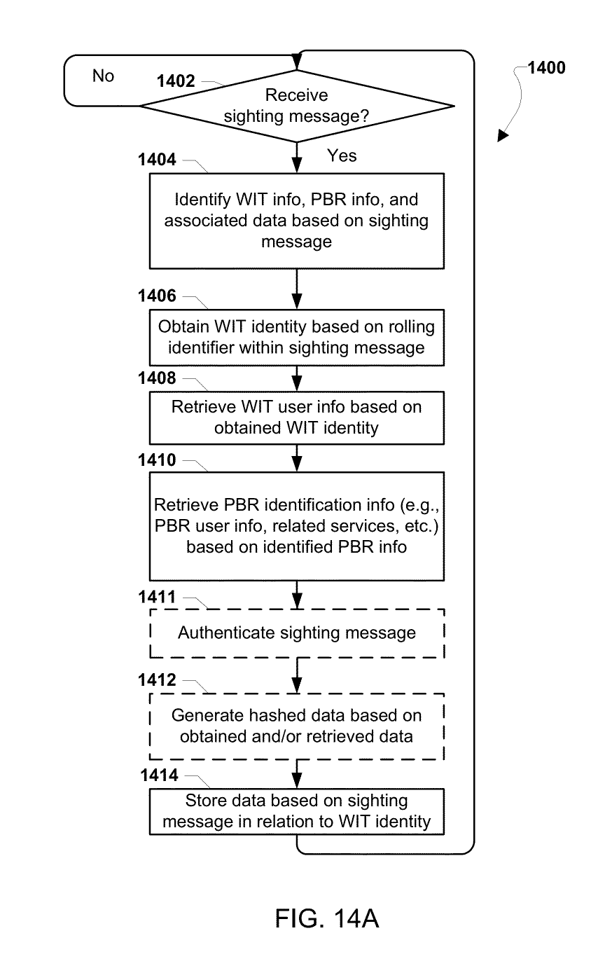

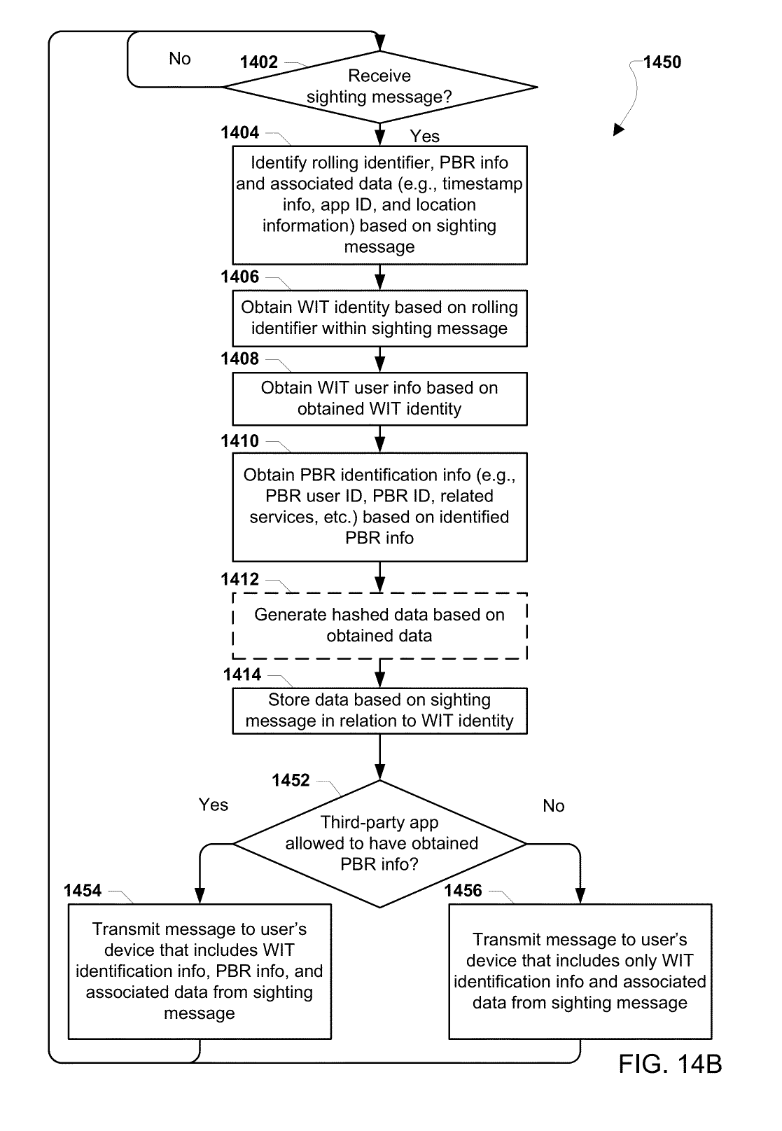

FIG. 14A illustrates an embodiment method 1400 for a central server to process sighting messages received from proximity broadcast receivers. As described above, the central server may be configured to utilize various modules, components, circuitry, and software to process sighting messages. In determination block 1402, the central server may determine whether a sighting message is received. The central server may evaluate a receiving circuit, buffer, queue or other indicator to determine when messages are received from various devices, such as proximity broadcast receivers. In an embodiment, the central server may utilize a network module as described above to determine whether a sighting message is received. In general, sighting messages may be received via long-range communications, such as packets transmitted via a cellular network over the Internet. If the central server does not receive a sighting message (i.e., determination block 1402=“No”), the central server may continue with the operations in determination block 1402.

If the central server receives a sighting message (i.e., determination block 1402=“Yes”), in block 1404 the central server may identify wireless identity transmitter information, proximity broadcast receiver information, and associated data based on the sighting message. The central server may evaluate, parse, and otherwise make accessible various data and information segments within the received sighting message. For example, the central server may parse the sighting message to identify an included broadcast message from the wireless identity transmitter. As another example, the central server may identity encoded data corresponding to a wireless identity transmitter identity (i.e., rolling identifier), proximity broadcast receiver identification information (e.g., a receiver ID), location information, timestamp information, sensor data (e.g., accelerometer sensor data, etc.), identifiers of applications (or apps) associated with a proximity broadcast receiver (e.g., a list of installed applications, an identifier for a relevant app executing on the proximity broadcast receiver, etc.). In an embodiment, the central server may perform the operations of block 1404 with a sightings resolver module as described above.

In block 1406, the central server may obtain the wireless identity transmitter identity based on the rolling identifier within the sighting message. The central server may perform operations to decode, descramble, decrypt, or otherwise make accessible the rolling identifier. For example, the central server may perform operations to apply a secret key or decoding algorithm to obtain the identity of the wireless identity transmitter. In an embodiment, the operations of block 1406 may be performed by the central server by way of a rolling ID resolver component as described above. For example, the central server may cause a sightings resolver module to exchange data with the rolling ID resolver component to obtain a decoded wireless identity transmitter identifier. Embodiment operations to identity the wireless identity transmitter based on a sighting message that includes a rolling identifier are described below.

In block 1408, the central server may retrieve the wireless identity transmitter user information based on the obtained wireless identity transmitter identity. For example, the central server may retrieve user account information related to the wireless identity transmitter, such as demographics information, stored data indicating previous behaviors (e.g., travel paths, location history, etc.). In an embodiment, the operations of block 1408 may be performed by the central server by way of an authorization system module as described above. For example, the central server may cause the authorization system module to exchange wireless identity transmitter identity information with a user portal component to obtain user information as saved within user registration databases.

In block 1410, the central server may retrieve proximity broadcast receiver identification information, such as proximity broadcast receiver user information and related services, based on the identified proximity broadcast receiver information. For example, the central server may retrieve the merchant identity associated with the proximity broadcast receiver that transmitted the received sighting message, the tracking services the proximity broadcast receiver is registered to participate in, as well as any other relevant information to the proximity broadcast receiver. The central server may retrieve email addresses, MAC addresses, phone numbers, and other contact information related to a user of related proximity broadcast receiver based on the information within the sighting message. For example, the central server may determine the user contact information associated with a proximity broadcast receiver that may be used for subsequent transmissions from the central server, such as emails or SMS text messages that indicate proximity to an item of interest. In an embodiment, the central server may determine the identity of a user of a smartphone that is configured to perform operations of a mobile proximity broadcast receiver. In an embodiment, the operations of block 1410 may be performed by the central server by way of an authorization system module as described above. For example, the central server may cause the authorization system module to exchange proximity broadcast receiver information with a developer (or user) portal component to obtain information about related registered services (e.g., merchants, stores, vendors, services, etc.) as saved within developer registration databases.

In optional block 1411, the central server may authenticate the sighting message. Based on authentication information within the received sighting message, the central server may perform authentication operations that confirm the legitimacy of the sighting message as coming from a known or otherwise valid proximity broadcast receiver. As described above, sighting messages may include data, such as secret codes, certificates, or hash data, that can be used to confirm the identities of valid proximity broadcast receivers. As third-parties may attempt to spoof proximity broadcast receivers associated with registered services (e.g., a nefarious spammer may attempt to imitate a merchant's store proximity broadcast receiver by sending a fraudulent sighting message), the central server may check for authentication information that confirms the information within the sighting message is useful and related to a registered service (e.g., a registered merchant, a valid developer, or other party that deploys legitimate proximity broadcast receivers). For example, the central server may detect obscured header information within the sighting message that relates to a merchant established within the central server as a registered developer. When the sighting message does not include authentication information expected by the central server, such as a special code that all proximity broadcast receivers within a certain building possess, or does include authentication information that does not match information stored in the central server, the central server may disregard the sighting message and all included information. For example, a sighting message with out-of-date or incomplete authentication information may be disregarded by the central server, or alternatively stored in a list for potentially fraudulent proximity broadcast receivers.

In optional block 1412, the central server may generate hashed data based on the obtained and/or retrieve data. In an embodiment, the operations of optional block 1412 may be performed by the central server by way of a data anonimizer module as described above. In block 1414, the central server may store data based on the sighting message in relation to the wireless identity transmitter identity. For example, the central server may store identified associated data from the sighting message in a database in relation to the wireless identity transmitter's decoded identity. In an embodiment, the operations of block 1414 may be performed by the central server by way of a data layer module as described above.

FIG. 14B illustrates an embodiment method 1450 for a central server to process sighting messages received from proximity broadcast receivers. The method 1450 is similar to the method 1400 described above, except that the central server may perform the method 1450 to transmit messages for use by a third-party application executing on mobile device carried by a user. As described above, various messages, such as return messages, alerts (or search activation messages), may be transmitted by the central server to various recipients, such as mobile devices associated with a user. For example, the central server may transmit messages to a user's tablet, smartphone, mobile proximity broadcast receiver, or other computing device. A recipient may also include an application or app executing on a mobile device. In an embodiment, the central server may also transmit messages to other third-party recipients or devices, such registered services that may include emergency medical technicians (EMTs), fire, local police, retail store, merchant computing devices, and ad servers.

Messages transmitted by the central server in response to receiving sighting messages may be transmitted to inform devices, such as a mobile phone or mobile proximity broadcast receiver carried by a user, of the location of proximity of known wireless identity transmitters. For example, when a proximity broadcast receiver, such as a stationary proximity broadcast receiver within a retail store, relays a broadcast message from a wireless identity transmitter associated with a user, the central server may respond by transmitting a message back to a mobile device of the user indicating the user is near the store's proximity broadcast receiver. Further, a third-party application running on the user's device may use information within the message. For example, a retail store app running on a user's smartphone may receive a notice that the user has moved within proximity of a display area within proximity of a retail store building. In various other embodiments, the third-party applications may be utilized to track owned items associated with wireless identity transmitters. For example, a particular third-party application may perform a ring tone when the user is within proximity of a searched for missing child.

In determination block 1402, the central server may determine whether a sighting message is received. If the central server does not receive a sighting message (i.e., determination block 1402=“No”), the central server may continue with the operations in determination block 1402. If the central server receives a sighting message (i.e., determination block 1402=“Yes”), in block 1404 the central server may identify wireless identity transmitter information, proximity broadcast receiver information, and associated data based on the sighting message. In block 1406, the central server may obtain the wireless identity transmitter identity based on the rolling identifier within the sighting message. In block 1408, the central server may retrieve the wireless identity transmitter user information based on the obtained wireless identity transmitter identity. In block 1410, the central server may retrieve proximity broadcast receiver identification information, such as proximity broadcast receiver user information and related services, based on the identified proximity broadcast receiver information. In optional block 1412, the central server may generate hashed data based on the obtained and/or retrieve data. In block 1414, the central server may store data based on the sighting message in relation to the wireless identity transmitter identity.

In determination block 1452, the central server may determine whether a third-party application (or app) is allowed to have obtained proximity broadcast receiver information. In other words, based on data stored in the central server that is associated with the user of the wireless identity transmitter, the central server may detect any registered services or third-party applications that are associated with the user's devices. For example, the central server may evaluate database information to identify the user has installed a third-party application on his/her smartphone that corresponds to a retail store. The proximity broadcast receiver information may include proximity broadcast receiver identification (e.g., an ID code or identifier) and the user identity of the proximity broadcast receiver. In an embodiment, the central server may identify whether third-party applications are allowed such information based on the third-party's developer rights, such as indicated when the third-party registered as a developer or registered service, or alternatively based on the user's permission settings, as described below. In an embodiment, the central server may use application identification information provided within the received sighting message to determine whether the third-party applications on the user's device may receive proximity broadcast receiver information. For example, the sighting message may contain indicators of applications (e.g., app IDs) that correspond to the sighting message and thus are allowed to receive any proximity broadcast receiver information from the central server.

If the third-party app is not allowed to have the obtained proximity broadcast receiver information (i.e., determination block 1452=“No”), in block 1456 the central server may transmit a message to the user's device that includes only wireless identity transmitter identification information and associated data from the sighting message. For example, the message transmitted by the central server may include the obtained wireless identity transmitter identity, user information, timestamp data, and location information from the sighting message. If the third-party app is allowed to have the obtained proximity broadcast receiver information (i.e., determination block 1452=“Yes”), in block 1454 the central server may transmit a message to the user's device that includes wireless identity transmitter identification information, proximity broadcast receiver information, and associated data from the sighting message. For example, the message transmitted by the central server to the user's smartphone may include indicators of the obtained proximity broadcast receiver identification (e.g., serial code, group affiliation, merchant category, etc.). The central server may then continue with the operations in determination block 1402. In an embodiment, the central server may utilize an alert engine module, such as described above with reference to FIG. 12, to transmit and/or generate messages for transmission to various devices.

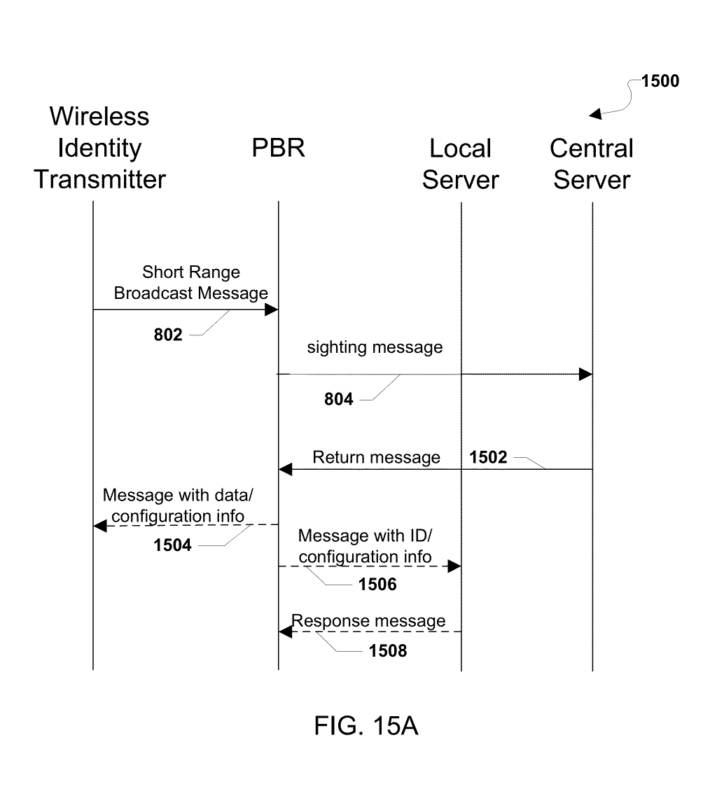

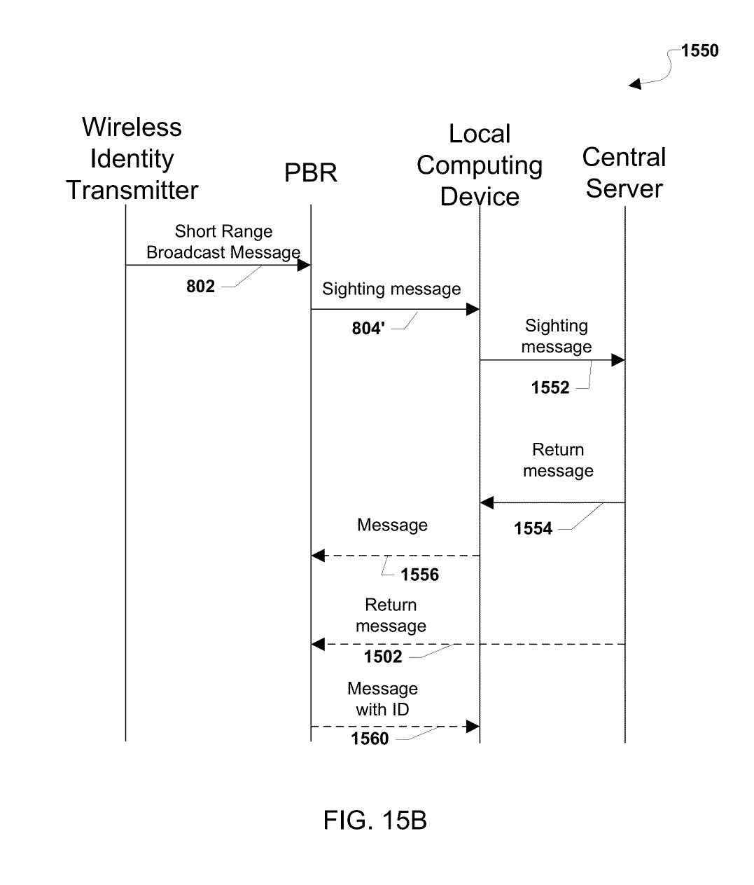

FIG. 15A illustrates an embodiment call flow diagram 1500 illustrating communications between a wireless identity transmitter, a proximity broadcast receiver, and a central server. As described above, the wireless identity transmitter may periodically transmit a short-range broadcast message 802 via a short-range radio. When within signal range of the broadcast message 802, the proximity broadcast receiver may receive the broadcast message 802 using a similar short-range radio. The broadcast message 802 may be processed by the proximity broadcast receiver and related data may be relayed to the central server as a sighting message 804. In an embodiment, the sighting message 804 may include the broadcast message, identification information of the proximity broadcast receiver and/or the wireless identity transmitter, encrypted information the proximity broadcast receiver is incapable of decoding, and other information related to the reception of the broadcast message 802. In an embodiment, the sighting message 804 may be transmitted over various wireless or wired networks that may be configured to communicate via Internet protocols.

The central server may receive and process the sighting message 804. When the central server determines that the sighting message 804 requires a response based on the information in the sighting messages (e.g., metadata requesting a response, the sighting message relates to a wireless identity transmitter that needs to receive upgraded firmware, etc.), the central server may generate and transmit a return message 1502 to the proximity broadcast receiver. In various embodiments, the return message 1502 may contain configuration information, identification information describing the wireless identity transmitter, or other data as described above. The proximity broadcast receiver may receive and process the return message 1502. Based on the data within the return message 1502, the proximity broadcast receiver may optionally transmit a message 1504 to the wireless identity transmitter that may contain configuration information and other data from the central server. The wireless identity transmitter may selectively accept transmissions such as the message 1504 using operations as described above with reference to FIG. 4.

As another option, the proximity broadcast receiver may transmit a message 1506 to a local server based on the return message 1502. The message 1506 may contain wireless identity transmitter identification information, configuration information, software routines, and various other data from the return message 1502 for storage, processing, and otherwise additional use by the local server. Based on the message 1506, the local server may in turn transmit an optional response message 1508 to the proximity broadcast receiver that may include software instructions, configuration data, or other data generated in response to receiving the message 1506.

In an embodiment, the central server may also transmit messages directly to the local server (not shown) that include configuration information and other data. For example, the sighting message 804 from the proximity broadcast receiver may provide the contact information for the local server which the central server may utilize for subsequent communications.

FIG. 15B illustrates an embodiment call flow diagram 1550 illustrating communications between a wireless identity transmitter, a proximity broadcast receiver, a local computing device, and a central server. The local computing device may be a local server, such as within a retail store, or alternatively, a device configured to perform operations of a point-of-sale device (e.g., a cash register). The proximity broadcast receiver may be a stationary receiver device associated with and communicates information to the local computing device. For example, the local computing device and the proximity broadcast receiver may both be associated with a merchant and/or both communicate over a common local area network, such as via a WiFi router. For example, the stationary proximity broadcast receiver may be placed at the cash register of the retail store and may receive transmissions from wireless identity transmitters when customers walk within proximity of the cash register.

As described above, the wireless identity transmitter 110 may periodically transmit a broadcast message 802 via short-range wireless signals (e.g., Bluetooth® LE radio signals). When within signal range of the broadcast message 802, the proximity broadcast receiver may receive the broadcast message 802 using a similar transceiver. The broadcast message 802 may be processed by the proximity broadcast receiver and transmitted to the local computing device as a first sighting message 804′ for processing. The local computing device may in turn transmit a second sighting message 1552 to the central server. The second sighting message 1552 may be identical to the first sighting message 804′ or alternatively a new or modified version of the first sighting message 840′. For example, the second sighting message 1552 may include identification information of the local computing device in addition to a representation of the broadcast message 802.

The central server may receive and process the second sighting message 1552, as described above, and may generate and transmit a return message 1554 to the local computing device. In an embodiment, the local computing device may be configured to act as a message router and may transmit a message 1556 to the proximity broadcast receiver. The message 1556 may be similar to the return message 1554 or alternatively may include only portions of the return message 1554. For example, the message 1556 may contain information (e.g., marketing information, payment authentication information, etc.) to be rendered or otherwise used by the proximity broadcast receiver. In an embodiment, the message 1556 may include instructions for presenting marketing information, such as software instructions for rendering an advertising video.

In an embodiment, the central server may transmit a return message 1502 to the proximity broadcast receiver, which may in turn transmit a message 1560 to the local computing device that reports various information (e.g., the identification information of the wireless identity transmitter). In an embodiment, the proximity broadcast receiver may process the return message 1502 and the message 1556 and may store, utilize, and/or evaluate data of the return message 1502. For example, the stationary proximity broadcast receiver may detect software instructions within the return message 1502 or the message 1556, such as an instruction to re-calibrate a radio within the proximity broadcast receiver, and may perform operations in response to detecting the software instructions. As another example, the proximity broadcast receiver may store a list of wireless identity transmitter identities based on the return message 1502 or the message 1556. In an embodiment, the return message 1502, 1554 may not include identification information of the wireless identity transmitter, but may instead include an indicator of whether the wireless identity transmitter is related to an authorized user.

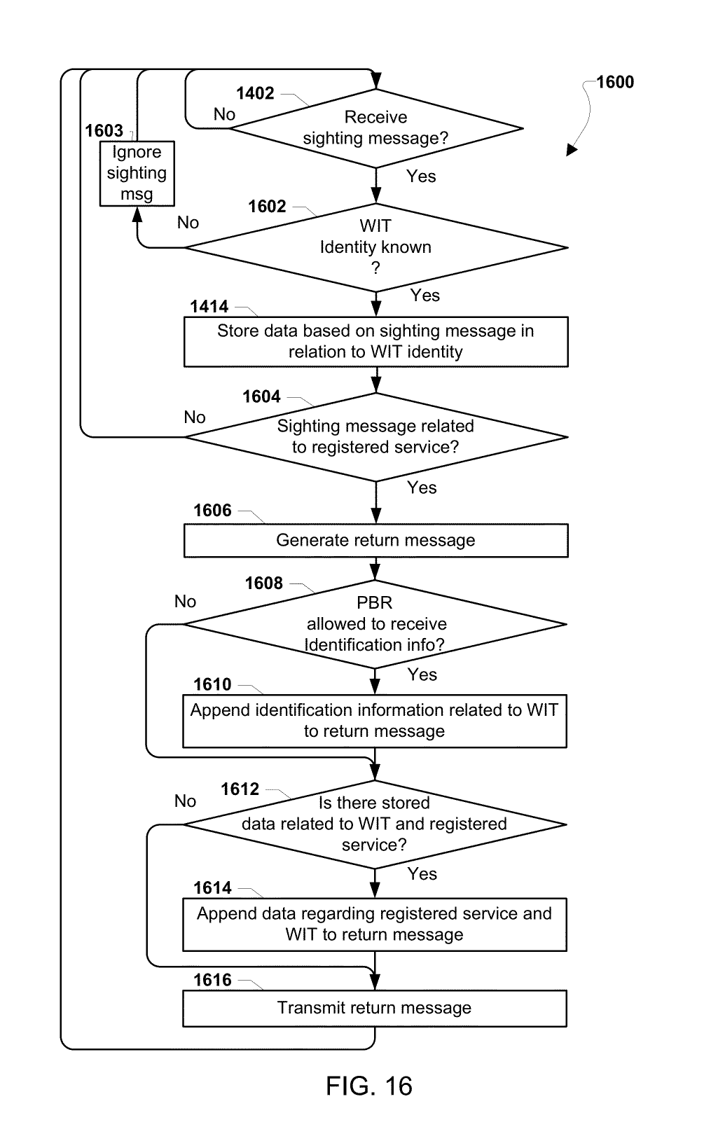

FIG. 16 illustrates an embodiment method 1600 for a central server to process sighting messages received from a proximity broadcast receiver. In general, based on the information within sighting messages, the central server may identify a wireless identity transmitter (and related user), determine whether there is a relationship between the proximity broadcast receiver and the wireless identity transmitter (i.e., related to a registered service), and transmit return messages with various data and/or information based on the sighting messages. Accordingly, return messages may be provided to proximity broadcast receivers such that no identifying information about the wireless identity transmitter is included. This may enable the proximity broadcast receiver to anonymously personalize equipment, devices, or other facilities, as described above, to benefit the user of the wireless identity transmitter without disclosing his/her identity. For example, a return message from the central server may include a user's configuration data for a piece of equipment but not the user's identity. In an embodiment, the method 1600 may be performed by the central server in connection with the proximity broadcast receiver performing the operations of the method 1100 as described above with reference to FIG. 11. In various embodiments, such return messages may be transmitted to any devices related to received sighting messages and/or the related wireless identity transmitter, such as third-parties (e.g., emergency services, retailers, etc.) or user devices associated with the sighting message.

In determination block 1402, the central server may determine whether a sighting message is received. If no sighting message is received (i.e., determination block 1402=“No”), the central server may continue with the operations in determination block 1402. If a sighting message is received (i.e., determination block 1402=“Yes”), in determination block 1602 the central server may determine whether the wireless identity transmitter identity is known. In other words, the central server may perform the operations in block 1404-1410 as described above with reference to FIG. 14A in order to evaluate, decode, decrypt, and otherwise access the data within the received sighting message to determine whether it includes a wireless identity transmitter identity (or identifier) that is associated with a user registered with the central server. For example, the central server may decrypt a rolling identifier within the received sighting message to identify a device identifier of a wireless identity transmitter and may match that identifier to stored information representing all registered users and/or devices. If the wireless identity transmitter is not known (i.e., determination block 1602=“No”), in block 1603 the central server may ignore the sighting message and continue to perform the operations in determination block 1402. If the wireless identity transmitter is known (i.e., determination block 1602=“Yes”), in block 1414 the central server may store data based on the sighting message in relation to the wireless identity transmitter identity, such as storing location data within the sighting message in a database in relation to the user of the wireless identity transmitter.

In determination block 1604, the central server may determine whether the received sighting message relates to a registered service. In other words, the central server may compare information obtained from the sighting message to lists of registered services to determine whether the sighting message is valid (or authenticated) and corresponding to a third-party, merchant, or other service registered with the central server. To make the determination, the central server may analyze the received sighting message and evaluate any metadata or header information that identifies the proximity broadcast receiver, the subject matter of the sighting message, or other descriptive information regarding the proximity broadcast receiver and/or the wireless identity transmitter that transmitted the broadcast message reported by the sighting message. For example, the sighting message may contain metadata that indicates the sighting message was sent by a proximity broadcast receiver in response to an active alert. Alternatively, the sighting message may contain header information that indicates relevance to a particular vendor facility or service. For example, the sighting message may contain metadata that indicates the proximity broadcast receiver is associated with a particular third-party application (e.g., a retail store app ID). As another example, the central server may evaluate metadata within the sighting message to detect a code that identifies a registered merchant or retail store that is associated with a marketing service or data collection scheme.

A sighting message may not relate to a registered service if the transmitting proximity broadcast receiver is not registered, authenticated, or otherwise known to the central server. If the sighting message is not related to a registered service (i.e., determination block 1604=“No”), the central server may continue with the operations in determination block 1402. If the sighting message does relate to a registered service, such as a valid vendor service or an active alert (i.e., determination block 1604=“Yes”), in block 1606 the central server may generate a return message. The return message may include information that indicates the sighting message, the proximity broadcast receiver, related services, time of receipt of the sighting message, and other informational data. In determination block 1608, the central server may determine whether the proximity broadcast receiver is allowed to receive identification info. In other words, the central server may determine whether the proximity broadcast receiver has permission or is authorized to receive identification information of the wireless identity transmitter. For example, based on metadata within the sighting message indicating that the proximity broadcast receiver is associated with a vendor or a registered service, the central server may determine that the identification of the wireless identity transmitter (or its user) may not be included within the return message. In an embodiment, the central server may evaluate a stored database that describes information permissions based on the identity of the proximity broadcast receiver and its associated services. For example, the database may indicate that the proximity broadcast receiver is associated with a service that is allowed to receive identification information about the wireless identity transmitter. As another example, using user identification information obtained based on the sighting message, the central server may look-up user permissions to identify whether the user authorized user data to be shared with registered services.

If the proximity broadcast receiver is allowed to receive identification information (i.e., determination block 1608=“Yes”), in block 1610 the central server may append identification information to the return message. For example, the return message may include the username, customer ID, address and/or name of the user of the wireless identity transmitter. If the proximity broadcast receiver is not allowed to receive identification information (i.e., determination block 1608=“No”) or if the central server appended identification information to the return message in block 1610, the central server may determine whether there is stored data related to the wireless identity transmitter and the registered service in determination block 1612. The central server may evaluate a database and identify whether the proximity broadcast receiver, its associated devices or services (e.g., a local server), and/or the wireless identity transmitter require data based on the sighting message. Examples of such data may include firmware, software instructions, configuration information, proprietary information (e.g., customer ID), activity information (e.g., information describing recent wireless identity transmitter activities related to the proximity broadcast receiver), or any other relevant information. The central server may query the database using the wireless identity transmitter identification information in combination with the proximity broadcast receiver identification information to detect data within the database that may be included in the return message. For example, the return message may contain personalization information for the user of the wireless identity transmitter to be used by the proximity broadcast receiver. In an embodiment, the database may indicate that the proximity broadcast receiver is associated with a service (e.g., vendor, merchant, etc.) that stores proprietary data within the central server database.

If there is stored data related to the wireless identity transmitter and the registered service (i.e., determination block 1612=“Yes”), in block 1614 the central server may append the data regarding registered service and the wireless identity transmitter to the return message. If there is no stored data related to the wireless identity transmitter and the registered service (i.e., determination block 1612=“No”), or if data is already appended, in block 1616 the central server may transmit the return message, such as to the proximity broadcast receiver. The central server may then continue to perform the operations in determination block 1402.

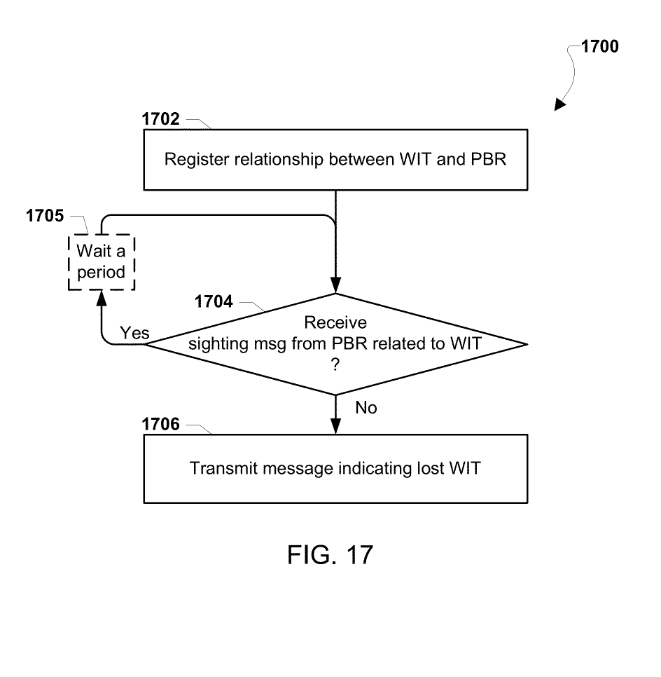

FIG. 17 illustrates an embodiment method 1700 for a central server determining whether a proximity broadcast receiver has lost a wireless identity transmitter. In the central server, the proximity broadcast receiver may be associated with the wireless identity transmitter. For example, the proximity broadcast receiver may be a user's smartphone that is associated with the wireless identity transmitter within an asset (e.g., wallet, purse, luggage, medicine bag, clothing, etc.). In response to failing to receive sighting messages from a proximity broadcast receiver associated with a particular wireless identity transmitter, the central server may be configured to transmit messages, such as warnings, indicating that the wireless identity transmitter (and the object it is connected to) is lost, absent, forgotten, or otherwise non-proximate to the proximity broadcast receiver. This embodiment method 1700 may be useful for leashing certain assets, such as possessions, pets, and children. For example, when a child runs from a parent, broadcast messages from the child's wireless identity transmitter may no longer be received by the parent's proximity broadcast receiver. As a result, the parent's proximity broadcast receiver may not transmit sighting messages to the central server and the central server may determine the child has been lost or run away.

In block 1702, the central server may register a relationship between the proximity broadcast receiver and the wireless identity transmitter, such as by storing information within a database. In various embodiments, each proximity broadcast receiver and wireless identity transmitter may be involved in numerous relationships. Additionally, the relationship information may be stored based on user input data to the central server via a registration web portal (e.g., the user may access a website and indicate all of his/her wireless identity transmitters). During such a registration, the central server may prompt the user to provide conditions under which the central server should transmit messages when wireless identity transmitters are lost or otherwise outside of the proximity of the proximity broadcast receiver. For example, the user may enter configuration data stored by the central server that indicates that if the proximity broadcast receiver does not receive broadcast messages from the wireless identity transmitter between certain hours of the day, the central server should transmit a warning message.

In determination block 1704, the central server may determine whether a sighting message has been received from the proximity broadcast receiver related to the wireless identity transmitter. In other words, based on whether or not such a sighting message is received, the central server may detect if the wireless identity transmitter is close to the proximity broadcast receiver. The central server may also evaluate sighting messages received over a period to determine whether the wireless identity transmitter is (or has recently been) within proximity of the proximity broadcast receiver. In an embodiment, the central server may determine whether it receives a sighting message for each wireless identity transmitter registered in the relationship. For example, if the registered relationship includes multiple wireless identity transmitters, the central server may expect to receive sighting messages from the proximity broadcast receiver regarding all the wireless identity transmitters. If the central server receives a sighting message related to the wireless identity transmitter (i.e., determination block 1704=“Yes”), in optional block 1705 the central server may wait a period and may continue with the operations in determination block 1704. In various embodiments, the central server may perform the operations in determination block 1704 periodically, such as every few seconds, minutes, or hours.

If the central server does not receive a sighting message related to the wireless identity transmitter (i.e., determination block 1704=“No”), in block 1706 the central server may transmit a message indicating the wireless identity transmitter is lost. In various embodiments, the central server may transmit such a message to the proximity broadcast receiver, other devices associated with the user of the proximity broadcast receiver (e.g., a smartphone, tablet), and/or any other device relevant to the wireless identity transmitter. For example, the central server may transmit a warning message to a police server when the wireless identity transmitter is lost and associated with a child.

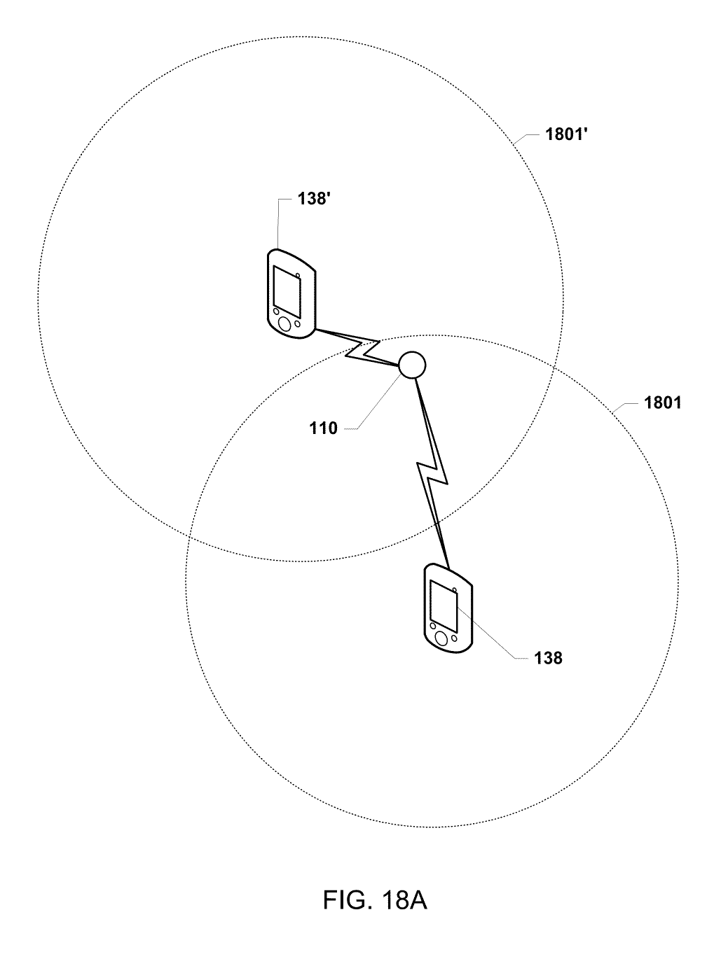

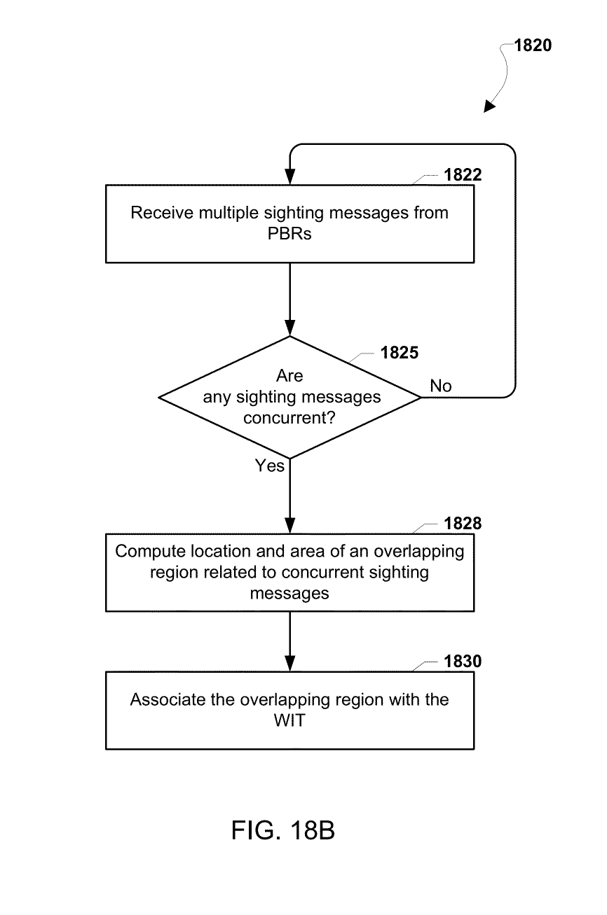

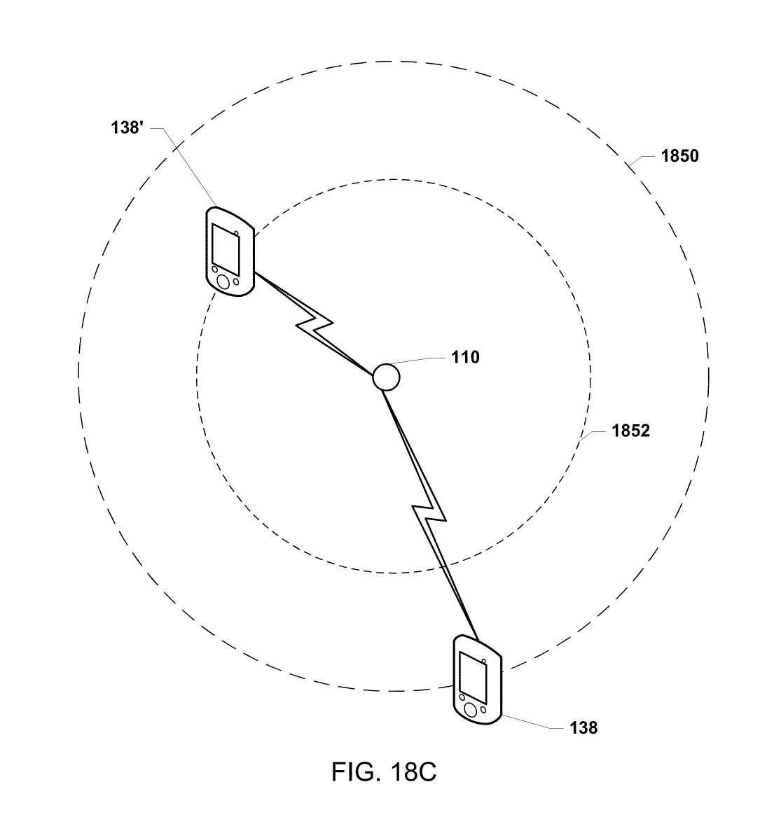

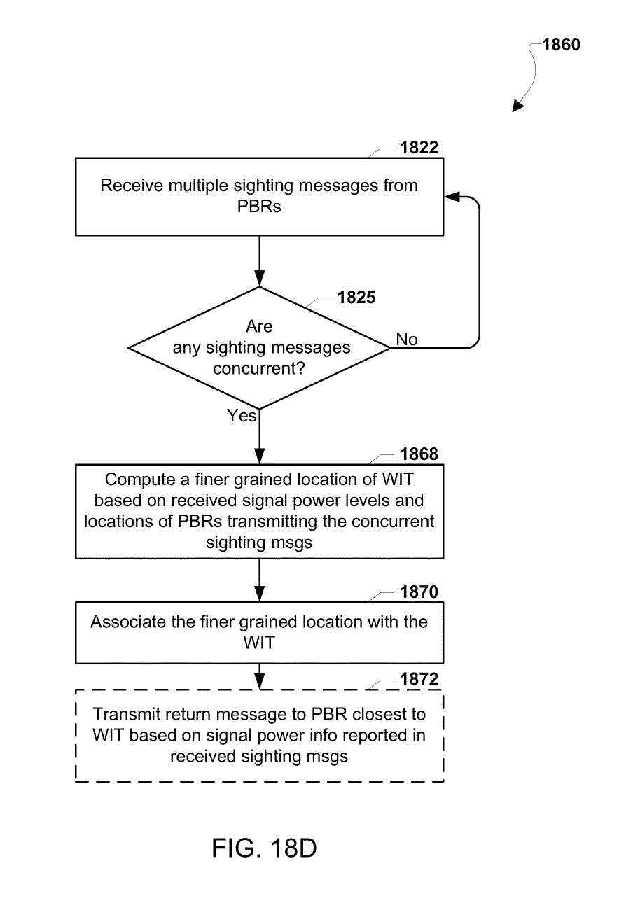

FIG. 18A illustrates two proximity broadcast receivers 138, 138′ receiving short-range broadcast messages from a wireless identity transmitter 110. In various embodiments, the communication system may provide increased location or proximity granularity when multiple proximity broadcast receivers (e.g., mobile proximity broadcast receivers) are able to successfully communicate with a wireless identity transmitter. As previously discussed, since the wireless identity transmitter relies on a short-range radio to broadcast its identifier to proximity broadcast receivers, the location of a proximity broadcast receiver receiving such a short-range broadcast message provides an approximate location for the wireless identity transmitter (i.e., the proximity broadcast receiver and wireless identity transmitter are within proximity of each other when a broadcast message is received). However, if multiple proximity broadcast receivers receive the broadcast message from the wireless identity transmitter, the location of the wireless identity transmitter may be more precisely approximated.

In particular, two proximity broadcast receivers 138, 138′ may receive broadcast messages from a wireless identity transmitter 110. Since the reception range of signals transmitted by wireless identity transmitters 110 is limited, proximity broadcast receivers 138, 138′ may receive the broadcast messages only if the wireless identity transmitter 110 is within that reception range 1801, 1801′. Thus, if both proximity broadcast receivers 138, 138′ receive the same broadcast message from the wireless identity transmitter 110, then the wireless identity transmitter 110 must be located in the overlapping region that is within the reception range 1801, 1801′ of both of the two proximity broadcast receivers 138, 138′. Since the reception range 1801, 1801′ will depend upon signal attenuators (e.g., structures and vegetation) along the transmission path and the sensitivity of proximity broadcast receivers 138, 138′, this variability may be taken into account by a central server, such as by treating the reception range 1801, 1801′ as a statistical parameter (e.g., average range with standard deviations, which may be determined through field testing). In such an embodiment, the central server may assign probabilities to different overlapping region sizes, which may help searchers focus initial search efforts.

FIG. 18B illustrates an embodiment method 1820 for a central server providing a finer grained location for a wireless identity transmitter. The central server may receive multiple sighting messages from proximity broadcast receivers in block 1822. The central server may determine whether any of the received sighting messages are concurrent in determination block 1825 (i.e., whether broadcast messages from the same wireless identity transmitter are reported as being received at approximately the same time from two different proximity broadcast receivers). The central server may not consider sighting messages concurrent unless they are associated with the same wireless identity transmitter (i.e., include the same identifier or corresponding rolling identifiers) and come from different proximity broadcast receivers. Further, the central server may determine whether sighting messages are concurrent based on the contents of the messages, such as by comparing and matching timestamps in the received sighting messages (i.e., the time the proximity broadcast receivers received broadcast messages from the same wireless identity transmitter). The timestamps may be matched without being exactly the same in order to accommodate differences due to unsynchronized clocks within the proximity broadcast receivers, transmission delays, etc. In some cases, such as if the wireless identity transmitter is assumed or determined to be stationary, received sighting messages may be matched for purposes of refining the position despite the messages being received at different times. The acceptable time range for matching may be adjustable. Alternately, if the wireless identity transmitter is using a rolling identifier that shifts with each broadcast message, the central server may match received sighting messages based on the rolling identifier rather than on timestamps. If none of the sighting messages are determined to be concurrent (i.e., determination block 1825=“No”), the central server may continue with the operations in block 1822.

If the central server determines that two or more sighting messages are concurrent (i.e., determination block 1825=“Yes”), the central server may compute the location and area of an overlapping region related to the concurrent sighting messages in block 1828. For example, based on the locations of each of the proximity broadcast receivers associated with the concurrent sighting messages and the known transmission range of the wireless identity transmitter, the central server may compute the reception radius of each proximity broadcast receiver to determine the overlapping region. The location of each proximity broadcast receiver may be included in sighting messages transmitted by each proximity broadcast receiver.

In block 1830, the central server may associate the overlapping region (i.e., the computed location and area of the overlapping region) with the wireless identity transmitter. In other words, the central server may associate a finer grained location of the wireless identity transmitter by calculating multiple reception radii for each of the proximity broadcast receivers and identifying an overlapping region that falls within the reception range of each proximity broadcast receiver. This finer grained location may also be associated with the contents of one or more of the proximity broadcast receiver sighting messages (e.g., timestamp, sensor data, etc.). Also as part of block 1830, the central server may identify a number of overlapping area boundaries and assign a probability value to each based on the average and variability of the transmission range.

Embodiment method 1820 may be applied to many concurrent sighting messages received from several proximity broadcast receivers, which may enable the overlapping area to be more narrowly defined. For example, the central server may compute the overlapping region between several proximity broadcast receiver listening ranges or refine a previously computed overlapping region based on another overlapping report (i.e., compute the overlapping region shared by a previous overlapping region and another proximity broadcast receiver listening area). For example, as searchers close in on the wireless identity transmitter, each of their respective mobile proximity broadcast receivers will begin to transmit sighting messages related to the wireless identity transmitter, which the central server may combine to further narrow the search area as searchers approach from different directions. This capability may be further leveraged by having some searchers move away from a suspected location of the wireless identity transmitter until their mobile proximity broadcast receivers are transmitting sighting messages only intermittently, indicating they are on the edge of the transmission range. With multiple proximity broadcast receivers positioned near the apparent maximum transmission range, the overlapping area computed by the central server can be minimized, thereby helping to further pinpoint the location of the wireless identity transmitter.

Further embodiments may provide increased location granularity by considering the power level of the broadcast messages received by multiple proximity broadcast receivers. As is well known, the signal strength of a radio transmission from a point transmitter decreases with distance by a factor proportional to the inverse of the square of the distance (i.e., 1/R²), with any intervening structure or vegetation causing further attenuation. Thus, proximity broadcast receivers located at different distances from a wireless identity transmitter will typically receive the broadcast messages with different signal strengths. For, example, FIG. 18C illustrates a wireless identity transmitter 110 whose transmissions (i.e., broadcast messages) are being received by two proximity broadcast receivers 138, 138′ at different ranges. Due to the attenuation of radio signals with distance, the proximity broadcast receiver 138′ at distance 1852 from the wireless identity transmitter 110 may typically receive the transmissions with a higher signal strength than a more distant proximity broadcast receiver, such as the proximity broadcast receiver 138 at distance 1850. Thus, by including the signal strength of received transmissions in sighting messages transmitted by proximity broadcast receivers 138, 138′ to a central server, the central server may be able to further refine the location of a wireless identity transmitter 110.

A proximity broadcast receiver's distance to the wireless identity transmitter 110 may be estimated as inversely proportional to the power level. Distance estimations may also account for channel conditions such as intervening signal attenuators (e.g., vegetation, buildings, etc.), echoes (i.e., multipath reception) or other interferences. The distance may be estimated locally on the proximity broadcast receiver 138,138′ or alternately by the central server if the proximity broadcast receiver 138, 138′ includes the power level in a sighting message. Each proximity broadcast receiver's own location and estimated distance from the wireless identity transmitter 110 may be used to triangulate the approximate location of the wireless identity transmitter 110. For example, as searchers close in on the wireless identity transmitter, the signal strength of received broadcast messages from the wireless identity transmitter may increase, enabling the central server to further narrow the search area as searchers approach from different directions. Thus, when proximity broadcast receivers 138, 138′ include signal strength data in sighting messages, the central server can reduce the overlap area for searching as multiple searchers approach the wireless identity transmitter 110 (which would not be the case in the circumstances similar to illustrated above with reference to FIGS. 18A and 18B as the overlap area was determined solely upon the maximum reception range).

FIG. 18D illustrates an embodiment method 1860 for a central server providing a finer grained location for a wireless identity transmitter based on the power level of broadcast messages received by proximity broadcast receivers. The central server may receive multiple sighting messages from proximity broadcast receivers in block 1822. The sighting messages may include the power level of a broadcast messages received by the reporting proximity broadcast receivers, or an estimated distance from the proximity broadcast receiver to the wireless identity transmitter determined based on the received signal strength. The central server may determine whether any of the sighting messages are concurrent in determination block 1825. The central server may not consider sighting messages concurrent unless they are associated with the same wireless identity transmitter (i.e., include the same identifier or corresponding rolling identifiers) and are received from different proximity broadcast receivers. Further, the central server may determine whether sighting messages are concurrent based on the contents of the sighting messages as described above with reference to FIG. 18B. If none of the sighting messages are concurrent (i.e., determination block 1825=“No”), the central server may continue with the operations in block 1822.

If the central server determines that two or more sighting messages are concurrent (i.e., determination block 1825=“Yes”), the central server may compute a finer grained location of the wireless identity transmitter based on the received signal power levels and the locations of proximity broadcast receivers transmitting the concurrent sighting messages in block 1868. The central server may estimate the distance between the proximity broadcast receivers and the wireless identity transmitter or may receive an estimated distance in the sighting messages as discussed above. Each proximity broadcast receiver's location and estimated distance from the wireless identity transmitter may be used to triangulate the finer grained location. Triangulation based on information within sighting messages received from only two proximity broadcast receivers may result in two possible locations for the wireless identity transmitter. However, information in sighting messages from three or more proximity broadcast receivers may be used to better approximate the wireless identity transmitter's location. The central server may associate the finer grained location (i.e., the triangulated location) with the wireless identity transmitter in block 1870. This finer grained location may also be associated with the contents of one or more of the proximity broadcast receiver sighting messages (e.g., timestamp, sensor data, etc.).

In optional block 1872, the central server may transmit a return message to a proximity broadcast receiver that is closest to the wireless identity transmitter based on signal power information reported in received sighting messages. In other words, the central server may determine the closest proximity broadcast receiver to the wireless identity transmitter among the plurality of proximity broadcast receivers that transmitted the concurrent sighting messages. Often, a user of a wireless identity transmitter may intend to use a device associated with a single proximity broadcast receiver within a plurality of proximity broadcast receivers (e.g., a point-of-sale device in a line of point-of-sale devices each connected to proximity broadcast receivers). The central server may use signal strength or signal power indicators within concurrent sighting messages, as well as any other relevant data (e.g., location information, direction of the wireless identity transmitter based on previous sighting messages, etc.) to determine the single proximity broadcast receiver the user of the wireless identity transmitter likely intends to interface. The return message may indicate to the proximity broadcast receiver that the wireless identity transmitter is likely intending to interface with that proximity broadcast receiver, and may additionally include instructions, data, or other information for the proximity broadcast receiver. For example, the return message may include a message indicating the user of the wireless identity transmitter is near, or alternatively instructions on how to handle the user.

In an embodiment, the return message may indicate information describing the certainty of the determination that the recipient proximity broadcast receiver is the closest to the wireless identity transmitter. Additionally, the return message may request a confirmation of proximity to the wireless identity transmitter. For example, the closest proximity broadcast receiver may confirm that it is the closest proximity broadcast receiver based on subsequent input data related to the user of the wireless identity transmitter (e.g., the user of the wireless identity transmitter pressed a ‘confirm’ button on the proximity broadcast receiver). In another embodiment, the central server may transmit messages to the proximity broadcast receivers determined to not be the closest proximity broadcast receiver, indicating that these proximity broadcast receivers are not closest and/or the identity of the determined closest proximity broadcast receiver. In response, the proximity broadcast receivers that are not the closest may modify their subsequent transmission of sighting messages regarding the wireless identity transmitter. For example, the proximity broadcast receivers may adjust (i.e., increase or decrease) the frequency of transmitting sighting messages regarding the wireless identity transmitter (i.e., adjust receiver thresholds) or alternatively may ignore future broadcast messages from the wireless identity transmitter for a period of time.

FIG. 19 illustrates an embodiment method 1900 that may be implemented within a central server. The method 1900 may be performed by the central server in response to receiving a sighting message from a proximity broadcast receiver that includes encoded, rolling, or otherwise protected data originally broadcast by a wireless identity transmitter. Privacy of users of wireless identity transmitters may be protected by using a rolling or randomly varying identifier for each wireless identity transmitter so the identifier changes with time. New identifiers may be generated periodically or based on certain events, such when a wireless identity transmitter broadcasts an identifier a certain number of times or for a certain time period (e.g., an hour), or after one or more pairings. This rolling of identifiers may be coordinated with the central server so that the wireless identity transmitter may still be tracked. For example, the wireless identity transmitter and the central server may each have a cryptographically secure pseudo-random number generator algorithm that is used to generate identifiers on a common time scale so that any given moment, the central server can calculate the identifier being transmitted by a particular wireless identity transmitter.

Generating rolling identifiers, or other methods of obfuscating identifiers, is important in that it may prevent sniffing attacks from a third party. For example, if the identifier was static, a third party could sniff the identifier, such as by impersonating a proximity broadcast receiver, and then use the identifier to track the wireless identity transmitter. A rolling identifier may hinder such an attack impossible if the third party lacks the pseudo-random number generator or other means of generating the latest rolling identifiers.

In block 1902, the central server may receive a wireless identity transmitter's rolling identifier in a sighting message from a proximity broadcast receiver. In block 1904, the central server may compare the rolling identifier with code calculated by an algorithm shared with the wireless identity transmitter, such as a pseudo-random function or an encryption algorithm with shared secret keys. The algorithm may be software instructions, routines, algorithms, circuitry, or modules that are utilized by the central server to calculate codes that are expected to align with rolling identifiers generated and broadcast by the wireless identity transmitter over a period. In various embodiments, the central server may compare the received identifier with the next several codes in case some identifiers were missed. If the received identifier matches any codes generated or expected by the central server, in block 1906 the central server may associate the matching identifier and any associated data with a serial code corresponding to the wireless identity transmitter. This way, if the central server later receives a user request with the wireless identity transmitter's serial code, such as a request from a parent to locate the wireless identity transmitter carried by a child, then the central server can find all the prior matches and any associated data without having to search for every previous rolling identifier.

In an embodiment, when initiating a search for a target wireless identity transmitter, the central server may use the shared algorithm and information (e.g., key) to generate a target device ID that is transmitted in an alert message. In this embodiment, alert messages may be retransmitted with an updated target device ID whenever the target wireless identity transmitter is scheduled to roll its identifier. Various algorithms for generating rolling identifiers or other encoded identifiers, as well as other decoding algorithms, are discussed below.

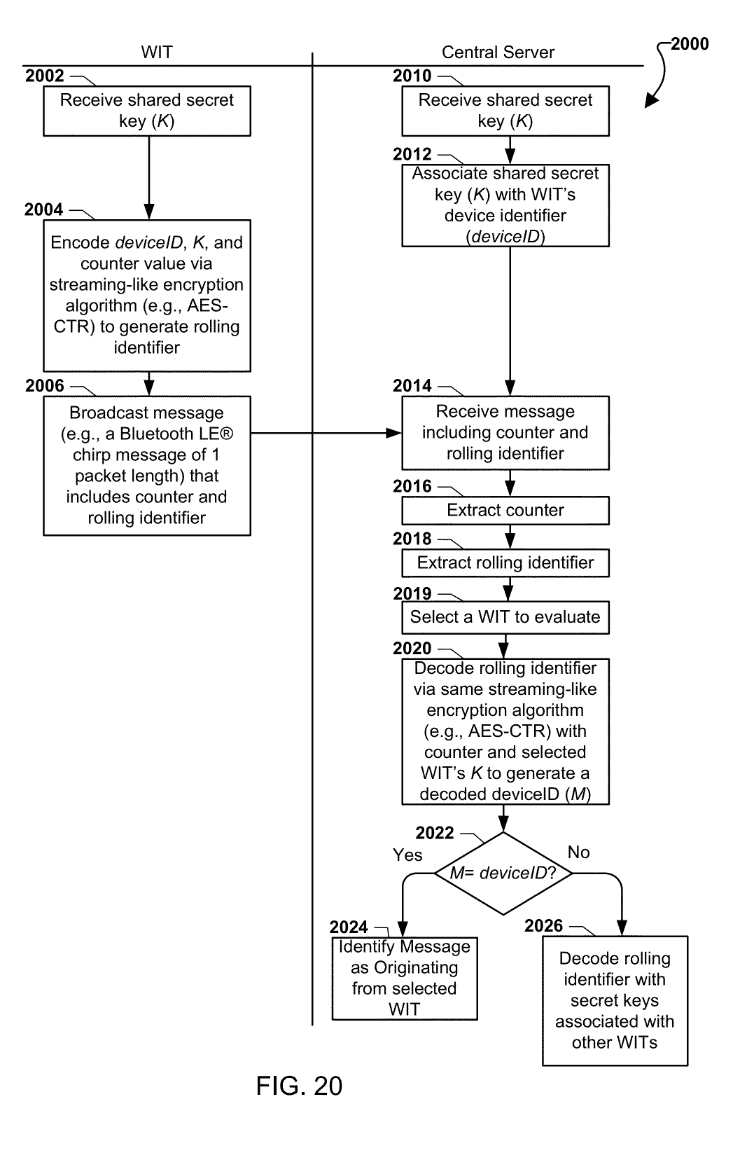

FIGS. 20-24C illustrate various embodiment methods for synchronizing a nonce or counter between a wireless identity transmitter and a central server to enable transmitting and receiving obscured information. The wireless identity transmitter may perform various methods for broadcasting messages that include obscured identifiers and data (i.e., payloads) that identify the wireless identity transmitter to the central server and provide a relative reading on the wireless identity transmitter clock. Likewise, the central server may perform various methods for processing obscured information within received messages corresponding to the wireless identity transmitter. As described above, the broadcast messages from the wireless identity transmitter may be sent to the central server directly or through intermediary devices, such as proximity broadcast receivers transmitting sighting messages.

Due to privacy concerns regarding unintended tracking of devices described above, the wireless identity transmitter may obscure information within the transmitted messages through obfuscation measures (e.g., encryption or pseudo-random data generation) known only to the central server and wireless identity transmitter. In an embodiment, the wireless identity transmitter may maintain a clock or timer mechanism that is represented by a nonce or counter value and that may begin once the device is operational (e.g., activated through the insertion of a battery). The clock may be relatively low-quality and therefore may drift unlike more accurate clocks, such as in the central server (e.g., clocks calibrated by periodic atomic clock readings). The counter or nonce may be a non-repeating number generated by the wireless identity transmitter, and may be changed each time wireless identity transmitter encodes its identifier for broadcasting, such as once every hour or even once every broadcast message. In various embodiments, nonces or counters (or counter values) may be encrypted or encoded using pseudo-random functions or other encryptions algorithms (e.g., AES). For example, a wireless identity transmitter may encode a nonce or counter value with an AES-CTR block cipher to create a nonce for use in generating the payload including a rolling identifier of a broadcast message. As another example, a nonce may be generated by applying a linear feedback shift register (LFSR) to a nonce or counter value.

As described throughout the disclosure, the wireless identity transmitter may also store a unique device identification code or number (i.e., a device identifier or ‘deviceID’) and be pre-provisioned with a per-device shared secret key (or K) which is associated with the unique identifier at the central server. For example, the central server may store the unique device identifier and the secret key in a database and may maintain a table of deviceID and K pairs for all wireless identity transmitters registered with the central server. The central server may use the device identifier and secret key, along with other information such as reported nonce or counter values, to identify, decrypt and otherwise process obscured messages from the wireless identity transmitter. In an embodiment, the device identifier (or deviceID) may be generated sequentially or randomly.

FIG. 20 illustrates an embodiment method 2000 for a central server to identify a wireless identity transmitter indicated by encrypted data within a message broadcast by the wireless identity transmitter. In block 2002, the wireless identity transmitter may receive a shared secret key (i.e., “K”). In other words, the wireless identity transmitter may be pre-provisioned with a per-device shared secret key (K), such as during manufacturing. In another embodiment, the wireless identity transmitter may receive the secret key in a messages broadcast from a proximate proximity broadcast receiver, such as described above with reference to FIG. 4. The secret key may be associated with the wireless identity transmitter's unique device identifier (i.e., deviceID) at the central server. In an embodiment, the secret key may be a 128 bit secret key.

In block 2004, the wireless identity transmitter may encode the device identifier (deviceID), secret key (K), and a nonce or counter value via a streaming-like encryption algorithm (e.g., AES-CTR encryption) to generate a rolling identifier. “AES-CTR” is one of the confidentiality modes recommended by the National Institute of Standards and Technology for implementations of the Advanced Encryption Standard (AES). In an embodiment, the wireless identity transmitter may include an AES coprocessor that is configured to support the “CTR” mode. In an embodiment, the rolling identifier may be represented by the following equation:

Rolling identifier=(deviceID∥data)XOR(MSB_{—}N(AES_{—}K(t)))

where t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘MSB_N( )’ means the ‘N’ most significant bits (e.g., 60 bits). This rolling identifier may then be included in the broadcast message that is regularly transmitted by the wireless transmitter device. In an embodiment, other device data (e.g., battery level, temperature, etc.) may be transmitted along with the rolling identifier in a broadcast packet.

In a further embodiment, other information may be included within the rolling identifier. Thus, in addition to providing an obscured identifier for the wireless identity transmitter, the rolling identifier field may include obscured data that only the central server can recover. One method for accomplishing this is to concatenate the additional information, such as a few bits to indicate the battery status (bat_stat) to the device identifier (deviceID) and applying the XOR function to the concatenation. The amount of additional information (i.e., number of bits of information) that can be included within (i.e., obscured within the same data field of) the rolling identifier is limited by the length N of significant bits within the rolling identifier field. Thus, if more bits are available in the data portion carrying the rolling identifier, more such data may be included within the encrypted rolling identifier. Since the data that is included within the rolling identifier is likely to change over time, this approach may further obscure the device's identity.

If more data is desired to be transmitted in broadcast messages, some of that data may be carried in the clear or encrypted with the data. There are a number of approaches for including data (e.g., battery state, temperature, etc.) within broadcast messages. In addition to including the data within the rolling identifier as described above, the data may be added by concatenating the data to the end of the rolling identifier as part of the manufacturer specific data payload, either before or after the rolling identifier, as sensor data in the clear. Thus, if there are more bits available in the manufacturer specific data payload they may be used to convey the data in the clear. Alternatively, the data may be encoded using the same key as used to generate the rolling identifier or an alternate key that is known to the server to be associated with the wireless identity transmitter or such data fields. In this alternative, the information in the rolling identifier enables the server to both determine the device's true identifier and the encryption key used to encrypt the other data included in the message. In yet a further embodiment, these options for carrying other data may be combined, such that some of it is included within the rolling identifier, some is carried in the clear and/or some data may be encrypted and included within the broadcast message.

In block 2006, the wireless identity transmitter may then broadcast a message that includes the nonce and the rolling identifier, or simply the rolling identifier (i.e., without a nonce). In an embodiment, the broadcast message may be a single packet length Bluetooth LEO chirp message. In various embodiments, the nonce included in the broadcast message may be 20 bits and the rolling identifier may be 60 bits, so that the entire broadcast message is 80 bits.

As an example embodiment in which the battery status is included within the rolling identifier, the broadcast message (or the payload of the broadcast message) may be represented by the following equation:

Payload=t∥(deviceID∥bat_stat)XOR(MSB_{—}N(AES_{—}K(t)))

where t is the value of the wireless identity transmitter's nonce, which may just be the nonce or counter (e.g., a 20 bit value), ‘bat_stat’ is the battery status information of the device (e.g., a 4-bit code), ‘∥’ means concatenation, ‘XOR’ denotes the bitwise exclusive-or operation, ‘AES_K( )’ is the AES block cipher with key ‘K’, and ‘MSB_N( )’ means the ‘N’ most significant bits (e.g., 60 bits). In other words, the embodiment broadcast message may include the nonce in the clear (i.e., not encrypted) in addition to a rolling identifier that includes a battery level indicator. In another embodiment, the battery level indicator (i.e., bat_stat) may not be encrypted, and may be included in another field of the broadcast message, such as within the service universally unique identifier (UUID) portion of a message.

In another embodiment, the payload may not include a nonce t, in which case the payload may be represented by the following equation:

Payload=(deviceID∥bat_stat)XOR(MSB_{—}N(AES_{—}K(t))).

In block 2010, the central server may receive the shared secret key (K), such as during the account creation operations described above with reference to FIG. 13. For example, the central server may generate the secret key in response to receiving account registration information from the user of the wireless identity transmitter (e.g., deviceID and registration request information). In block 2012, the central server may associate the shared secret key (i.e., K) with the wireless identity transmitter's device identifier (i.e., deviceID). For example, the central server may store the deviceID and K in a data table of registered devices.

In block 2014, the central server may receive a message including the nonce or counter and the rolling identifier. For example, the received message may be a sighting message from a proximity broadcast receiver that includes the information broadcast by the wireless identity transmitter with the operations in block 2006. In block 2016, the central server may extract the nonce or counter from the received message, and in block 2018 may extract the rolling identifier. In block 2019, the central server may select a wireless identity transmitter (i.e., selected wireless identity transmitter) to evaluate. In other words, the central server may obtain a stored deviceID, K, and nonce or counter for a registered wireless identity transmitter known to the central server, such as from the database or data table storing such information for all registered wireless identity transmitters. In block 2020, the central server may decode the rolling identifier via the same streaming-like encryption algorithm (e.g., AES-CTR) with the nonce or counter and the selected wireless identity transmitter's secret key (K) to generate a decoded device identifier (or M). For example, the central server may perform a decoding operation based on the AES-CTR algorithm that uses the rolling identifier as input along with the selected wireless identity transmitter's secret key (K) and the nonce or counter indicated in the received message.

In an embodiment, the decoded device identifier (M) may be represented by the following equation:

M=(rolling identifier)XOR(MSB_{—}{N−a}(AES_{—}K(t))),

where t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘MSB_{N−a}’ means the ‘N−a’ most significant bits (e.g., 56 bits when a is 4 bits and N is 60 bits).

In determination block 2022, the central server may determine whether the decoded device identifier (M) and the deviceID match. In other words, the central server may compare the decoded device identifier (M) to the deviceID for the selected wireless identity transmitter whose secret key (K) was used with the AES-CTR algorithm operations to obtain the decoded device identifier (M). If M and the deviceID do match (i.e., determination block 2022=“Yes”), in block 2024, the central server may identify the broadcast message as originating from the selected wireless identity transmitter. If M and the deviceID do not match (i.e., determination block 2022=“No”), in block 2026 the central server may decode the rolling identifier with secret keys associated with other wireless identity transmitters. For example, the central server may select the next registered wireless identity transmitter and use the corresponding stored pair of a secret key (K) and corresponding deviceID. In this manner, all K and deviceID pairs stored for all registered wireless identity transmitters and/or users of the system may be tried by the central server until a match is found that identifies the originator of the broadcast message.

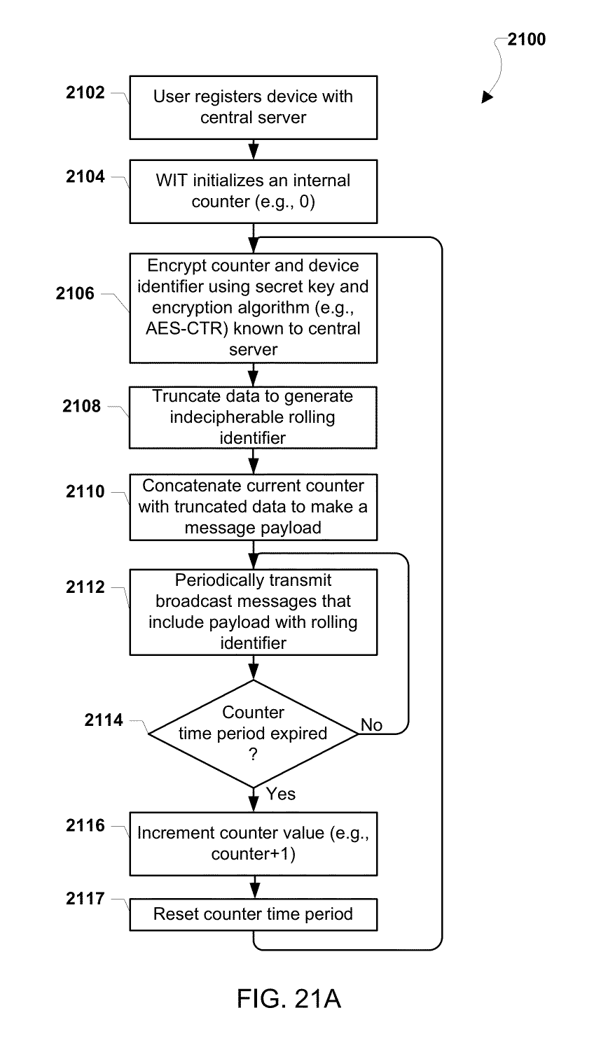

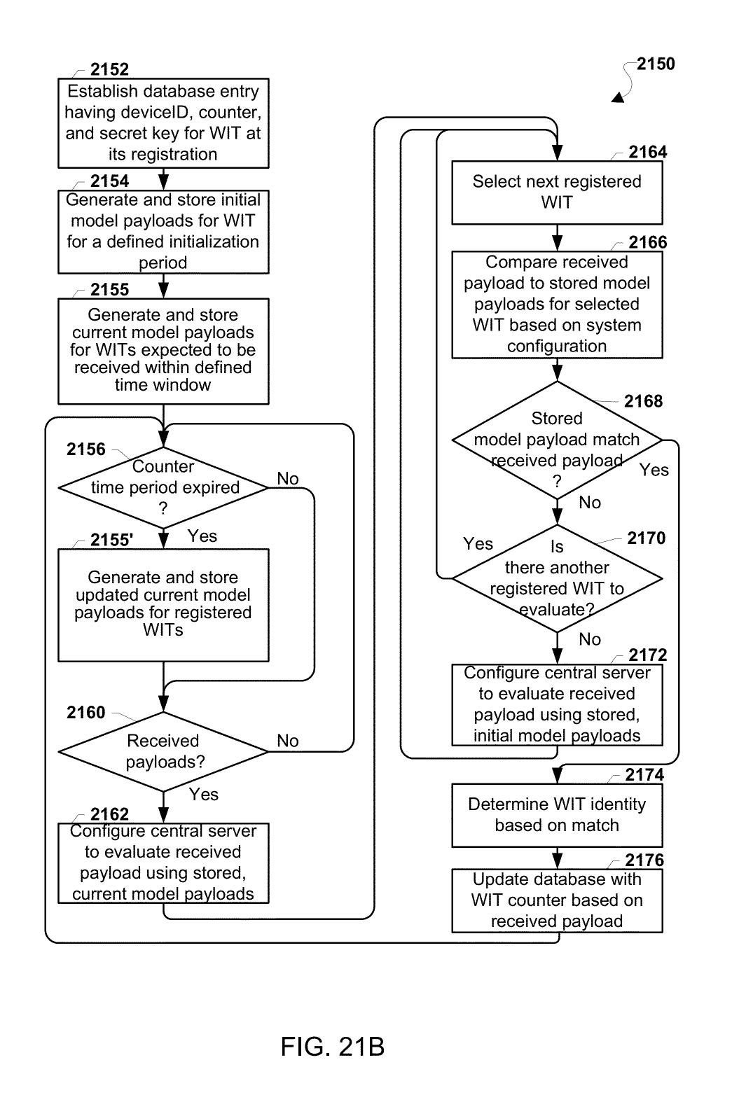

FIG. 21A illustrates the embodiment method 2100 for a wireless identity transmitter generating and broadcasting an encrypted message (i.e., a rolling identifier) for receipt/use by a central server.

In block 2102, a user of the wireless identity transmitter may register the device with the central server. The services the wireless identity transmitter utilizes may require registrations of all active devices employed by users (e.g., consumers, proprietors, etc.). The registration process may include an initial synchronization with the central server by the user of the wireless identity transmitter. For example, the user of the wireless identity transmitter may register the device with the central server through a Web application, in a mobile device or a PC able to receive wireless identity transmitter messages and operated by the user. The wireless identity transmitter may be required to be registered with the central server within a certain time period from activation of the device. For example, the wireless identity transmitter may be required to be registered within the first 24 hours after the device is initiated (e.g., a battery is placed within the wireless identity transmitter). Registration operations are further described above with reference to FIG. 13.

In block 2104, the wireless identity transmitter may initialize an internal nonce or counter, such as by setting the nonce or counter to a zero value. The nonce or counter initialization may occur due to a triggering event, such as the placement of a battery or power source within the wireless identity transmitter. For example, the nonce or counter may begin incrementing once the wireless identity transmitter is activated or powered on. Alternatively, the initialization may occur in response to registration operations described above. The nonce or counter may begin with ‘0’ (or any other starting value, such as ‘1’) and may be incremented periodically by the wireless identity transmitter. In an embodiment, when the battery of the wireless identity transmitter is replaced (e.g., due to battery failure) or the wireless identity transmitter is otherwise reset/restarted/rebooted, the nonce or counter may return to the initial value (e.g., ‘0’). The nonce or counter may not repeat the value it represents unless the wireless identity transmitter is reset/restarted/rebooted. In an alternative embodiment, during initialization of the nonce or counter, the wireless identity transmitter may read from flash memory a predefined initial nonce or counter value. For example, the wireless identity transmitter may initialize the nonce or counter with a value set at a factory or updated by an installed application.

In an embodiment, the counter or nonce may be initialized and adjusted in a random or pseudo-random fashion using methods well known in the art. The nonce or counter may be a pseudo-randomly generated value that can be replicated in both the wireless identity transmitter and the central server. In another embodiment, the nonce or counter may be generated by the wireless identity transmitter using a linear feedback shift register (LFSR) with a proper period configured to create nonce or counter values that do not repeat during the lifetime of the device. Such nonces or counters derived from the LFSR may also be pseudo-random.

In block 2106, the wireless identity transmitter may encrypt the concatenated data using a secret key and encryption algorithm known to the central server. For example, the wireless identity transmitter may encode the nonce or counter and/or the device identifier (i.e., deviceID) using an AES-CTR block cipher. The encryption algorithm may utilize the secret key for encryption and decryption purposes, as the secret key is known by both the central server and wireless identity transmitter. The encryption algorithm may result in encrypted (or encoded) data of a certain size. For example, using the AES-CTR cipher, the wireless identity transmitter may generate encoded data of 128-bits. In an embodiment, the wireless identity transmitter may generate encrypted data represented by the following equation:

(deviceID∥bat_stat)XOR(MSB_{—}N(AES_{—}K(t))),

where t is the value of the wireless identity transmitter's nonce or counter (e.g., a 20 bit value), ‘bat_star’ is the battery status information of the wireless identity transmitter (e.g., a 4-bit code), ‘∥’ means concatenation, ‘XOR’ denotes the bitwise exclusive-or operation, ‘AES_K( )’ is the AES block cipher with key ‘K’, and ‘MSB_N( )’ means the ‘N’ most significant bits (e.g., 60 bits). In other words, the embodiment broadcast message may include the nonce or counter in the clear (i.e., not encrypted) in addition to a rolling identifier that includes a battery level indicator. In another embodiment, the encrypted data may be represented by the following equation:

(deviceID)XOR(AES_{—}K(t)),

where deviceID is a unique device identifier, t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘MSB_N( )’ means the ‘N’ most significant bits (e.g., 60 bits).

Due to the limited communication capabilities of the wireless identity transmitter, the payload of broadcast messages (e.g., the payloads supported by Bluetooth LE broadcast packets) may not be able to contain the entire encrypted message, but instead only include a portion of an encrypted piece of data. Accordingly, in block 2108, the wireless identity transmitter may truncate data to generate an indecipherable rolling identifier. In other words, by truncating the encrypted data, the wireless identity transmitter may create an identifier to be put in a broadcast message (or payload) such that the identifier's size may be supported by the utilized communication format, such as Bluetooth LE. For example, the wireless identity transmitter may truncate the encrypted data to fit within an 80-bit payload maximum size. When encrypted data is truncated, the decryption of that data within the central server may be impossible. However, the incomplete encrypted data may still be used by the central server as described below with reference to FIG. 21B. In an embodiment, truncation may be accomplished with a function, such as a most-significant-bit operation. In another embodiment, the truncated data may be represented by the following equation:

TRUNC(deviceID XOR AES_{—}K(t)),

where t is the value of the wireless identity transmitter's nonce or counter (e.g., a 20 bit value), ‘XOR’ denotes the bitwise exclusive-or operation, ‘AES_K( )’ is the AES block cipher with key ‘K’, and ‘TRUNC( )’ denotes a truncation operations that may create a certain number of bits or bytes (e.g., 56 bits or 7 bytes).

In block 2110, the wireless identity transmitter may concatenate the current nonce or counter with the truncated data to make a message payload. For example, the wireless identity transmitter may combine the current wireless identity transmitter system clock value (e.g., 20 bits long) with the unique identification code of the wireless identity transmitter truncated to be 60 bits long. In an embodiment, the payload may include both encrypted data and unencrypted data (or “in the clear” data). For example, the payload may contain many bits representing the encrypted and/or truncated data and several other bits that represent the battery status of the wireless identity transmitter or a nonce or counter value.

In block 2112, the wireless identity transmitter may periodically transmit broadcast messages that include the payload with the rolling identifier, such as by broadcasting via short-range wireless communication techniques as described above. The frequency of transmissions of the broadcast messages may vary dependent upon system configurations, user settings, or any other source of scheduling and timing relevant for wireless identity transmitters communicating via radio signals. For example, the wireless identity transmitter may broadcast the rolling identifier every few seconds.

In determination block 2114, the wireless identity transmitter may determine whether a predefined nonce or counter time period has expired. This nonce or counter time period may be set in a similar manner as the broadcast frequency periodicity as described above. For example, the manufacturer or may establish the nonce or counter time period using various techniques, such as hard-coding variables within the wireless identity transmitter's processor circuitry.

If the nonce or counter time period has not expired (i.e., determination block 2114=“No”), the wireless identity transmitter may continue with the operations in block 2112. For example, the wireless identity transmitter may broadcast the payload via short-range radio transmissions at a frequency of a few seconds for a time period of many minutes.

If the device determines the nonce or counter time period has expired (i.e., determination block 2114=“Yes”), in block 2116 the wireless identity transmitter may increment the nonce or counter value, such as by adding 1. In block 2117, the wireless identity transmitter may reset the nonce or counter time period. For example, after a nonce or counter time period has expired, the wireless identity transmitter may increase the nonce or counter by a value of 1 and reset the nonce or counter time period to 0. The wireless identity transmitter may continue with the operations in block 2106 (e.g., the wireless identity transmitter may create a new payload and broadcast it for another nonce or counter time period).

FIG. 21B illustrates an embodiment method 2150 for a central server receiving messages and syncing timing nonce or counters based on payload information. In block 2152, the central server may establish a database entry having the device identifier (i.e., deviceID), nonce or counter, and secret key data for the wireless identity transmitter at its registration. The central server may maintain a database containing data records for each wireless identity transmitter associated with the central server and/or the central server's affiliated services. The database may be populated with information obtained via registration operations described above. Thus, there may be a data record for each wireless identity transmitter associated with the central server, and each record may contain information that represents a particular device's identification, its current nonce or counter (e.g., clock value), and a secret key associated with the wireless identity transmitter. In an embodiment, the secret key may be unique to each wireless identity transmitter registered with the central server. In an embodiment, the central server may also store the initial nonce or counter value for each wireless identity transmitter registered with the central server.

In various embodiments, when a wireless identity transmitter is registered, the central server may store the initial nonce or counter value for the wireless identity transmitter. Dependent upon the time between the activation of the wireless identity transmitter (e.g., when the battery was inserted and the device became operational) and the registration of the device, the initial nonce or counter for the wireless identity transmitter may or may not be 0. For example, if the registration of the wireless identity transmitter with the central server occurred several hours after a user inserted a battery in the wireless identity transmitter, the initial nonce or counter may not be 0. In an embodiment, the central server may also indicate the registration status of the wireless identity transmitter by setting a registration flag or other indicator and may store information describing wireless identity transmitters that have yet to be registered in the database. In an embodiment, the central server may maintain a database with initial values provided for all known wireless identity transmitter whether or not they have been registered. For example, based on manufacturing records, the central server may contain a database having information about every wireless identity transmitter created.

The central server may generate and store model payloads using operations similar to those described above with reference to blocks 2106-2110. Model payloads may be payloads the central server expects to receive from the wireless identity transmitter based on stored secret key, device identifier (deviceID), and nonce or counter information. For example, for each registered wireless identity transmitter, the central server may create a model payload by concatenating the device's deviceID to a nonce or counter value, encrypting the concatenated data using an encryption protocol that employs the secret key for the wireless identity transmitter, and truncating the encrypted data. Each model payload may be stored in a central server data table (or lookup table) in relation to the corresponding deviceID and nonce or counter values used to generate the respective model payloads. For example, for each model payload for each wireless identity transmitter, the central server may store in the data table the model payload, a time offset value (e.g., −2, −1, 1, 2, etc.), and the nonce or counter, all in relation to the deviceID of the wireless identity transmitter.

In block 2154, the central server may generate and store initial model payloads for the wireless identity transmitter for a defined initialization period. For example, starting at the initial nonce or counter value (e.g., 0 or a pseudo-random value known to the device and the central server), the central server may generate model payloads using nonce or counter values that are the same, lower, and/or higher than the actual initial nonce or counter of a wireless identity transmitter such that these model nonces or counters cover the initialization period. In an embodiment, the initialization period may be an hour, several hours, days, etc.). The central server may store the initial model payloads for use in the event of a registration/reset/reboot of a wireless identity transmitter.

In block 2155, the central server may also generate and store current model payloads for wireless identity transmitters expected to be received within a defined time window. To account for possible clock drift in wireless identity transmitters, the central server may generate and store model payloads for the defined time window (or time period) by using multiple derivative nonce or counter values that represent a range of possible nonces or counters. In other words, derivative nonce or counter values may be offsets to the current nonce or counter value stored for a wireless identity transmitter. For example, the central server may generate model payloads for derivative nonce or counter values that are lower and higher than the currently stored nonce or counter value in the database. A derivative nonce or counter value may be the result of an offset value (e.g., −2, −1, 1, 2, etc.) added to the stored nonce or counter value for a wireless identity transmitter. The central server may generate model payloads to represent the stored nonce or counter value and derivative nonce or counter values that incrementally represent the window time period. For example, the model payloads may represent nonces or counters increasing by a small time value, such as an hour, and covering a large period of time, such as multiple hours. As another example, the central server may store a payload corresponding to the current nonce or counter value stored for a wireless identity transmitter, a payload corresponding to the previous nonce or counter value for the device, and a payload corresponding to the next nonce or counter value for the device.

In an embodiment, the first generated current model payloads for a given wireless identity transmitter may be identical to the initial model payloads for the wireless identity transmitter as both sets of payloads may be generated by the central server based on the same initial nonce or counter values. In an embodiment, the initialization period may coincide with the defined time window. For example, the initialization period may involve a similar number of days, hours, minutes, etc. as the defined time window.

In determination block 2156, the central server may determine whether a nonce or counter time period has expired. The central server may initialize the evaluation of a nonce or counter time period at an arbitrary time or, alternatively, upon the receipt of a wireless identity transmitter registration. The nonce or counter time period may be the same period of time used by the wireless identity transmitters as described above with reference to determination block 2114.

If the nonce or counter time period has expired (i.e., determination block 2156=“Yes”), in block 2155′ the central server may generate and store updated current model payloads for registered wireless identity transmitters. The updated current model payloads may replace the previous current model payloads and may be based on the stored nonce or counter value in each respective wireless identity transmitter's database record.

If the nonce or counter time period has not expired (i.e., determination block 2156=“No”) or if the nonce or counter time period has expired and the central server has generated updated current model payloads, in determination block 2160, the central server may determine whether any payloads have been received. In an embodiment, payloads may be delivered directly from wireless identity transmitters or alternatively indirectly from proximity broadcast receivers via sighting messages which include (or relay) rolling identifier payloads from proximate wireless identity transmitters to the central server. If no payloads have been received (i.e., determination block 2160=“No”), the central server may continue with the operations in determination block 2156.

If a payload has been received (i.e., determination block 2160=“Yes”), in block 2162, the central server may be configured to evaluate the received payload using stored, current model payloads, such as the current model payloads stored for each registered wireless identity transmitter. As described above, the central server may maintain two sets of stored model payloads for each registered wireless identity transmitter, an initial model payload set that may include model payloads based on the initial nonce or counter and derivative nonce or counter values that span the initialization period, and a current model payload set that is based on the current nonce or counter value stored within the database record for each wireless identity transmitter. In an embodiment, the central server may set a system variable indicating the central server should compare the received payload to stored, current model payloads. The system variable may be set to direct the central server to evaluate either the current or initial model payloads for wireless identity transmitters.

In blocks 2164-2172, the central server may perform an operational loop in which the central server compares the received payload (i.e., data broadcast by the wireless identity transmitter) to stored model payloads for all registered wireless identity transmitters until a match is found. In block 2164, the central server may select a next registered wireless identity transmitter. The central server may determine the next registered device based on the database of registered wireless identity transmitters and may sequentially iterate through each device during the operations in blocks 2164-2172. In block 2166, the central server may compare the received payload to the stored model payloads for the selected wireless identity transmitter based on the system configuration, such as the configuration set in the operations in block 2162. For example, based on the system variable set to ‘current’ with the operations in block 2162, the central server may compare the received payload to stored current model payloads for the selected wireless identity transmitter. Based on the form of the encrypted data of the received payload, the comparison may be a pattern-matching routine in which the central server compares the data of the model payloads against the received payload. For example, the central server may compare the bit values for the stored and received payloads.

In determination block 2168, the central server may determine whether any of the stored model payloads match the received payload. If none of the stored model payloads match the received payload (i.e., determination block 2168=“No”), in determination block 2170, the central server may determine whether there is another registered wireless identity transmitter to evaluate. In other words, the central server may determine whether the stored model payloads of all registered wireless identity transmitters have been evaluated. If there is another registered wireless identity transmitter to evaluate (i.e., determination block 2170=“Yes”), the central server may continue by selecting the next registered wireless identity transmitter with the operations in block 2164.

If the central server has evaluated the stored model payloads of all registered wireless identity transmitters (i.e., determination block 2170=“No”), in block 2172, the central server may be configured to evaluate the received payload using stored, initial model payloads, such as the initial model payloads stored for each registered wireless identity transmitter at the time of the devices' registration. For example, the central server may set a system variable indicating the central server should compare the received payload to stored, initial model payloads for evaluated registered wireless identity transmitters (e.g., the system variable may be set to ‘initial’). The operational loop may then continue with the operations in blocks 2164-2168 wherein the central server may select each registered wireless identity transmitter and compare the initial model payloads of that selected device to the received payload.

If the central server does find a match between the received payload and any of the stored model payloads (current or initial) of a registered wireless identity transmitter (i.e., determination block 2168=“Yes”), in block 2174, the central server may determine a wireless identity transmitter identity based on the match. In other words, the central server may identify the wireless identity transmitter corresponding to the received payload based on the identification information (e.g., deviceID) stored in relation to the matching stored model payload. In block 2176, the central server may update the database with the identified wireless identity transmitter's nonce or counter based on the received payload. Based on the database record corresponding to the matching stored model payload, the central server may determine the derivative nonce or counter value corresponding to the received payload and may update the stored nonce or counter value to represent the derivative nonce or counter value, thus syncing the identified wireless identity transmitter's nonce or counter and the central server nonce or counter. In an embodiment, the central server may also store in the database the central server nonce or counter (or time) at which the central server received the received payload.

In an embodiment, the central server may maintain a list (or data table) of recently received messages and the corresponding wireless identity transmitter identification. For example, the central server may record within a data table the deviceID and payload information for messages received within a certain period. The central server may compare any subsequently received payload to the data table to determine whether the subsequently received payload is redundant based on recently received payloads from the same wireless identity transmitter. For example, a subsequently received payload may represent a certain nonce or counter value from a particular wireless identity transmitter that was already received and processed by the central server a few minutes ago. This may expedite the method 2150 process and decrease search times for the operations in blocks 2164-2172. In an embodiment, the central server may expunge (or clear) the data table of recently identified payloads and wireless identity transmitters and may schedule the clearing operations similarly as described in block 2176 (e.g., the recent data table may be cleaned every time the nonce or counter time period is determined to be expired).

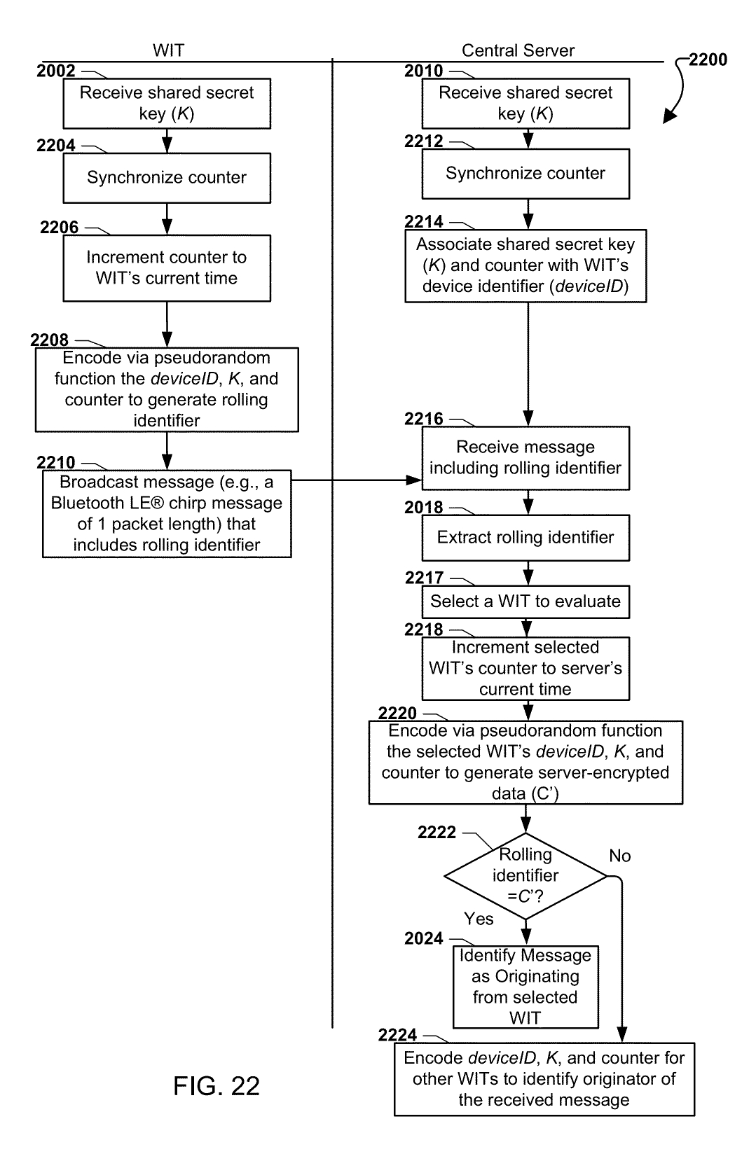

FIG. 22 illustrates another embodiment method 2200 for a central server to identify a wireless identity transmitter indicated by encrypted data within a message broadcast by the wireless identity transmitter. In the operations of the method 2200, nonce or counter values may never be included in broadcast messages to increase the security with which wireless identity transmitters transmit their identities. For example, as nonce or counter values may differ among different wireless identity transmitters, an attacker with the ability to capture a broadcast message may be able to easily predict values within future broadcast messages from the wireless identity transmitter. However, without nonce or counter data transmitted in the clear, nefarious snoopers may be better thwarted from following broadcasts from a particular wireless identity transmitter.

In block 2002, the wireless identity transmitter may receive a shared secret key (i.e., “K”). For example, each wireless identity transmitter may be pre-provisioned with a per-device shared secret key which is associated with the wireless identity transmitter's unique device identifier (or deviceID) at the central server. In block 2204, the wireless identity transmitter may synchronize a nonce or counter. The nonce or counter may be synchronized with the central server upon registration of the wireless identity transmitter at the central server. The synchronized nonce or counter value may also be associated with the deviceID and K in a data table stored in the central server (e.g., a table with stored pairs of IDs and K values).

In block 2206, the wireless identity transmitter may increment the nonce or counter to the wireless identity transmitter's current device time. For example, the nonce or counter may be incremented after a predefined number of seconds (e.g., one second, one hour, etc.). As another example, every 3600 seconds the wireless identity transmitter may increment the nonce or counter by one value. In this manner, the nonce or counter value may change to the current time as counted by the oscillator on the wireless identity transmitter. In block 2208, the wireless identity transmitter may encode via a pseudo-random function the device identifier (i.e., deviceID), the shared secret key (i.e., K), and the nonce or counter to generate a rolling identifier. In this manner, the rolling identifier may be generated as the nonce or counter value changes. In an embodiment, the pseudo-random function may be a polynomial time computable function with a seed (‘s’) and input variable (‘x’), such that when the seed is randomly selected and not known to observers, the pseudo-random function (e.g., PRF(s, x)) may be computationally indistinguishable from a random function defined on the same domain with output to the same range. For example, the Keyed-Hash Message Authentication Code (HMAC) or the Cipher-Based Message Authentication Code (CMAC) may be used as the pseudo-random function.

In block 2210, the wireless identity transmitter may broadcast a message (e.g., a Bluetooth LE chrp message of 1 packet length) that includes the rolling identifier. In an embodiment, the broadcast message (or the payload of the broadcast message) may be represented by the following equation:

Payload=MSB_{—}N(PRF(K,(deviceID∥t)))

where t is the value of the wireless identity transmitter's nonce or counter, ‘∥’ means concatenation, ‘PRF ( )’ is the pseudo-random function, and ‘MSB_N( )’ means the ‘N’ most significant bits (e.g., 80 bits). In other words, the wireless identity transmitter may intentionally obscure (or skew) the device identifier and the nonce or counter information, thus the broadcast message's payload may not include either the device identifier or the nonce or counter information in the clear.

In block 2010, the central server may receive the shared secret key (K). In block 2212, the central server may synchronize a nonce or counter. For example, the nonce or counter may be set to represent a value included in a previous message related to the wireless identity transmitter, such as a registration message. In block 2214, the central server may associate the shared secret key (i.e., K) and nonce or counter with the wireless identity transmitter's device identifier (i.e., deviceID). For example, the central server may store the deviceID, K, and nonce or counter in a data table of registered devices (e.g., in a tuple record of a database). In an embodiment, the central server may also store an indicator or flag indicating whether each wireless identity transmitter has been registered or activated.

In block 2216, the central server may receive a message including the rolling identifier. For example, the received message may be a sighting message from a proximity broadcast receiver that includes the rolling identifier broadcast by the wireless identity transmitter with the operations in block 2210. In block 2018, the central server may extract the rolling identifier, such as by parsing the received message to identify the payload of the rolling identifier.

In block 2019, the central server may select a wireless identity transmitter (i.e., selected wireless identity transmitter) to evaluate. In other words, the central server may obtain a stored deviceID, K, and nonce or counter for a registered wireless identity transmitter known to the central server, such as from the database or data table storing such information for all registered wireless identity transmitters. In block 2218, the central server may increment the selected wireless identity transmitter's nonce or counter to the server's current time. In an embodiment, the central server may then increment the stored nonce or counter value to account for the time that has elapsed since the stored nonce or counter value was synchronized. As an example, the central server may compare the time of receipt of the message with the operations in block 2216 to the central server's current time (e.g., via a central server clock or time mechanism). Based on a known periodicity that wireless identity transmitters may increment their individual nonces or counters (e.g., once every hour), the central server may increment the selected nonce or counter value to account for the time difference.

In an embodiment, the central server may only increment the selected nonce or counter an amount that represents the time between broadcasts by a wireless identity transmitter. In other words, the central server may not increment the selected nonce or counter to include the time between receiving the message within the operations in block 2216 and the time a proximity broadcast receiver received the broadcast message. For example, the proximity broadcast receiver may have buffered broadcast messages before relaying sighting messages to the central server. The central server may calculate this time difference based on metadata within the message received with the operations in block 2216. For example, a sighting message from a proximity broadcast receiver may indicate when a broadcast message was received. Thus, the amount the selected nonce or counter is incremented may be based on when the proximity broadcast receiver actually received the broadcast message and not when the message from the proximity broadcast receiver was received by the central server.

In block 2220, the central server may encode via a pseudo-random function the selected wireless identity transmitter's device identifier, secret key, and nonce or counter to generate a server-encrypted data (i.e., C′). The pseudo-random function may be the same pseudo-random function utilized in the operations in block 2208. In an embodiment, the generated server-encrypted data may be represented by the following equation:

C′=MSB_{—}N(PRF(sel_{—}K,(sel_deviceID∥sel_{—}t)))),

where sel_K is the value of the selected wireless identity transmitter's secret key, sel_deviceID is the value of the selected wireless identity transmitter's unique device identifier, sel_t is the value of the selected wireless identity transmitter's nonce or counter, ‘II’ means concatenation, ‘PRF ( )’ is the pseudo-random function, and ‘MSB_N( )’ means the ‘N’ most significant bits (e.g., 60 bits, 74 bits, 80 bits, etc.).

In determination block 2222, the central server may determine whether the generated server-encrypted data (C′) is the same as the received rolling identifier. In other words, the central server may compare the received rolling identifier to the generated server-encrypted data to determine whether they match. If the rolling identifier and the generated server-encrypted data match (i.e., determination block 2222=“Yes”), in block 2024 the central server may identify the received message as originating from the selected wireless identity transmitter (e.g., corresponding to the selected wireless identity transmitter's unique identifier).

If the rolling identifier and the generated data do not match (i.e., determination block 2222=“No”), in block 2224 the central server may encode device identifiers, secret keys, and nonces or counters for other wireless identity transmitters to identify the originator of the received message. In other words, the central server may select the next stored deviceID, nonce or counter, and K group from the database, increment that selected nonce or counter value, encode the selected deviceID, nonce or counter, and K, and compare the generated encoded data to the received rolling identifier until a match is found and the identity of the originator of the rolling identifier in the received message is known.

In an embodiment, when the wireless identity transmitter's battery has been removed and re-installed, the latest nonce or counter value may be persisted in the non-volatile memory of the wireless identity transmitter, so that the nonce or counter value can be read back from the non-volatile memory of the wireless identity transmitter when the battery is removed and then put back in. Alternatively, if no non-volatile memory is available or is not used, the wireless identity transmitter may fall back to the initial nonce or counter value after a battery re-installation. The central server may be required to be modified slightly to accommodate such a “counter synchronization”. More specifically, in addition to trying values greater than the largest nonce or counter value for the pre-computed counter or nonce list, the central server may also try values, such as (counter+i) where i=0, . . . , n, when a “counter synchronization” is performed. In this case, a wireless identity transmitter user may need to be informed that the battery needs to be re-installed when “counter synchronization” fails multiple times.

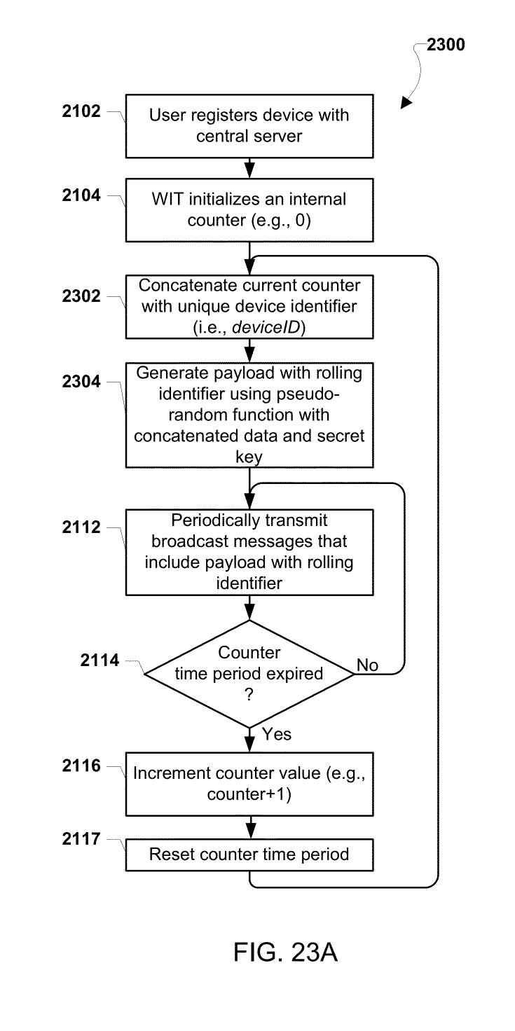

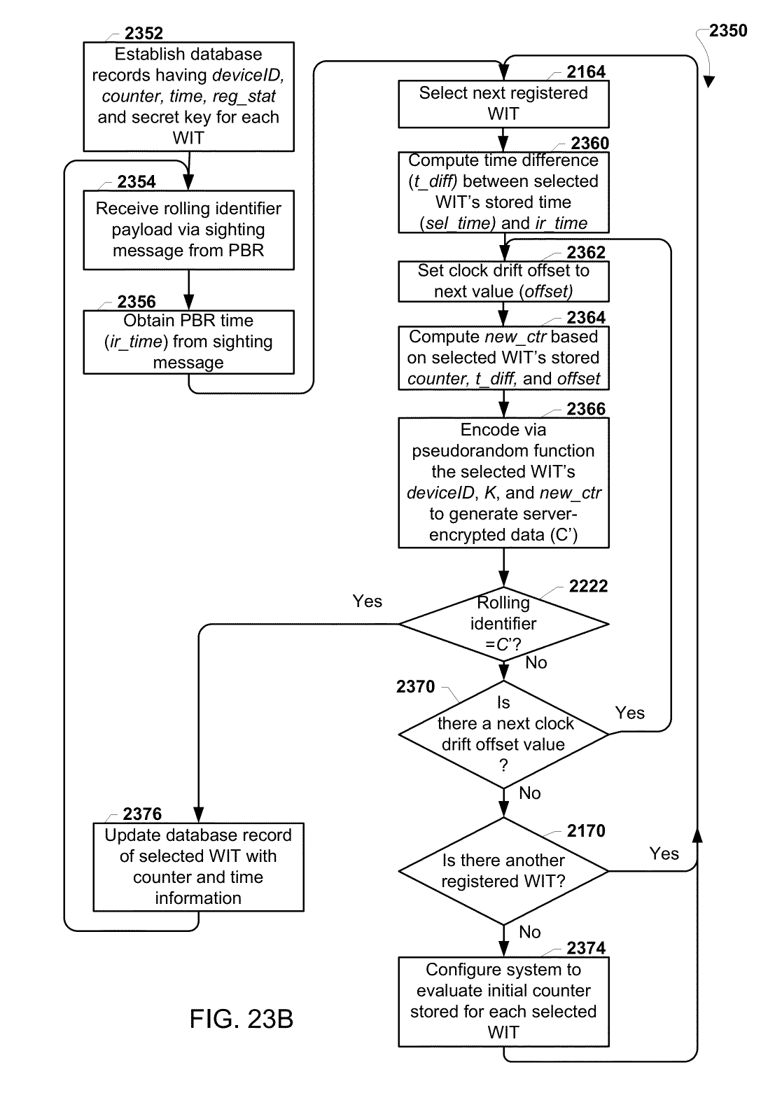

FIG. 23A illustrates an embodiment method 2300 for a wireless identity transmitter employing a pseudo-random function to generate a rolling identifier for broadcasting. The operations in the method 2300 may be similar to the embodiment method 2100 described above. However, instead of encrypting data, such as a nonce or counter value, with an AES-CTR encryption algorithm, the method 2300 may generate payloads based on the application of a pseudo-random function. As described above, the pseudo-random function and secret keys for each wireless identity transmitter may be known to both the corresponding wireless identity transmitter and a central server so that both may generate similar payloads based on similar data.

In block 2102, a user of the wireless identity transmitter may register the device with the central server. In block 2104, the wireless identity transmitter may initialize an internal nonce or counter, such as by setting the nonce or counter to a zero value. In block 2302, the wireless identity transmitter may concatenate the current nonce or counter with the wireless identity transmitter's unique device identifier (i.e., deviceID). In block 2304, the wireless identity transmitter may generate a payload with a rolling identifier using pseudo-random function with the concatenated data and the secret key. For example, the pseudo-random function may take as inputs the concatenated data (i.e., the deviceID+nonce/counter) and may use the secret key for the wireless identity transmitter as a randomness seed variable. The payload with the rolling identifier may include the output data from the pseudo-random function. In an embodiment, the payload with the rolling identifier may also include in-the-clear information regarding other aspects of the wireless identity transmitter. For example, the wireless identity transmitter may append to the payload several bits (e.g., 4 bits) of information which describe the battery status of the wireless identity transmitter. In an embodiment, the pseudo-random function may be a polynomial time computable function that is computationally indistinguishable from a random function defined on the same domain with output to the same range as the pseudo-random function. For example, the keyed hash Message Authentication Code (HMAC) or the Cipher-based Message Authentication Code (CMAC) may be used as the pseudo-random function. In an embodiment, the wireless identity transmitter may or may not perform a truncation operation to the generated rolling identifier payload. For example, the payload with the rolling identifier may be the result of performing a most-significant-bit operation on the results of the pseudo-random function.

In block 2112, the wireless identity transmitter may periodically transmit broadcast messages that include the payload with the rolling identifier, such as by broadcasting via short-range wireless communication techniques as described above. In determination block 2114, the wireless identity transmitter may determine whether a predefined nonce or counter time period has expired. If the nonce or counter time period has not expired (i.e., determination block 2114=“No”), the wireless identity transmitter may continue with the operations in block 2112. If the device determines the nonce or counter time period has expired (i.e., determination block 2114=“Yes”), in block 2116 the wireless identity transmitter may increment the nonce or counter value, such as by adding 1. In block 2117, the wireless identity transmitter may reset the nonce or counter time period, and may continue with the operations in block 2302.

FIG. 23B illustrates an embodiment method 2350 for a central server responding to received messages containing pseudo-random function rolling identifiers. The embodiment method 2350 operations may be similar to the operations described above with reference to FIG. 21B, with the exception that the central server may compare outputs of a pseudo-random function with time-synchronized information stored in the central server to match payloads in messages received from wireless identity transmitters.

In block 2352, the central server may establish database records having device identifier (i.e., deviceID), nonce or counter, time, registration status (i.e., ‘reg_stat’), and secret key (i.e., ‘K’) information for each wireless identity transmitter in a system. The time may indicate the last time the central server received a message corresponding to a particular wireless identity transmitter (e.g., a sighting message relaying a broadcast message), or in other words, the central server clock value at the moment when the nonce or counter value for a wireless identity transmitter was received/recorded in the database. It may be assumed that the period between when a wireless identity transmitter broadcasts a message with a rolling identifier (or rolling identifier payload) and when the central server receives the rolling identifier is very short. Thus, the stored nonce or counter and time values may be assumed to create a roughly accurate clock status of a wireless identity transmitter.

Additionally, once a wireless identity transmitter transmits registration information, the central server may indicate a valid registration by setting a registration flag in the database for the wireless identity transmitter (e.g. ‘reg_stat’). The central server may query the database for all wireless identity transmitter records where the reg_stat indicates a valid registration has been conducted and may create data tables that include only registered wireless identity transmitters based on the reg_stat values.

In block 2354, the central server may receive a rolling identifier payload via a sighting message from a proximity broadcast receiver. The sighting message may have time information appended to the payload that describes the time at which the proximity broadcast receiver encountered the payload via a broadcast message from the respective wireless identity transmitter. For example, a payload may be received by a smartphone proximity broadcast receiver which in turn may append its own system clock reading to the payload information and transmit the data to the central server as a sighting message. The time measurement provided by the proximity broadcast receiver may be approximately synchronized with the central server system time. In an embodiment, the proximity broadcast receiver may append other additional information to the sighting message, such as location information (e.g., GPS coordinates) of the proximity broadcast receiver. In block 2356, the central server may obtain a proximity broadcast receiver time (i.e., ‘ir_time’) from the sighting message, such as indicated within the sighting message. For example, the central server may parse the sighting message and extract a time value indicating when the proximity broadcast receiver received a broadcast message that corresponds to the rolling identifier payload.

In blocks 2164-2374, the central server may perform an operational loop in which the central server may evaluate all registered wireless identity transmitters stored within the central server's database to find a device record that matches the received rolling identifier payload. In block 2164, the central server may select a next registered wireless identity transmitter. For example, the central server may iteratively select the next wireless identity transmitter represented in a data table of all wireless identity transmitters that have the reg_stat variable set to indicate registration occurred. The central server may sequentially iterate through such a data table or list for each device during the operations in blocks 2164-2374. In an embodiment, the central server may access a stored database record corresponding to the selected registered wireless identity transmitter that contains the current values for the information established with registration operations in block 2352.

In block 2360, the central server may compute the time difference (i.e., ‘t_diff’) between the time indicated in the sighting message (ir_time) and the time stored within the database record of the selected registered wireless identity transmitter (i.e., ‘sel_time’). For example, the t_diff value may be a non-zero or a zero value. This time difference may be a measure of the expected elapsed time between instances of the central server receiving payloads from the selected wireless identity transmitter.

In block 2362, the central server may set a clock drift offset (i.e., ‘offset’) to a next value. In general, the central server may account for possible wireless identity transmitter clock drift (e.g., inaccurate device system clock readings) by setting the clock drift offset value. The clock drift offset values may represent offsets that, when applied to nonce or counter values, may represent nonces or counters lower, the same, or higher than an expected nonce or counter value. In other words, the clock drift offsets may represent time before, during, or after the time represented by the current nonce or counter for the selected registered device. The clock drift offset value may be one of a sequence of clock drift offset values. In an embodiment, the clock drift offset value may be 0. In an embodiment, possible clock drift offset values may include numbers within a set {−N, . . . , −1, 0, 1, . . . , N}, where N is an arbitrary number.

In block 2364, the central server may compute an expected nonce or counter value (i.e., ‘new_ctr’) using the selected wireless identity transmitter's stored nonce or counter value, the computed time difference (i.e., t_diff) and the set offset value (i.e., offset). As described above, the nonce or counter may be stored within the selected registered wireless identity transmitter database record. For example, the central server may calculate new_ctr by adding the clock drift offset value to the sum of the t_diff value and the stored nonce or counter value.

In determination block 2366, the central server may encode via a pseudo-random function the selected wireless identity transmitter's device identifier, secret key, and computed nonce or counter (i.e., new_ctr) to generate a server-encrypted data (i.e., C′). The pseudo-random function may be the same pseudo-random function utilized by a wireless identity transmitter as described above with reference to FIG. 23A.

In determination block 2222, the central server may determine whether the generated server-encrypted data (C′) is the same as the received rolling identifier. In other words, the central server may compare the received rolling identifier to the generated server-encrypted data to determine whether they match. If the rolling identifier and the generated server-encrypted data match (i.e., determination block 2222=“Yes”), the central server may identify the received message as originating from the selected wireless identity transmitter (e.g., corresponding to the selected wireless identity transmitter's unique identifier). In an embodiment, the secret key (K) may be the seed value of the pseudo-random function. In an embodiment, the central server may concatenate the selected wireless identity transmitter's deviceID and the computed new_ctr value and provide that concatenated data to the pseudo-random function. The pseudo-random function may return (or output) encrypted data having a similar structure as received rolling identifier payload.

If the rolling identifier, such as received in the sighting message, and the generated server-encrypted data (i.e., C′) match (i.e., determination block 2222=“Yes”), in block 1276 the central server may update the database record of the selected wireless identity transmitter with the nonce or counter and time information, such as the new_ctr and the it time. For example, the central server may update the database record's time value to represent the time of receipt of the payload within the proximity broadcast receiver (e.g., irtime) and may also update the stored nonce or counter value to represent the new_ctr value. The central server may continue with the operations in block 2354.

If the rolling identifier, such as received in the sighting message, and the generated server-encrypted data (i.e., C′) do not match (i.e., determination block 2222=“No”), the central server may determine whether there is a next clock drift offset value in determination block 2370. In other words, the central server may determine whether new_ctr values have been computed using all possible clock drift offset values (e.g., −1, 0, 1, etc.). If there is a next clock drift offset value (i.e., determination block 2370=“Yes”), the central server may continue with the operations in block 2362. However, if there is not a next clock drift offset value (i.e., determination block 2370=“No”), in determination block 2170, the central server may determine whether there is another registered wireless identity transmitter to evaluate. If there is another registered wireless identity transmitter to evaluate (i.e., determination block 2170=“Yes”), the central server may continue with the operations in block 2164. However, if there is no other registered wireless identity transmitter (i.e., determination block 2170=“No”), in block 2374 the central server may configure the system to evaluate initial nonce or counter values stored for each registered wireless identity transmitter. In an embodiment, the registration database described above may further include data that represents the initial nonce or counter value corresponding to each registered wireless identity transmitter. This initial nonce or counter value may be used if/when the various wireless identity transmitters are rebooted or otherwise reset their nonces or counters. For example, a wireless identity transmitter may operate and deliver payloads describing non-initial nonces or counters for a period of time before resetting its internal nonce or counter due to battery replacement. In such a scenario, the wireless identity transmitter may broadcast messages that include rolling identifier payloads based on reset nonce or counter information.

In another embodiment, the operations in block 2374 may be performed for individual registered selected devices during the operational loop in blocks 2362-2370, wherein the stored nonce or counter value in block 2364 may be replaced with the initial stored nonce or counter value. For example, once the central server determines a selected registered wireless identity transmitter's stored nonce or counter value with the various clock drift offset values cannot be used to generate encrypted data that matches the received rolling identifier payload, the central server may evaluate the initial stored nonce or counter value of the selected wireless identity transmitter before selecting the next registered wireless identity transmitter.

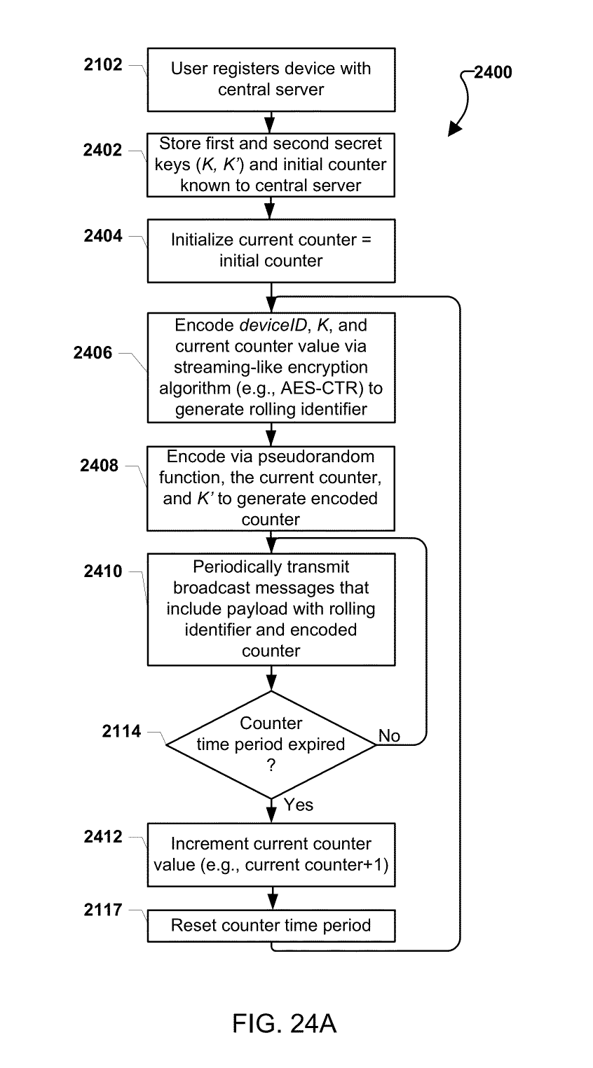

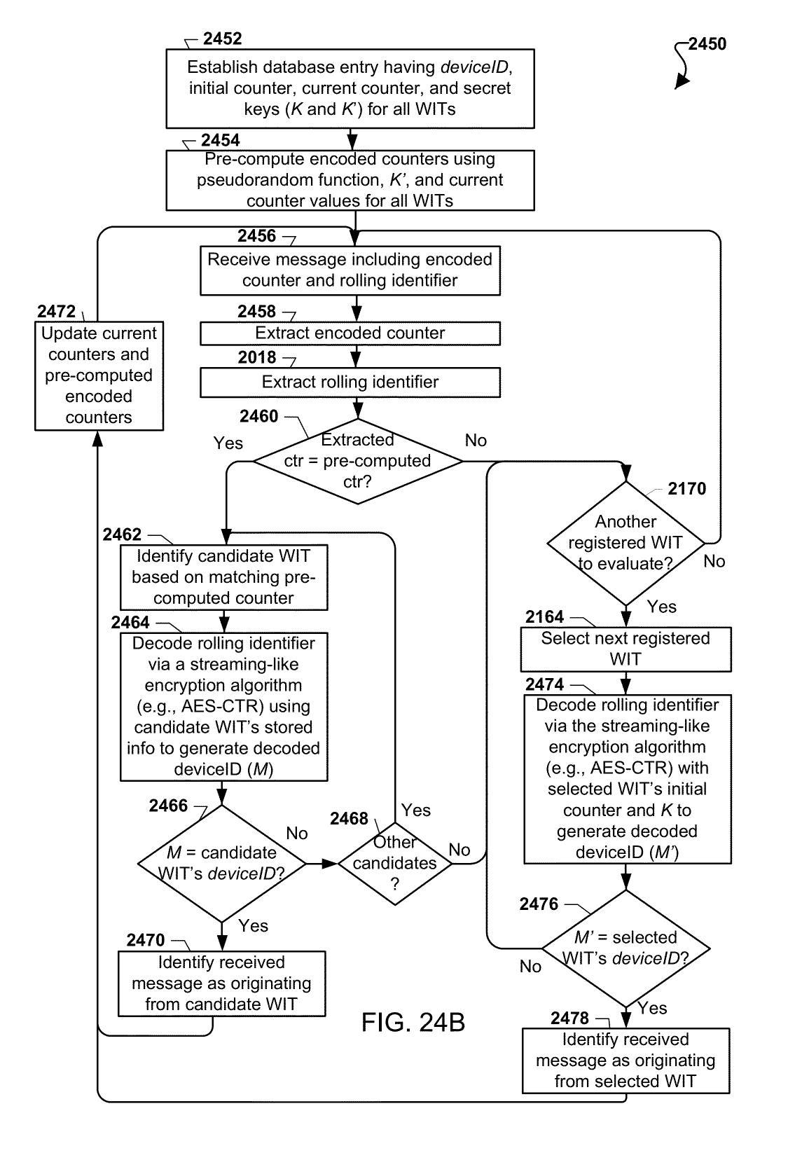

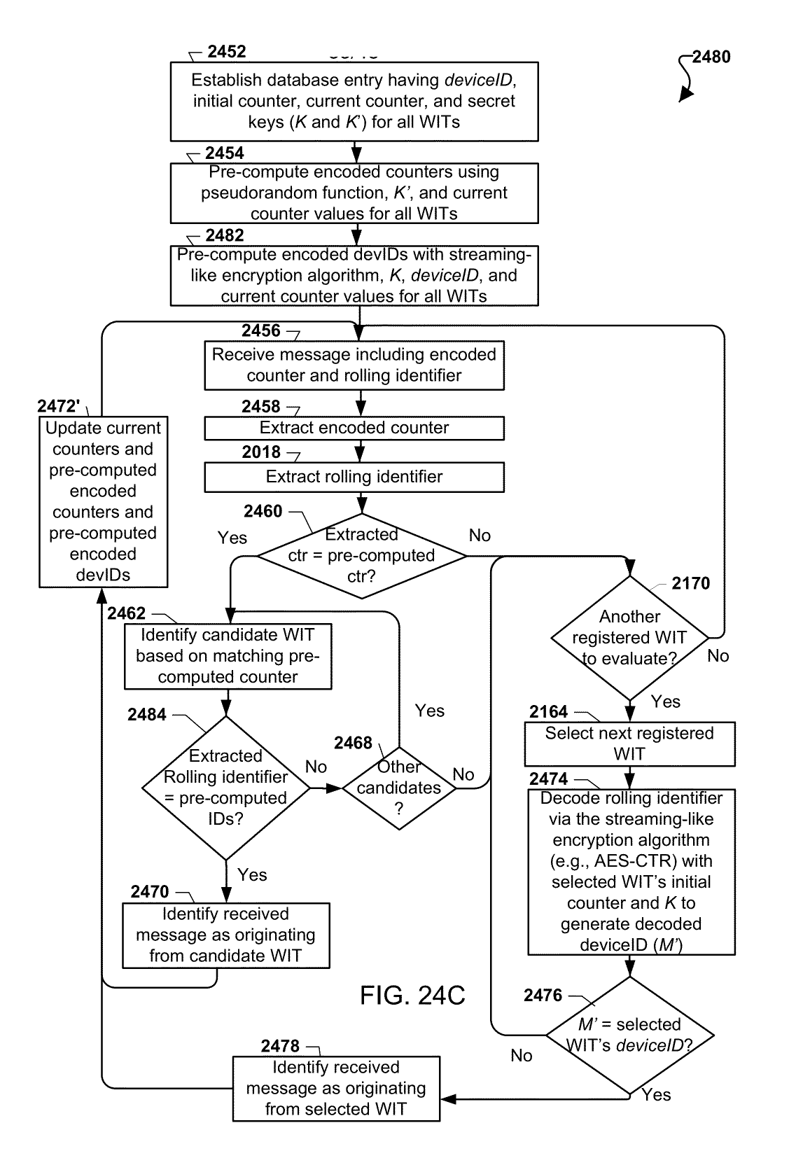

FIG. 24A illustrates an embodiment method 2400 for a wireless identity transmitter generating and broadcasting messages with rolling identifiers and encoded nonces or counters. The method 2400 may have operations performed by a wireless identity transmitter that are similar to those described above with reference to FIGS. 20, 21A, 22, and 23A. However, the method 2400 may involve broadcasting messages that include a rolling identifier (i.e., an encoded device identifier) as well as an encoded nonce or counter that may be evaluated separately by the central server with the operations described below with reference to FIG. 24B. In this manner, the wireless identity transmitter's nonce or counter value (or nonce) may not be sent in the clear in the payload of the broadcast message.

In block 2102, a user of the wireless identity transmitter may register the device with the central server. For example, the wireless identity transmitter may provide the unique device identifier (i.e., deviceID) to a central server for storage in a database of registered wireless identity transmitters. In block 2402, the wireless identity transmitter may store a first secret key (K) and a second secret key (K′) and an initial nonce or counter that are known to the central server. For example, these values may be shared between the central server and the wireless identity transmitter during registration operations described in this disclosure. In block 2404, the wireless identity transmitter may initialize a current nonce or counter by setting it to the value of the initial nonce or counter value.

Similar to as described above with reference to FIG. 20, in block 2406, the wireless identity transmitter may encode the device identifier (deviceID), the first secret key (K), and the current nonce or counter via a streaming-like encryption algorithm (e.g., AES-CTR) to generate a rolling identifier. In block 2408, the wireless identity transmitter may encode via a pseudo-random function, the current nonce or counter, and the second secret key (K′) to generate an encoded counter or nonce. In an embodiment, the encoded nonce or counter may be represented by the following equation:

Encoded nonce/counter=MSB_{—}M(PRF(K′,t)),

where ‘K′’ is a per-device second secret key (usually different from the first per-device secret key K), ‘t’ is the current nonce or counter, PRF( )’ is the pseudo-random function, and ‘MSB_M( )’ means the ‘M’ most significant bits (e.g., 20 bits).

In block 2410, the wireless identity transmitter may periodically transmit broadcast messages that include the payload with the rolling identifier and the encoded nonce or counter. In determination block 2114, the wireless identity transmitter may determine whether a predefined nonce or counter time period has expired. If the nonce or counter time period has not expired (i.e., determination block 2114=“No”), the wireless identity transmitter may continue with the operations in block 2410. If the device determines the nonce or counter time period has expired (i.e., determination block 2114=“Yes”), in block 2412 the wireless identity transmitter may increment the current nonce or counter value, such as by adding 1. In block 2117, the wireless identity transmitter may reset the nonce or counter time period and may continue with the operations in block 2406.

FIG. 24B illustrates an embodiment method 2450 for a central server receiving and handling messages including rolling identifiers and encoded nonces or counters. The central server may perform the operations of method 2450 in combination or response to a wireless identity transmitter performing the method 2400 described above. The method may include two passes: a first pass wherein the central server attempts to identify a wireless identity transmitter based on an encoded nonce or counter within a received message (e.g., a sighting message), and a second pass wherein the central server attempts the identification based on a rolling identifier to within the received message

In block 2452, the central server may establish a database entry having a device identifier (i.e., deviceID), initial nonce or counter, current nonce or counter, and secret keys (K and K′) for all wireless identity transmitters in the system. The current nonce or counter values may be the same as the initial nonces or counters at the time of registration of wireless identity transmitters. In block 2454, the central server may pre-compute encoded nonces or counters using a pseudo-random function, the second secret key (K′), and current nonce or counter values for all wireless identity transmitters. For example, the central server may generate a plurality of encoded nonce or counter values for each registered wireless identity transmitter, such as one based on the current nonce or counter value, another based on a value one larger than the current counter value, etc. In an embodiment, the central server may pre-compute 24 encoded nonce or counters for each registered wireless identity transmitter. In an embodiment, the central server may store a separate list (or data table) of the pre-computed encoded nonces or counters for all registered wireless identity transmitters that also includes the device identifiers associated with each stored pre-computed encoded nonce or counter.

In block 2456, the central server may receive a message including an encoded nonce or counter and a rolling identifier, such as within a sighting message transmitted by a proximity broadcast receiver. In block 2458, the central server may extract an encoded nonce or counter from the received message, and in block 2018 may extract a rolling identifier from the received message. In determination block 2460, the central server may determine whether the extracted nonce or counter (or ‘ctr’) matches any of the pre-computed nonce or counters. For example, the central server may compare the encoded nonce or counter value extracted from the received message to the plurality of central server-encoded nonce or counter values for each registered wireless identity transmitter to identify any matches. If the extracted nonce or counter matches a pre-computed nonce or counter (i.e., determination block 2460=“Yes”), in block 2462 the central server may identity a candidate wireless identity transmitter based on the matching pre-computed nonce or counter. In other words, the central server may identity the candidate as the deviceID stored in relation to the pre-computed nonce or counter in a data table in the central server. In block 2464, the central server may decode the rolling identifier via a streaming-like encryption algorithm (e.g., the same AES-CTR wireless identity transmitters use when performing the operations in FIG. 24A) using the candidate wireless identity transmitter's stored information (e.g., deviceID, secret key, etc.) to find a decoded device identifier (or M). In determination block 2466, the central server may determine whether the decoded device identifier (M) matches the candidate wireless identity transmitter's deviceID. Such a match may enable the central server to identify the wireless identity transmitter associated with that received rolling identifier without decoding the rolling identifier or the encoded nonce or counter value. If the deviceID and decoded identifier (M) match (i.e., determination block 2466=“Yes”), in block 2470 the central server may identity the received message as originating from the candidate wireless identity transmitter. In block 2472, the central server may update current nonces or counters and pre-computed encoded nonces or counters. For example, the database entry for the wireless identity transmitter identified as the originator of the received message may be updated with new current nonce or counter information as well as new pre-computed encoded nonces or counters. Additionally, any stored lists of pre-computed encoded nonces or counters may have older pre-computed encoded nonces or counters removed at the same time newly computed encoded nonces or counters corresponding to the identified wireless identity transmitter are added to the list. In another embodiment, if the wireless identity transmitter identified as the originator of the received message is indicated in the central server's database as “not activated” (i.e., a flag is not set), then the central server may also adjust the database to reflect that the identified wireless identity transmitter is now activated (e.g., set a flag). The central server may then continue with the operations in block 2456.

If the deviceID and decoded identifier (M) do not match (i.e., determination block 2466=“No”), in determination block 2468, the central server may determine whether there are other candidates, such as other registered wireless identity transmitters that have not been evaluated by the central server. If there are other candidates (i.e., determination block 2468=“Yes”), the central server may continue with the operations in block 2462, such as by identifying the next wireless identity transmitter to evaluate regarding the rolling identifier.

If there are no other candidates (i.e., determination block 2468=“No”), or if the extracted nonce or counter does not match the pre-computed nonce or counter (i.e., determination block 2460=“No”), the central server may attempt to identify the originator of the received message by comparing the extracted rolling identifier to information associated with all registered wireless identity transmitters in the system. Thus, in determination block 2170 the central server may determine whether there is another registered wireless identity transmitter to evaluate. For example, the central server may iteratively use information of all registered wireless identity transmitters. If there is not another (i.e., determination block 2170=“No”), the central server may continue with the operations in block 2456.

If there is another (i.e., determination block 2170=“Yes”), in block 2164 the central server may select the next registered wireless identity transmitter. In block 2474, the central server may decode the rolling identifier via the streaming-like encryption algorithm (e.g., AES-CTR) with the selected wireless identity transmitter's initial nonce or counter and first secret key (K) to find a decoded device identifier (M′), similar to as described above with reference to FIG. 20. In determination block 2476, the central server may determine whether the decoded device identifier (M′) matches the selected wireless identity transmitter's deviceID. If the identifiers do not match (i.e., determination block 2476=“No”), the central server may continue with the operations in determination block 2170. However, if the identifiers match (i.e., determination block 2476=“Yes”), in block 2478 the central server may identify the received messages as originating from the selected wireless identity transmitter, and may continue with the operations in block 2472.

FIG. 24C illustrates an embodiment method 2480 for a central server receiving and handling messages including rolling identifiers and encoded nonces or counters. The operations of method 2480 are similar to the operations of method 2450, except that rather than perform a two pass process as discussed above in FIG. 24B, the central server may perform method 2480 as a one pass process. In particular, the central server may generate both a plurality of central server encrypted nonce or counter values for each registered wireless identity transmitter and a plurality of central server-encrypted device identifiers (i.e., deviceID). The central server may use the data stored in the database for each wireless identity transmitter (e.g., deviceID, K, K′, initial nonce or counter, and current nonce or counter) and the plurality of pre-computed nonce or counter values for each device to encode a plurality of central server encrypted nonce or counter values and a plurality of server encrypted device IDs. When the central server receives the sighting message including the rolling identifier and encoded nonce or counter, the central server may compare the plurality of central server encrypted nonce or counter values and the plurality of central server encoded device IDs to the rolling identifier and encoded nonce or counters obtained from the received sighting message. The device identifier of the wireless identity transmitter that originated the rolling identifier may then be identified based entirely on matching the pre-computed nonce or counter values and device identifiers without requiring actual decoding of the rolling identifier itself.

In block 2452, the central server may establish a database entry having a device identifier (i.e., deviceID), initial nonce or counter, current nonce or counter, and secret keys (K and K′) for all wireless identity transmitters in the system. In block 2454, the central server may pre-compute encoded nonces or counters using a pseudo-random function, the second secret key (K′), and current nonce or counter values for all wireless identity transmitters. In block 2482, the central server may pre-compute encoded device identifiers with a streaming-like encryption algorithm (e.g., AES-CTR block cipher), the device identifier, current nonce or counter, and the first secret key (K) for all wireless identity transmitters. In other words, the central server may generate a plurality of encoded device identifiers for each registered wireless identity transmitter, such as by using the current nonce or counter and predefined offset nonce or counter values, or alternatively, only a single encoded device identifier based only on the current nonce or counter stored within the central server.

In block 2456, the central server may receive a message including an encoded nonce or counter and a rolling identifier, such as within a sighting message transmitted by a proximity broadcast receiver. In block 2458, the central server may extract an encoded nonce or counter from the received message, and in block 2018 may extract a rolling identifier from the received message. In determination block 2460, the central server may determine whether the extracted nonce or counter (or ‘ctr’) matches any of the pre-computed nonces or counters. If the extracted nonce or counter matches a pre-computed nonce or counter (i.e., determination block 2460=“Yes”), in block 2462 the central server may identity a candidate wireless identity transmitter based on the matching pre-computed nonce or counter. In determination block 2484, the central server may determine whether the extracted rolling identifier matches any of the pre-computed identifiers, such as the pre-computing device identifiers for the candidate wireless identity transmitter.

If the extracted rolling identifier does match any of the pre-computed identifiers for the candidate wireless identity transmitter (i.e., determination block 2484=“Yes”), in block 2470 the central server may identity the received message as originating from the candidate wireless identity transmitter. In block 2472′, the central server may update current nonces or counters and pre-computed encoded nonces or counters and pre-computed encoded device identifiers. For example, the database entry for the wireless identity transmitter identified as the originator of the received message may be updated with new current nonce or counter information as well as new pre-computed encoded nonces or counters and pre-computed encoded device identifiers. Additionally, any stored lists of pre-computed encoded nonces or counters may have older pre-computed encoded nonces or counters or encoded device identifiers removed at the same time newly computed encoded nonces or counters or device identifiers corresponding to the identified wireless identity transmitter are added to the list.

In another embodiment, if the wireless identity transmitter identified as the originator of the received message is indicated in the central server's database as “not activated” (i.e., a flag is not set), then the central server may also adjust the database to reflect that the identified wireless identity transmitter is now activated (e.g., set a flag). The central server may then continue with the operations in block 2456.

If the extracted rolling identifier does not match any of the pre-computed identifiers for the candidate wireless identity transmitter (i.e., determination block 2484=“No”), in determination block 2468, the central server may determine whether there are other candidates, such as other registered wireless identity transmitters that have not been evaluated by the central server. If there are other candidates (i.e., determination block 2468=“Yes”), the central server may continue with the operations in block 2462, such as by identifying the next wireless identity transmitter to evaluate regarding the rolling identifier.

If there are no other candidates (i.e., determination block 2468=“No”), or if the extracted nonce or counter does not match the pre-computed nonce or counter (i.e., determination block 2460=“No”), the central server may attempt to identify the originator of the received message by comparing the extracted rolling identifier to information associated with all registered wireless identity transmitters in the system. Thus, in determination block 2170 the central server may determine whether there is another registered wireless identity transmitter to evaluate. For example, the central server may iteratively use information of all registered wireless identity transmitters. If there is not another (i.e., determination block 2170=“No”), the central server may continue with the operations in block 2456.

If there is another (i.e., determination block 2170=“Yes”), in block 2164 the central server may select the next registered wireless identity transmitter. In block 2474, the central server may decode the rolling identifier via the streaming-like encryption algorithm (e.g., AES-CTR) with the selected wireless identity transmitter's initial nonce or counter and first secret key (K) to find a decoded device identifier (M′). In determination block 2476, the central server may determine whether the decoded device identifier (M′) matches the selected wireless identity transmitter's deviceID. If the identifiers do not match (i.e., determination block 2476=“No”), the central server may continue with the operations in determination block 2170. However, if the identifiers match (i.e., determination block 2476=“Yes”), in block 2478 the central server may identify the received messages as originating from the selected wireless identity transmitter, and may continue with the operations in block 2472′.

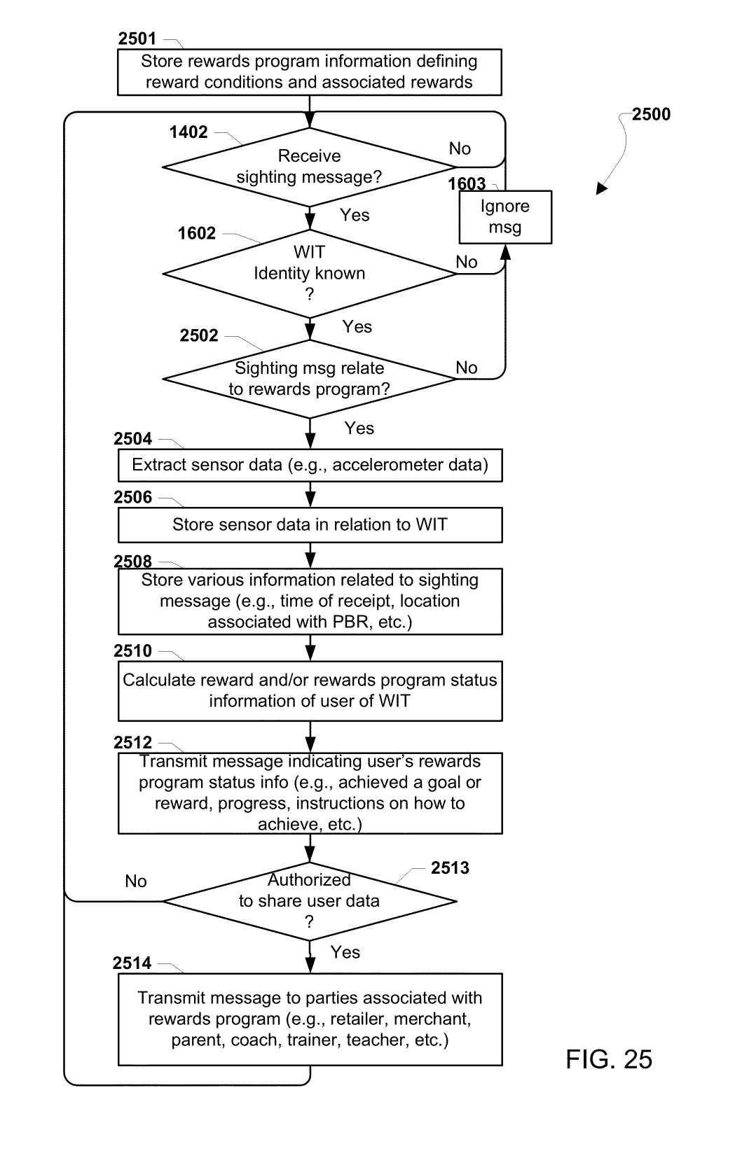

FIG. 25 illustrates an embodiment method 2500 for a central server calculating rewards information in response to receiving sighting messages related to a wireless identity transmitter. The central server may calculate or otherwise determine rewards in response to receiving sighting messages that indicate the user's behavior. In particular, the user's wireless identity transmitter may include various sensors, such as an accelerometer configured to measure motion data. The wireless identity transmitter may include sensor data within broadcast messages that are delivered to the central server via a sighting message from a proximity broadcast receiver. Once detected within the sighting message, the central server may use the sensor data to calculate rewards information related to a rewards program maintained by the central server. For example, accelerometer data indicating a high amount of motion may be used to estimate a child's activity for a period of time. Based on the activity, the central server may calculate that the child has earned a ‘congratulations’ SMS message reward for meeting a certain daily activity level prescribed by a fitness rewards program.

In block 2501, the central server may store rewards program information defining reward conditions and associated rewards. In particular, the central server may store conditions for operating a rewards program that may be executed as a service, process, thread, or other routine via the central server. Such conditions may include windows of time, geographical areas (e.g., GPS coordinates), and periodicity (e.g., a certain number of times for every hour, day, week, etc.), and may be linked or associated with various prizes, incentives, or benefits. For example, a first coupon may be associated with a first geofence condition within a restaurant (e.g., a geofence at the entry), and a second coupon may be associated with a second geofence condition within the restaurant (e.g., a geofence at a bar within the restaurant). Such reward program information may be provided by registered services, users, or various parties that intend to influence the behavior of users registered (or known) within the central server. The stored reward program information may also include equations and/or rule sets for calculating rewards for the rewards program. For example, the stored information may indicate that a single reward credit (e.g., an hour of television time) may be awarded to a user of a wireless identity transmitter when that wireless identity transmitter is detected within proximity of the user's junior high school during school hours. In an embodiment, the central server may store information that indicates how often or how many times a particular award may be awarded to a user. For example, the central server may store rules that indicate each unique user may only ever receive a single coupon when entering a certain area within a shopping mall or amusement park.

In determination block 1402, the central server may determine whether a sighting message is received. The central server may evaluate a receiving circuit, buffer, queue or other indicator to determine when messages are received from various devices, such as proximity broadcast receivers. In an embodiment, the central server may utilize a network module as described above to determine whether a sighting message is received. In general, sighting messages may be received via long-range communications, such as packets transmitted via a cellular network over the Internet. As described above, the central server may receive a sighting message from a proximity broadcast receiver in response to the proximity broadcast receiver receiving a broadcast message from the wireless identity transmitter. Such as proximity broadcast receiver may include a smartphone carried by the user of the wireless identity transmitter, a stationary proximity broadcast receiver positioned around a place (e.g., home, school, daycare, etc.), a parent's smartphone, etc., and the wireless identity transmitter may be carried by a child, elderly person, pet, or other individual to track. If the central server does not receive a sighting message (i.e., determination block 1402=“No”), the central server may continue with the operations in determination block 1402.

If the central server does receive a sighting message (i.e., determination block 1402=“Yes”), in determination block 1062 the central server may determine whether the wireless identity transmitter identity is known. In other words, the central server may perform the operations to determine whether the sighting message indicates a wireless identity transmitter identity (or identifier) that is associated with a user registered with the central server. If the wireless identity transmitter is not known (i.e., determination block 1602=“No”), in block 1603 the central server may ignore the sighting message and continue to perform the operations in determination block 1402. If the wireless identity transmitter is known (i.e., determination block 1602=“Yes”), in determination block 2502 the central server may determine whether the sighting message relates to a rewards program, such as a program related to the rewards program information stored with the operations in block 2501. For example, the central server may compare the identification information of the wireless identity transmitter (e.g., decrypted/decoded rolling identifier) to a list of users that have registered to participate in an activity rewards program. Alternatively, the central server may determine whether the sighting message is related to a rewards program based on metadata which indicates the rewards program (e.g., a metadata code that indicates affiliation with a particular merchant's rewards program). In an embodiment, the central server may also authenticate the received sighting message based on metadata within the sighting message (e.g., metadata identifying the proximity broadcast receiver that transmitted the sighting message). If the message does not relate to the rewards program (i.e., determination block 2502=“No”), the central server may continue with the operations in block 1603. However, if the message relates to the rewards program (i.e., determination block 2502=“Yes”), in block 2504 the central server may extract sensor data, such as from metadata indicated within from the sighting message or otherwise encoded or encrypted within the sighting message. For example, the central server may detect that the sighting message includes a broadcast message that indicates accelerometer sensor data, thermometer sensor data, and/or pulse sensor data within its payload. In block 2506, the central server may store the extracted sensor data in relation to the wireless identity transmitter, for example, by storing the sensor data in a database entry that is linked to the user or the device identifier of the user's wireless identity transmitter. As another example, the central server may maintain a database for the rewards program that stores sensor data for each registered user. As described above, in block 2508, the central server may also store various information related to the sighting message, such as the time of receipt of the sighting message, and location information (e.g., GPS coordinates) of the proximity broadcast receiver at the time of receipt of the broadcast message. In an embodiment, the central server may generate statistical information, such as median, mean, minimum, and maximum values for reported sensors of the wireless identity transmitter, and may also calculate trending information for the sensor data based on particular time periods (e.g., months, years, days, daytime, nighttime, etc.) and conditions (e.g., sensor data reported while at school, inside, outside, in room, etc.). In other embodiments, the central server may maintain statistical information for any devices associated with the rewards program. For example, the central server may generate statistics that indicates how many devices achieved rewards within a period.

In block 2510, the central server may calculate a reward and/or a rewards program status information of the user associated with the wireless identity transmitter. The central server may calculate the reward and/or reward status information by comparing some or all of the user's information stored within the database to the stored reward program information. For example, the central server may compare the user's current stored sensor data to stored program threshold values to determine whether a reward was achieved. The reward program status information (or status) may be an assessment of the user's progress towards a certain goal or achievement. For example, the central server may calculate how close the user is to completing his daily target of physical activity as prescribed by a fitness rewards program (e.g., a percentage of completion). As another example, the central server may calculate status information that indicates the user's activity for the month is worse than the previous month.

In an embodiment, the central server may determine rewards and/or indicators of progress based on the stored sensor data received for the user over a period of time. Based on the stored rewards program information, the central server may attribute a certain amount of rewards for certain levels of calculated progress towards a goal for a certain period of time. For example, the user may be awarded several reward “points,” coupons, or privileges for completing an activity goal for the day. As another example, the central server may award additional rewards when a user's activity data occurs outside of the house as opposed to within the user's room.

In block 2512, the central server may transmit a message indicating the user's rewards program status information. For example, upon receiving sensor data related to the rewards program, the central server may transmit a message to the smartphone of the user. The message may be an email, SMS text message, telephonic message, or other procedurally generated communication. The message may include indications of the progress or status towards achieving a goal or reward (e.g., “You're 50% done exercising!” or “You've almost earned that cookie!”), statistics of the user's performance in relation to time periods or conditions, information about the variables used to calculate the status, and instructions on how to achieve goals, rewards, or how to be awarded more rewards points. In an embodiment, the message may also include indications of achieved rewards, such as coupons, prizes, encouraging messages, benefits, accolades, special offers, and other incentives for the user to continue using the rewards program. For example, based on meeting an activity goal for the day, the user may receive an email indicating an award of an extra hour of television use in his/her house. As another example, for jumping up and down for a period of time during gym class, the child may get a school pass to eat lunch outside. In an embodiment, the message may be accessed, rendered, and otherwise utilized by applications, software, and/or services executing on the user's mobile device. For example, the message may be formatted so that a retail store app running on the user's smartphone may display a store coupon to the user.

In determination block 2513, the central server may determine whether it is authorized to share the user's data, such as the user's identity and/or rewards program status information. In other words, based on permissions settings associated with the user, the central server may determine whether the user should be anonymous or identified to other parties related to the rewards program (e.g., a merchant, a parent, etc.). The central server may base this determination on permissions information stored in the central server with relation to the user, such as within a profile linked to the user's identity (or the identity of the user's wireless identity transmitter). For example, the user may have indicated during a registration process that he/she only authorizes the central server to share his reward program status with his/her parents. If the central server is not authorized to share user data (i.e., determination block 2513=“No”), the central server may continue with the operations in determination block 1402. This authorization determination is important as it may enable the central server to anonymously distribute rewards to users, such as anonymously transmitting coupons, promotions, discounts, or other attractive information to customers without identifying the customers to merchants associated with the rewards.

If the central server is authorized to share the user's data (i.e., determination block 2513=“Yes”), in block 2514, the central server may also transmit a message to parties associated with the rewards program. Such parties may include the retailer or merchant that developed the reward program to distribute coupons, or alternatively support parties related to the user. Support parties may include any persons indicated in the central server that may need to be informed of the user's reward program status, such as a caregiver, a parent, a teacher, a coach, and a trainer. For example, if the rewards program regards physical activity of children in school, the central server may send a message to a gym teacher indicating information about the user's participation in the rewards program. The message may include the user's reward program status information, such as indicators of the user's progress towards achieving a goal or prize as well as any rewards the user has received (e.g., codes of coupons or privileges the user has received). In an embodiment, the message may also include instructions on how to assist the user achieve the rewards program goals. For example, the gym teacher may receive a text message indicating that he/she should go encourage the user who is not active during gym class. The central server may continue with the operations in determination block 1402.

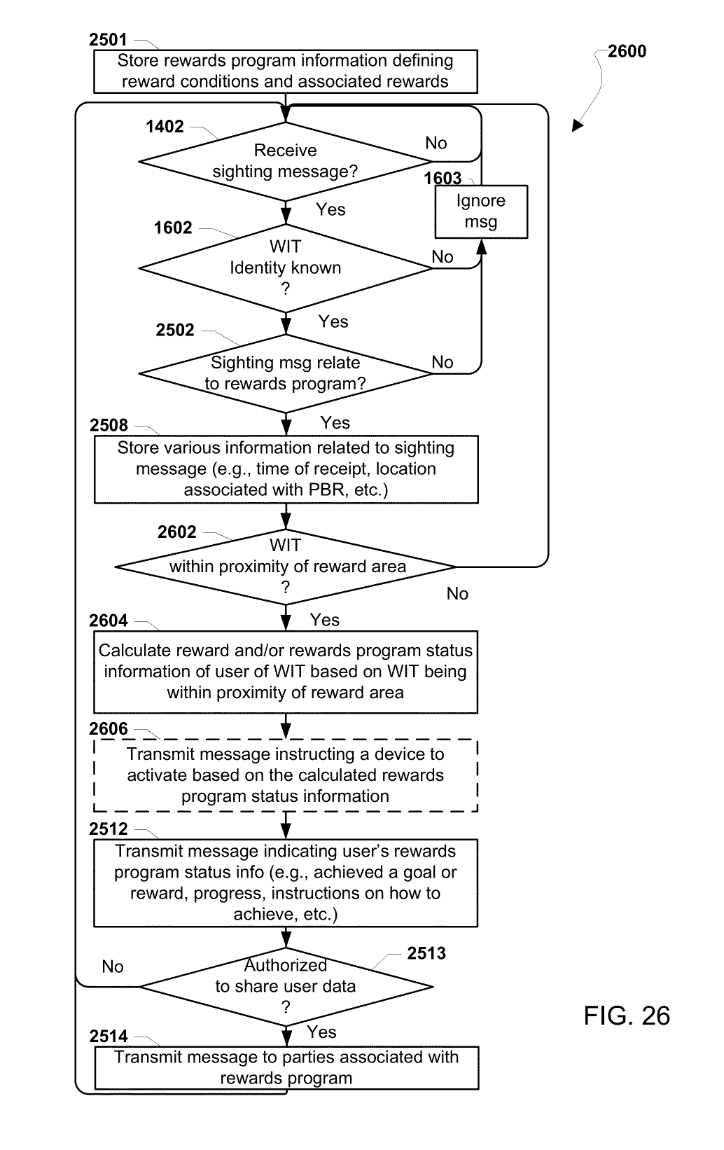

FIG. 26 illustrates an embodiment method 2600 for a central server calculating rewards in response to receiving sighting messages related to a wireless identity transmitter within proximity of a reward area. The method 2600 is similar to the method 2500 described above, except the method 2600 may be performed to provide, calculate, otherwise assign rewards (e.g., coupons, prizes, information, messages, etc.) based on a user being within proximity of a predefined area (i.e., a reward area). For example, a reward program maintained by the central server may indicate that there is a prize associated with a reward area within a retail store, such that any customer walking within proximity of the area may receive a coupon, promotion, or other enticing offer. Reward areas may be particular aisles or end caps within a retail store, a school, a library, a church, a particular room within a house, or any other place associated with a rewards program. Rewards may be calculated and transmitted to users when a predefined geofence is broken or simply when a proximity broadcast receiver receives broadcast messages from the user's wireless identity transmitter while within a reward area. Such proximity-based rewards may drive and direct foot traffic within customer environments, as well as encourage other user behaviors. For example, a parent may configure a rewards program for his/her children that provides credits (or an allowance) for using with home electronics (e.g., iPads, tablets, television, Internet devices, etc.) when the children go to certain places (e.g., school, the library, grand mom's house, the garbage can, etc.).

In block 2501, the central server may store rewards program information defining reward conditions and associated rewards. The reward conditions may indicate reward areas that are associated with particular rewards, such that when a user is within proximity of a reward area, the associated reward may be earned, awarded, or otherwise achieved. Reward areas may be defined by data identifying certain places, such as geofence information, GPS coordinates, and/or unique identities of proximity broadcast receivers within certain places. In an embodiment, the central server may store a data table that links various sets of GPS coordinates with different prizes, coupons, or benefits. For example, the central server may store a reward program data table that links a store coupon (i.e., a reward) with GPS coordinates corresponding to the store's entrance (i.e., a reward area). Further, various conditions may be combined in relation to particular rewards. For example, the central server may store a reward program data table that links allowance credits for a child to the geofence coordinates of the child's school and the hours of school operation (i.e., allowance may be awarded the child when he/she visits the school during school hours).

In determination block 1402, the central server may determine whether a sighting message is received. If the central server does not receive a sighting message (i.e., determination block 1402=“No”), the central server may continue with the operations in determination block 1402. If the central server does receive a sighting message (i.e., determination block 1402=“Yes”), in determination block 1062 the central server may determine whether the wireless identity transmitter identity is known. If the wireless identity transmitter is not known (i.e., determination block 1602=“No”), in block 1603 the central server may ignore the sighting message and continue to perform the operations in determination block 1402. If the wireless identity transmitter is known (i.e., determination block 1602=“Yes”), in determination block 2502 the central server may determine whether the sighting message relates to a rewards program. If the message does not relate to the rewards program (i.e., determination block 2502=“No”), the central server may continue with the operations in block 1603.

However, if the message relates to the rewards program (i.e., determination block 2502=“Yes”), in block 2508, the central server may also store various information related to the sighting message, such as the time of receipt of the sighting message, and location information (e.g., GPS coordinates) of the proximity broadcast receiver at the time of receipt of the broadcast message. In determination block 2602, the central server may determine whether the wireless identity transmitter is within proximity of a reward area. As described above, since sighting messages are transmitted by proximity broadcast receivers within proximity (or broadcast range) of wireless identity transmitters, the central server may determine whether the wireless identity transmitter is within proximity of the reward area by comparing the location information of the proximity broadcast receiver that transmitted the received sighting message to known reward area locations as stored with the operations of block 2501. In an embodiment, the central server may compare location information within the received sighting message (e.g., metadata indicating the proximity broadcast receiver's GPS coordinates) to a list of locations corresponding to reward areas associated with the reward program. In another embodiment in which stationary proximity broadcast receivers are deployed, the central server may compare stored location information of such stationary proximity broadcast receivers to known reward areas to determine whether the received sighting message corresponds to a rewards area. In an embodiment, the central server may determine the wireless identity transmitter is within proximity of (or near to) a reward area when the distance between the location of the proximity broadcast receiver that transmitted the sighting message is within a proximity threshold to the reward area.

In various embodiments, the central server may utilize additional information when determining whether the wireless identity transmitter is near a reward area. In particular, the central server may estimate the position of the wireless identity transmitter as within a circular area of the proximity broadcast receiver that transmitted the sighting message. The circular area may have a radius equal to the wireless identity transmitter's average broadcast range. The central server may also evaluate signal strength information describing the broadcast message reported within the sighting message to determine more precise proximity information of the wireless identity transmitter. For example, based on known capabilities of the proximity broadcast receiver and the signal strength of the associated broadcast message, the central server may determine that the wireless identity transmitter was within a certain distance from the proximity broadcast receiver at the time of transmitting the broadcast message within the sighting message. In an embodiment, the central server may use received signal strength indication (or “RSSI”) information from within the sighting message to determine approximate distance of the wireless identity transmitter to the proximity broadcast receiver. In an embodiment, the central server may also employ schematics or other floor plan or blueprint data to determine more precise location information of the proximity broadcast receiver and thus the wireless identity transmitter. For example, the central server may determine that the wireless identity transmitter is located to the east or south side of the proximity broadcast receiver based on a floor plan that indicates the proximity broadcast receiver is surrounded by exterior walls to the north and west. In an embodiment, the central server may perform the operations of the methods 1820 and/or 1860 described above to determine more precise location information for the wireless identity transmitter. For example, the central server may compare information within concurrent sighting messages to define a precise location of a wireless identity transmitter within a place. In another embodiment, the central server may utilize dead reckoning and other estimation routines or algorithms to determine whether the customer (and the wireless identity transmitter) may be near a reward area in the near future. For example, the central server may evaluate recent movement patterns of the customer to determine within a few seconds he/she may be in front of a product display within a retail store.

Returning to FIG. 26, if the wireless identity transmitter is not within proximity of a reward area (i.e., determination block 2602=“No”), the central server may continue with operations in determination block 1402. However, if the wireless identity transmitter is within proximity of a reward area (i.e., determination block 2602=“Yes”), in block 2604, the central server may calculate a reward and/or rewards program status information of the user of the wireless identity transmitter based on the wireless identity transmitter being within proximity of a reward area. The central server may evaluate the stored reward conditions and associated rewards to find a reward matching the reward area proximate to the user's wireless identity transmitter. For example, the central server may determine that a coupon for twenty minutes of Internet access via a private network may be awarded to the user because the user's wireless identity transmitter was within proximity of a kiosk reward area within a shopping mall. As another example, the central server may determine that another award (e.g., an additional dollar of allowance) may be awarded to the user because the user's wireless identity transmitter was within proximity of a proximity broadcast receiver within a schoolhouse during the morning of a non-holiday weekday.

In an embodiment, when the wireless identity transmitter is determined to be within proximity of a plurality of reward areas, the central server may identify rewards for all reward areas. Alternatively, the central server may identify a reward corresponding to the closest predefined area. For example, the central server may determine the reward area that the wireless identity transmitter is closest to based on signal strength information within the received sighting message (or concurrent sighting messages).

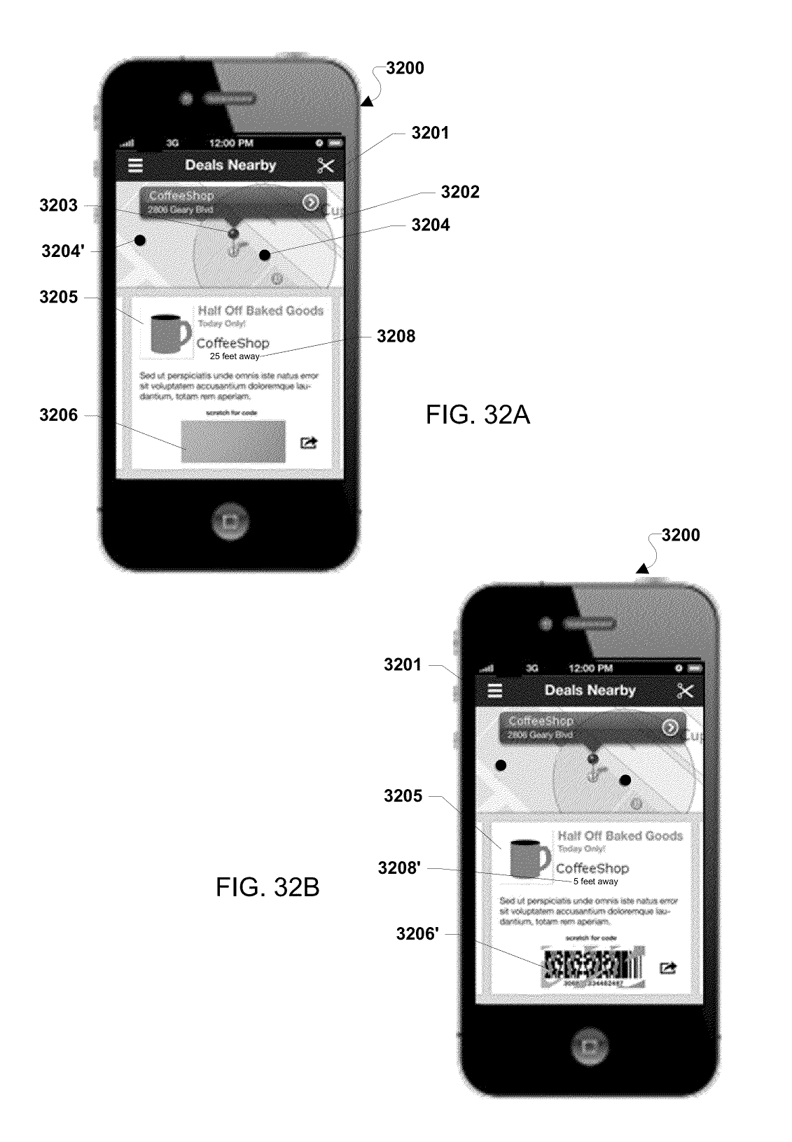

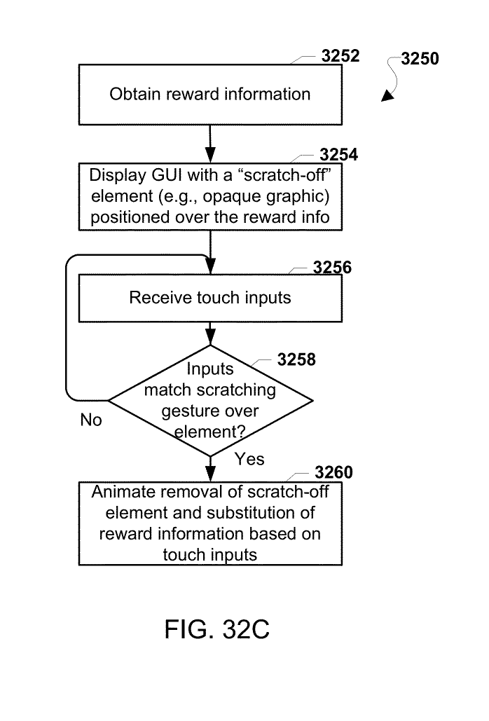

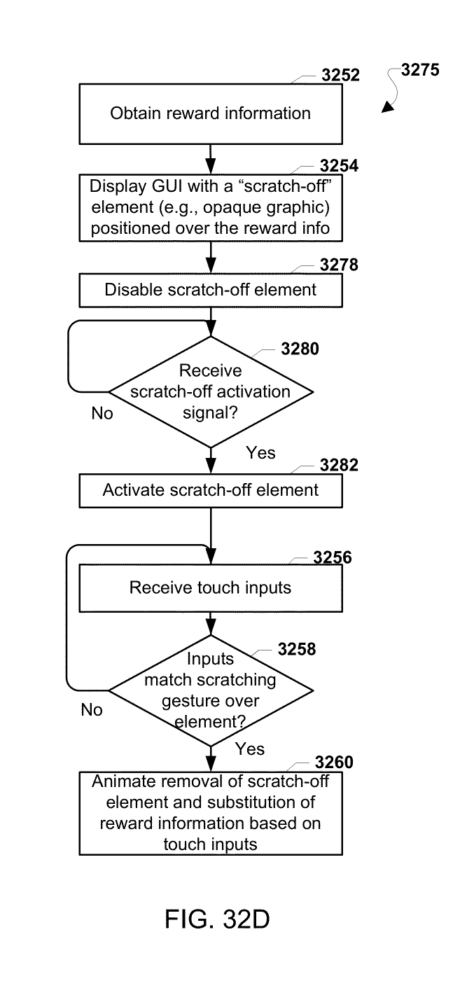

In optional block 2606, the central server may transmit a message instructing a device to activate based on the calculated rewards program status information. In other words, the central server may transmit a message to a device associated with the rewards program and/or the user (or the wireless identity transmitter) that includes instructions for activating software, a routine, or functionality to enable a reward. For example, the message may be a signal to a family television, a tablet (e.g., an iPad), wireless router, telephone, or laptop that unlocks the device for use by the user for a certain period of time. In another embodiment, the message may be sent to a display device within the reward area and that may include instructions for the display device to render information related to a reward the user has earned/achieved. For example, the message may instruct an LCD display at the end cap of a retail store aisle to render a coupon code. In another embodiment, the message may include a signal or instructions that activate a scratch-off element in a user interface as described below with reference to FIGS. 32A-D.

In block 2512, the central server may transmit a message indicating the user's rewards program status information. For example, the central server may transmit a SMS text message to the mobile device associated with the user indicating that the user has been awarded a coupon for entering a reward area. As another example, the central server may transmit a message that indicates the user needs to go to another place/area in order to achieve a coupon.

In determination block 2513, the central server may determine whether it is authorized to share the user's data, such as the user's identity and/or rewards program status information. In other words, based on permissions settings stored for the user, the central server may determine whether the user should be anonymous or identified to other parties related to the rewards program (e.g., a merchant, a parent, etc.). If the central server is not authorized to share user data (i.e., determination block 2513=“No”), the central server may continue with the operations in determination block 1402. If the central server is authorized to share the user's data (i.e., determination block 2513=“Yes”), in block 2514, the central server may also transmit a message indicating the user's status information to parties associated with the rewards program. The central server may continue with the operations in determination block 1402.

For illustration purposes, the central server may be configured to perform the method 2600 to enable a scavenger hunt (or treasure hunt) rewards program. The scavenger hunt rewards program may be developed by a merchant registered with the central server to encourage foot traffic within a retail store associated with the merchant. The central server may store location information for a list of reward areas within the retail store. The reward areas may include proximity broadcast receivers configured to receive and relay broadcast messages from wireless identity transmitters of customers as they walk within proximity. The central server may also store information provided by the merchant that indicates particular coupons for each of the reward areas within the retail store, as well as a condition that indicates the rewards program is only active on Black Friday. Further, the rewards program stored information may include a condition that indicates a special coupon is to be awarded a customer who walks within proximity of all of the reward areas. For example, a customer who visits each reward area during Black Friday may receive a coupon offering a very deep discount on a high-profile product within the retail store. Thus, during Black Friday, the central server may transmit messages to a customer's mobile device that indicate coupons awarded to the customer based on his/her proximity to reward areas within the retail store. The central server may further transmit messages to the customer's mobile device that indicate other reward areas within the retail store that have not been visited, encouraging the customer to continue exploring to possibly receive more and better coupons.

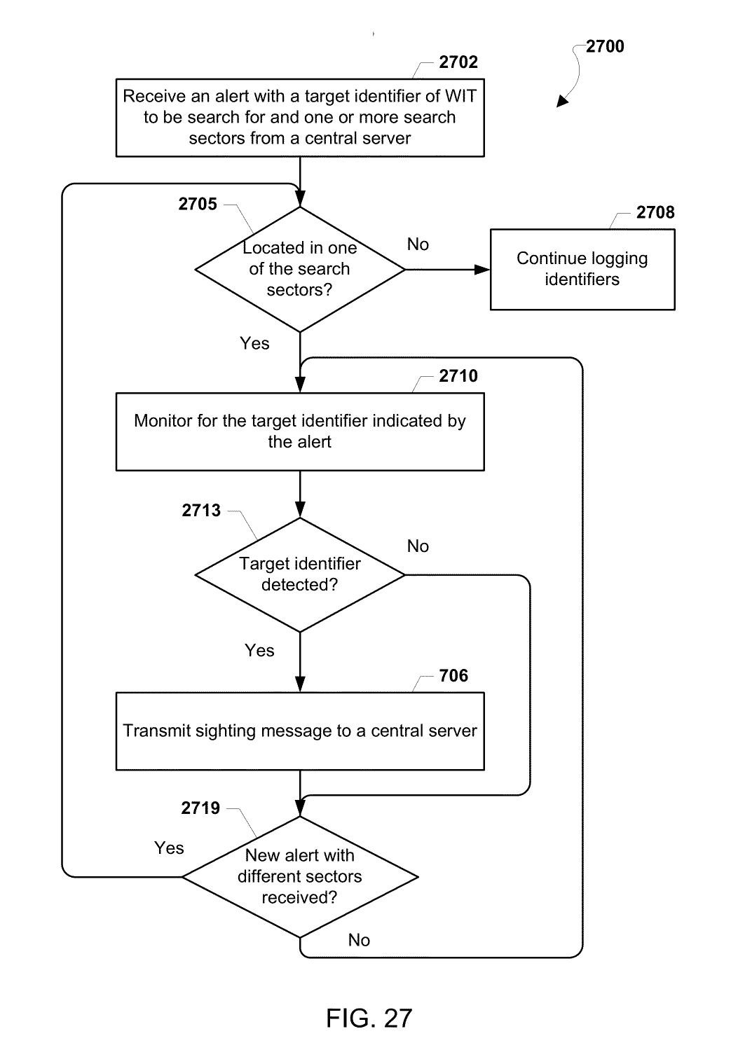

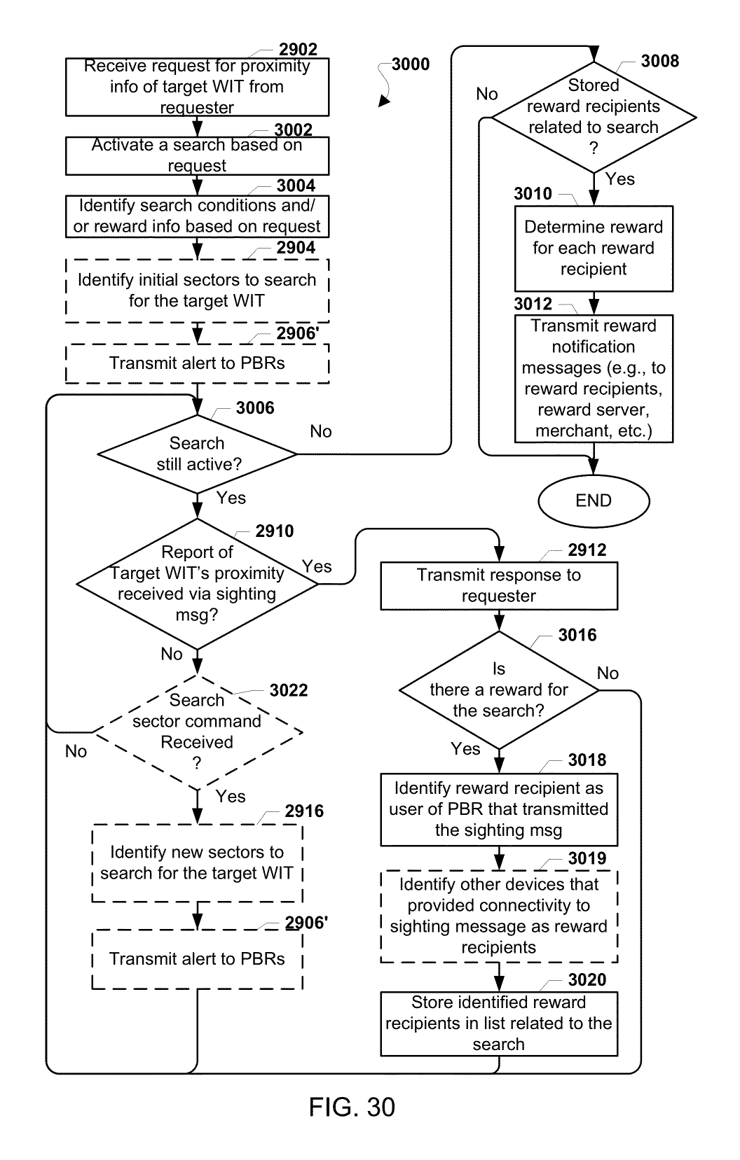

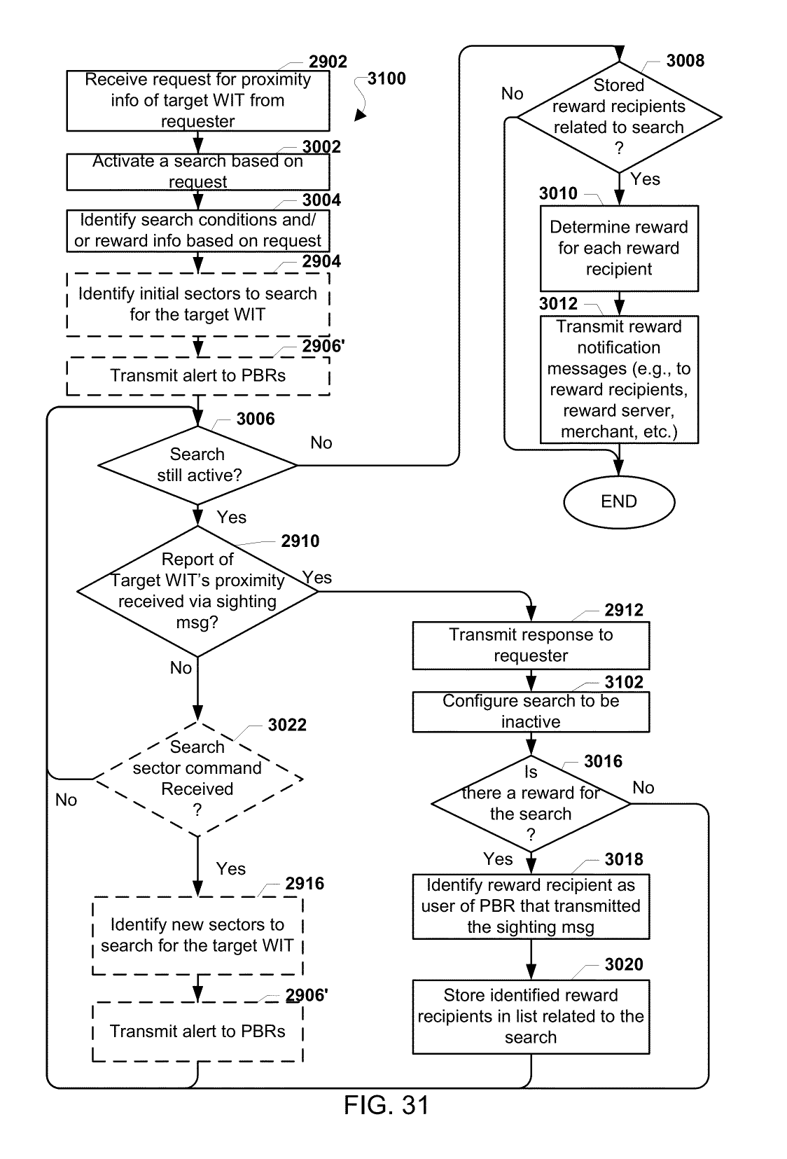

FIGS. 30-31 discuss providing rewards for registered users participating in a search for a target device. In particular, the central server may identify rewards, such as coupons and monetary awards, in response to a registered user's proximity broadcast receiver (e.g., a smartphone executing software to operate as a mobile proximity broadcast receiver or transceiver) reporting proximity information of a searched-for wireless identity transmitter. For example, when a user's mobile proximity broadcast receiver transmits to the central server a sighting message including the rolling identifier of a stolen bulldozer's wireless identity transmitter (i.e., the target device), the central server may award the user with a reward for participating in locating the stolen bulldozer. FIGS. 27-29 describe embodiments for enabling searches for target devices.

FIG. 27 illustrates an embodiment method 2700 for a proximity broadcast receiver actively searching for a wireless identity transmitter. In block 2702, the proximity broadcast receiver may receive an alert (or search activation message) with a target identifier of the wireless identity transmitter (referred to as “WIT” in FIG. 27) to be searched for and one or more search sectors from a central server. In an embodiment, the alert may include an encoded, encrypted, or otherwise obscured identifier that the proximity broadcast receiver may not access such that the target of the search may not be identified by the proximity broadcast receiver. The search sectors indicated in the alert may correspond to one or more sectors to be searched. The proximity broadcast receiver may determine whether it is located within one of the search sectors in determination block 2705. For example, the proximity broadcast receiver may compare the search sectors from the alert to its current GPS coordinates or Cell ID.

If the proximity broadcast receiver is not located in one of the search sectors (i.e., determination block 2705=No), in block 2708 the proximity broadcast receiver may continue logging identifiers, such as storing obscured or secure identifiers (i.e., rolling identifiers) within received broadcast messages in relation to corresponding locations and times. In an embodiment, the proximity broadcast receiver may maintain a log of previous wireless identity transmitter sightings. In this embodiment, rather than storing all of the data from previous sightings on one or more remote servers (e.g., the central server), the data may remain distributed on the proximity broadcast receiver until a search or alert is active. In various embodiments, the proximity broadcast receiver may store data from previous sightings, such as the wireless identity transmitter's rolling identifier and the location and time of the sighting (as well as any other associated data). In response to an alert, the proximity broadcast receiver may search its database for any recorded sightings for which the stored identifier matches with the target identifier provided in the alert or activation message. If a match is present, a response may be transmitted to the central server that provides data corresponding to that target identifier as described below.

If the mobile proximity broadcast receiver is located in one of the search sectors (i.e., determination block 2705=Yes), the proximity broadcast receiver may monitor for the target identifier indicated by the alert in block 2710, such as by comparing the target identifier with any identifiers received in broadcast messages from proximate wireless identity transmitters. In determination block 2713, the proximity broadcast receiver may determine whether the target identifier is detected. If the target identifier is not detected (i.e., determination block 2713=No), the proximity broadcast receiver may proceed to determination block 2719 discussed below.

If the target identifier is detected (i.e., determination block 2713=Yes), the proximity broadcast receiver may immediately transmit a sighting message to a central server in block 706, such as by transmitting a sighting message including the target identifier, a time, and location information (e.g., GPS coordinates). The proximity broadcast receiver may determine whether a new alert with different sectors from the previous alert has been received in determination block 2719. If a new alert is received (i.e., determination block 2719=Yes), the proximity broadcast receiver may determine whether it is located in one of the new sectors by performing the operations in determination block 2705. If no new alert is received (i.e., determination block 2719=No), the proximity broadcast receiver may continue monitoring for the target identifier in block 2710.

In further embodiments, the proximity broadcast receiver may determine the search sectors for which it is responsible. For example, a cell phone that has opted in may install a tracking application for finding wireless identity transmitters. This application may develop a list of sectors in which a search should be conducted by monitoring the cell phone's location over time. The application may then search for wireless identity transmitters based on alert messages that list the search sectors. Thus, in this embodiment, the alerts (or search activation message) may be broadcast or multicast by a central server to all proximity broadcast receivers identifying the sectors being searched, and the receivers themselves may determine whether they should enter the active search mode based upon their current location.

In other embodiments, proximity broadcast receivers may be configured to transmit sighting messages for all broadcast messages received, regardless of having received an alert message. In other words, proximity broadcast receivers may transmit sighting messages for the central server to detect whether a target identifier is included and therefore the wireless identity transmitter targeted by an active search has been sighted.

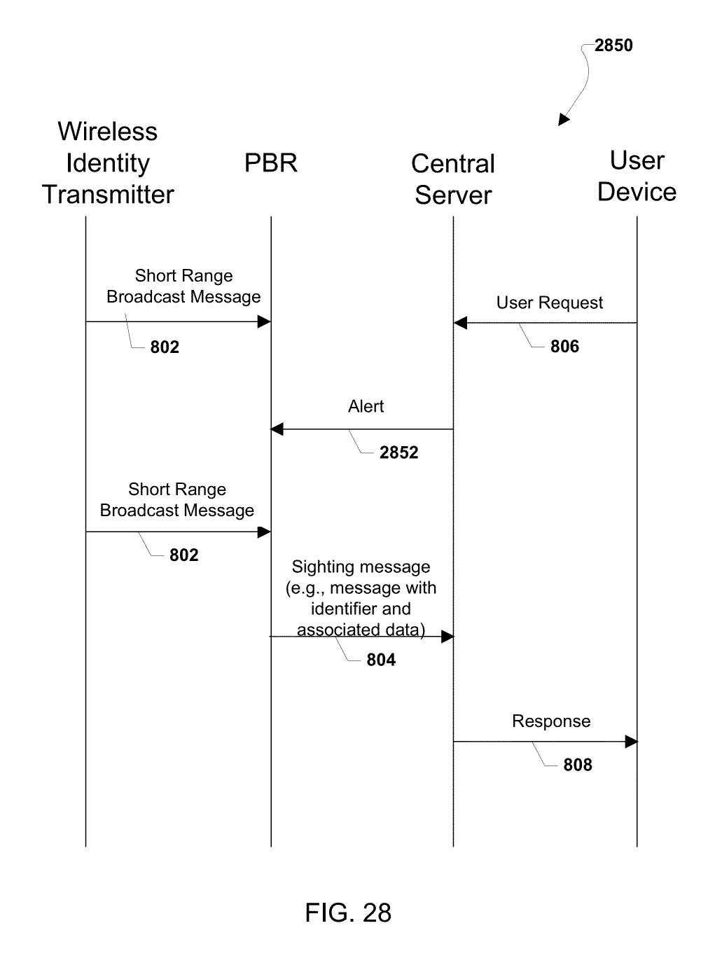

FIG. 28 is a call flow diagram 2850 illustrating communications related to an alert 2852 during various embodiments. In general, an alert 2852 may be related to an active search as described above. A user request 806 may be sent to a central server from a user device, such as a terminal or mobile device. The user request 806 may request the location of a wireless identity transmitter and may include a code or identifier associated with the wireless identity transmitter. The central server may transmit an alert 2852 (or search activation message) to one or more proximity broadcast receivers. The alert 2852 a representation of the identifier of the requested wireless identity transmitter. For example, the alert 1252 may contain a rolling identifier that is secure and does not provide the identity of the wireless identity transmitter or its user.

As mentioned above, in an embodiment the central server may transmit the alert to a certain subsets of proximity broadcast receivers, such as proximity broadcast receivers located within a particular geographic sector where the requested wireless identity transmitter is likely or suspected to be. For example, the user request 806 may specify the last known location of the requested wireless identity transmitter, and the central server may transmit the alert 2852 to proximity broadcast receivers in sectors near that location.

Proximity broadcast receivers receiving the alert 2852 may monitor for broadcast messages 802 (e.g., broadcast advertisements) with the identifier of the requested wireless identity transmitter. The proximity broadcast receiver may then transmit a sighting message 804 to the central server. In other words, the proximity broadcast receiver may upload associated data, such as timestamp, GPS coordinates, proximity broadcast receiver identification, and/or Cell ID, that is associated with the wireless identity transmitter or its identifier. The central server may transmit a response 808 to the user device informing the user of the associated data from the proximity broadcast receiver's contact with the searched for wireless identity transmitter.

Various embodiments may combine the active searching method illustrated in FIG. 28 with the passive searching model discussed above. For example, the proximity broadcast receiver may have previously received a short range broadcast message 802 (e.g., a Bluetooth LE radio signal) from the wireless identity transmitter. This message 802 and any associated data (e.g., timestamp, GPS coordinates, Cell ID, etc.) may be stored locally on the proximity broadcast receiver or forwarded to the central server performing tracking services. When a user request 806 is received, the central server or proximity broadcast receiver may search a database corresponding to prior received broadcast messages 802 from wireless identity transmitters and associated data in addition to initiating an active search by transmitting the alert 2852. The response 808 may include all data resulting from the active search and associated with any prior messages 802.

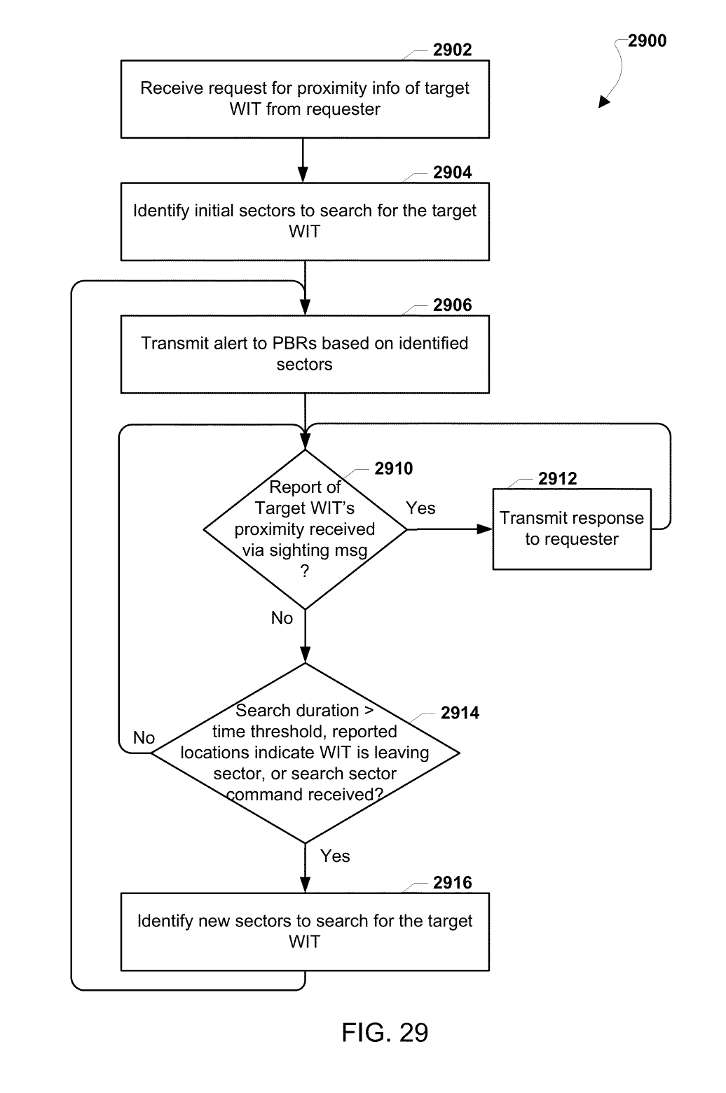

FIG. 29 illustrates an embodiment method 2900 for a central server activating a search by sending activation messages to proximity broadcast receivers in particular sectors. In block 2902, the central server may receive a request, such as a user request described above, for proximity information of a particular wireless identity transmitter (i.e., the target wireless identity transmitter). In other words, the requester may want to locate the target wireless identity transmitter. The central server may identify one or more initial sectors to search for the target wireless identity transmitter in block 2904. The initial sectors may be identified in various ways. For example, the request may include a location (e.g., the last known location of the target wireless identity transmitter) and the central server may identify the sectors around the location. Alternatively, the target wireless identity transmitter may have sectors associated with it based on prior tracking attempts or data (e.g., GPS coordinates, Cell ID) received from proximity broadcast receivers based on prior sightings.

The central server may transmit an alert to proximity broadcast receivers based on the identified sectors in block 2906. For example, the central server may transmit the alert to proximity broadcast receivers that are currently located in the identified sectors, that frequently travel in the sectors (e.g., mobile proximity broadcast receivers known to go into the sectors), that are near or have ever previously been near the sectors, and/or that are predicted to be in the sectors in the future. In various embodiments, the alert may indicate that the central server has initiated or activated a search. In alternate embodiments, the alert message may be available on a separate server or other network location and the proximity broadcast receivers may periodically query a URL where the alert may be maintained. For example, cellular phones often periodically check in for a variety of data, such as clock and other network settings, so proximity broadcast receivers may be configured to also check for alerts the same way or on the same connection used for these other data checks. In an embodiment, the central server may transmit such alert messages such that the recipient proximity broadcast receivers may not be able to identify the target wireless identity transmitter. For example, the alert message may include an encoded, encrypted, or otherwise obscured identifier for the target wireless identity transmitter that only the central server can access, thus keeping the search anonymous to all proximity broadcast receivers and other devices, except for the requester. In another embodiment, the operations in block 2906 may be optional when mobile proximity broadcast receivers are configured to automatically relay broadcast messages received from the target wireless identity transmitter, regardless of whether the mobile proximity broadcast receivers have received any alert or search activation message. For example, mobile proximity broadcast receivers may transmit sighting messages to the central server that include any broadcast messages received from wireless identity transmitters within proximity.

Upon transmitting the alert, in determination block 2910 the central server may determine whether a report of the target wireless identity transmitter's proximity is received via a sighting message. In other words, the central server may stand by to receive sighting messages that indicate the target or searched for wireless identity transmitter has been within proximity of a proximity broadcast receiver and thus has been located. In an embodiment, the operations of determination block 2910 may include the operations of determination blocks 1402-1602 described above. For example, the central server may decode, decrypt, or otherwise access a rolling identifier within the received sighting message and determine whether it matches the identity of the target wireless identity transmitter. If a report of the target wireless identity transmitter proximity is received (i.e., determination block 2910=“Yes”), then the central server may transmit a response to the requester with any data received from proximity broadcast receiver(s) in block 2912. The process of standing by and receiving sighting messages (or other location reports) from proximity broadcast receiver(s) in determination block 2910 and transmitting responses to one or more requesters in block 2912 may continue so long as the alert remains in effect (e.g., until the child is found and the alert is cancelled by the requesting authority), or until the central server stops receiving proximity reports of the target wireless identity transmitter (i.e., determination block 2910=No).

In determination block 2914 and block 2916 the central server may be configured to adjust the search sector to expand the search area, shift the search area from sector to sector to follow a moving target wireless identity transmitter, and respond to commands to move, expand or focus the search received from the requester or an authority. In this manner the central server can actively adjust the search sectors by notifying proximity broadcast receivers in order to increase the likelihood that a device may be located and tracked. In determination block 2914, the central server may determine whether the search duration exceeds a time threshold, whether there are reported locations indicating the target wireless identity transmitter is leaving the sector, or whether a search sector command is received. So long as the search duration or duration since a last report is less than the predetermined time threshold, the target wireless identity transmitter does not move out of the search sector and/or the central server is not commanded to adjust the search area (i.e., determination block 2914=No), the central server may continue standing by for and receiving proximity reports via sighting messages in determination block 2910.

In an embodiment, if the central server fails to receive or stops receiving proximity reports via sighting messages regarding the target wireless identity transmitter (i.e., determination block 2910=No), the central server may determine whether the time since the search began or the last received report exceeds a predetermined threshold in determination block 2914. This predetermined threshold may be set by the requester or an authority at the time the search was activated, such as depending upon a suspected mode of transportation. For example, the search may be activated in a sector surrounding a last known location of a child, but be configured to expand within 15 minutes if the abductor is suspected to be traveling on foot or expand within five minutes if the abductor is suspected to be traveling by car. In this manner, the central server may expand the search area automatically. If the central server determines that the preset duration since the search was initiated or a last location report was received has expired (i.e., determination block 2914=Yes), the central server may identify new sectors to search for the target wireless identity transmitter in block 2916, and a new alert within the new sectors may be transmitted or otherwise made available to proximity broadcast receivers in block 2906. In this manner, a search may expand to encompass a larger area to accommodate a potentially moving abductor.

In another embodiment, a search may be expanded based on movement of the target wireless identity transmitter. For example, in an ongoing search, the central server may have received sighting messages from one or more proximity broadcast receivers. Based on the times and locations in these messages, the central server may assume that the target wireless identity transmitter is moving in a particular direction, such as down a highway and add sectors in the direction of travel to anticipate the target wireless identity transmitter's future location. Thus, in determination block 2914 the central server may determine when received reported locations (or proximities) indicate the target wireless identity transmitter is leaving the sector. This may be accomplished by comparing a sequence of locations or proximities received in determination block 2910 to a digital map to estimate a direction and speed of travel. When the central server determines that location or proximity reports have ceased being received and the target wireless identity transmitter was moving out of the current search sector (i.e., determination block 2914=Yes), the central server may identify new sectors to search in block 2916, and a new alert with the new sectors may be transmitted or otherwise made available to proximity broadcast receivers in block 2906. In block 2916 the identified new sector(s) may be the sector or sectors along the direction of motion estimated by the central server. In this manner, a search maybe shifted from sector to sector in sequence in order to track a moving wireless identity transmitter.

In another embodiment, the central server may be configured to receive commands to expand, shift or focus the search area, which may be received in determination block 2914. When the central server receives a command to expand the search (i.e., determination block 2914=Yes), the central server may identify new sectors to search for the target wireless identity transmitter in block 2916 consistent with the received command, and then a new alert with the new sectors may be transmitted or otherwise made available to proximity broadcast receivers in block 2906. In this manner, a requestor or search authority may adjust the search dynamically via the central server such as to investigate tips and eye witness reports.

Alternatively, a search may be expanded gradually. The central server may identify one or just a few sectors initially, and if the target wireless identity transmitter is not located, the central server may identify additional sectors to alert. For example, if a child goes missing after school, the alert may be sent to proximity broadcast receivers in the school's sector, then to devices in neighboring sectors, then to devices in the rest of town, and then even to devices in neighboring towns and beyond if necessary.

Searching by sectors may conserve network resources and allow more efficient responses. Cell phones users that have opted in as proximity broadcast receivers may not have to worry about unproductive searches in other cities or states, such as California phones searching for a wireless identity transmitter missing in Atlanta. A child in Atlanta missing after school for only a few hours could not have possibly made it across the country to California. However, as the search progresses and time passes, sectors may be added and the search scope expanded as appropriate.

Various embodiments may include one or more features to protect the privacy of each party involved. In various embodiments, the proximity broadcast receiver may not report to the proximity broadcast receiver's user anything about a search (e.g. a cell phone may not reveal to a user the identifier of a target wireless identity transmitter, the identity of the requester, whether a target wireless identity transmitter has been found, or even that a search is under way). In various embodiments, the personal information of any proximity broadcast receiver may be protected by excluding any such information from any data sent to the central server.

FIGS. 30 and 31 illustrate embodiment methods 3000, 3100 for determining reward recipients in response to receiving proximity information related to an active search for a device. As described above, a central server may be employed to locate wireless identity transmitters associated with assets or things, such as pets, users, and equipment, as well as associated with planned events, such as scavenger hunts and marketing stunts. In particular, the central server may receive requests to activate searches for target wireless identity transmitters. For example, a pet owner may submit a request to locate a wireless identity transmitter that is carried by a missing pet or a construction company may submit a request to locate a wireless identity transmitter that is affixed to a stolen bulldozer.

The chances of locating search targets may be improved by increasing the number of devices participating in the search. Thus, to act as an incentive for users of mobile devices to participate in a search, a request to locate a target wireless identity transmitter may include a reward for anyone whose mobile device locates the target (i.e., transmits a sighting message related to a broadcast message from the missing person/item). For example, the construction company mentioned in the above example may indicate that a monetary reward (e.g., $200) may be given to users of mobile proximity broadcast receivers that receive and relay broadcast messages from the stolen bulldozer's wireless identity transmitter. As another example, a merchant may give coupons to users of mobile proximity broadcast receivers that transmit sighting messages related to target wireless identity transmitters within a retail store (e.g., a treasure hunt or scavenger hunt). In various embodiments, user's mobile devices may be configured to participate in active searches by installing and/or activating an application, service, or other software on mobile devices that enables the devices to transmit sighting messages and otherwise perform as mobile proximity broadcast receivers.

In response to relevant proximity information being relayed by user's mobile proximity broadcast receivers (e.g., sighting messages indicating the target wireless identity transmitter, etc.), the central server may transmit messages to the mobile proximity broadcast receivers indicating that a reward may be bestowed upon the users. For example, the central server may transmit a reward notification message to a mobile proximity broadcast receiver that includes a code for a free online product. In addition to incentivizing users to configure their devices to operate as proximity broadcast receivers, a sizeable reward may also incentivize people to modify their travels (e.g., driving on side roads) in ways that includes their own chances of winning rewards, and thus result in a better search. For example, a user may walk through every department in a retail store in order to win larger prizes related to a treasure hunt search.

As described above, rewards may include money, prizes, offers, coupons, promotions, discounts, favors, messages, items (e.g., cars), privileges (e.g., free WiFi access), commentary, secrets, product offers, and/or anything an owner may offer in return for location information related to a target wireless identity transmitter. For example, a merchant implementing a “treasure hunt” marketing ploy may submit a request for proximity information related to a merchant item within the merchant's store, and may offer a reward of a discount coupon (or other in-store perk, such as a promotional offer or loyalty points) to any customer whose mobile proximity broadcast receiver relays a broadcast message from a wireless identity transmitter associated with the merchant item. As another example, the merchant may submit another request that offers a reward for any mobile proximity broadcast receiver that relays a broadcast message from every wireless identity transmitter within each department of a store. Various rewards may be earned when a user's proximity broadcast receiver transmits information related to lost items, missing items, stolen items, or items related to an advertising activity, marketing activity, or any gimmick (e.g., scavenger hunts, treasure hunts, etc.). For example, a finder's fee money reward may be earned by any mobile proximity broadcast receiver that relays a broadcast message from a target wireless identity transmitter within a requester's missing wallet.

FIG. 30 illustrates an embodiment method 3000 for a central server determining reward recipients in response to receiving sighting messages related to a wireless identity transmitter targeted by a search. In block 2902, the central server may receive a request for proximity information of a target wireless identity transmitter (referred to as “WIT” in FIG. 30) from a requester. In other words, the requester may request that a search be activated to locate the target wireless identity transmitter having a specified ID or identifier. For example, a requester pet owner may use a smartphone to transmit a message to the central server that requests an active search be performed to locate the target wireless identity transmitter identifier worn by the owner's dog. In various embodiments, the request may be a message, such as an SMS text, email, or other electronic correspondence that the central server can receive via Internet or other communication protocols. Further, the target wireless identity transmitter indicated in the request may be associated with a scavenger hunt, a lost item, a missing item, a stolen item, and an advertising activity.

In an embodiment, to protect innocent parties from being tracked, stalked, or searched for without a valid purpose, the requester may be required to be registered with the central server and the target wireless identity transmitter must be associated with the requester's registered account. In other words, the central server may not perform a search for a device that is not linked, owned, or otherwise connected to the requester. In this way, nefarious users may not employ the central server to find devices these users are not authorized to locate.

In block 3002, the central server may activate a search based on the request. In other words, the search may be considered active (or activated) in response to the central server receiving the request. For example, immediately upon receiving the request for proximity information for the target wireless identity transmitter, the central server may activate the search. In an alternative embodiment, the request may indicate a future time at which the search may be activated. For example, the request may indicate the requester wants proximity information starting in one hour, day, or week.

In block 3004, the central server may identify search conditions and/or reward information based on the received request. For example, the central server may identify whether a reward is indicated by the request. As another example, the central server may identify parameters or conditions for executing the search (e.g., length of the search). The central server may evaluate the received request to determine whether the request includes metadata, header information, or other indicators that correspond to a reward and/or the search for the target wireless identity transmitter. For example, the received request may be a message that includes indicators that describe a monetary reward. As another example, the received request may include a bit that indicates whether a reward corresponds to the request or not. In another embodiment, the central server may perform natural language processing on the received request to determine whether a reward is indicated. In an embodiment, the central server may identify a message associated with or describing the reward. For example, the received request may include text to be delivered to mobile proximity broadcast receivers, such as “If you find my dog, I'll give you some money!”

The identified search conditions and/or the reward information may identify reward rules, stipulations, or other conditions indicated by the request that the central server may utilize in the operations described below. In other words, the request may include information that indicates when the search may be active, what sectors should be searched, and/or how rewards may be divided between reward recipients. For example, the central server may identify reward information that defines the total numbers of mobile proximity broadcast receiver that may be eligible for the reward (e.g., “max ten winners,” “one reward available,” etc.). As another example, the central server may identify search conditions that define how and when the search may be active, such as defining that search to be active only for a certain period of time (e.g., minutes, hours, days, weeks, etc.) or active only on particular days of the week. In another embodiment, the reward information may further indicate characteristics of potential reward recipients. For example, the request may include reward rules indicating the reward may only be given to a certain type of user of mobile proximity broadcast receivers (e.g., only children are eligible, only registered customers of a particular merchant are eligible, etc.).

In an embodiment, the central server may store information within a database or data table that indicates reward information and/or search conditions indicated by the request. For example, the central server may store information describing rewards indicated by the request in a data table of active searches.

In optional block 2904, the central server may identify initial sectors to search for the target wireless identity transmitter. This may be optional when the central server is configured to not restrict the search to any particular area or geographic region. In optional block 2906′, the central server may transmit an alert (or search activation message) to proximity broadcast receivers, such as proximity broadcast receiver within a certain search sector. As described above, the central server may transmit such alert messages such that the recipient proximity broadcast receivers may not be able to identify the target wireless identity transmitter. In an embodiment, the alert may be sent to all proximity broadcast receivers known to the central server (i.e., all registered proximity broadcast receivers), or alternatively to all proximity broadcast receivers within sectors identified in optional block 2904.

The alert or search activation message may include an indication or description of any identified reward related to the search. For example, the search activation message may include identifying information regarding the target wireless identity transmitter (e.g., “Please find the brown dog”, etc.) as well as the reward for relaying proximity information (e.g., “There is a money reward.”). The operations in optional block 2906′ may be optional because in various embodiments proximity broadcast receivers may be configured to automatically relay broadcast messages received from the wireless identity transmitter, regardless of whether the proximity broadcast receivers have received any alert or search activation message. In an embodiment, the search activation message may include photographic data (e.g., images, photos, etc.) that may be rendered on mobile proximity broadcast receivers. Additionally, the alert or search activation message may include any message from the requesting party identified with the operations in block 3004. For example, the alert or search activation message may include an advertisement message. Alternatively, the search activation message may not include any identifying information at all, enabling proximity broadcast receivers to be on the look-out for the target wireless identity transmitter without providing any notice to their respective users.

In determination block 3006, the central server may determine whether the search is still active. In other words, the central server may determine whether the target wireless identity transmitter is still lost, stolen, or missing, or if the requester still wants the search to be active. In various embodiments, the search may be active based on search conditions identified in the operations in block 3004. For example, the search conditions may indicate the search may be active indefinitely (i.e., an open-ended search active until the target wireless identity transmitter has been located), for a predefined period (e.g., the request message may indicate the search may include a time threshold for the request to remain active), until a message is received from the requester that indicates the request is inactive (e.g., a subsequent message from the requester indicating the search may cease or “deactivate”), or until a proximity broadcast receiver relays proximity information related to the target wireless identity transmitter.

In an embodiment, the search may remain active until a certain number of mobile proximity broadcast receivers have relayed proximity information related to the target wireless identity transmitter. For example, the search may be related to a contest that is designed to determine first, second, and third place winners based on the first three mobile proximity broadcast receivers to relay location information related to a target wireless identity transmitter associated with the contest. Accordingly, the central server may evaluate a stored list of reward recipients, as described below with reference to the operations in block 3020, to determine whether the search is still active based on whether a predefined number of reward recipients have been identified.

If the search is still active (i.e., determination block 3003=“Yes”), in determination block 2910 the central server may determine whether a report of the target wireless identity transmitter's proximity is received via a sighting message. For example, the central server may receive sighting messages that indicate locations (e.g., GPS coordinates) of proximity broadcast receivers within proximity of the target wireless identity transmitter. As described above, as proximate proximity broadcast receivers receive broadcast messages (i.e., short-range wireless signals) from the target wireless identity transmitter, the location of such proximity broadcast receivers may be the approximate location of the target wireless identity transmitter at the time of receiving such broadcast messages. Thus, the central server may evaluate received messages from proximity broadcast receivers to determine whether they include location information related to the target wireless identity transmitter. For example, the central server may receive a message, decrypt identification information within the received message, and determine location information from the received message if the received message contains identification information of the target wireless identity transmitter.

If proximity information of the target wireless identity transmitter is received (i.e., determination block 2910=“Yes”), in block 2912 the central server may transmit a response to the requester. In an embodiment, the response may include the location information and/or identification information of the proximity broadcast receiver(s) that relayed the proximity information. For example, the response may include GPS coordinates (having a certain timestamp) of the mobile proximity broadcast receiver that transmitted a sighting message related to the wireless identity transmitter. As another example, the response may include information that describes the proximity broadcast receiver that relayed the proximity information corresponding to the wireless identity transmitter (e.g., “A smartphone found your item!” or “A stationary device within a Store X found your item at 12:22 pm today!”). Alternatively, the response to the requester may preserve the privacy and anonymity of the proximity broadcast receiver that reported the proximity of the target wireless identity transmitter by only including the time and location of the sighting. For example, the central server may only transmit a response to the request that indicates the target wireless identity transmitter was found by an anonymous smartphone.

In determination block 3016, the central server may determine whether there is a reward for the search. For example, the central server may look-up the search for the target wireless identity transmitter in a stored data table of active searches to see if reward information is stored in relation to the search. In other words, the central server may determine whether a reward was identified within the request using the operations in block 3004 described above. If there is no reward for the search (i.e., determination block 3016=“No”), the central server may continue with the operations in determination block 3006. However, if there is a reward for the search (i.e., determination block 3016=“Yes”), in block 3018 the central server may identify a reward recipient as the user of the proximity broadcast receiver that transmitted the received sighting message. In other words, because the proximity broadcast receiver transmitted the sighting message indicating being within proximity (and therefore giving an approximate location) of the target wireless identity transmitter, the registered user (or owner) associated with that proximity broadcast receiver may receive a reward. For example, the central server may parse a received sighting message to detect metadata that identifies the mobile proximity broadcast receiver (and associated registered user) that transmitted the sighting message, such as a code that indicates a unique identifier of the proximity broadcast receiver that the central server may use as a look-up key on a database of registered proximity broadcast receivers and/or users.

In optional block 3019, the central server may identity other devices that provided connectivity to the sighting message as reward recipients. In other words, any device participating in the connectivity or relay of information related to the target wireless identity transmitter may be considered a reward recipient as well as the proximity broadcast receiver that was within proximity of the target wireless identity transmitter. For example, when a proximity broadcast receiver transmits a sighting message related to the target wireless identity transmitter, the sighting message may be relayed from multiple access points and/or devices (e.g., cell sites, local servers, local computing devices, WiFi routers, etc.) before reaching the central server, and thus each of the devices along the path from the first proximity broadcast receiver to the central server may be awarded a portion of a reward.

In various embodiments, the reward conditions established by the requester may delimit the conditions that must be fulfilled to be considered a reward recipient. For example, only proximity broadcast receivers that transmit sighting messages based on direct reception of broadcast messages from the target wireless identity transmitter may be considered reward recipients (i.e., only those proximity broadcast receivers who transmit sighting messages that are a “hit” regarding the target wireless identity transmitter may be considered for a reward). In other embodiments, devices that provided connectivity to a sighting message may only receive a small “finders' fee” (e.g., a small percentage of the reward recipient's reward or a small flat fee) for relaying messages from the proximity broadcast receiver that encountered the target wireless identity transmitter. For example, a retail store may receive a small percentage of a raffle reward when the store's WiFi router was used to relay a sighting message to the Internet and the central server.

In block 3020, the central server may store the identified reward recipients in a list related to the search. In an embodiment, the central server may store in a data table or database a list of all reward recipients (e.g., mobile proximity broadcast receivers that transmitted proximity information relevant to the target wireless identity transmitter) in relation to the search. For example, the central server may append the unique identifier of the proximity broadcast receiver that transmitted the proximity information of the target wireless identity transmitter to a data table of current reward recipients. The stored list may be any type of data structure. The central server may continue with the operations in determination block 3006 until the search is no longer active.

If a report of the target wireless identity transmitter's proximity is not received (i.e., determination block 2910=“No”), in optional determination block 3022, the central server may determine whether a search sector command has been received. A search sector command may indicate that new search sectors should be used for the search. When search sectors are utilized in optional embodiments as described above with reference to the operations in optional block 2904, the central server may be configured to adjust the search sector and expand the search area in response to receiving search sector commands. For example, based on a search sector command, the central server may expand or focus the search area. In an embodiment, search sector commands may be received from the requester. For example, the requester may transmit a message that indicates a new sector should be searched (e.g., the message may include instructions directing the central server to change the sector being searched, etc.). Alternatively, the central server may generate a search sector command itself based on a certain period of inactivity from proximity broadcast receivers within a certain search sector. For example, the central server may configure the search to focus on new search sectors when no sighting messages are received from the current search sector, or when no sighting messages from the current search sector are related to the target wireless identity transmitter.

If a search sector command is not received (i.e., optional determination block 3022=No), the central server may continue with the operations in determination block 3006. However, if the central server receives a search sector command (i.e., optional determination block 3022=Yes), in optional block 2916 the central server may identify new sectors to search for the target wireless identity transmitter, such as new sectors consistent with the received search sector command. In various embodiments, the central server may identify new sectors based on received search sector commands (e.g., commands to search in adjacent areas, etc.) or alternatively based on evaluations of stored data that indicate previous locations of the target wireless identity transmitter. For example, the central server may determine new sectors to search based on areas the target wireless identity transmitter was reported being within during similar times of the day throughout a year. In optional block 2906′, the central server may transmit an alert to proximity broadcast receivers, such as a new alert to proximity broadcast receiver within the new sectors, and the central server may continue with the operations in determination block 3006.

If the search is not still active (i.e., determination block 3006=“No”), in determination block 3008 the central server may determine whether there are stored reward recipients related to the search. For example, the central server may assess a database that stores proximity broadcast receiver identities in relation to particular searches or requests for proximity information of wireless identity transmitters. A plurality of reward recipients, or alternatively no recipients may be stored related to the search. For example, if the search is aborted based on an elapsed time or a subsequent message from the requester before any sighting message is received related to the target wireless identity transmitter, no reward recipients may be stored related to the search. If no reward recipients are stored related to the search (i.e., determination block 3008=“No”), the central server may cease operations regarding the search and/or the request for proximity information for the target wireless identity transmitter. In another embodiment, the central server may transmit a message to the requester indicating the search has ended.

However, if a reward recipient is stored related to the search (i.e., determination block 3008=“Yes”), in block 3010 the central server may determine a reward for each reward recipient. When there is only one reward recipient, the central server may determine that the reward recipient's reward is the entire reward identified with the operations in block 3004. For example, the one reward recipient may be the sole recipient of the monetary reward for finding a dog. When there are more than one reward recipient, the central server may divide the reward equally, or alternatively using some other predefined percentage, between the reward recipients if that is what was stipulated in the reward rules. In an embodiment, the requester may indicate how to divide the reward in the event of multiple reward recipients. For example, the request message transmitted by the requester may indicate how to subdivide the reward (e.g., award a first amount of items to the first reward recipient and a second amount to the second reward recipient, etc.). In another embodiment, the reward may not be unique and therefore may be duplicated. For example, the reward may be an online coupon, a message, or a secret URL that numerous reward recipients may all be awarded. In another embodiment, the reward may be the same for each reward recipient. For example, the requester may indicate that each reward recipient is to receive $5 dollars, regardless of how many reward recipients there are.

In block 3012, the central server may transmit reward notification messages, such as messages to reward recipients that indicate they have earned or achieved a reward. Reward notification messages may include the reward (e.g., an online code for a prize, a URL for a download, etc.), instructions on how to obtain the reward (e.g., an invitation to come to a place to receive a gift, etc.), or other messages related to the reward (e.g., the reward notification message may be a SMS text message that indicates a reward is on the way, etc.). The reward notification messages may include instructions regarding how to retrieve the reward determined above. For example, the reward notification message may include a website password with text instructions on how to log-in and download a reward. Alternatively, the reward notification messages may include the rewards themselves (e.g., an email including a coupon or code for prizes, money, discounts, etc.). When the reward notification messages have been transmitted, the central server may cease performing the method 3000.

In an embodiment, the central server may transmit a reward notification message to each of the stored reward recipients. For example, the central server may transmit an SMS message that includes a URL for a reward coupon to the mobile proximity broadcast receivers associated with the reward recipients. In another embodiment, the central server may transmit reward notification messages to a reward server that is registered to administer rewards. For example, the reward server may be associated with a service that conducts scavenger hunts and that directly contacts winners of scavenger hunts (i.e., reward recipients). In another embodiment, the central server may also transmit reward notification messages to a merchant, store, and/or business that are associated with the reward. For example, the reward notification message may include a notice to a merchant indicating that a reward coupon for the merchant's products has been awarded to a reward recipient. In various embodiments, the central server may transmit reward notification messages to any combination of reward recipients, merchants, stores, reward servers, and/or third-party services. For example, upon receiving the location information for the wireless identity transmitter, the central server may send reward notification messages to the requester, reward recipients, and a store associated with the reward item (e.g., a coupon).

In various embodiments, the central server may not transmit the reward notification messages to any registered service or third-party when such messages identify the parties without the authorization of those parties. For example, the central server may not transmit reward notification messages to a merchant that indicate the identity of the reward recipient if the reward recipient has indicated he prefers to stay anonymous within a stored profile established during registration with the central server, as described above. In an embodiment, proximity broadcast receiver users may waive their privacy and/or authorize their identities to be shared with third-parties when software for participating in searches is installed on the proximity broadcast receiver. For example, a license agreement provision or condition of registering a mobile proximity broadcast receiver may require any proximity broadcast receiver user to authorize the central server to share certain personal or profile information with merchants in return for the right to participate in treasure hunt or scavenger hunt searches.

FIG. 31 illustrates another embodiment method 3100 for a central server determining rewards for recipients in response to receiving proximity information related to a target wireless identity transmitter. The method 3100 is similar to the method 3000 described above except that a search may be deactivated after a single proximity broadcast receiver relays location information related to the target wireless identity transmitter. In other words, a reward may be awarded to the user of the first mobile proximity broadcast receiver to report receiving a short-range wireless signal (i.e., broadcast message) from the target wireless identity transmitter. For example, in a scavenger hunt, a search request may activate a search such that a single car will be awarded to the first mobile proximity broadcast receiver that relays a broadcast message from a hidden wireless identity transmitter within a shopping mall.

In block 2902, the central server may receive a request for proximity information of a target wireless identity transmitter (referred to as “WIT” in FIG. 30) from a requester. In block 3002, the central server may activate a search based on the request. In block 3004, the central server may identify search conditions and/or reward information based on the received request. In optional block 2904, the central server may identify initial sectors to search for the target wireless identity transmitter. In optional block 2906′, the central server may transmit an alert (or search activation message) to proximity broadcast receivers, such as proximity broadcast receiver within a certain search sector.

In determination block 3006, the central server may determine whether the search is still active. If the search is still active (i.e., determination block 3003=“Yes”), in determination block 2910 the central server may determine whether a report of the target wireless identity transmitter's proximity is received via a sighting message. If proximity information of the target wireless identity transmitter is received (i.e., determination block 2910=“Yes”), in block 2912 the central server may transmit a response to the requester. In block 3102, the central server may configure the search to be inactive. For example, the central server may set a system variable or change a database value to indicate the search is inactive. As another example, the central server may cease performing routines, software modules, or other operations related to the search. As stated above, the search may be configured to only require one mobile proximity broadcast receiver to relay location information (e.g., in a sighting message, location report, etc.) before ending the search. Such a single relay of location or proximity information may be useful for scenarios such as a scavenger hunt, competition, or other controlled event in which the requestor knows the location of the target wireless identity transmitter and is encouraging others to find it.

In determination block 3016, the central server may determine whether there is a reward for the search. If there is no reward for the search (i.e., determination block 3016=“No”), the central server may continue with the operations in determination block 3006. However, if there is a reward for the search (i.e., determination block 3016=“Yes”), in block 3018 the central server may identify a reward recipient as the user of the proximity broadcast receiver that transmitted the sighting message. In block 3020, the central server may store the identified reward recipients in a list related to the search, such as by storing the identified proximity broadcast receiver's unique identifier in a data table of current reward recipients, and may continue with the operations in determination block 3006.

If a report of the target wireless identity transmitter's proximity is not received (i.e., determination block 2910=“No”), in optional determination block 3022, the central server may determine whether a search sector command has been received. If a search sector command is not received (i.e., optional determination block 3022=No), the central server may continue with the operations in determination block 3006. However, if the central server receives a search sector command (i.e., optional determination block 3022=Yes), in optional block 2916 the central server may identify new sectors to search for the target wireless identity transmitter, such as new sectors consistent with the received search sector command. In optional block 2906′, the central server may transmit an alert to proximity broadcast receivers, such as a new alert to proximity broadcast receiver within the new sectors, and the central server may continue with the operations in determination block 3006.

If the search is not still active (i.e., determination block 3006=“No”), in determination block 3008 the central server may determine whether there are stored reward recipients related to the search. In this case, the central server may determine if a single reward recipient exists, as the search is configured to be active only until a first reward recipient is identified. If no reward recipients are stored related to the search (i.e., determination block 3008=“No”), the central server may cease operations regarding the search and/or the request for proximity information for the target wireless identity transmitter. However, if a reward recipient is stored related to the search (i.e., determination block 3008=“Yes”), in block 3010 the central server may determine a reward for each reward recipient. In this case, as the method 3100 is performed to delimit the set of reward recipients to a single recipient per search, the central server may determine that the reward recipient's reward is the entire reward identified with the operations in block 3004. For example, the one reward recipient may be the sole recipient of the grand prize of a treasure hunt. Alternatively, the one reward recipient may be the awarded the only monetary reward for finding a lost dog. In block 3012, the central server may transmit reward notification messages, such as messages to reward recipients that indicate the reward item or amount each has been awarded.

FIGS. 32A-32B illustrate a graphical user interface (GUI) element that simulates a scratch-off ticket that may prevent the user from obtaining a reward until he/she has fulfilled certain conditions. As described above, users of wireless identity transmitters, mobile proximity broadcast receivers, and/or identity transceivers may receive rewards for participating in searches or other reward programs. Rewards may be transmitted to devices associated with the user, such as a mobile device 3200 linked to the user within an account (or profile) stored within a central server. For example, the user may link a smartphone to the user's account created during registration of a wireless identity transmitter or an app installed on his/her smartphone. As another example, the user may indicate within a profile stored on the central server that messages (i.e., rewards) may be transmitted to his smartphone that is registered to operate as a mobile identity transceiver. However, the providers of such rewards (e.g., merchants, retail stores, etc.), may wish to tease or tantalize the user by showing reward information without providing the ability to claim the reward until the user fulfills certain requirements or conditions. For example, the user may be able to claim (or activate) a coupon reward after he/she has walked closer to a store department, broke a particular geofence boundary, or waited within a predefined area for a certain time. In an embodiment, digital techniques may be used to simulate a digital version of a scratch-off ticket, such as a ticket that has removable latex inks (e.g., a lottery ticket). Digital elements (i.e., digital “ink”) may appear to be scratched off to reveal a message, promo code, bar code, a game clue, a timer, or any other marketing information. The digital “ink” may be scratched off by a customer entering and getting closer to the middle of the geo-fence where a wireless identity transmitter is transmitting a signal (e.g., a broadcast message via Bluetooth protocols), or alternatively where a proximity broadcast receiver may receive broadcast messages from the customer's wireless identity transmitter. Such a technique may be an engaging experience for revealing information to the customer as well as an effective method for retailers, merchants, or other providing parties to drive customers to stores or other marketing areas.

FIG. 32A shows the mobile device 3200 displaying rewards within proximity of a user. A touchscreen display 3201 may be capable of receiving touch inputs from the user on a graphical user interface (GUI) rendered by software executing on the mobile device 3200. The graphical user interface may include a map graphic 3202 that indicates the user's current location, shown as a pin graphic 3203 on the rendered map graphic 3202. The graphical user interface may also include graphics corresponding to rewards within proximity (referred to as “nearby deals”), shown as circle graphics 3204, 3204′ within the rendered map graphic 3202. Information of such deals may be received from the central server and may be related to rewards programs established by registered services with the central server, such as merchants. In particular, the mobile device 3200 may receive a coupon 3205 reward from the central server in response to the user breaking a geofence associated with such a rewards program. For example, a coffee shop may be a registered service with the central server that awards the coupon 3205 to customers when they are determined to be within a certain proximity of the coffee shop. The mobile device 3200 may also display proximity information 3208 that indicates how close to a deal associated with the coupon 3205 the user may be at a given time. For example, the user may be 25 feet away from a nearby deal at a coffee shop.

The coupon 3205 may be associated with a graphical user interface element 3206 in an opaque state (i.e., the element 3206 may be solid and cannot be seen through). The element 3206 may be positioned over (or on top of) valuable information of the coupon 3205, such as a code for cashing-in or claiming the coupon 3205. In an embodiment, when the mobile device 3200 is not near (or within a predefined proximity threshold) to an area associated with the coupon 3205, the element 3206 may be configured to be deactivated, inaccessible, or otherwise incapable of being adjusted, moved, or seen through. For example, while the user is still outside of a coffee shop (e.g., 25 feet away), the mobile device 3200 may display the coupon 3205 associated with the coffee shop but also display the element 3206 in the opaque state so that the user cannot see a code underneath for claiming the coupon 3205. Thus, in such an opaque state, the element 3206 may prevent the user from utilizing (or claiming) the coupon 3205.

FIG. 32B shows the mobile device 3200 rendering a graphical user interface element 3206′ in a “scratched-off” state on the touchscreen display 3201. The coupon 3205 may include proximity information 3208′ that indicates how close to a deal the user may be at a given time. For example, the user may be 5 feet away from a nearby deal at a coffee shop. In an embodiment, in response to the mobile device 3200 being located within a predefined proximity threshold of a nearby deal, the element 3206′ may be configured to be in an adjustable state that may enable the user to reveal the coupon information underneath the element 3206′. For example, when the user carrying the mobile device 3200 walks from the street into a local coffee shop, the element 3206′ may become adjustable, such that touch inputs on the display 3201 (e.g., swipes, taps, button presses, etc.) may be used to uncover a coupon code for claiming a reward of half off baked goods at the local coffee shop.

For the purpose of illustration, a user may install a “deals nearby” application on his/her smartphone that is configured to operate as a mobile proximity broadcast receiver. The purpose of the application may be to encourage the user to investigate deals (e.g., popular nearby deals, highly-rated nearby deals, relevant nearby deals, etc.) within a geofence area, such as a geofence representing a retail store. The smartphone may be configured to periodically communicate via long-range transmissions over the Internet (e.g., via a cellular network, WiFi, etc.) with a central server to download lists of various rewards within the retail store, such as coupons, offers, or other promotions within the retail store. The application may cause the smartphone to render representations of the downloaded nearby rewards, such as by rendering a map of the retail store with indications of the various rewards throughout the retail store. The application may also cause the smartphone to render a visual coupon that states a discounted product is near a certain department within the store. The application may also cause the smartphone to render a scratch-off element as described above that obscures the details of the discount. For example, the user may not be able to see the product name, brand, description, or discount amount (e.g., percentage off the regular price) associated with the coupon. The user may also not be able to remove the scratch-off element (i.e., the element may be disabled). However, when the user walks to the certain department associated with the coupon, the smartphone may receive a short-range wireless broadcast message (e.g., Bluetooth LE signal) from a wireless identity transmitter within an end cap. The smartphone may transmit a sighting message to the central server, and may receive a return message from the central server. Based on the return message, the application may cause the smartphone to activate the scratch-off element such that the user may reveal the coupon information underneath the element. In particular, the user may remove the scratch-off element and reveal the details of the coupon by swiping his/her fingers back-and-forth over the GUI element on the smartphone's touchscreen. The user may then present the revealed coupon details (e.g., a code) to a store clerk to claim the discount.

FIG. 32C illustrates an embodiment method 3250 for revealing reward information on a mobile device with a graphical user interface employing a scratch-off element. The method 3250 may be performed by a mobile device, such as a smartphone, a tablet, or a mobile proximity broadcast receiver, to implement a user interface as described above with reference to FIGS. 32A-32B. In block 3252, the mobile device may obtain reward information. For example, the reward information may be a coupon, promotion, or other information transmitted by a central server in response to the mobile device transmitting sighting messages related to an active search (e.g., search for a stolen bulldozer), marketing ploy (e.g., a treasure hunt/scavenger hunt), or other rewards program. In block 3254, the mobile device may display a graphical user interface (i.e., GUI) with a “scratch-off” element positioned over the reward information. In other words, the element may be rendered to appear consistent with a scratch-off card or ticket. The element may be rendered on the mobile device's touchscreen display such that it obscures or covers the reward information or an area of the display where the reward information is supposed to be rendered. In an embodiment, the scratch-off element may be a graphic that distorts information placed (or rendered) behind it on the display of the mobile device. For example, the element may appear consistent with a wavy graphic. The mobile device may display the element, along with various read-outs, messages, labels, and graphics, on a touchscreen display that is configured to detect touch inputs on or around the surface of the display unit.

In block 3256, the mobile device may receive touch inputs, such as finger swipes, wipes, scratches, and taps on the mobile device's touchscreen display. In determination block 3258, the mobile device may determine whether the received inputs match a scratching gesture over the element. The mobile device may perform various pattern recognition operations to determine whether the touch inputs correspond to a scratching gesture. For example, the mobile device may evaluate touch inputs received over a period of time (e.g., a second) to identify whether the inputs represent a finger moving back-and-forth (i.e., a back-and-forth movement) similar to a scratch or a swipe. The mobile device may also compare the location of the received touch inputs on the touchscreen display to the position of the element as displayed within the graphical user interface. For example, the mobile device may compare the x-axis and y-axis coordinates of the received touch inputs to the area of the touchscreen that displays the opaque graphic element to detect whether the user interacted with the element. If the inputs are not a scratching gesture over the element (i.e., determination block 3258=“No”), the mobile device may continue with the operations in block 3256. For example, if the touch inputs are taps or are scratches that do not coincide with the element on the touchscreen, the mobile device may continue to listen for more touch inputs.

If the inputs match a scratching gesture over the element (i.e., determination block 3258=“Yes”), in block 3260 the mobile device may animate the removal of the scratch-off element and the substitution of the reward information based on the touch inputs. In particular, the scratch-off element may be removed and the reward information may be added only in the areas of the touchscreen display that correspond to the received scratching gesture touch inputs. In other words, the element may be removed based on the touch inputs to reveal the reward information where the element was once displayed. The element removal and reward information substitution may be partial such that portions of the element and the reward information are displayed simultaneously.

FIG. 32D illustrates an embodiment method 3275 for revealing reward information on a mobile device with a graphical user interface employing a scratch-off element. The method 3275 is similar to the method 3250 described above, except the method 3275 may include further operations to activate the scratch-off element when a user is within proximity of a predefined area. For example, the mobile device may display a coupon with a scratch-off element that the user cannot adjust to reveal rewards information until he/she walks within a certain proximity threshold of a retail store's front door.

In block 3252, the mobile device may obtain reward information. In an embodiment, the mobile device may obtain reward information in response to breaking a geofence perimeter. For example, the mobile device may receive reward information from a central server based on GPS coordinates related to the mobile device. Alternatively, the mobile device may execute a software routine, service, or other operations that monitor location data (e.g., GPS coordinates from a GPS chip), and may request reward information when the mobile device's location data is within a predefined area. For example, the mobile device may execute an application that stores geofence location data for a certain chain of retail stores, monitors the mobile device's current GPS coordinates, and requests reward information from the central server when the mobile device is determined to be within such a retail store.

In block 3254, the mobile device may display a graphical user interface (i.e., GUI) with a “scratch-off” element positioned over the reward information. In block 3278, the mobile device may disable the scratch-off element, such as by configuring the graphical user interface to ignore touch inputs coinciding with the displayed scratch-off element. In other words, the reward information may not be revealed regardless of any received user touch inputs. In determination block 3280, the mobile device may determine whether a scratch-off activation signal is received. Such an activation signal may be within a return message transmitted by a central server in response to detecting the mobile device is within proximity of an area associated with the reward information. For example, the reward information may be a coupon for a product that may only be “unlocked” when the mobile device is within a proximity threshold of a proximity broadcast receiver positioned near an aisle in a retail store that houses that product. Alternatively, the scratch-off activation signal may be transmitted to the mobile device at a certain time or date, such as on Black Friday. If the scratch-off activation signal is not received (i.e., determination block 3280=“No”), the mobile device may continue to monitor for the activation signal in determination block 3280. In other words, the scratch-off element may stay locked.

If the scratch-off activation signal is received (i.e., determination block 3280=“Yes”), in block 3282 the mobile device may activate the scratch-off element, thereby configuring the graphical user interface to recognize any touch inputs coinciding with the element. In block 3256, the mobile device may receive touch inputs, such as finger swipes, wipes, scratches, and taps on the mobile device's touchscreen display. In determination block 3258, the mobile device may determine whether the received inputs match a scratching gesture over the element. If the inputs are not a scratching gesture over the element (i.e., determination block 3258=“No”), the mobile device may continue with the operations in block 3256. If the inputs match a scratching gesture over the element (i.e., determination block 3258=“Yes”), in block 3260 the mobile device may animate the removal of the scratch-off element and the substitution of the reward information based on the touch inputs.

In another embodiment, scratch-off activation signals may be broadcast by devices associated with rewards. For example, a retail store may deploy an identity transceiver at the location of a deal associated with a disabled scratch-off coupon. The identity transceiver may be configured to broadcast activation signals for the reward, such that when the mobile device is within proximity of the identity transceiver, the scratch-off element may be activated. This embodiment may still utilize proximity to activate a scratch-off coupon without requiring another communication with the central server.

FIG. 33A illustrates components of an exemplary wireless identity transmitter 110. The wireless identity transmitter 110 may include a microcontroller 3302, a short-range radio 3304 (e.g., a Bluetooth® radio or transceiver) coupled to an antenna 3306, a memory 3308, and a battery 3310. Although these components are shown linked by a common connection, they may be interconnected and configured in various ways. For example, a wireless identity transmitter 110 may be configured such that the microcontroller 3302 may determine when to transmit a message based on the contents of the memory 3308. In an embodiment, the microcontroller 3302 may be a Bluetooth® system-on-chip unit. The memory 3308 may also include one or more messages or message portions to be transmitted by the short-range radio 3304 via the antenna 3306 based on commands from the microcontroller 3302. The battery 3310 may supply power as needed by the other components. Also, in some implementations the microcontroller 3302, the short-range radio 3304 and/or the memory 3308 may be integrated together as a single integrated circuit. Since these components may be microchips of standard or off-the-shelf configuration, they are represented in FIG. 33A as blocks consistent with the structure of an example embodiment.

The wireless identity transmitter 110 may be coupled with or built into various objects, such as a bracelet. For example, an exemplary wireless identity transmitter 110 may be in a form easily attached to a strap, such as a watchband or dog collar. Alternate embodiments may incorporate a wireless identity transmitter 110 into any other mobile objects that may need tracking.

The wireless identity transmitter 110 may conserve power by periodically entering a power saving mode or going to sleep, such as regularly alternating between sleeping and broadcasting of the packet with the wireless identity transmitter 110's identification code. Various embodiments may include different cycles of broadcasting and sleeping, such as some embodiments broadcasting more or less frequently, such as waking and broadcasting every few seconds or minutes between periods of sleep.

In an embodiment, the battery 3310 may be a replaceable coin cell battery. In another embodiment, the wireless identity transmitter 110 may utilize the antenna 3306 to receive update software, instructions, or other data for storage and use in configuration operations, such as configuring transmission intervals and/or transmissions power. The wireless identity transmitter 110 may also store and execute software, algorithms, instructions, code, or other routines for generating rolling codes or identifiers, as described above. In an embodiment, the wireless identity transmitter may not maintain time (e.g., UTC) information, but may instead use a 30 ppm 16 kHz crystal as a clock. Such use of a crystal as a clock may create a timing drift of approximately 40 seconds per year.

FIG. 33B illustrates components of an embodiment wireless identity transmitter 110. Similar to the embodiment described above with reference to FIG. 33A, the wireless identity transmitter 110 may include a microcontroller 3302, a short-range radio 3304 (e.g., Bluetooth®, BTLE, Zigbee®, Peanut®, etc.) connected to an antenna 3306 and coupled to the microcontroller 3302, memory 3308, and a battery unit 3310. Alternatively the memory 3308 may be contained within the microcontroller 3302, which may also include a separate processing unit. The short-range radio 3304 may be a transmitter capable of broadcasting messages or signals including a device ID or, alternatively, a transceiver configured to transmit and receive RF signals, enabling communications with other devices utilizing a communication protocol. For example, the wireless identity transmitter 110 may be configured to communicate with other short-range radio enabled devices, such as smartphones. In an embodiment, the short-range radio 3304 may be configured to communicate via various low-energy, wireless communication protocols, such as LTE-D, peer-to-peer LTE-D, and WiFi-Direct.

In an embodiment, the wireless identity transmitter 110 may include a speaker (not shown) configured to emit a sound capable of being received by a proximity broadcast receiver and/or being heard by a heard by a user. For example, the wireless identity transmitter 110 may emit audible communications that may indicate its presence to listening proximity broadcast receivers. In another embodiment, the wireless identity transmitter 110 may be configured to transmit signals at varying signal strengths, thereby varying the range at which broadcasts from the wireless identity transmitter 110 may be received by proximity broadcast receivers.

Additionally, the wireless identity transmitter 110 may include one or more sensors for measuring various conditions and variables. In an embodiment, the wireless identity transmitter 110 may include an accelerometer 3315 (or any other motion sensor such as a gyroscope or gravitometer), which may collect data indicative of motion of an asset associated with the wireless identity transmitter 110. For example, the accelerometer 3315 may generate motion data describing the movements of a child carrying the wireless identity transmitter 110. Other sensors that may be included within the wireless identity transmitter 110 include a temperature sensor 3316 (such as a thermistor), a radiation sensor 3317, a humidity sensor 3318, and a carbon dioxide (CO₂) sensor 3319. In the various embodiments, the wireless identity transmitter 110 may include any combination of these and other sensors. These potential sensors are only examples of the types of sensors that may be integrated into wireless identity transmitters 110 and other types of sensors may be included. For example, the wireless identity transmitter 110 may also include sensors not shown in the various diagrams, such as a microphone, a camera, a heat sensor, a pressure sensor, and a light sensor.

FIG. 34A illustrates primary components of an exemplary proximity broadcast receiver embodiment. The proximity broadcast receiver 142 may include a short-range radio 3404 (e.g., a Bluetooth radio or transceiver) capable of communicating with a short-range wireless radio (e.g., a Bluetooth® radio in the wireless identity transmitter) coupled to an antenna 3406, and a secondary network device 3408 capable of communicating directly or indirectly back to a central server via a network, such as the Internet. In some embodiments, the secondary network device 3408 may be a cellular or wireless radio or a modem or other wired network device. The proximity broadcast receiver 142 may also include a processor 3402, a memory 3412, and a battery 3410 either as the primary power supply or as a backup power supply in the case of proximity broadcast receiver 142 coupled to utility power. The proximity broadcast receiver 142 may include a GPS receiver 3414 or other type of location determining mechanism for determining a current location to associate with any message received from a wireless identity transmitter. If the proximity broadcast receiver is not mobile, it may not include a GPS receiver 3414 in some embodiments since the location may be known and constant. Although these components are shown linked by a common connection, they may interconnected and configured in various ways. Since these components may be microchips of standard or off-the-shelf configuration, they are represented in FIG. 34A as blocks consistent with the structure of an example embodiment.

FIG. 34B illustrates an embodiment proximity broadcast receiver 3475 that can be plugged into a power outlet. Similar to the embodiment described above with reference to FIG. 34A, the proximity broadcast receiver 3475 may include a processor 3402, a memory unit 3412, and a short-range radio 3404 (e.g., Bluetooth®, Bluetooth® LE, LTE-D, peer-to-peer LTE-D, Zigbee®, Peanut®, etc.) connected to an antenna 3406. The proximity broadcast receiver 3475 may also include a WiFi system-on-chip 3478 (referred to as “SOC” in FIG. 34B) coupled to a second antenna 3476. In another embodiment, the system-on-chip 3478 may be a Bluetooth® Low Energy system-on-chip. The proximity broadcast receiver 3475 may utilize the system-on-chip 3478 to exchange data over a wireless local area network, such as by communicating with a WiFi router. Additionally, the proximity broadcast receiver 3475 may include a plug 3482 for interfacing with a power supply or otherwise receiving power, such as alternating current power (or “AC”). In various embodiments, the plug 3482 may be configured to connect with different power outlets standards (e.g., British Standards, National Electrical Manufacturers Association, etc.), and may include a grounding element (not shown). The plug 3482 may be coupled to a USB Power supply 3480 that provides power to the various components of the proximity broadcast receiver 3475, such as the processor 3402. In an alternative embodiment, the proximity broadcast receiver 3475 may recharge an internal battery (not shown) using power received from the plug 3482 and/or USB power supply 3480.

In an embodiment, the proximity broadcast receiver 3475 may store software instructions, such as within the memory 3412 or other circuitry that may be utilized by the processor 3402 and/or the system-on-chip 3478 to perform operations to transmit and/or receive short-range and long-range signals, respectively. In an embodiment, the proximity broadcast receiver 3475 may utilize the antennas 3406, 3476 to receive update software, instructions, or other data for storage and use in updating firmware, modifying operating parameters, and other configuration modifications.

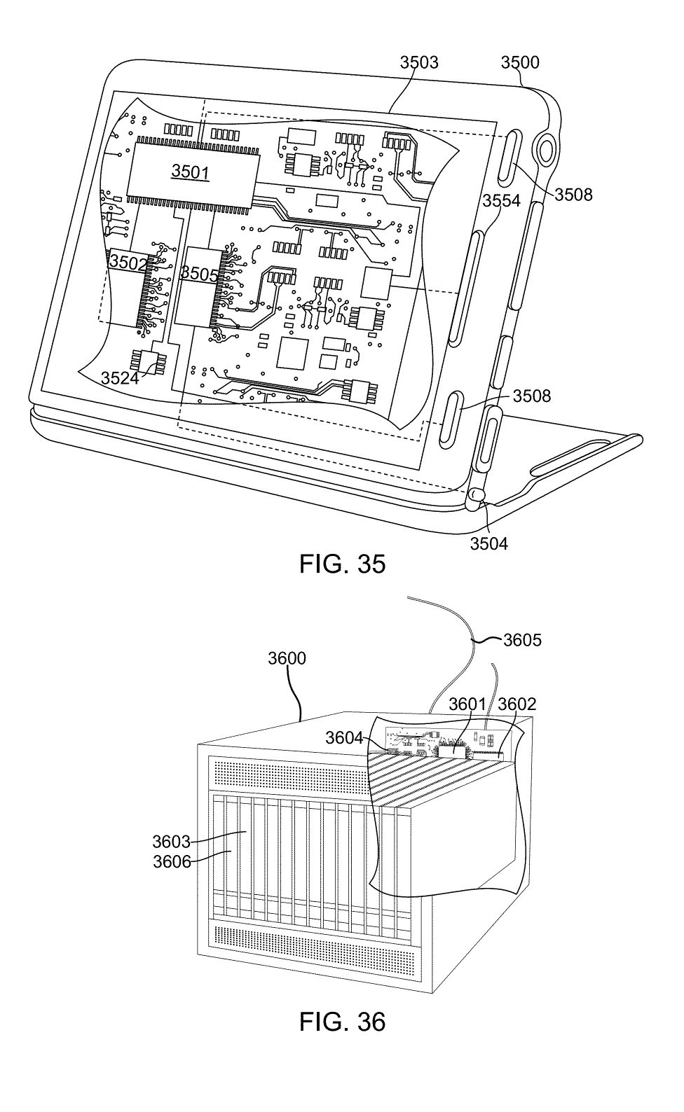

FIG. 35 is a system block diagram of a smartphone type mobile device suitable for use with various embodiments. A smartphone 3500 may include a processor 3501 coupled to internal memory 3502, a display 3503, and to a speaker 3554. Additionally, the smartphone 3500 may include an antenna 3504 for sending and receiving electromagnetic radiation that may be connected to a wireless data link and/or cell telephone transceiver 3505 coupled to the processor 3501 and capable of communicating over a wide area wireless communication network. Smartphones may include a separate short-range radio transceiver 3524 capable of communicating or pairing with wireless identity transmitters. Smartphones 3500 typically may also include menu selection buttons or rocker switches 3508 for receiving user inputs.

FIG. 36 is a system block diagram of a server 3600 suitable for implementing the various embodiments of this disclosure. The server 3600 may be a commercially available server device. Such a server 3600 typically includes a processor 3601 coupled to volatile memory 3602 and a large capacity nonvolatile memory, such as a disk drive 3603. The server 3600 may also include a floppy disc drive, compact disc (CD) or DVD disc drive 3606 coupled to the processor 3601. The server 3600 may also include network access ports 3604 coupled to the processor 3601 for establishing data connections with a network 3605, such as a local area network coupled to other broadcast system computers and servers.

The processors 3501, 3601 may be any programmable microprocessor, microcomputer or multiple processor chip or chips that can be configured by software instructions (applications) to perform a variety of functions, including the functions of the various embodiments described below. In some mobile proximity broadcast receivers, multiple processors 3501 may be provided, such as one processor dedicated to wireless communication functions and one processor dedicated to running other applications. Typically, software applications may be stored in the internal memory 3502, 3602 before they are accessed and loaded into the processor 3501, 3601. The processor 3501, 3601 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for presenting rewards information to a user, comprising:
receiving in a server a sighting message that includes an identifier of a wireless identity transmitter associated with an individual;
determining in the server whether the wireless identity transmitter is associated with the user based on the identifier;
determining in the server whether the sighting message is related to a rewards program based on information included within the sighting message;
calculating a rewards program status information for the user when the wireless identity transmitter is associated with the user and the sighting message is related to the rewards program; and
transmitting a first message that includes the calculated rewards program status information.

2. The method of claim 1, wherein the rewards program status information includes information related to at least one of an achieved goal, an achieved reward, progress towards achieving a goal or a reward, and instructions on how to achieve.

3. The method of claim 1, wherein the identifier is a rolling identifier generated via an algorithm that uses a unique device identifier of the wireless identity transmitter and a secret key shared with the server.

4. The method of claim 1, further comprising:
determining whether user data is authorized to be shared based on permissions settings associated with the user; and
transmitting a second message to a party associated with the rewards program when the user data is authorized to be shared, wherein the party includes at least one of a caregiver, a parent, a teacher, a coach, and a trainer.

5. The method of claim 1, further comprising extracting sensor data from the received sighting message, wherein sensor data includes at least accelerometer sensor data, thermometer sensor data, and pulse sensor data, and
wherein calculating a rewards program status information comprises calculating the rewards program status information using the extracted sensor data.

6. The method of claim 1, further comprising determining whether the wireless identity transmitter is within proximity of a reward area based on the received sighting message, and
wherein calculating a rewards program status information comprises calculating the rewards program status information for the user based on the wireless identity transmitter being within proximity of the reward area.

7. The method of claim 6, further comprising transmitting a second message instructing a device to activate based on the calculated rewards program status information, wherein the device includes at least one of a television, an iPad, a wireless router, telephone, and a laptop, and
wherein the device is instructed to be unlocked for use by the user for a certain period of time.

8. A method for presenting rewards to encourage participation in a search for a target wireless identity transmitter, comprising:
activating the search based on a request from a requester for proximity information of the target wireless identity transmitter;
receiving in a server a sighting message that includes an identifier of the target wireless identity transmitter;
determining whether the proximity information related to the target wireless identity transmitter is received based on the identifier within the received sighting message;
identifying a first recipient as a user of a proximity broadcast receiver that transmitted the sighting message when the proximity information related to the target wireless identity transmitter is received and when the search is active; and
determining a first reward for the identified first recipient based on the request.

9. The method of claim 8, wherein the identifier is a rolling identifier generated via an algorithm that uses a unique device identifier of the target wireless identity transmitter and a secret key shared with the server.

10. The method of claim 8, further comprising transmitting a reward notification message to the identified first recipient that indicates the first reward.

11. The method of claim 8, further comprising transmitting a response message to the requester when the proximity information related to the target wireless identity transmitter is received and the search is active.

12. The method of claim 8, further comprising providing a second reward to a second recipient associated with a device that provided connectivity for the sighting message, wherein the device is one of an access point, a cell site, a local server, a local computing device, and a WiFi router.

13. The method of claim 12, wherein the second reward is one of a small percentage of the first reward and a small flat fee.

14. The method of claim 8, further comprising identifying search conditions and reward information based on the request, wherein the search conditions indicate when the search may be active, and wherein the reward information indicates how rewards are divided between reward recipients.

15. The method of claim 8, further comprising transmitting a reward notification message to a reward server.

16. The method of claim 8, wherein the target wireless identity transmitter is associated with at least one of a scavenger hunt, a lost item, a missing item, a stolen item, and an advertising activity.

17. The method of claim 8, further comprising deactivating the search when the proximity information related to the target wireless identity transmitter is received and when the search is active.

18. A server configured to present rewards information to a user, comprising:
means for receiving in the server a sighting message that includes an identifier of a wireless identity transmitter associated with an individual;
means for determining in the server whether the wireless identity transmitter is associated with the user based on the identifier;
means for determining in the server whether the sighting message is related to a rewards program based on information included within the sighting message;
means for calculating a rewards program status information for the user when the wireless identity transmitter is associated with the user and the sighting message is related to the rewards program; and
means for transmitting a first message that includes the calculated rewards program status information.

19. The server of claim 18, wherein the rewards program status information includes information related to at least one of an achieved goal, an achieved reward, progress towards achieving a goal or a reward, and instructions on how to achieve.

20. The server of claim 19, wherein the identifier is a rolling identifier generated via an algorithm that uses a unique device identifier of the wireless identity transmitter and a secret key shared with the server.

21. The server of claim 18, further comprising:
means for determining whether user data is authorized to be shared based on permissions settings associated with the user; and
means for transmitting a second message to a party associated with the rewards program when the user data is authorized to be shared, wherein the party includes at least one of a caregiver, a parent, a teacher, a coach, and a trainer.

22. The server of claim 18, further comprising means for extracting sensor data from the received sighting message, wherein sensor data includes at least accelerometer sensor data, thermometer sensor data, and pulse sensor data, and wherein means for calculating a rewards program status information comprises means for calculating the rewards program status information using the extracted sensor data.

23. The server of claim 18, further comprising means for determining whether the wireless identity transmitter is within proximity of a reward area based on the received sighting message, and
wherein means for calculating a rewards program status information comprises means for calculating the rewards program status information for the user based on the wireless identity transmitter being within proximity of the reward area.

24. The server of claim 23, further comprising means for transmitting a second message instructing a device to activate based on the calculated rewards program status information, wherein the device includes at least one of a television, a tablet, a wireless router, telephone, and a laptop, and
wherein the device is instructed to be unlocked for use by the user for a certain period of time.

25. A server configured to present rewards to encourage participation in a search for a target wireless identity transmitter, comprising:
means for activating the search based on a request from a requester for proximity information of the target wireless identity transmitter;
means for receiving in the server a sighting message that includes an identifier of the target wireless identity transmitter;
means for determining whether the proximity information related to the target wireless identity transmitter is received based on the identifier within the received sighting message;
means for identifying a first recipient as a user of a proximity broadcast receiver that transmitted the sighting message when the proximity information related to the target wireless identity transmitter is received and when the search is active; and
means for determining a first reward for the identified first recipient based on the request.

26. The server of claim 25, wherein the identifier is a rolling identifier generated via an algorithm that uses a unique device identifier of the target wireless identity transmitter and a secret key shared with the server.

27. The server of claim 25, further comprising means for transmitting a reward notification message to the identified first recipient that indicates the first reward.

28. The server of claim 25, further comprising means for transmitting a response message to the requester when the proximity information related to the target wireless identity transmitter is received and the search is active.

29. The server of claim 25, further comprising means for providing a second reward to a second recipient associated with a device that provided connectivity for the sighting message, wherein the device is one of an access point, a cell site, a local server, a local computing device, and a WiFi router.

30. The server of claim 29, wherein the second reward is one of a small percentage of the first reward and a small flat fee.

31. The server of claim 25, further comprising means for identifying search conditions and reward information based on the request, wherein the search conditions indicate when the search may be active, and wherein the reward information indicates how rewards are divided between reward recipients.

32. The server of claim 25, further comprising means for transmitting a reward notification message to a reward server.

33. The server of claim 25, wherein the target wireless identity transmitter is associated with at least one of a scavenger hunt, a lost item, a missing item, a stolen item, and an advertising activity.

34. The server of claim 25, further comprising means for deactivating the search when the proximity information related to the target wireless identity transmitter is received and when the search is active.

35. A server configured to present rewards information to a user, comprising:
a memory; and
a server processor coupled to the memory, wherein the server processor is configured with server processor-executable instructions to perform operations comprising:
receiving in the server a sighting message that includes an identifier of a wireless identity transmitter associated with an individual;
determining in the server whether the wireless identity transmitter is associated with the user based on the identifier;
determining in the server whether the sighting message is related to a rewards program based on information included within the sighting message;
calculating a rewards program status information for the user when the wireless identity transmitter is associated with the user and the sighting message is related to the rewards program; and
transmitting a first message that includes the calculated rewards program status information.

36. The server of claim 35, wherein the rewards program status information includes information related to at least one of an achieved goal, an achieved reward, progress towards achieving a goal or a reward, and instructions on how to achieve.

37. The server of claim 36, wherein the identifier is a rolling identifier generated via an algorithm that uses a unique device identifier of the wireless identity transmitter and a secret key shared with the server.

38. The server of claim 35, wherein the server processor is configured with server processor-executable instructions to perform operations further comprising:
determining whether user data is authorized to be shared based on permissions settings associated with the user; and
transmitting a second message to a party associated with the rewards program when the user data is authorized to be shared, wherein the party includes at least one of a caregiver, a parent, a teacher, a coach, and a trainer.

39. The server of claim 35, wherein the server processor is configured with server processor-executable instructions to perform operations further comprising extracting sensor data from the received sighting message, wherein sensor data includes at least accelerometer sensor data, thermometer sensor data, and pulse sensor data, and
wherein the server processor is configured with server processor-executable instructions to perform operations such that calculating a rewards program status information comprises calculating the rewards program status information using the extracted sensor data.

40. The server of claim 35, wherein the server processor is configured with server processor-executable instructions to perform operations further comprising determining whether the wireless identity transmitter is within proximity of a reward area based on the received sighting message, and
wherein the server processor is configured with server processor-executable instructions to perform operations such that calculating a rewards program status information comprises calculating the rewards program status information for the user based on the wireless identity transmitter being within proximity of the reward area.

41. The server of claim 40, wherein the server processor is configured with server processor-executable instructions to perform operations further comprising transmitting a second message instructing a device to activate based on the calculated rewards program status information, wherein the device includes at least one of a television, a tablet, a wireless router, telephone, and a laptop, and
wherein the device is instructed to be unlocked for use by the user for a certain period of time.

42. A server configured to present rewards to encourage participation in a search for a target wireless identity transmitter, comprising:
a memory; and
a server processor coupled to the memory, wherein the server processor is configured with server processor-executable instructions to perform operations comprising:
activating the search based on a request from a requester for proximity information of the target wireless identity transmitter;
receiving in the server a sighting message that includes an identifier of the target wireless identity transmitter;
determining whether the proximity information related to the target wireless identity transmitter is received based on a rolling identifier within the received sighting message;
identifying a first recipient as a user of a proximity broadcast receiver that transmitted the sighting message when the proximity information related to the target wireless identity transmitter is received and when the search is active; and
determining a first reward for the identified first recipient based on the request.

43. The server of claim 42, wherein the identifier is a rolling identifier generated via an algorithm that uses a unique device identifier of the target wireless identity transmitter and a secret key shared with the server.

44. The server of claim 42, wherein the server processor is configured with server processor-executable instructions to perform operations further comprising transmitting a reward notification message to the identified first recipient that indicates the first reward.

45. The server of claim 42, wherein the server processor is configured with server processor-executable instructions to perform operations further comprising transmitting a response message to the requester when the proximity information related to the target wireless identity transmitter is received and the search is active.

46. The server of claim 42, wherein the server processor is configured with server processor-executable instructions to perform operations further comprising providing a second reward to a second recipient associated with a device that provided connectivity for the sighting message, wherein the device is one of an access point, a cell site, a local server, a local computing device, and a WiFi router.

47. The server of claim 46, wherein the second reward is one of a small percentage of the first reward and a small flat fee.

48. The server of claim 42, wherein the server processor is configured with server processor-executable instructions to perform operations further comprising identifying search conditions and reward information based on the request, wherein the search conditions indicate when the search may be active, and wherein the reward information indicates how rewards are divided between reward recipients.

49. The server of claim 42, wherein the server processor is configured with server processor-executable instructions to perform operations further comprising transmitting a reward notification message to a reward server.

50. The server of claim 42, wherein the target wireless identity transmitter is associated with at least one of a scavenger hunt, a lost item, a missing item, a stolen item, and an advertising activity.

51. The server of claim 42, wherein the server processor is configured with server processor-executable instructions to perform operations further comprising deactivating the search when the proximity information related to the target wireless identity transmitter is received and when the search is active.

52. A non-transitory server-readable storage medium having stored thereon server-executable instructions configured to cause a server to perform operations to present rewards information to a user, the operations comprising:
receiving in the server a sighting message that includes an identifier of a wireless identity transmitter associated with an individual;
determining in the server whether the wireless identity transmitter is associated with the user based on the identifier;
determining in the server whether the sighting message is related to a rewards program based on information included within the sighting message;
calculating a rewards program status information for the user when the wireless identity transmitter is associated with the user and the sighting message is related to the rewards program; and
transmitting a first message that includes the calculated rewards program status information.

53. The non-transitory server-readable storage medium of claim 52, wherein the rewards program status information includes information related to at least one of an achieved goal, an achieved reward, progress towards achieving a goal or a reward, and instructions on how to achieve.

54. The non-transitory server-readable storage medium of claim 53, wherein the identifier is a rolling identifier generated via an algorithm that uses a unique device identifier of the wireless identity transmitter and a secret key shared with the server.

55. The non-transitory server-readable storage medium of claim 52, wherein the stored server-executable instructions are configured to cause the server to perform operations further comprising:
determining whether user data is authorized to be shared based on permissions settings associated with the user; and
transmitting a second message to a party associated with the rewards program when the user data is authorized to be shared, wherein the party includes at least one of a caregiver, a parent, a teacher, a coach, and a trainer.

56. The non-transitory server-readable storage medium of claim 52, wherein the stored server-executable instructions are configured to cause the server to perform operations further comprising extracting sensor data from the received sighting message, wherein sensor data includes at least accelerometer sensor data, thermometer sensor data, and pulse sensor data, and
wherein the stored server-executable instructions are configured to cause the server to perform operations such that calculating a rewards program status information comprises calculating the rewards program status information using the extracted sensor data.

57. The non-transitory server-readable storage medium of claim 52, wherein the stored server-executable instructions are configured to cause the server to perform operations further comprising determining whether the wireless identity transmitter is within proximity of a reward area based on the received sighting message, and
wherein the stored server-executable instructions are configured to cause the server to perform operations such that calculating a rewards program status information comprises calculating the rewards program status information for the user based on the wireless identity transmitter being within proximity of the reward area.

58. The non-transitory server-readable storage medium of claim 57, wherein the stored server-executable instructions are configured to cause the server to perform operations further comprising transmitting a second message instructing a device to activate based on the calculated rewards program status information, wherein the device includes at least one of a television, a tablet, a wireless router, telephone, and a laptop, and
wherein the device is instructed to be unlocked for use by the user for a certain period of time.

59. A non-transitory server-readable storage medium having stored thereon server-executable instructions configured to cause a server to perform operations to present rewards to encourage participation in a search for a target wireless identity transmitter, the operations comprising:
activating the search based on a request from a requester for proximity information of the target wireless identity transmitter;
receiving in the server a sighting message that includes an identifier of the target wireless identity transmitter;
determining whether the proximity information related to the target wireless identity transmitter is received based on the identifier within the received sighting message;
identifying a first recipient as a user of a proximity broadcast receiver that transmitted the sighting message when the proximity information related to the target wireless identity transmitter is received and when the search is active; and
determining a first reward for the identified first recipient based on the request.

60. The non-transitory server-readable storage medium of claim 59, wherein the identifier is a rolling identifier generated via an algorithm that uses a unique device identifier of the target wireless identity transmitter and a secret key shared with the server.

61. The non-transitory server-readable storage medium of claim 59, wherein the stored server-executable instructions are configured to cause the server to perform operations further comprising transmitting a reward notification message to the identified first recipient that indicates the first reward.

62. The non-transitory server-readable storage medium of claim 59, wherein the stored server-executable instructions are configured to cause the server to perform operations further comprising transmitting a response message to the requester when the proximity information related to the target wireless identity transmitter is received and the search is active.

63. The non-transitory server-readable storage medium of claim 59, wherein the stored server-executable instructions are configured to cause the server to perform operations further comprising providing a second reward to a second recipient associated with a device that provided connectivity for the sighting message, wherein the device is one of an access point, a cell site, a local server, a local computing device, and a WiFi router.

64. The non-transitory server-readable storage medium of claim 63, wherein the second reward is one of a small percentage of the first reward and a small flat fee.

65. The non-transitory server-readable storage medium of claim 59, wherein the stored server-executable instructions are configured to cause the server to perform operations further comprising identifying search conditions and reward information based on the request, wherein the search conditions indicate when the search may be active, and wherein the reward information indicates how rewards are divided between reward recipients.

66. The non-transitory server-readable storage medium of claim 59, wherein the stored server-executable instructions are configured to cause the server to perform operations further comprising transmitting a reward notification message to a reward server.

67. The non-transitory server-readable storage medium of claim 59, wherein the target wireless identity transmitter is associated with at least one of a scavenger hunt, a lost item, a missing item, a stolen item, and an advertising activity.

68. The non-transitory server-readable storage medium of claim 59, wherein the stored server-executable instructions are configured to cause the server to perform operations further comprising deactivating the search when the proximity information related to the target wireless identity transmitter is received and when the search is active.

69. A system, comprising:
a server;
a wireless identity transmitter; and
a proximity broadcast receiver,
wherein the wireless identity transmitter comprises:
a first memory;
a first transceiver configured to broadcast short-range wireless signals capable of being received by the proximity broadcast receiver; and
a first processor coupled to the first memory and the first transceiver, and configured with processor-executable instructions to perform operations comprising:
generating a rolling identifier periodically via an algorithm that uses a unique device identifier of the wireless identity transmitter that is associated with an individual and a secret key shared with the server; and
periodically broadcasting via the first transceiver a short-range wireless signal including the rolling identifier of the wireless identity transmitter, and
wherein the proximity broadcast receiver comprises:
a second memory;
a second transceiver configured to exchange short-range wireless signals with the wireless identity transmitter;
a network device configured to exchange signals with the server;
a second processor coupled to the second memory, the second transceiver, and the network device and configured with processor-executable instructions to perform operations comprising:
receiving via the second transceiver the short-range wireless signal including the rolling identifier broadcast by the wireless identity transmitter within proximity;
generating a sighting message in response to the received signal, wherein the sighting message includes the rolling identifier and associated data; and
transmitting the sighting message via long-range communications using the network device, and
wherein the server is configured with server-executable instructions to perform operations comprising:
receiving in the server the sighting message that includes the rolling identifier;
determining in the server whether the wireless identity transmitter is associated with a user based on the rolling identifier;
determining in the server whether the sighting message is related to a rewards program based on information included within the sighting message;
calculating a rewards program status information for the user when the wireless identity transmitter is associated with the user and the sighting message is related to the rewards program; and
transmitting a first message that includes the calculated rewards program status information.

70. The system of claim 69, wherein the rewards program status information includes information related to at least one of an achieved goal, an achieved reward, progress towards achieving a goal or a reward, and instructions on how to achieve.

71. The system of claim 70, wherein the achieved reward may be at least one of a coupon, a prize, an encouraging message, a benefit, an accolade, and a special offer.

72. The system of claim 69, wherein the server is configured with server-executable instructions to perform operations further comprising:
determining whether user data is authorized to be shared based on permissions settings associated with the user; and
transmitting a second message to a party associated with the rewards program when the user data is authorized to be shared, wherein the party includes at least one of a caregiver, a parent, a teacher, a coach, and a trainer.

73. The system of claim 69, wherein the server is configured with server-executable instructions to perform operations further comprising extracting sensor data from the received sighting message, wherein sensor data includes at least accelerometer sensor data, thermometer sensor data, and pulse sensor data, and
wherein the server is configured with server-executable instructions to perform operations such that calculating a rewards program status information comprises calculating the rewards program status information using the extracted sensor data.

74. The system of claim 69, wherein the server is configured with server-executable instructions to perform operations further comprising determining whether the wireless identity transmitter is within proximity of a reward area based on the received sighting message, and
wherein the server is configured with server-executable instructions to perform operations such that calculating a rewards program status information comprises calculating the rewards program status information for the user based on the wireless identity transmitter being within proximity of the reward area.

75. The system of claim 74, wherein the server is configured with server-executable instructions to perform operations further comprising transmitting a second message instructing a device to activate based on the calculated rewards program status information, wherein the device includes at least one of a television, a tablet, a wireless router, telephone, and a laptop, and
wherein the device is instructed to be unlocked for use by the user for a certain period of time.

76. A system, comprising:
a server;
a wireless identity transmitter; and
a proximity broadcast receiver,
wherein the wireless identity transmitter comprises:
a first memory;
a first transceiver configured to broadcast short-range wireless signals capable of being received by the proximity broadcast receiver; and
a first processor coupled to the first memory and the first transceiver, and configured with processor-executable instructions to perform operations comprising:
generating a rolling identifier periodically via an algorithm that uses a unique device identifier of the wireless identity transmitter that is associated with an individual and a secret key shared with the server; and
periodically broadcasting via the first transceiver a short-range wireless signal including the rolling identifier of the wireless identity transmitter, and
wherein the proximity broadcast receiver comprises:
a second memory;
a second transceiver configured to exchange short-range wireless signals with the wireless identity transmitter;
a network device configured to exchange signals with the server;
a second processor coupled to the second memory, the second transceiver, and the network device and configured with processor-executable instructions to perform operations comprising:
receiving via the second transceiver the short-range wireless signal including the rolling identifier broadcast by the wireless identity transmitter within proximity;
generating a sighting message in response to the received signal, wherein the sighting message includes the rolling identifier and associated data; and
transmitting the sighting message via long-range communications using the network device, and
wherein the server is configured with server-executable instructions to perform operations comprising:
receiving in the server the sighting message that includes the rolling identifier;
activating a search based on a request from a requester for proximity information of the wireless identity transmitter;
determining whether the proximity information related to the wireless identity transmitter is received based on the rolling identifier within the received sighting message;
identifying a first recipient as a user of the proximity broadcast receiver that transmitted the sighting message when the proximity information related to the wireless identity transmitter is received and when the search is active; and
determining a first reward for the identified first recipient based on the request.

77. The system of claim 76, wherein the first reward may be at least one of money, a prize, an offer, a coupon, a promotion, a discount, a favor, an item, and a privilege.

78. The system of claim 76, wherein the server is configured with server-executable instructions to perform operations further comprising transmitting a reward notification message to the identified first recipient that indicates the first reward.

79. The system of claim 76, wherein the server is configured with server-executable instructions to perform operations further comprising transmitting a response message to the requester when the proximity information related to the wireless identity transmitter is received and the search is active.

80. The system of claim 76, wherein the server is configured with server-executable instructions to perform operations further comprising providing a second reward to a second recipient associated with a device that provided connectivity for the sighting message, wherein the device is one of an access point, a cell site, a local server, a local computing device, and a WiFi router.

81. The system of claim 80, wherein the second reward is one of a small percentage of the first reward and a small flat fee.

82. The system of claim 76, wherein the server is configured with server-executable instructions to perform operations further comprising identifying search conditions and reward information based on the request, wherein the search conditions indicate when the search may be active, and wherein the reward information indicates how rewards are divided between reward recipients.

83. The system of claim 76, wherein the server is configured with server-executable instructions to perform operations further comprising transmitting a reward notification message to a reward server.

84. The system of claim 76, wherein the wireless identity transmitter is associated with at least one of a scavenger hunt, a lost item, a missing item, a stolen item, and an advertising activity.

85. The system of claim 76, wherein the server is configured with server-executable instructions to perform operations further comprising deactivating the search when the proximity information related to the wireless identity transmitter is received and when the search is active.

86. A method for displaying reward information on a mobile device, comprising:
displaying on a touchscreen a graphical user interface that includes an element positioned over an area where the reward information is to be displayed, the element appearing consistent with a scratch-off card;
determining whether touch inputs received on the touchscreen match a scratching gesture over the element, where the scratching gesture is a back-and-forth movement; and
animating removal of the element and substitution of the reward information in response to received touch inputs matching the scratching gesture over the element.

87. The method of claim 86, further comprising:
disabling the element so that a user may not interact with the element; and
activating the element in response to receiving a scratch-off activation signal so that the user may interact with the element.

88. A mobile device configured to display reward information, comprising:
means for displaying on a touchscreen a graphical user interface that includes an element positioned over an area where the reward information is to be displayed, the element appearing consistent with a scratch-off card;
means for determining whether touch inputs received on the touchscreen match a scratching gesture over the element, where the scratching gesture is a back-and-forth movement; and
means for animating removal of the element and substitution of the reward information in response to received touch inputs matching the scratching gesture over the element.

89. The mobile device of claim 88, further comprising:
means for disabling the element so that a user may not interact with the element; and
means for activating the element in response to receiving a scratch-off activation signal so that the user may interact with the element.

90. A mobile device configured to display reward information, comprising:
a memory; and
a processor coupled to the memory, wherein the processor is configured with processor-executable instructions to perform operations comprising:
displaying on a touchscreen a graphical user interface that includes an element positioned over an area where the reward information is to be displayed, the element appearing consistent with a scratch-off card;
determining whether touch inputs received on the touchscreen match a scratching gesture over the element, where the scratching gesture is a back-and-forth movement; and
animating removal of the element and substitution of the reward information in response to received touch inputs matching the scratching gesture over the element.

91. The mobile device of claim 90, wherein the processor is configured with processor-executable instructions to perform operations further comprising:
disabling the element so that a user may not interact with the element; and
activating the element in response to receiving a scratch-off activation signal so that the user may interact with the element.

92. A non-transitory processor-readable storage medium having stored thereon processor-executable software instructions configured to cause a processor to perform operations for a mobile device to display reward information, the operations comprising:
displaying on a touchscreen a graphical user interface that includes an element positioned over an area where the reward information is to be displayed, the element appearing consistent with a scratch-off card;
determining whether touch inputs received on the touchscreen match a scratching gesture over the element, where the scratching gesture is a back-and-forth movement; and
animating removal of the element and substitution of the reward information in response to received touch inputs matching the scratching gesture over the element.

93. The non-transitory processor-readable storage medium of claim 92, wherein the stored processor-executable instructions are configured to cause the processor to perform operations further comprising:
disabling the element so that a user may not interact with the element; and
activating the element in response to receiving a scratch-off activation signal so that the user may interact with the element.
